(19) United States
(12) Patent Application Publication
(10) Pub. No.: US 2009/0201620 A1
(43) Pub. Date: Aug. 13, 2009

(54) ELECTROMAGNETIC FIELD ENERGY RECYCLING

(75) Inventors: Ashley James Gray, Wellington (NZ); Neville Roy Samuel Illsley, Nelson (NZ)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Restech Limited, Wellington (NZ)

(21) Appl. No.: 12/367,092

(22) Filed: Feb. 6, 2009

Related U.S. Application Data
(60) Provisional application No. 61/065,202, filed on Feb. 8, 2008.
(60) Provisional application No. 61/072,121, filed on Mar. 27, 2008.

(30) Foreign Application Priority Data
Feb. 5, 2009 (GB) 0901849.0

(51) Int. Cl. H01H 47/22

(52) U.S. Cl. 361/159

(57) ABSTRACT

An electromagnetic field energy recycling circuit recovers energy from collapsing magnetic fields, stores recovered energy as charge on a capacitance, and subsequently re-uses stored recovered energy to establish a magnetic field. Capacitance and inductance are sequentially connected in various configurations to recycle the energy by a discontinuous resonant energy transfer. In a magnetizing configuration, a magnetic field is established by transfer of energy from a capacitance to an inductance. In a recovery configuration, a capacitance is charged with energy recovered from the inductance on collapse of the magnetic field. In a third configuration, recovered energy stored by the capacitance is held until required for establishing a magnetic field. During magnetizing, the capacitance voltage drops by at least 50%: preferably to zero. During recovery, current flowing in the inductance falls to zero. The circuit drives electromagnetic devices, e.g., electric motors, generators, transformers, solenoids, induction heating coils and inductive power transfer windings.

### CROSS-REFERENCE TO RELATED APPLICATIONS

This application claims the benefit of the filing date of U.S. Provisional Patent Application No. 61/065,202, filed Feb. 8, 2008 and entitled “Electromagnetic Field Energy Recycling”, attorney docket No. RESTEC 3.8-001, and U.S. Provisional Patent Application No. 61/072,121, filed Mar. 27, 2008 and entitled “Electromagnetic Field Energy Recycling”, attorney docket No. RESTEC 3.8-003, and also claims the benefit of UK Patent Application No. 0901849.0, filed Feb. 5, 2009 and entitled “Electromagnetic Field Energy Recycling,” case reference No. P22213GB/GDM, the entire disclosures of which are hereby expressly incorporated herein by reference.

### FIELD OF INVENTION

The present invention relates to the recycling of electromagnetic field energy. More particularly, the present invention relates to the recycling (i.e. the recovery and reuse) of energy from a magnetic field using an electromagnetic circuit having controlled switches. Energy from a collapsing magnetic field of an inductive device is recovered and stored in a capacitor for later use when re-establishing a magnetic field at that, or another, inductive device.

### BACKGROUND OF THE INVENTION

A common aspect of conventional inductive devices, such as motors, linear actuators, solenoids, transformers and induction coils, is that they rely on the building of a magnetic field to perform a motoring, transforming or inducing action, or a magnetic attraction or repulsion. The energy built up or contained within the magnetic field in these instances is substantial and significant energy remains even after work has been performed.

Standard designs of motors, solenoids, linear actuators, transformers and induction coils do not as a general rule use field energy recovery on the primary or secondary windings. The propensity of the magnetic field to remain once built up in inductive devices is often treated to some degree as a nuisance. Many control strategies are used to deplete or diminish the magnetic field in a way that minimizes damage to the inductive device or to other circuit components from excessive inductive voltage spikes and the like. Depletion of the magnetic field, sometimes referred to as ‘defluxing’, has been achieved by diode clamping, applying reverse voltages and by other field control techniques.

In some cases, rather than merely dissipating the energy and to avoid potentially destructive voltages, the energy has been recovered for later re-use. Typically, energy from a collapsing magnetic field has been returned to a capacitor, such as a supply reservoir or supplementary capacitor, for re-use when demand is next placed on the supply.

### BRIEF SUMMARY OF INVENTION

The present invention can be used to recover energy from a collapsing magnetic field and efficiently capture this recovered energy for effective re-use.

In broad terms a first aspect of the invention comprises a magnetic field energy recycling circuit comprising one or more capacitances, an inductive device, a switching circuit, and a switching circuit controller; the switching circuit controller being arranged to repetitively configure the switching circuit in a first switching circuit configuration by which the switching circuit electrically couples a first capacitance to a first inductance of the inductive device in a first circuit for a first period to transfer energy stored in the first capacitance to the inductive device by discharge of the first capacitance to thereby assist in establishing a magnetic field at the inductive device, the voltage across the first capacitance at the end of the first period being less than half the voltage across the first capacitance at the beginning of the first period; subsequent to configuration of the switching circuit in the first switching circuit configuration, the switching circuit adopting a second switching circuit configuration by which the switching circuit electrically couples a second inductance of the inductive device to a second capacitance in a second circuit for a second period to transfer energy stored in the magnetic field to the second capacitance by a current flow in the second inductance to thereby assist in establishing a charge on the second capacitance, the current flow in the second inductance being substantially zero at the end of the second period; subsequent to configuration of the switching circuit in the second switching circuit configuration, the switching circuit adopting a third switching circuit configuration by which the charge established on the second capacitance during the second period is held on the second capacitance; and the switching circuit controller being arranged to configure the switching circuit, subsequent to configuration of the switching circuit in the third switching circuit configuration, in a switching circuit configuration by which energy stored in the second capacitance is transferred to an inductive device.

The voltage across the first capacitance at the end of the first period is optionally less than 30%, or less than 20%, or less than 10% of the voltage across the first capacitance at the beginning of the first period.

Optionally, the voltage across the first capacitance at the end of the first period is substantially zero.

Optionally, the first period is substantially equal to one quarter of a natural resonance period of the first circuit; and the second period is substantially equal to one quarter of a natural resonance period of the second circuit.

Optionally, the first period, in seconds, is substantially equal to half the product of pi (π) and the square root of the product of the first capacitance in farads during the first period and the average value of the first inductance in henries during the first period; and the second period, in seconds, is substantially equal to half the product of pi and the square root of the product of the second capacitance in farads during the second period and the average value of the second inductance in henries during the second period.

Optionally, the first period is substantially equal to kπ√(L1 C1) seconds, where C1 is the first capacitance in farads during the first period and L1 is the average value of the first inductance in henries during the first period; the second period is substantially equal to kπ√(L2 C2) seconds, where C2 is the second capacitance in farads during the second period and L2 is the average value of the second inductance in henries during the second period; and k is between 0.1 and 2.5.

Optionally, k is between 0.25 and 2.5, or between 0.35 and 2.5, or between 0.5 and 2.5, or substantially equal to 0.5.

Optionally, the magnetic field energy recycling circuit is adapted for connection to a supply of electrical energy that is electrically coupled in series with the first capacitance when the switching circuit is configured in the first switching circuit configuration.

Optionally, the voltage across the second capacitance at the end of the second period is substantially greater than the voltage across the first capacitance at the beginning of the first period.

Optionally, the first capacitance is provided by one or more capacitors; and the second capacitance is provided by the same one or more capacitors.

Optionally, the first capacitance is provided by two or more capacitors electrically connected in parallel when the switching circuit is in the first switching circuit configuration; and the second capacitance is provided by the same two or more capacitors electrically connected in series when the switching circuit is in the second switching circuit configuration.

Optionally, the voltage across the one or more capacitors at the beginning of the first period and the voltage across the one or more capacitors at the end of the second period have the same polarity. Alternatively, the voltage across the one or more capacitors at the beginning of the first period and the voltage across the one or more capacitors at the end of the second period have opposite polarities.

Optionally, the first capacitance is provided by one or more capacitors; and the second capacitance is not provided by the same one or more capacitors providing the first capacitance.

Optionally, one terminal of the first capacitance and one terminal of the second capacitance are connected to a common potential; and the voltage across the first capacitance at the beginning of the first period and the voltage across the second capacitance at the end of the second period have the same polarity.

Optionally, the first inductance and the second inductance are provided by respective windings of the same inductive device. Alternatively, the first inductance and the second inductance are both provided by a common winding of the same inductive device.

Optionally, the switching circuit, when in the first switching circuit configuration, is configured to transfer energy stored in the first capacitance to the winding to establish a magnetic field at the winding; the switching circuit, when in the second switching circuit configuration, is configured to transfer energy stored in the magnetic field at the winding to the second capacitance to establish a charge on the second capacitance; and the switching circuit, when in the third switching circuit configuration, is configured to hold the charge on the second capacitance until the switching circuit controller configures the switching circuit in a further switching circuit configuration for a further period by which further configuration energy stored in the second capacitance is transferred back to the winding.

Optionally, the switching circuit is configured to direct current flow in the winding during the second period and current flow in the winding during the further period in the same direction. Alternatively, the switching circuit is configured to direct current flow in the winding during the second period and current flow in the winding during the further period in opposite directions.

Optionally, after the end of the first period and before the beginning of the second period, the switching circuit is configured in an intermediate switching circuit configuration by which current from the supply is directed through the first inductance to assist in maintaining the magnetic field established at the inductive device.

In one alternative, the first inductance is provided by a first winding; the second inductance is provided by a second winding; and the first and second windings are windings of respective first and second inductive devices.

Optionally, the switching circuit comprises at least one controlled switching device; the switching circuit controller is repetitively operable to make the at least one controlled switching device alternatively conductive and non-conductive; and the switching circuit adopts the first switching circuit configuration when the at least one controlled switching device is conductive.

Optionally, the switching circuit adopts the second switching circuit configuration when the at least one controlled switching device is non-conductive.

Optionally, the switching circuit controller is operable to make the at least one controlled switching device conductive for the first period, and non-conductive for the second and third periods.

Alternatively, the switching circuit adopts the second switching circuit configuration when the at least one controlled switching device is conductive.

Optionally, the switching circuit comprises at least one semi-conductor diode; and the at least one semi-conductor diode is conductive when the switching circuit adopts the second switching circuit configuration.

Optionally, the at least one semi-conductor diode is non-conductive when the switching circuit adopts the third switching circuit configuration.

In broad terms a second aspect of the invention comprises a magnetic field energy recycling circuit comprising a capacitor, an inductive device and a switching circuit; wherein: the switching circuit is configurable in a first configuration to direct a capacitor discharge current to flow in a first direction from the capacitor and through the inductive device to thereby establish a magnetic field in association with the inductive device; the switching circuit is configurable in a second configuration, after the magnetic field has been established, to direct a current induced in the inductive device during collapse of the magnetic field to flow into the capacitor in a second direction that is opposite the first direction to thereby charge the capacitor; and the switching circuit is configured in the first configuration for a period that is substantially equal to kπ√(LC) seconds, where L is the inductance value in henries of the inductive device, C is the capacitance value in farads of the capacitor, and k is between 0.1 and 2.5.

In broad terms a third aspect of the invention comprises a magnetic field energy recycling circuit comprising a capacitor, an inductive device and first, second, third and fourth switching devices; wherein: each of the first and second switching devices is a respective controllable switch having a closed state and an open state; each of the third and fourth switching devices has a closed state and an open state; the capacitor, the first switching device, the inductive device and the second switching device are series connected in that order in a first series circuit through which, during a first period when the first and second switching devices are each in the closed state, a capacitor discharge current flows in a first direction from the capacitor and through the inductive device to thereby establish a magnetic field in association with the inductive device; the capacitor, the third switching device, the inductive device and the fourth switching device are series connected in that order in a second series circuit through which, after the magnetic field has been established and during a second period when the first and second switching devices are each in the open state, a current induced in the inductive device during collapse of the magnetic field flows into the capacitor in a second direction that is opposite the first direction to thereby charge the capacitor; and the first period is substantially equal to kπ√(LC) seconds, where L is the inductance value of the inductive device, C is the capacitance value of the capacitor, and k is between 0.1 and 2.5.

In broad terms a fourth aspect of the invention comprises a magnetic field energy recycling circuit comprising a capacitor, an inductive device and first, second, third, fourth, fifth and sixth switching devices; wherein: each of the switching devices is a respective controllable switch having a closed state and an open state; the capacitor, the first switching device, the inductive device and the second switching device are series connected in that order in a first series circuit through which, during a first period when the first and second switching devices are each in the closed state and the third, fourth, fifth and sixth switching devices are each in the open state, a capacitor discharge current flows in a first direction from the capacitor and through the inductive device to thereby establish a first magnetic field in association with the inductive device, the first magnetic field having a first polarity; the capacitor, the third switching device, the inductive device and the fourth switching device are series connected in that order in a second series circuit through which, after the first magnetic field has been established and during a second period when the first, second, fifth and sixth switching devices are each in the open state and the third and fourth switching devices are each in the closed state, a current induced in the inductive device during collapse of the first magnetic field flows to provide a capacitor charge current flowing in a second direction that is opposite the first direction to thereby charge the capacitor; the capacitor, the fourth switching device, the inductive device and the fifth switching device are series connected in that order in a third series circuit through which, during a third period when the fourth and fifth switching devices are each in the closed state and the first, second, third and sixth switching devices are each in the open state, a capacitor discharge current flows in the first direction from the capacitor and through the inductive device to thereby establish a second magnetic field in association with the inductive device, the second magnetic field having a second polarity that is opposite the first polarity; the capacitor, the sixth switching device, the inductive device and the first switching device are series connected in that order in a fourth series circuit through which, after the second magnetic field has been established and during a fourth period when the second, third, fourth and fifth switching devices are each in the open state and the first and sixth switching devices are each in the closed state, a current induced in the inductive device during collapse of the second magnetic field flows into the capacitor in the second direction to thereby charge the capacitor; the switching devices are repeatedly switched between the closed and open states to repeatedly provide in sequence the first, second, third and fourth series circuits for the respective first, second, third and fourth periods; and the first and third periods are each substantially equal to kπ√(LC) seconds, where L is the inductance value of the inductive device, C is the capacitance value of the capacitor, and k is between 0.1 and 2.5.

Optionally, in the second, third and fourth aspects of the invention, k is between 0.25 and 1.0, or between 0.35 and 0.70, or substantially equal to 0.5.

In broad terms a fifth aspect of the invention comprises a magnetic field energy recycling circuit comprising a capacitor, an inductive device and a switching circuit; wherein: the switching circuit is configurable in a first configuration to direct a capacitor discharge current to flow in a first direction from the capacitor and through the inductive device to substantially discharge the capacitor and thereby establish a magnetic field in association with the inductive device; the switching circuit is configurable in a second configuration, after the magnetic field has been established, to direct a current induced in the inductive device during collapse of the magnetic field to flow into the capacitor in a second direction that is opposite the first direction to thereby charge the capacitor.

In broad terms a sixth aspect of the invention comprises a magnetic field energy recycling circuit comprising a capacitor, an inductive device and a switching circuit; wherein: the switching circuit is configurable in a first configuration to direct a capacitor discharge current to flow in a first direction from the capacitor and through the inductive device to substantially discharge the capacitor and thereby establish a magnetic field in association with the inductive device; the switching circuit is configurable in a second configuration, after the magnetic field has been established, to direct a current induced in the inductive device during collapse of the magnetic field to flow into the capacitor in a second direction that is opposite the first direction to thereby charge the capacitor.

In broad terms a seventh aspect of the invention comprises a magnetic field energy recycling circuit comprising a capacitor, an inductive device and first, second, third and fourth switching devices; wherein: each of the first and second switching devices is a respective controllable switch having a closed state and an open state; each of the third and fourth switching devices has a closed state and an open state; the capacitor, the first switching device, the inductive device and the second switching device are series connected in that order in a first series circuit through which, during a first period when the first and second switching devices are each in the closed state, a capacitor discharge current flows in a first direction from the capacitor and through the inductive device to substantially discharge the capacitor and thereby establish a magnetic field in association with the inductive device; the capacitor, the third switching device, the inductive device and the fourth switching device are series connected in that order in a second series circuit through which, after the magnetic field has been established and during a second period when the first and second switching devices are each in the open state, a current induced in the inductive device during collapse of the magnetic field flows into the capacitor in a second direction that is opposite the first direction to thereby charge the capacitor.

In broad terms an eighth aspect of the invention comprises a magnetic field energy recycling circuit comprising a capacitor, an inductive device and first, second, third, fourth, fifth and sixth switching devices; wherein: each of the switching devices is a respective controllable switch having a closed state and an open state; the capacitor, the first switching device, the inductive device and the second switching device are series connected in that order in a first series circuit through which, during a first period when both the first and second switching devices are each in the closed state and the third, fourth, fifth and sixth switching devices are each in the open state, a capacitor discharge current flows in a first direction from the capacitor and through the inductive device to substantially discharge the capacitor and thereby establish a first magnetic field in association with the inductive device, the first magnetic field having a first polarity; the capacitor, the third switching device, the inductive device and the fourth switching device are series connected in that order in a second series circuit through which, after the first magnetic field has been established and during a second period when the first, second, fifth and sixth switching devices are each in the open state and the third and fourth switching devices are each in the closed state, a current induced in the inductive device during collapse of the first magnetic field flows to provide a capacitor charge current flowing in a second direction that is opposite the first direction to thereby charge the capacitor; the capacitor, the fourth switching device, the inductive device and the fifth switching device are series connected in that order in a third series circuit through which, during a third period when both the fourth and fifth switching devices are each in the closed state and the first, second, third and sixth switching devices are each in the open state, a capacitor discharge current flows in the first direction from the capacitor and through the inductive device to substantially discharge the capacitor and thereby establish a second magnetic field in association with the inductive device, the second magnetic field having a second polarity that is opposite the first polarity; the capacitor, the sixth switching device, the inductive device and the first switching device are series connected in that order in a fourth series circuit through which, after the second magnetic field has been established and during a fourth period when the second, third, fourth and fifth switching devices are each in the open state and the first and sixth switching devices are each in the closed state, a current induced in the inductive device during collapse of the second magnetic field flows into the capacitor in the second direction to thereby charge the capacitor; and the switching devices are repeatedly switched between the closed and open states to repeatedly provide in sequence the first, second, third and fourth series circuits for the respective first, second, third and fourth periods.

Optionally, in the second to eighth aspects of the invention, the capacitor discharge current discharges the capacitor such that the voltage across the capacitor is substantially zero.

Optionally, in the second and sixth aspects of the invention, the switching circuit is configurable in a third configuration by which charge established on the capacitor when the circuit was configured in the second configuration is held on the capacitor until the switching circuit is next configured in the first configuration.

Optionally, in the third and seventh aspects of the invention, during a third period, when the first, second, third and fourth switching devices are each in the open state, a charge established on the capacitor during the second period is held on the capacitor until the first and second switching devices are both closed to re-establish the first series circuit.

Optionally, in the fourth and eighth aspects of the invention, during a fifth period, when the first, second, third, fourth, fifth and sixth switching devices are each in the open state, a charge established on the capacitor during the second period is held on the capacitor until the third period when the fourth and fifth switching devices are each in the closed state to establish the third series circuit; and during a sixth period, when the first, second, third, fourth, fifth and sixth switching devices are each in the open state, a charge established on the capacitor during the fourth period is held on the capacitor until the first and second switching devices are next each in the closed state to establish the first series circuit.

Optionally, the second and sixth aspects of the invention comprise a switching circuit controller that is operable to control the switching circuit to repetitively adopt the first configuration.

Optionally, the third and seventh aspects of the invention comprise a switching circuit controller that is operable to control the first and second switching devices to repetitively adopt the closed state and thereby repetitively establish the first series circuit.

Optionally, the fourth and eighth aspects of the invention comprise a switching circuit controller that is operable to control and repetitively switch the first, second, third, fourth, fifth and sixth switching devices between the closed and open states to repeatedly provide in sequence the first, second, third and fourth series circuits for the respective first, second, third and fourth periods.

In broad terms a ninth aspect of the invention comprises a circuit for energizing a multiple phase inductive device, wherein: the circuit comprises a plurality of magnetic field energy recycling circuits each according to any of the above-mentioned first to eighth aspects, and options and alternatives; the multiple phase inductive device comprises a plurality of phase windings; the inductive device of each magnetic field energy recycling circuit is a respective phase winding of the multiple phase inductive device; the magnetic field energy recycling circuits are connected together in a closed loop with the second capacitance of each magnetic field energy recycling circuit being the first capacitance of the next magnetic field energy recycling circuit in the loop; and the respective switching circuits of the magnetic field energy recycling circuits are selectively controlled to sequentially transfer energy to each phase winding in turn around the loop.

In broad terms a tenth aspect of the invention comprises a switched reluctance motor comprising a magnetic field energy recycling circuit according to any of the above-mentioned first to eighth aspects, and options and alternatives; wherein the inductive device is a stator winding of the switched reluctance motor.

In broad terms an eleventh aspect of the invention comprises a synchronous reluctance motor comprising a magnetic field energy recycling circuit according to any of the above-mentioned first to eighth aspects, and options and alternatives; wherein the inductive device is a stator winding of the synchronous reluctance motor.

In broad terms a twelfth aspect of the invention comprises a solenoid driven actuator comprising a magnetic field energy recycling circuit according to any of the above-mentioned first to eighth aspects, and options and alternatives; wherein the inductive device is a solenoid of the solenoid driven actuator.

In broad terms a thirteenth aspect of the invention comprises a solenoid driven pump comprising a magnetic field energy recycling circuit according to any of the above-mentioned first to eighth aspects, and options and alternatives; as claimed in any one of claims 1 to 50, wherein: the inductive device is a solenoid of the solenoid driven pump.

In broad terms a fourteenth aspect of the invention comprises a transformer comprising a magnetic field energy recycling circuit according to any of the above-mentioned first to eighth aspects, and options and alternatives; wherein the inductive device is a winding of the transformer.

In broad terms a fifteenth aspect of the invention comprises an electrical generator comprising a magnetic field energy recycling circuit according to any of the above-mentioned first to eighth aspects, and options and alternatives; wherein the inductive device is a winding of the electrical generator.

In broad terms a sixteenth aspect of the invention comprises an induction heater comprising a magnetic field energy recycling circuit according to any of the above-mentioned first to eighth aspects, and options and alternatives; wherein the inductive device is a work coil of the induction heater.

In broad terms a seventeenth aspect of the invention comprises an inductive power transfer device comprising a magnetic field energy recycling circuit according to any of the above-mentioned first to eighth aspects, and options and alternatives; wherein the inductive device is a winding of the inductive power transfer device.

In broad terms an eighteenth aspect of the invention comprises a method of operating an inductive device comprising the steps of: connecting a capacitance to an inductance of the inductive device in a first circuit for a first period to transfer energy stored in the capacitance to the inductive device by discharge of the capacitance such that voltage across the capacitance at the end of the first period is less than half the voltage across the capacitance at the beginning of the first period, and to thereby assist in establishing a magnetic field at the inductive device; connecting the inductance of the inductive device to the capacitance in a second circuit for a second period to transfer energy stored in the magnetic field to the capacitance by a current flow in the inductance such that the current flow in the inductance at the end of the second period is substantially zero, and to thereby assist in establishing a charge on the capacitance; holding the charge, established on the capacitance during the second period, on the capacitance for a third period; and repeating steps (a), (b) and (c).

Optionally, in step (a), the voltage across the capacitance at the end of the first period is less than 30%, or 20%, or 10% of the voltage across the capacitance at the beginning of the first period.

Optionally, in step (a), the voltage across the capacitance at the end of the first period is substantially zero.

Optionally, the first period is substantially equal to one quarter of a natural resonance period of the first circuit; and the second period is substantially equal to one quarter of a natural resonance period of the second circuit.

Optionally, the first period, in seconds, is substantially equal to half the product of pi and the square root of the product of the capacitance in farads during the first period and the average value of the inductance in henries during the first period; and the second period, in seconds, is substantially equal to half the product of pi and the square root of the product of the capacitance in farads during the second period and the average value of the inductance in henries during the second period.

Optionally, the first period is substantially equal to 0.5π√(L1 C1) seconds where C1 is the capacitance in farads during the first period and L1 is the average value of the inductance in henries during the first period, and the second period is substantially equal to 0.5π√(L2 C2) seconds, where C2 is the capacitance in farads during the second period and L2 is the average value of the inductance in henries during the second period.

Optionally, in step (a), a supply of electrical energy is electrically connected in series with the capacitance.

Optionally, in step (a), the capacitance is provided by one or more capacitors connected in parallel; and in step (b), the capacitance is provided by the same one or more capacitors connected in series.

Optionally, between steps (a) and (b), current from a supply of electrical energy is directed through the inductance to assist in maintaining the magnetic field established in step (a) at the inductive device.

Optionally, in step (a), the capacitance is connected to the inductance of the inductive device by making at least one controlled switching device conductive.

Optionally, in step (b), the inductance is connected to the capacitance by making the at least one controlled switching device conductive. Alternatively, in step (b), the at least one controlled switching device is non-conductive, and the inductance is connected to the capacitance by making at least one semi-conductor diode conductive.

Optionally, in step (c), the at least one controlled switching device is non-conductive and the at least one semi-conductor diode is non-conductive.

Optionally, the electromagnetic field energy recycling circuit connected to a supply of electrical energy; and between steps (a) and (b), current from the supply is directed through the inductance to assist in maintaining the magnetic field established in step (a) at the inductive device.

Optionally, the inductive device is a stator winding of a switched reluctance motor.

Optionally, the inductive device is a stator winding of a synchronous reluctance motor.

Optionally, the inductive device is a solenoid of a solenoid driven actuator.

Optionally, the inductive device is a solenoid of a solenoid driven pump.

Optionally, the inductive device is winding of a transformer.

Optionally, the inductive device is a winding of an electrical generator.

Optionally, the inductive device is a work coil of an induction heater.

Optionally, the inductive device is a winding of an inductive power transfer device.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

As used herein the term “and/or” means “and” or “or”, or both.

As used herein “(s)” following a noun means the plural and/or singular forms of the noun.

The term ‘inductor’ as used in this specification means a passive component that is incorporated in a circuit primarily for its property of inductance.

The term ‘inductive device’ as used in this specification means a device having inductance but which is incorporated in a circuit primarily for establishing a magnetic field to perform, for example, a motoring, transforming or inducing action, or a magnetic attraction or repulsion. Inductive devices include, but are not limited to, transformers, electromagnetic motors, linear actuator coils, electromagnets, solenoid coils and induction coils.

References herein to a current induced in an inductive device during collapse of a magnetic field can be understood as referring to a current that is driven by a voltage induced in the inductive device by collapse of the magnetic field through the winding inductance of the device.

### BRIEF DESCRIPTION OF DRAWINGS

The invention will be further described by way of example only and without intending to be limiting with reference to the following drawings, wherein:

FIG. 1A shows a circuit illustrating a first embodiment of the invention;

FIG. 1B is a switch timing diagram for the circuit of FIG. 1A, showing one cycle of circuit operation;

FIG. 1C is a first magnetizing configuration of the circuit of FIG. 1A during a first stage of a cycle of operation;

FIG. 1D is a second magnetizing configuration of the circuit of FIG. 1A during a first stage of a cycle of operation;

FIG. 1E is a first energy recovery configuration of the circuit of FIG. 1A during a second stage of a cycle of operation;

FIG. 1F is a second energy recovery configuration of the circuit of FIG. 1A during a second stage of a cycle of operation;

FIG. 1G shows waveforms of the supply current (upper waveform) and inductive device current (lower waveform), for the circuit of FIG. 1A over several cycles of operation during initial start-up;

FIG. 1H shows waveforms of the supply current (upper waveform) and inductive device current (lower waveform), for the circuit of FIG. 1A over two cycles of operation for a run mode;

FIG. 1I shows a waveform of the voltage across a recovery capacitor of the circuit of FIG. 1A over several cycles of operation during initial start-up;

FIG. 1J shows a waveform of the voltage across a recovery capacitor of the circuit of FIG. 1A over two cycles of operation for a run mode;

FIG. 1K shows a table of circuit parameters and operating performance over range of capacitor values, for a circuit according to the first embodiment of the invention;

FIG. 1L shows a graph illustrating circuit operating performance over range of capacitor values, for a circuit according to the first embodiment of the invention;

FIG. 2A shows a circuit illustrating a second embodiment of the invention;

FIG. 2B is a switch timing diagram for the circuit of FIG. 2A, showing one cycle of circuit operation;

FIG. 2C is a first magnetizing configuration of the circuit of FIG. 2A during a first stage of a cycle of operation;

FIG. 2D is a second magnetizing configuration of the circuit of FIG. 2A during a first stage of a cycle of operation;

FIG. 2E is an energy recovery configuration of the circuit of FIG. 2A during a second stage of a cycle of operation;

FIG. 2F shows waveforms of the supply current (upper waveform) and inductive device current (lower waveform), for the circuit of FIG. 2A over several cycles of operation during initial start-up;

FIG. 2G shows waveforms of the supply current (upper waveform) and inductive device current (lower waveform), for the circuit of FIG. 2A over two cycles of operation for a run mode;

FIG. 2H shows a waveform of the voltage between upper and lower rails of the circuit of FIG. 2A over several cycles of operation during initial start-up;

FIG. 2I shows a waveform of the voltage between upper and lower rails of the circuit of FIG. 2A over two cycles of operation for a run mode;

FIG. 2J shows a circuit illustrating a specific application of the second embodiment of the invention;

FIG. 2K shows a prior art circuit of conventional topology for comparison with the circuit shown in FIG. 2J;

FIG. 3A shows a circuit illustrating a third embodiment of the invention;

FIG. 3B is a switch timing diagram for the circuit of FIG. 3A, showing one cycle of circuit operation;

FIG. 3C is a first magnetizing configuration of the circuit of FIG. 3A during a first stage of a cycle of operation;

FIG. 3D is a second magnetizing configuration of the circuit of FIG. 3A during a first stage of a cycle of operation;

FIG. 3E is an energy recovery configuration of the circuit of FIG. 3A during a second stage of a cycle of operation;

FIG. 3F shows waveforms of the supply current (upper waveform) and inductive device current (lower waveform), for the circuit of FIG. 3A over several cycles of operation during initial start-up;

FIG. 3G shows waveforms of the supply current (upper waveform) and inductive device current (lower waveform), for the circuit of FIG. 3A over two cycles of operation for a run mode;

FIG. 3H shows a waveform of the voltage across a recovery capacitor of the circuit of FIG. 3A over several cycles of operation during initial start-up;

FIG. 3I shows a waveform of the voltage across a recovery capacitor of the circuit of FIG. 3A over two cycles of operation for a run mode;

FIG. 4A shows a circuit illustrating a fourth embodiment of the invention;

FIG. 4B is a switch timing diagram for the circuit of FIG. 4A, showing one cycle of circuit operation in a run mode;

FIG. 4C is a first magnetizing configuration of the circuit of FIG. 4A during a first stage of a cycle of operation;

FIG. 4D is a second magnetizing configuration of the circuit of FIG. 4A during a first stage of a cycle of operation;

FIG. 4E is a third magnetizing configuration of the circuit of FIG. 4A during a first stage of a cycle of operation;

FIG. 4F is an energy recovery configuration of the circuit of FIG. 4A during a second stage of a cycle of operation;

FIG. 4G shows waveforms of the supply current (upper waveform) and inductive device current (lower waveform), for the circuit of FIG. 4A over several cycles of operation during initial start-up;

FIG. 4H shows waveforms of the supply current (upper waveform) and inductive device current (lower waveform), for the circuit of FIG. 4A over two cycles of operation for a run mode;

FIG. 4I shows a waveform of the voltage between upper and lower rails of the circuit of FIG. 4A over several cycles of operation during initial start-up;

FIG. 4J shows a waveform of the voltage between upper and lower rails of the circuit of FIG. 4A over two cycles of operation for a run mode;

FIG. 5A shows a circuit illustrating a fifth embodiment of the invention;

FIG. 5B is a switch timing diagram for the circuit of FIG. 5A, showing one cycle of circuit operation;

FIG. 5C is a first magnetizing configuration of the circuit of FIG. 5A during a first stage of a cycle of operation;

FIG. 5D is a second magnetizing configuration of the circuit of FIG. 5A during a first stage of a cycle of operation;

FIG. 5E is an energy recovery configuration of the circuit of FIG. 5A during a second stage of a cycle of operation;

FIG. 5F shows a circuit illustrating a specific application of the fifth embodiment of the invention;

FIG. 5G shows a prior art circuit of conventional topology for comparison with the circuit shown in FIG. 5I;

FIG. 5H shows a circuit illustrating a specific application of the second embodiment of the invention for comparison with the circuit shown in FIG. 5I;

FIG. 5I shows a circuit illustrating a specific application of the fifth embodiment of the invention, for comparison with the circuits shown in FIGS. 5G and 5H;

FIG. 5J shows waveforms of current and inductance for a motor winding in the circuit of FIG. 5F, in a motor driven at low speed;

FIG. 5K shows waveforms of current and inductance for a motor winding in the circuit of FIG. 5F, in a motor driven at medium speed;

FIG. 5L shows waveforms of current and inductance for a motor winding in the circuit of FIG. 5F, in a motor driven at high speed;

FIG. 6A shows a circuit illustrating a sixth embodiment of the invention;

FIG. 6B is a switch timing diagram for the circuit of FIG. 6A, showing one cycle of circuit operation;

FIG. 6C is a first magnetizing configuration of the circuit of FIG. 6A during a first stage of a cycle of operation;

FIG. 6D is a second magnetizing configuration of the circuit of FIG. 6A during a first stage of a cycle of operation;

FIG. 6E is a third magnetizing configuration of the circuit of FIG. 6A during a first stage of a cycle of operation;

FIG. 6F is a fourth magnetizing configuration of the circuit of FIG. 6A during a first stage of a cycle of operation;

FIG. 6G is a first energy recovery configuration of the circuit of FIG. 6A during a second stage of a cycle of operation;

FIG. 6H is a second energy recovery configuration of the circuit of FIG. 6A during a second stage of a cycle of operation;

FIG. 7A shows a circuit illustrating a seventh embodiment of the invention;

FIG. 7B is a switch timing diagram for the circuit of FIG. 7A, showing one cycle of circuit operation;

FIG. 7C is a first magnetizing configuration of the circuit of FIG. 7A during a first stage of a cycle of operation;

FIG. 7D is a second magnetizing configuration of the circuit of FIG. 7A during a first stage of a cycle of operation;

FIG. 7E is an energy recovery configuration of the circuit of FIG. 7A during a second stage of a cycle of operation;

FIG. 8A shows a circuit illustrating an eighth embodiment of the invention;

FIG. 8B is a switch timing diagram for the circuit of FIG. 8A, showing one cycle of circuit operation;

FIG. 8C is a first magnetizing configuration of the circuit of FIG. 8A during a first stage of a cycle of operation;

FIG. 8D is a second magnetizing configuration of the circuit of FIG. 8A during a first stage of a cycle of operation;

FIG. 8E is a third magnetizing configuration of the circuit of FIG. 8A during a first stage of a cycle of operation;

FIG. 8F is an energy recovery configuration of the circuit of FIG. 8A during a second stage of a cycle of operation;

FIG. 8G shows waveforms for the supply current (upper waveform), recovery capacitor current (middle waveform), and inductive device current (lower waveform), for the circuit of FIG. 8A over several cycles of operation during initial start-up;

FIG. 8H shows waveforms for the supply current (upper waveform), recovery capacitor current (middle waveform) and inductive device current (lower waveform), for the circuit of FIG. 8A over two cycles of operation for a run mode;

FIG. 8I shows voltage waveforms of the circuit of FIG. 8A over several cycles of operation during initial start-up, the upper waveform showing the voltage of the dual voltage supplies as applied to the anode of diode D3 and the lower waveform showing the voltage across the recovery capacitor C1;

FIG. 9A shows a circuit illustrating a ninth embodiment of the invention;

FIG. 9B is a magnetizing configuration of the circuit of FIG. 9A during a first stage of a cycle of operation;

FIG. 9C an energy recovery configuration of the circuit of FIG. 9A during a second stage of a cycle of operation;

FIG. 10A shows a circuit illustrating a tenth embodiment of the invention;

FIG. 10B is a switch timing diagram for the circuit of FIG. 10A, showing one cycle of circuit operation;

FIG. 10C is a first magnetizing configuration of the circuit of FIG. 10A, during a first quarter of a cycle of operation;

FIG. 10D is a second magnetizing configuration of the circuit of FIG. 20A, during the first quarter of a cycle of operation;

FIG. 10E is a first energy recovery configuration of the circuit of FIG. 10A, during a second quarter of a cycle of operation;

FIG. 10F is a third magnetizing configuration of the circuit of FIG. 10A, during a third quarter of a cycle of operation;

FIG. 10G is a fourth magnetizing configuration of the circuit of FIG. 10A, during the third quarter of a cycle of operation;

FIG. 10H is a second energy recovery configuration of the circuit of FIG. 10A, during a fourth quarter of a cycle of operation;

FIG. 10I shows waveforms for the current delivered from a reservoir capacitor (upper waveform) and the inductive device current (lower waveform), for the circuit of FIG. 10A over several cycles of operation during initial start-up;

FIG. 10J shows waveforms for the current delivered from a reservoir capacitor (upper waveform) and the inductive device current (lower waveform), for the circuit of FIG. 10A over several cycles of operation for a run mode;

FIG. 10K shows a circuit illustrating a specific application of the tenth embodiment of the invention;

FIG. 11A shows a circuit illustrating an eleventh embodiment of the invention;

FIG. 11B is a switch timing diagram for the circuit of FIG. 11A, showing one cycle of circuit operation;

FIG. 11C shows a block diagram of an application of the invention for driving a two phase motor;

FIG. 11D shows a block diagram of an application of the invention for driving a three phase motor;

FIG. 12A shows a circuit illustrating a twelfth embodiment of the invention;

FIG. 12B is a first switch timing diagram for the circuit of FIG. 12A, showing a minor pulse cycle of circuit operation;

FIG. 12C is a second switch timing diagram for the circuit of FIG. 12A, showing a major cycle of circuit operation;

FIG. 13A shows a circuit illustrating a thirteenth embodiment of the invention;

FIG. 13B is a first switch timing diagram for the circuit of FIG. 13A, showing a minor pulse cycle of circuit operation;

FIG. 13C is a second switch timing diagram for the circuit of FIG. 13A, showing a major cycle of circuit operation;

FIG. 13D shows a circuit illustrating a specific application of the thirteenth embodiment of the invention;

FIG. 13E shows waveforms of voltage and current for the circuit of FIG. 13D;

FIG. 14A shows a circuit illustrating a fourteenth embodiment of the invention;

FIG. 14B is a switch timing diagram for the circuit of FIG. 14A, showing one cycle of circuit operation;

FIG. 14C is a first magnetizing configuration of the circuit of FIG. 14A during a first stage of a cycle of operation;

FIG. 14D is a second magnetizing configuration of the circuit of FIG. 14A during a first stage of a cycle of operation;

FIG. 14E is an energy recovery configuration of the circuit of FIG. 14A during a second stage of a cycle of operation,

FIG. 15A shows a circuit illustrating a fifteenth embodiment of the invention;

FIG. 15B shows waveforms of the voltage across a recovery capacitor (upper waveform) and current through an inductive device (lower waveform) of the circuit of FIG. 15A;

FIG. 16A shows a circuit illustrating a sixteenth embodiment of the invention;

FIG. 16B shows waveforms of the voltage across a recovery capacitor (upper waveform) and the current through an inductive device (lower waveform) of the circuit of FIG. 16A;

FIG. 17A shows a circuit illustrating a seventeenth embodiment of the invention;

FIG. 17B shows waveforms of the voltage across a recovery capacitor (upper waveform), current through a first inductance (middle waveform), and current through a second inductance (lower waveform) of the circuit of FIG. 17A;

FIG. 18A shows a circuit illustrating an eighteenth embodiment of the invention;

FIG. 18B shows waveforms: the upper two waveforms are of the voltages across two recovery capacitors, and the lower waveform is of the current through an inductance, of the circuit of FIG. 18A;

FIG. 19A shows a circuit illustrating a nineteenth embodiment of the invention;

FIG. 19B shows waveforms of the voltages across four recovery capacitors of the circuit of FIG. 19A;

FIG. 19C shows waveforms of the current through four inductances of the circuit of FIG. 19A;

FIG. 20A shows a circuit illustrating a twentieth embodiment of the invention;

FIG. 20B shows waveforms of the voltages across four recovery capacitors of the circuit of FIG. 20A;

FIG. 20C shows waveforms of the current through four inductances of the circuit of FIG. 20A;

FIG. 21 shows examples of end use applications of the current invention using various inductive devices driven from various supply types;

FIGS. 22A to 22G show seven examples of power supply circuits suitable for powering the current invention; and

FIGS. 23A and 23B show two examples of gate driver circuits suitable for driving FET switches in the current invention.

### DETAILED DESCRIPTION

The current invention relates to circuits for driving electromagnetic devices. The invention relates particularly to such circuits incorporating recovery of energy from a collapsing magnetic field, the storage of that recovered energy as charge on a capacitance, and the subsequent use of the stored recovered energy to establish a magnetic field. The invention makes use of efficient transfer of energy between charge stored on capacitors and magnetic fields associated with inductances of inductive devices, such as in electric motors, generators, transformers, solenoids and induction heating coils, for example.

In the current invention, the transfer of energy, from inductance to capacitance, and from capacitance to inductance, behaves similarly to corresponding energy transfers between the inductance and capacitance of a resonant circuit. However, unlike freely oscillating resonant circuits in which energy is continuously and repetitively transferred back and forth between inductance and capacitance without interruption, circuits according to the current invention operate repetitively but with what may be termed interrupted, or discontinuous, resonant energy transfer. In applications of the current invention, the repetitive but interrupted transfer of energy between capacitance and inductance is performed under the control of a switching circuit, for example using transistors and semiconductor diodes as switch elements.

The repetitive transfer of energy between capacitance and inductance, even when discontinuous, builds energy in the reactive components (capacitor and inductor) in the same way as in a resonant circuit, such that, after successive cycles, the voltages and circulating currents in the reactive component circuit can be substantially greater than those of the supply feeding the circuit.

In the current invention, the controlled switching circuit effectively connects capacitance and inductance in various circuit configurations to carry out the energy transfers. In a magnetizing configuration, the switching circuit effectively connects a capacitance to an inductance to transfer energy stored on the capacitance to the inductance, to establish or assist in establishing a magnetic field. In an energy recovery configuration, the switching circuit effectively connects an inductance to a capacitance to charge the capacitance with energy recovered from the inductance on collapse of the magnetic field. In a third configuration, the switching circuit is configured to hold the recovered energy stored by the capacitance until required for establishing an electromagnetic field.

In embodiments of the invention, as in freely oscillating resonant circuits, transfer of energy from capacitance to inductance reaches a maximum when voltage across the capacitance falls to zero, and transfer of energy from inductance to capacitance reaches a maximum when current flowing in the inductance falls to zero.

In many prior art magnetic field energy recovery circuits using a capacitor to store energy recovered from a collapsing magnetic field, and later re-using the energy stored on the capacitor to establish a magnetic field, the voltage across the capacitor is maintained at a relatively high level, usually above or close to a supply voltage. This results in less than optimum efficiency of energy transfer. In these circuits the capacitance is relatively large and acts as an energy reservoir that is not completely, nor even nearly, depleted during a magnetizing period.

In the current invention, the switching circuit is configured in the magnetizing and energy recovery configurations for respective magnetizing and energy recovery periods. For efficient energy recovery and re-use of recovered energy, these periods are close to, or substantially equal to, one quarter of the natural resonance period of the respective circuit configuration. By correctly controlling these periods to suit the circuit reactances of the respective switching circuit configurations, and/or by designing the circuit to automatically and passively adopt the correct configurations at the correct times, each resonant-like energy transfer action can be dis-continued when the respective energy transfer is at, or close to, a maximum.

Maximum recovery of energy from the magnetic field occurs when current flowing in the inductance falls to zero. In practical switching circuits according to the invention, the recovery period is made sufficient to allow the inductor current that recharges the recovery capacitance to fall to zero. If the inductor current is not zero at the end of the recovery period, and provision is not made to deal with the non-zero current, large and potentially damaging voltages could be generated by the inductance, for example when reconfiguring the switching circuit from the recovery configuration to the magnetizing configuration.

Maximum transfer of energy stored in the charge on the capacitance occurs when voltage on the capacitance falls to zero. However, in practical switching circuits according to the invention, the capacitor voltage does not necessarily need to fall to zero. Unlike the preferred zero inductance current as discussed in the immediately preceding paragraph, there is no necessity for the capacitance voltage to fall to zero during the magnetizing period. Voltage remaining on the capacitance can be held, without significant loss, until further charge is added to the capacitance at the next energy recovery period. Substantial energy can be transferred from the capacitance to the inductance even when non-zero voltages remaining on the capacitance at the end of the magnetizing period, giving useful performance of circuits according to the current invention. Voltage remaining on the capacitance may result from incomplete discharge of the capacitance or, in some embodiments of the current invention, may result from first discharging the capacitance then recharging the capacitance to an opposite polarity.

For optimum energy transfers, the energy recovery period and the magnetizing period are each equal to half the product of pi and the square root of the product of the inductance and capacitance of the respective circuit configuration. In other words, the energy recovery period and the magnetizing period each equal 0.5π√(LC) seconds, where L is the circuit inductance value in henries, and C is the circuit capacitance value in farads.

It is to be noted that circuits according to the invention do not necessarily operate simultaneously at maximum overall efficiency of power transfer from supply to load and delivery of maximum output power. Furthermore, neither of these maxima necessarily occurs simultaneously with maximum energy transfer between the inductance and recovery capacitance of the switching circuit.

The value of the inductance may be substantially constant during magnetizing and/or recovery configurations, for example as in transformers, generators or induction heating coils. In some applications of the invention, the inductance may alter dynamically during the periods the switching circuit is configured in these configurations. For example, a switched reluctance motor or a solenoid-driven actuator or pump may present a winding inductance that varies, either linearly or non-linearly, over a wide range during operation. In this case, the capacitance and switching circuit periods can be selected so that even with the dynamically changing inductance, the objective of substantially complete energy transfer is achieved by the end of the respective magnetizing or field energy recovery periods. Whether the inductance value is fixed or dynamically varying, the maximum transfer of energy from the capacitance to the inductance still occurs when voltage on the capacitance falls to zero, and the maximum transfer of energy from the inductance to the capacitance occurs when current flowing in the inductance falls to zero.

In applications, for example switched reluctance motors, where the inductance is not fixed, an average inductance value can be used in mathematical expressions to determine a relationship between the inductance and the recovery capacitance, and a magnetizing or recovery period. Although this average inductance value may not be absolutely mathematically correct, an average value has been found to provide a close approximation for calculation of optimum values of periods and recovery capacitor values for practical circuits. The use of an approximate average inductance value can avoid the need for complex modelling and integration of changing inductance values over magnetizing and recovery periods.

The values of inductance and capacitance may be substantially the same for the magnetizing and recovery configurations. Alternatively, the values of inductance and/or capacitance for the magnetizing configuration may differ from the values of inductance and/or capacitance for the recovery configuration. For example, in some specific embodiments of the current invention, a plurality of two or more capacitors are connected in parallel for the magnetizing configuration but are connected in series for the recovery configuration. The series connection of the capacitors provides a lower capacitance value than the parallel connection. The lower capacitance of the series-connected capacitors decreases the natural resonance period or circuit time constant and therefore enables a faster recovery of magnetic field energy. This can be advantageous in applications of the current invention for driving high speed motors. The relatively larger capacitance of the parallel-connected capacitors increases the natural resonance period or circuit time constant and lengthens the duration of the magnetizing current pulse.

The changes between parallel connection and series connection of the two or more capacitors can be performed passively, for example by passive switching of semi-conductor diodes by the bias voltage on the diodes. Alternatively, the changes between parallel connection and series connection can be performed actively, for example by controlled switching of transistors. Active control of the series/parallel connection may be used to connect the capacitors solely in parallel, in series and parallel, and solely in series through various phases of start-up or operation of inductive devices to advantageously configure the magnetizing and recovery period capacitances to optimize maximum capacitor operating voltages and therefore energy transfers.

The recovery capacitance can also be dynamically varied throughout the operating cycle. In addition to the series/parallel switching arrangements cited above, combinations of capacitors from a bank of parallel capacitors can be switched in and out of circuit to provide a wide range of recovery capacitance values to meet the requirements of specific circuits or applications.

The switching circuit is selectively controlled to commence the magnetizing configuration. For example, in applications of circuits according to the current invention to drive a variable reluctance motor, the magnetizing configuration may be commenced at a synchronization time derived from a pick-up or sensor device monitoring the angular position of the rotor of the motor.

The duration or period that the switching circuit maintains the magnetizing configuration may be actively controlled by controlled switches, for example transistors, or may be determined by passive circuit elements, for example diodes, which respond automatically to polarities of circuit voltages or currents.

Similarly, the duration or period that the switching circuit maintains the field energy recovery configuration may be actively controlled by controlled switches, for example transistors, or may be determined by passive circuit elements, for example diodes, which respond automatically to polarities of circuit voltages or currents.

Semiconductor diodes are used in some embodiments of the current invention to make automatic changes to the switching circuit configurations. For example, semiconductor diodes are used to react to the fall to zero of the inductor current and to then change the switching circuit from the second configuration to the third configuration at the optimum time of maximum energy transfer, without requiring actively controlled switching.

In the third switching circuit configuration, energy recovered from a magnetic field is stored on an energy recovery capacitor and held there until required for establishing, or assisting in establishing, a subsequent magnetic field. The third switching circuit configuration ends and the cycle is repeated when the switching circuit is selectively controlled to commence the next magnetizing configuration. The next cycle is initiated by actively switching the switching circuit to adopt a magnetizing configuration. For example, the initiation of the next cycle may be synchronized with a predetermined position of a rotor in applications where the circuit is used to drive a motor, or synchronized with a clock signal where the circuit is used to provide a predetermined fixed frequency output.

In some circuits according to the invention, the first and second switching circuit configurations may be identical, in which case the first configuration provided by the switching circuit may be maintained to also provide the second configuration. For example, a capacitor charged to a voltage of one polarity is discharged to drive current into an inductor to establish a magnetic field. When the voltage on the capacitor reaches zero, the current in the inductor has reached a maximum and energy transfer from capacitor to inductor is complete. The inductor current continues to flow in the same direction, but starts to drop in amplitude and the magnetic field begins to collapse. The continuing, but falling, current recharges the capacitor to a voltage of the opposite polarity. Energy recovery is complete when the inductor current has dropped to zero. In this circuit there is no change in circuit configuration from the magnetizing configuration to the recovery configuration.

The transition from the second, i.e. energy recovery, configuration to the third, i.e. holding, configuration can be achieved by semiconductor diodes which conduct to allow the inductor current to flow in the one direction as described above, but which become non-conductive to block a reverse current from flowing. This blocking prevents discharge of the capacitor when charged to the opposite polarity, at least until actively switched by a switching circuit controller, to commence a new magnetizing period, for example.

Some circuits according to the invention may incorporate further switching circuit configurations between the three configurations described above, without departing from the invention.

For example, although in some circuits the second, i.e. recovery, configuration follows immediately after the first, i.e. magnetizing, configuration, there may be intermediate configurations by which the inductor current, initiated by transfer of recovered energy from the capacitor, is maintained or extended by passing current, drawn from a supply, through the inductor. At the end of the inductor current extension period the supply is disconnected from the inductor, configuring the switching circuit in a recovery configuration and initiating a field energy recovery phase. During the recovery phase, the inductor current falls, the magnetic field collapses and energy is recovered to be stored on the capacitor.

In a further example of other switching circuit configurations, the inductor current initiated by transfer of recovered energy from the capacitor may be regulated by switching, or chopping, the discharge of the capacitor into the inductor.

By recovering and re-using energy from the magnetic field using the discontinuous resonant-like energy transfer of the current invention, magnetic fields can be established with increased efficiency, using lower supply voltages and/or providing greater field strengths. For example, in some embodiments of the invention, the voltage stored on the recovery capacitor after recovery of energy from the collapsing magnetic field, is placed in series with the supply to compound the voltage available for subsequently re-establishing the magnetic field. After repetitively recycling energy recovered from the magnetic field over a few cycles, circuits according to the invention can operate with a significantly boosted voltage on the capacitor at the beginning of each magnetizing configuration period. The boosted voltage can be many times the voltage of the electrical source supplying the circuit. This voltage boosting or compounding action is similar to that of a resonant circuit, and like the resonant circuit, depends on the quality factor, or Q, of the circuit. The voltage compounding action allows motors and other inductive devices to be operated using relatively high working voltages derived from relatively low supply voltages. Some embodiments of the current invention drive inductive devices harder, i.e. with higher winding currents, and/or operated at higher efficiency, than when operated by prior art circuits using the same supply voltage.

The current invention has particular application to motors where higher mechanical output torque does not necessarily correlate with higher motor winding currents. Motor torque can be affected by the shape of the winding current waveform, and particularly by the steepness of the rise in winding current. A faster rising winding current can give a higher motor torque and is particularly advantageous at high speed operation. The voltage compounding action described above provides a higher voltage that gives a faster rising winding current waveform and a higher motor output torque, than would be achieved from just the supply voltage alone.

Circuits according to the invention can be configured in a wide range of circuit topologies. For example, circuits according to the invention can be configured to establish a magnetic field of one polarity by discharging a capacitor charged to a first polarity, and then recover energy from that magnetic field to recharge the capacitor to the same or opposite polarity. Successive magnetizings of the inductive device may provide magnetic fields of the same or alternating polarities. There may be only a single inductance and capacitance. Alternatively, a pair or a multiple number of capacitors may be alternately charged and discharged to repetitively recover energy from a magnetic field and deliver energy to re-establish a magnetic field, in a single inductor. A single capacitor may be discharged and charged to establish, and recover energy from, magnetic fields alternately in two or more inductances. The two inductances may be from respective inductive devices, or may be respective windings of a single device, or may be mutual inductances of the same inductive device.

In a three-stage closed-loop circuit according to the invention, the energy recovered from a magnetic field in a first inductor, can be transferred to a first capacitor for use in later establishing a magnetic field in a second inductor, and the energy recovered from the magnetic field in the second inductor can be transferred to a second capacitor for use in later establishing a magnetic field in a third inductor, and the energy recovered from the magnetic field in the third inductor can be transferred to a third capacitor for use in later establishing a magnetic field in the first inductor. Such a circuit can be used to efficiently drive a three phase motor having three stator windings. Similar closed-loop multi-stage circuits can be configured for two or four circuit stages, or any other suitable number of successively connected circuit stages, for example as might be desired for linear motors, according to the invention.

The invention utilizes energy that remains in a magnetic field after the field has been used to perform work, for example the mechanical work performed by the field of an electromagnetic motor. In general terms, the invention allows a magnetic field to be established in association with an inductive device (such as a transformer, motor, solenoid, or induction coil, for example). The field is predominantly established using energy recovered from the collapse of a previously-established magnetic field that may or may not be associated with the same inductive device. This recovery and re-use of the energy from a magnetic field allows inductive devices to be operated with improved performance and particularly with improved efficiency. Energy consumed in the circuits performing the work, through hysteresis, back emf or circuit losses can be replenished on a cycle-by-cycle basis. Significant efficiency gains can be made when these losses are kept low and are a small fraction of the energy needed to establish the magnetic field.

Energy is recovered from the magnetic field associated with an inductive device, such as a winding, while the field is performing, or has performed, useful work. The recovered energy is stored on a capacitor for re-use when later re-establishing a magnetic field at that or another inductive device. Controlled switches alternately interconnect the inductive device(s) and the capacitor(s) in the magnetizing and energy recovery configurations.

In one aspect the invention relates to the relationship between the timing of the controlled switches, the inductance of the inductive device and the capacitance of the capacitor. The switch-controlled magnetizing period is made approximately equal to one quarter of the natural resonant period of the capacitor and inductive device connected in a resonant circuit configuration. Substantially all the energy stored on the capacitor can be transferred to the inductive device over the magnetizing period and substantially all the energy then stored in the magnetic field can be transferred back to the capacitor over the following recovery period which can be of a similar duration to the magnetizing period.

In another aspect the invention relates to a switching circuit for charging a capacitor by energy recovered from a collapsing magnetic field, and discharging the capacitor to re-establish the magnetic field. The voltage on the charged capacitor is compounded, over only one cycle, or over several successive cycles, of circuit operation. The capacitor is charged by the recovered energy to a voltage that is substantially greater, and is typically several times higher, than the supply voltage.

The use of this relatively high compounded voltage on the capacitor provides a steeply rising and higher value magnetizing current for the inductive device. This rapid rise in magnetizing current is not provided by prior art recycling circuits which recover magnetic field energy for storage on a large value reservoir or supplementary capacitor. The voltage on the reservoir or supplementary capacitor is not compounded but remains close to that of the supply and can only provide a much lower rate of rise of magnetizing current at the next cycle.

In another aspect the invention relates to a switching circuit for charging a capacitor by energy recovered from a collapsing magnetic field, and re-establishing the magnetic field using energy obtained from discharging the capacitor.

The capacitor may be completely discharged when re-establishing the magnetic field during each cycle of operation. However, the circuits described below can be used without fully depleting the charge on the capacitor. That is, the circuits will operate effectively with a residual charge left on the capacitor after the magnetic field has been re-established.

This condition can occur when the timing of the switching of the circuit provides a magnetizing period that is less than optimal, or when the capacitance of the capacitor or the inductance of the inductive device is greater than optimal. A similar condition can occur when the timing of the switching of the circuit provides a magnetizing period that is greater than optimal, or when the capacitance of the capacitor or the inductance of the inductive device is less than optimal. In this case, the current that initially discharges the capacitor continues to flow without changing direction after the capacitor voltage reaches zero, and recharges the capacitor to the opposite polarity.

Dependent on the application and operating frequency, the switch timing can be controlled to optimize the current amplitude or wave shape in the inductive device, or the percentage of field energy recovered. Typically, 80-85% of the magnetic field energy can be recovered for recycling.

In application of the invention to the driving of switched reluctance motor windings, the discharge of the recovery capacitor to near zero voltage during re-magnetizing of the motor windings helps provide a smooth rollover at the peak of the winding current waveform. The reduction of rapid or sharp transients in the motor winding current waveforms helps to reduce acoustic motor noise.

Many of the inductances described and shown in the circuit diagrams are ‘ideal’ devices of fixed inductance. However, the inductance of many practical inductive devices can be significantly reduced by back emfs from secondary circuit loads or by inductances which vary rapidly over each cycle. These inductance changes may have complex profiles. For example, inductance changes may be linear, sinusoidal or trapezoidal, over parts of each operating cycle.

### Drawing Conventions

It should be noted that in the accompanying figures the connection between wires is shown with a dot. Wires that intersect but have no dot at the intersection are not connected.

In general, circuit components labelled similarly throughout the following description and in the accompanying figures provide corresponding functions. For example, in each of the circuits described with reference to the following labelled components, controlled switches S1 and S2 perform a corresponding function of controlling the delivery of energy stored in a capacitor C1 to an inductive device L1, and diodes D1 and D2 provide a path for a current induced in the inductive device L1 to flow back to charge the capacitor C1.

### Controlled Switches

The controlled switches in the circuits shown in the accompanying figures are controlled by any suitable controller. For example, the controller may be a microprocessor, microcontroller or other suitable digital logic or programmable device that can provide the switching devices with control pulses or signals of the required amplitude and timing. In some applications it is envisaged that the control signals provided to the switching devices by the controller will be responsive to one or more operating conditions associated with the inductive device. For example, where the inductive device is a motor, the timing of the control signals provided to the switches may be responsive to the rotational speed or shaft position of the motor, or of a component driven by the motor.

The switches are shown in some of the accompanying figures as simple switches whereas in figures relating to specific applications of some embodiments the switches are shown as field effect transistor (FET) switches.

In some low frequency applications the controlled switches may be reed switches or mechanical switches or contact points operated by mechanical means such as roller cams, lobes, or the like.

The controlled switches may be any switch suitable for the currents and voltages encountered, and having suitable switch characteristics such as switching speed, low ‘on’ or closed resistance, and high ‘off’ or open resistance. Metal oxide semiconductor field effect transistor (MOSFET) switches (for example, International Rectifier IRF740LC, IRFK4HE50 or IRFK4JE50, or IXYS IXTH20N60) have been found suitable for many applications of the circuits described below. The MOSFET (800 volt, 26 ampere, 0.046 ohm) is particularly useful where a higher voltage capability is required.

In many cases the MOSFETS can be replaced by insulated gate bipolar transistors (IGBTs) or other solid state switching devices.

In practical circuits according to some embodiments of the invention, and particularly circuits operating at higher switching frequencies, the controlled switches are preferably matched transistors having closely similar switching speeds, i.e. rise and fall times and switching turn-on and turn-off delay times.

The switches are coupled to the controller by any suitable means. In some specific embodiments, FET switches are coupled to the switch controller by optocouplers, for example HCPL-3120 from Hewlett Packard, with gate drives powered by isolated converter supplies, for example from C & D Technologies.

### Diodes

Some of the switching devices of the invention are semi-conductor diodes which inherently provide a closed state (i.e. a relatively low resistance path) to currents flowing in one direction but provide an open state (i.e. a relatively high resistance path) to currents flowing in an opposite direction. The diodes may be used alone or in conjunction with controlled switching devices. In the latter case, diodes can be used in parallel or in series with the controlled switch, depending on the switching required.

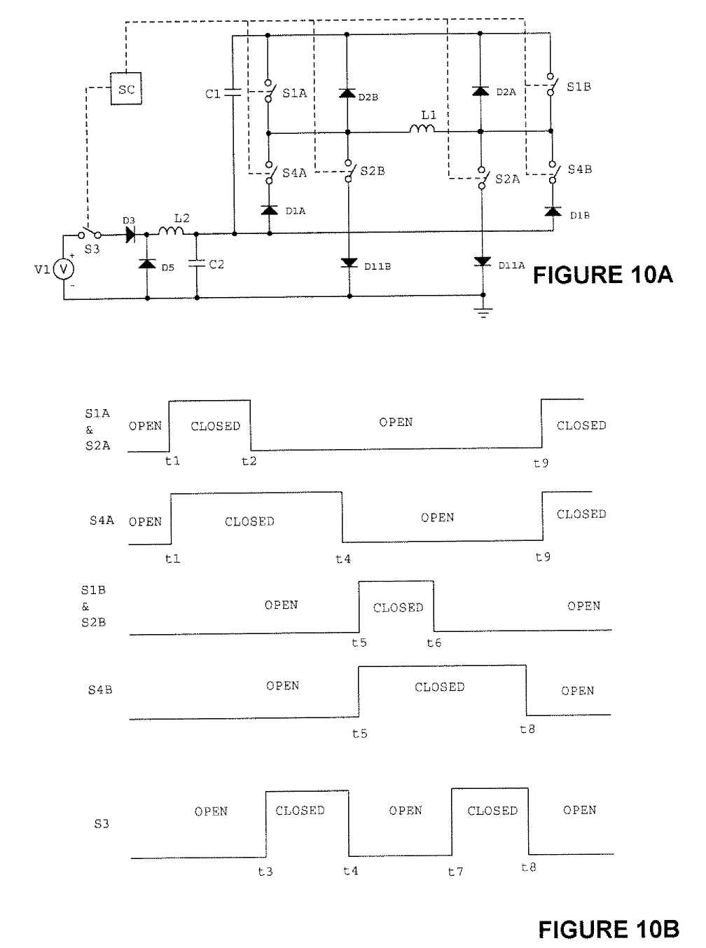

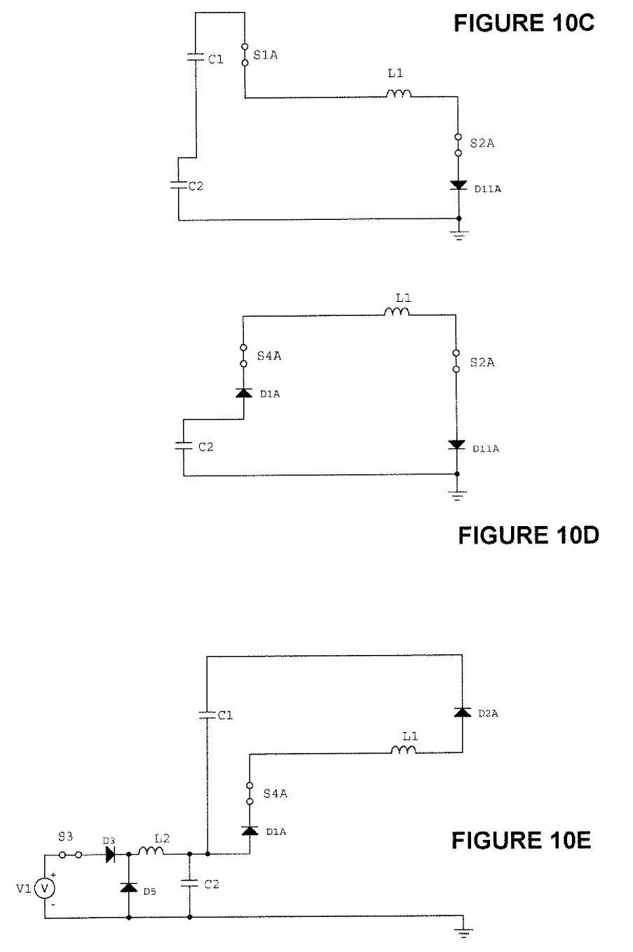

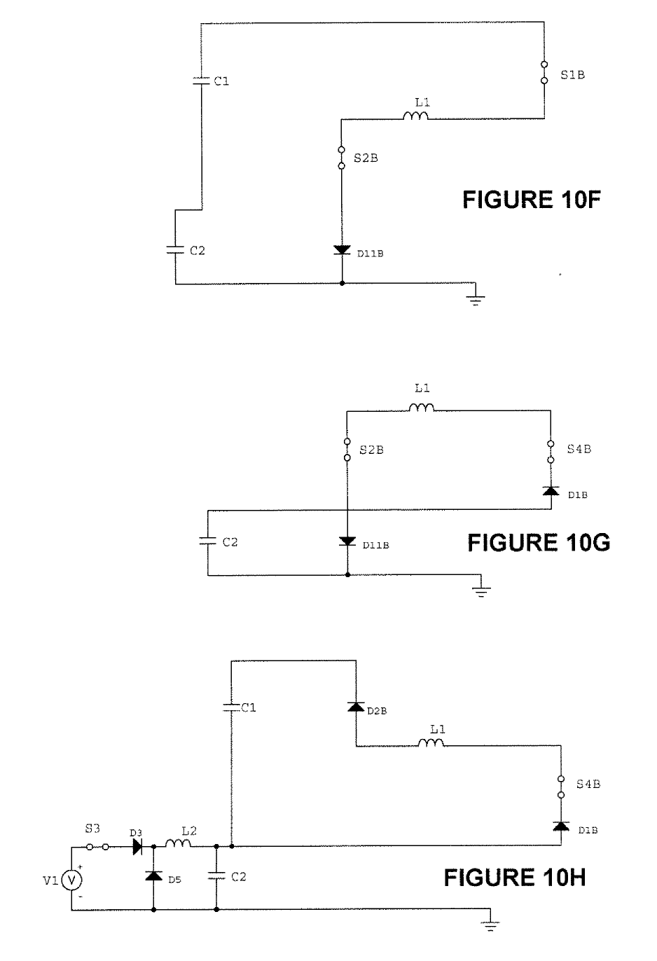

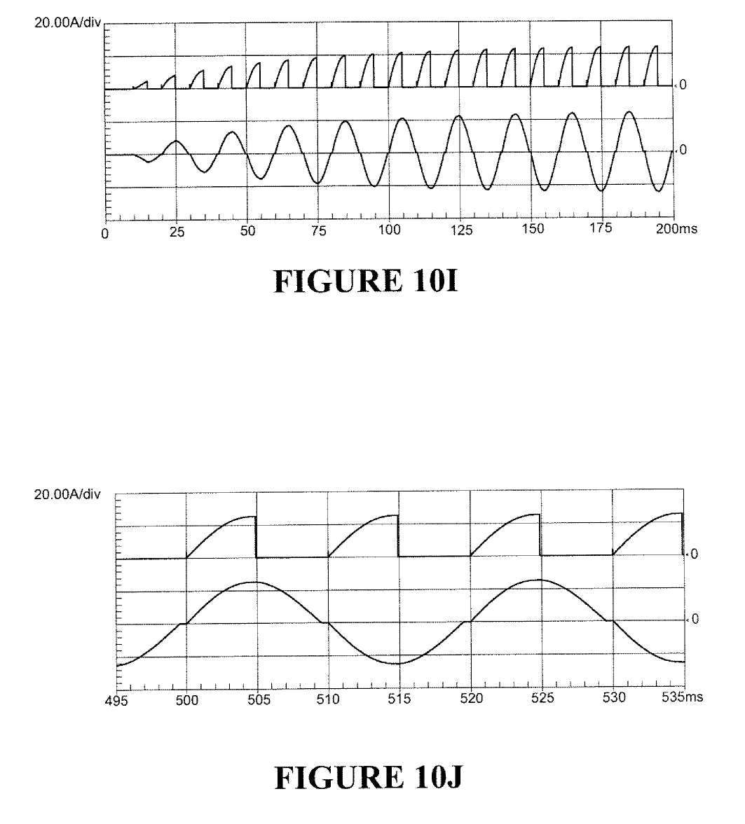

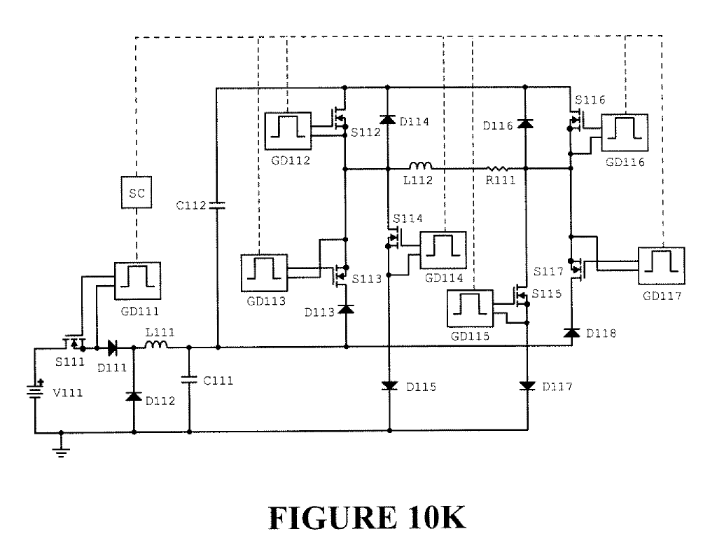

Diode switching devices are described and shown in the figures as discrete devices. However, in practice a discrete diode component may not be required. For example, where the switches in the circuits shown in FIG. 10A are MOSFETs, diodes D2A and D2B, shown as discrete diodes in parallel with respective controlled switches S1B and S1A, may each be provided by a diode that is inherently provided in the associated MOSFET switch.

Where discrete semiconductor diodes are used, one suitable diode is the Intersil RHRG30120 (1200 volt, 30 ampere, ultra fast).

The semiconductor diodes require a small forward bias voltage to make the diodes conductive. This requirement has generally been ignored in the following description to simplify the explanation of circuit operation.

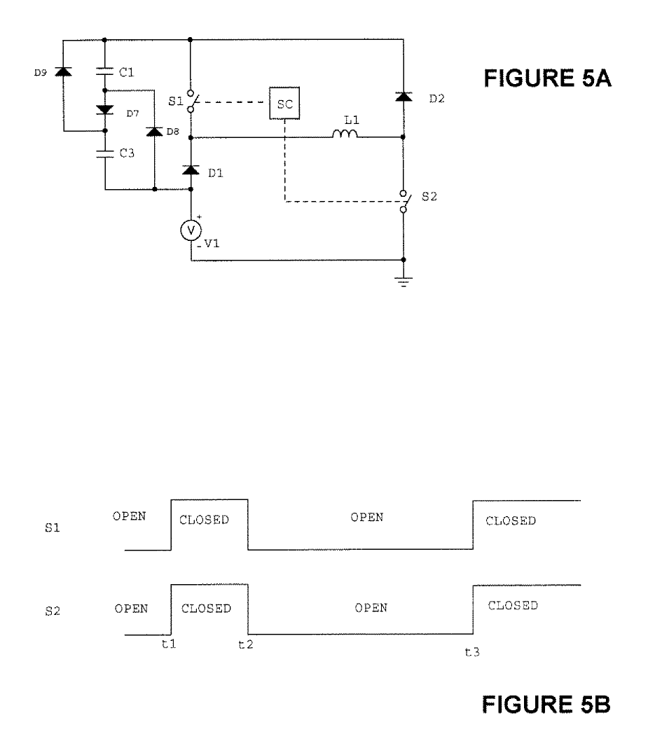

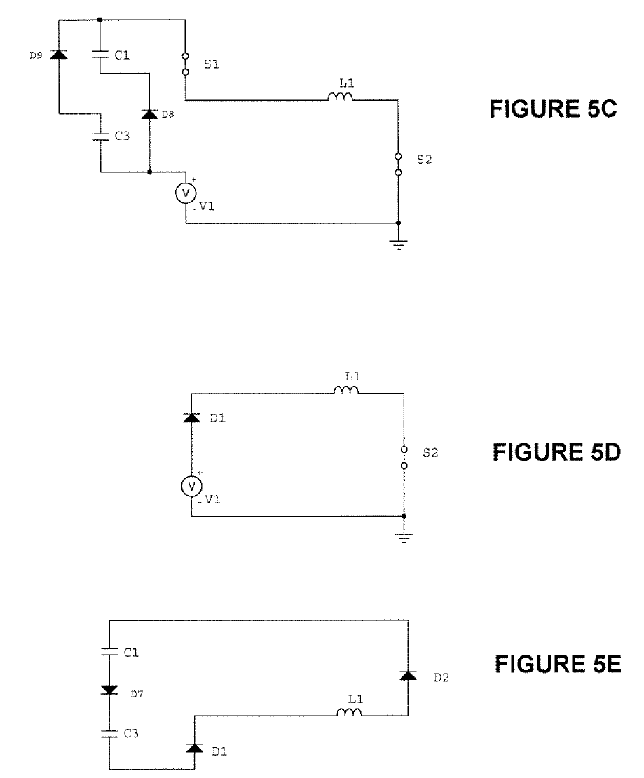

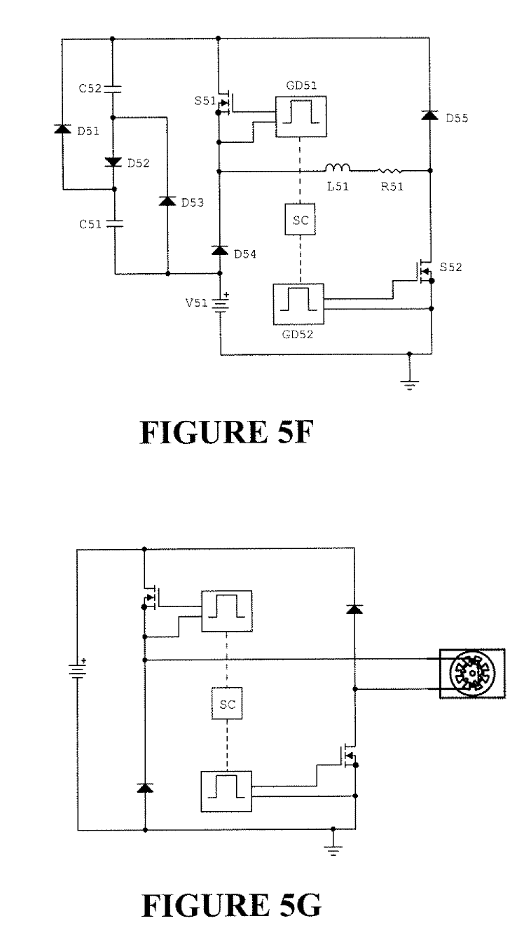

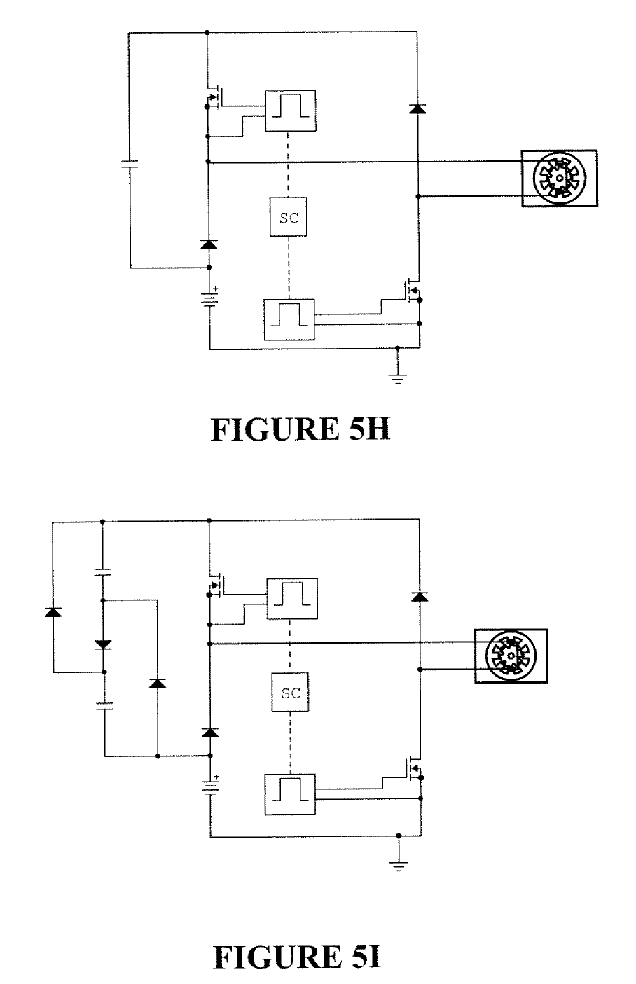

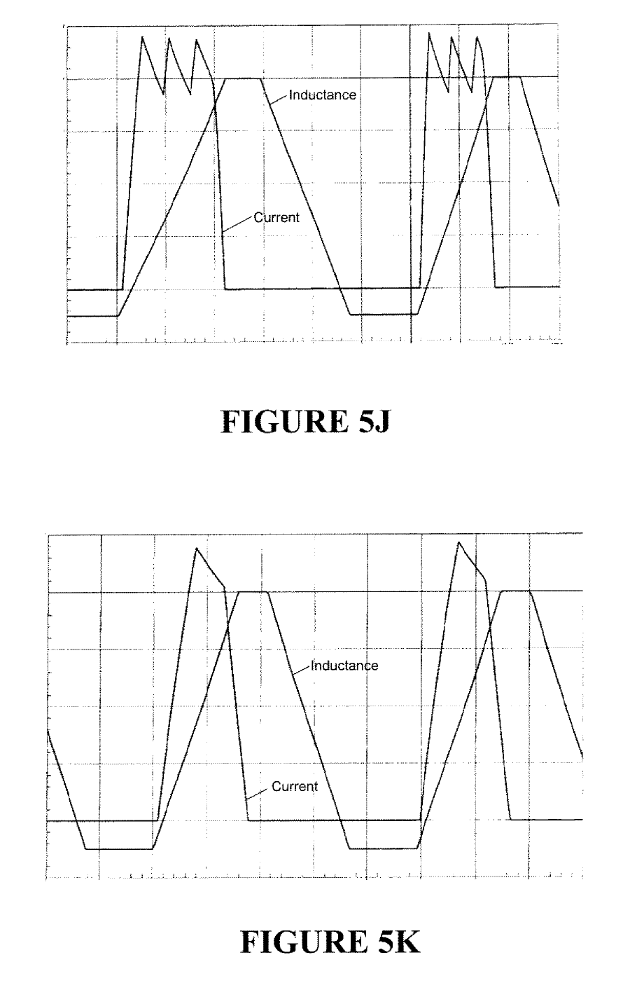

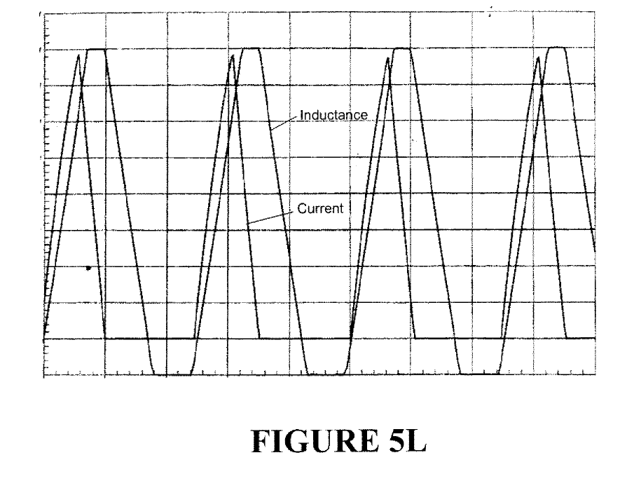

Although semiconductor diodes are preferred in the positions shown in the circuits of the accompanying figures, the diodes can be substituted by controlled switches. For example, diodes D1 and D2 can be substituted by controlled switches that are opened during the magnetizing stage and closed during the magnetic energy recovery stage. In a further example, the diodes D51, D52, and D53 in the embodiments described with reference to FIG. 5F can be substituted with FET switches or other controlled switching devices under control of a switch controller or any other suitable control device, to actively control the series/parallel connection of capacitors C51 and C52. This latter example is described further in paragraph 5.16.

### Capacitors

The recovery capacitors described in the following embodiments are preferably “low-loss” capacitors, i.e. capacitors having low equivalent series resistance and low equivalent series inductance. Suitable recovery capacitors are metallized polypropylene pulse capacitors, or metallized polypropylene foil-film capacitors for applications generating high voltages on the recovery capacitors.

The circuit of each embodiment described below includes one capacitor, or multiple capacitors, that temporarily stores, or store, energy recovered from the collapsing magnetic field of an inductive device. These recovered energy storage capacitors are, for convenience, generally referred to in this specification by the briefer term “recovery capacitor”, to help distinguish the function of these capacitors from the power supply reservoir or filter capacitors that are used in some circuits.

### Circuit Losses

It should also be noted that the inductors and inductive devices represented by the symbols shown in the figures are not perfect or idealized devices. In practice, these inductive components or devices also comprise winding resistance, core losses, and in some instances inter-winding capacitance. Furthermore, the controlled switches and diodes used in the circuits described exhibit resistance when ‘on’ or closed. When current is flowing, energy is dissipated in the ‘on’ resistance of the closed controlled switches, in the ‘on’ resistance of the conductive diodes, and in the winding resistance of the inductive devices. These losses are not recovered by the magnetic field energy recycling techniques described herein. In practice, the operation of the circuits described below can be affected by the resistances and other losses associated with the circuit components. For good energy recycling performance, it is preferred that these losses be kept as low as practicable by ensuring that the ‘on’ resistances of the controlled switches and diodes, and the winding resistances, are kept low.

### Earthing/Grounding

The circuits shown in the figures have a bottom rail that is earthed or grounded. The earthing or grounding of this rail is optional and is not a necessary part of the invention.

### First Embodiment

### 1.1 Circuit Layout

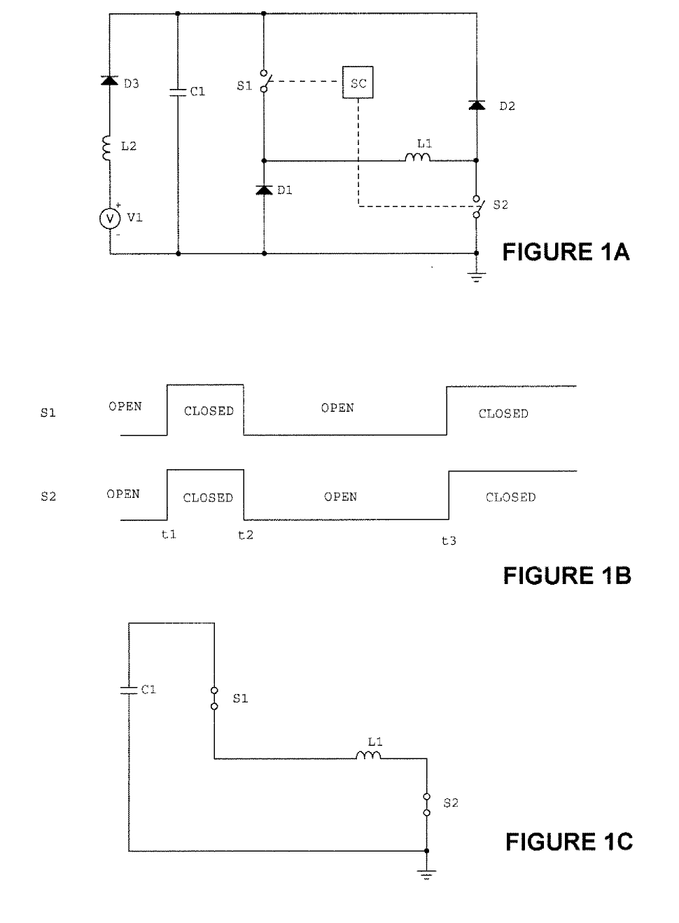

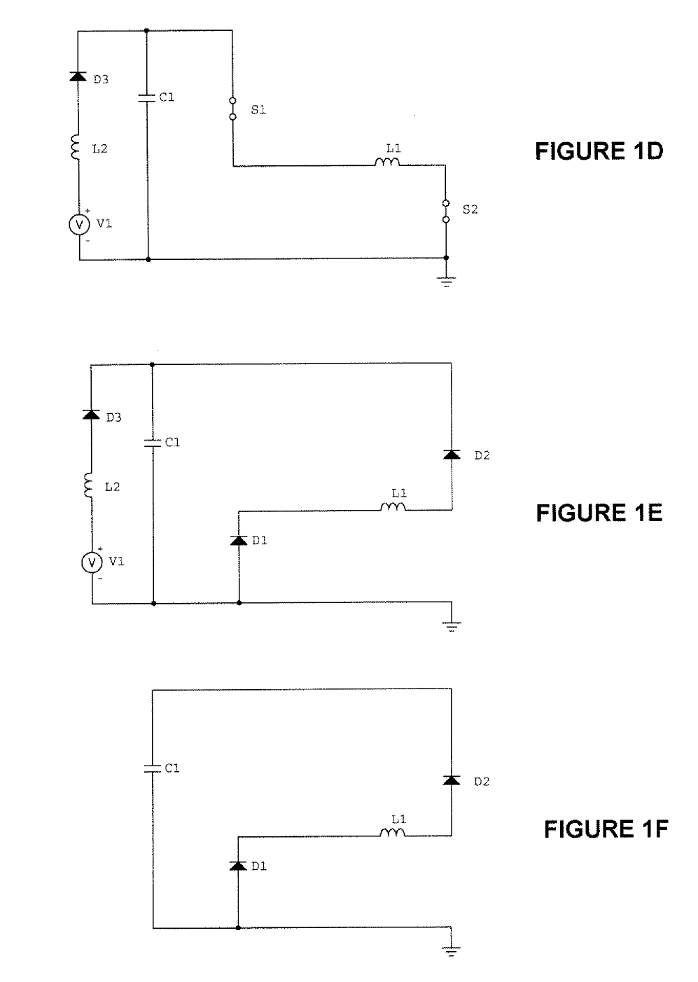

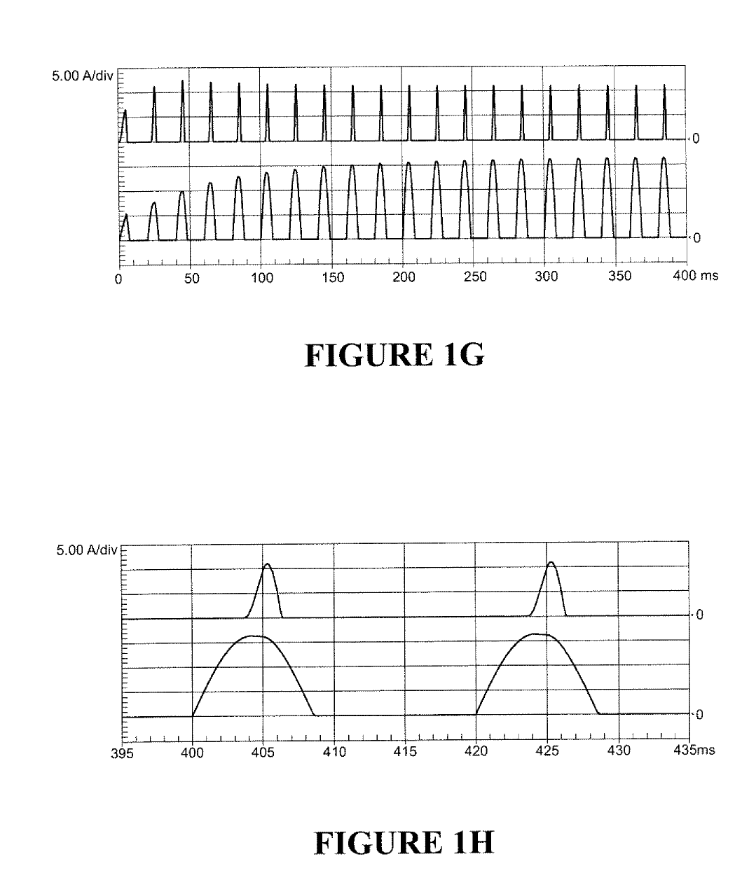

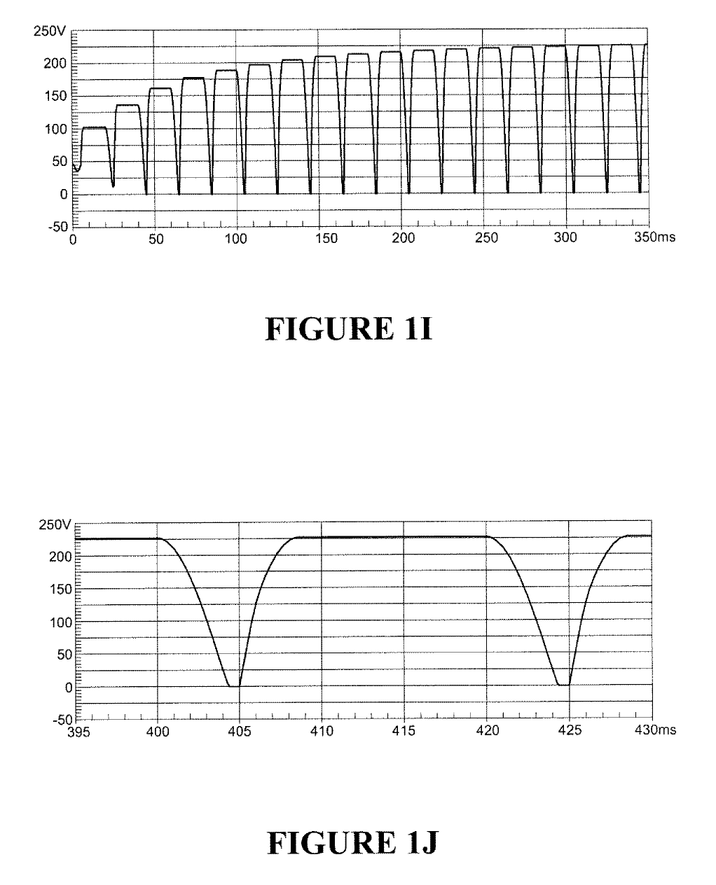

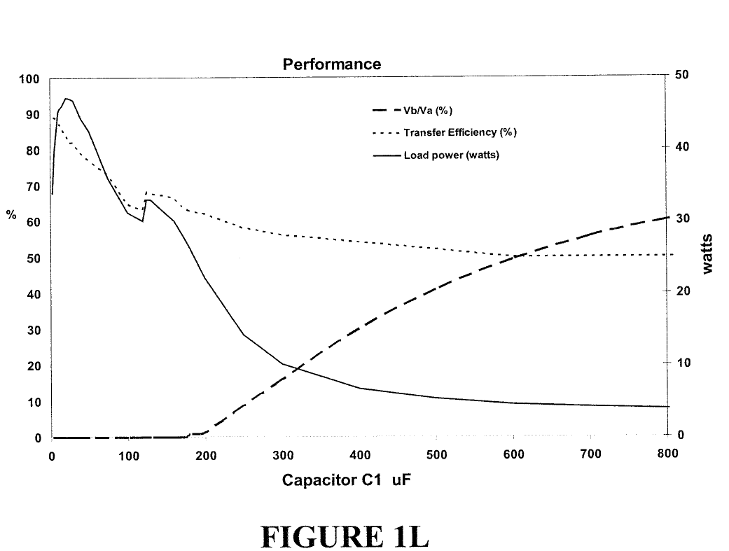

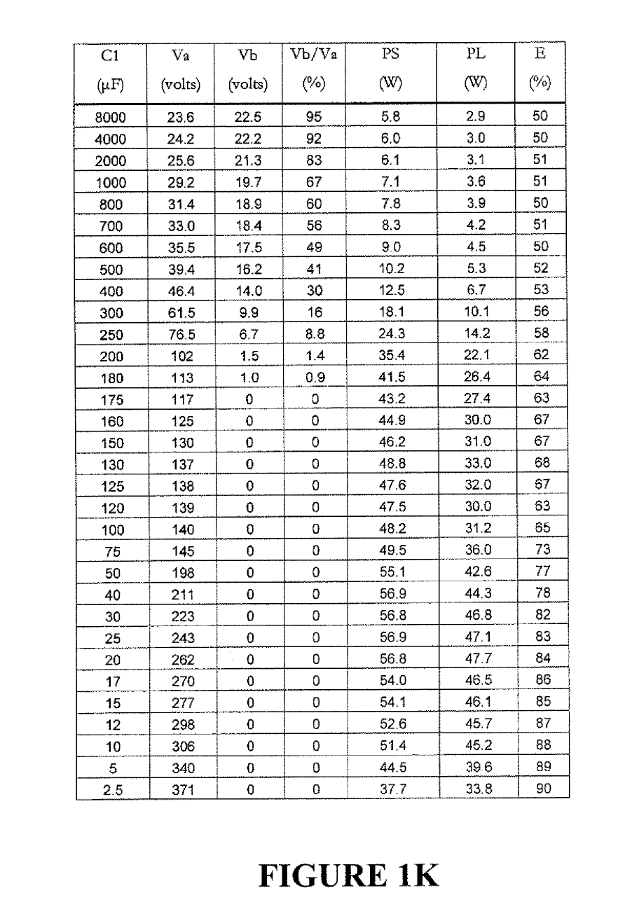

FIG. 1A is a circuit diagram illustrating a first embodiment of the invention. Energy recovered from an inductive device L1 is returned to, and stored in, a recovery capacitor C1.

The circuit comprises a DC power supply V1, three diodes D1, D2 and D3, a capacitor C1, two controlled switches S1 and S2, an inductive device L1 and a choke inductor L2. Switch S1 and diode D1 are connected in series between the upper and lower rails to form one leg of an H-bridge. Diode D2 and switch S2 are connected in series between the upper and lower rails to form the other leg of the H-bridge. The inductive device L1 is connected between the centre junctions of the two bridge legs. The capacitor C1 is connected between the upper and lower rails. The circuit is operated by periodically switching the controlled switches S1 and S2 between open and closed states to achieve the effective circuit configurations shown in FIGS. 1C to 1F. The opening and closing of the switches S1 and S2 are controlled by a common switch controller SC.

### 1.2 Switch Timing

FIG. 1B is a switch timing diagram for the controlled switches S1 and S2 showing one cycle of operation from time t₁ to time t₃. Switches S1 and S2 are operated synchronously over each cycle by the switch controller SC.

The switches S1 and S2 are both closed to arrange the circuit of FIG. 1A for a magnetizing stage from time t₁ to time t₂. During this magnetizing stage, a current is driven through the inductive device L1 to establish a magnetic field. The magnetizing current flows through the inductive device L1 from left to right in the circuits shown in FIGS. 1A, 1C and 1D.

Switches S1 and S2 remain closed from time t₁ to time t₂ for a period that is approximately equal to 0.5π√(L1 C1), where L1 is the inductance of the inductive device L1 in henries, C1 is the capacitance of capacitor C1 in farads, and the period is in seconds.

The magnetizing stage ends at time t₂ at which time switches S1 and S2 are opened to arrange the circuit of FIG. 1A for a recovery stage during which a current induced in the inductive device L1 during collapse of the magnetic field charges capacitor C1. The switches S1 and S2 are kept open from time t₂ to time t₃.

Both switches S1 and S2 are closed at time t₃ to arrange the circuit of FIG. 1A for the next magnetizing stage. The operating cycle is repeated with a repetition period equal to (t₃-t₁).

### 1.3 First Magnetizing Circuit

FIG. 1C shows a first effective circuit for the magnetizing stage of circuit operation when switches Si and S2 are closed. This circuit applies during the magnetizing stage when diode D3 is non-conductive, i.e. generally when the voltage on capacitor C1 is greater than that of the supply V1.

### 1.4 Second Magnetizing Circuit

FIG. 1D shows a second effective magnetizing circuit when switches S1 and S2 are still closed. This circuit applies when the voltage across the capacitor C1 is generally less than the voltage of the power supply V1, making diode D3 forward biased and conductive, and effectively placing the supply V1 in parallel across the capacitor C1.

### 1.5 Magnetizing Circuit Conversion

The conversion of the magnetizing circuit of FIG. 1C to that of FIG. 1D occurs automatically during the magnetizing stage. The conversion occurs when the voltage across the capacitor C1 falls below, or is less than, the voltage of the supply V1 and there is insufficient charge on the recovery capacitor to supply all the magnetizing current for the full magnetizing period t₁ to t₂.

This conversion occurs soon after switches S1 and S2 first close at time t₁ of the first cycle of operation, but can occur progressively later in subsequent cycles. In these subsequent cycles, the recovery capacitor can charge to progressively higher voltages as the circuit builds up to an operating mode.

### 1.6 First Energy Recovery Circuit

FIG. 1E shows a first effective circuit for the energy recovery stage of circuit operation when switches S1 and S2 are both opened at time t₂ and the voltage on the capacitor C1 is less than the voltage of the supply V1, making diode D3 forward biased and conductive.

### 1.7 Second Energy Recovery Circuit

FIG. 1F shows a second effective circuit for the energy recovery stage of circuit operation. Switches S1 and S2 are still open but capacitor C1 has charged to a voltage which is greater than that of the supply V1, reverse biasing diode D3 to make diode D3 non-conductive and effectively disconnecting the supply V1. Current flowing from the inductive device L1 on collapse of the magnetic field forward biases diodes D1 and D2 and charges capacitor C1, causing the current to fall.

When this falling inductive device current reaches zero, diodes D1, D2 and D3 become non-conductive, blocking discharge of the re-charged capacitor C1. This blocking holds the charge on capacitor C1 until the start of the next cycle at time t₃.

### 1.8 Energy Recovery Circuit Conversion

The conversion of the energy recovery circuit of FIG. 1E to that of FIG. 1F occurs automatically during the energy recovery stage: when the voltage across the capacitor C1 increases above the voltage of the power supply V1.

### 1.9 Start-Up Mode Magnetizing—First Cycle

Initial start-up of the circuit occurs when the switches S1 and S2 close at time t₁ of the first cycle of operation. For the purposes of the immediately-following explanation it is assumed that, prior to the initial start-up at time t₁, switches S1 and S2 have been open for sufficiently long for capacitor C1 to have charged from the power supply V1, and for the V1, L2, D3, C1 circuit to have reached a steady state.

At time t₁, switches S1 and S2 close to effectively arrange the circuit as shown in FIG. 1C. Magnetizing current then begins to flow from the pre-charged capacitor C1 through closed switch S1, inductive device L1 and closed switch S2, to establish a magnetic field in association with the inductive device. This flow of current from capacitor C1 depletes the charge on the capacitor, immediately decreasing the voltage across the capacitor, as may be seen in the start-up capacitor voltage waveform shown in FIG. 1I, to a voltage which is below the voltage of the power supply V1 to make diode D3 forward biased. Therefore, on this first start-up cycle, the circuit converts immediately to that shown in FIG. 1D.

In the effective circuit arrangement shown in FIG. 1D, magnetizing current also flows from the power supply V1, through inductor L2 and diode D3 to augment the magnetizing current flowing from capacitor C1. The combined currents flow through closed switch S1, through inductive device L1 (from left to right in FIGS. 1C and 1D), and back through closed switch S2 to establish the magnetic field in association with the inductive device L1.

As the voltage on the discharging capacitor C1 falls still further, and as supply current through inductor L2 increases, capacitor C1 ceases to discharge and begins to be charged by the current from supply V1 flowing through inductor L2 and diode D3. This recharging of capacitor C1 occurs simultaneously with continued flow of magnetizing current through inductive device L1 from the supply V1.

### 1.10 Start-Up Mode Magnetizing—Subsequent Cycles

The conversion of the magnetizing circuit of FIG. 1C to that of FIG. 1D (which occurred immediately after start time t₁ in the first cycle) occurs progressively later in subsequent start-up cycles as the circuit runs up to a run mode. The progressive delay of the conversion occurs because the capacitor C1 is charged to a progressively higher voltage as may be seen from the start-up voltage waveform of capacitor C1 as shown in FIG. 1I. This voltage is above the voltage of the supply V1, due to the recovery of energy from the inductive device L1 during a previous energy recovery stage, as will be explained further below.

The combination of current from capacitor C1, and from the supply V1 through inductor L2 and diode D3, flows through closed switch S1, through the inductive device L1 (from left to right in FIG. 1D), and through closed switch S2 back to the earthed or grounded side of the supply V1 and capacitor C1. This current establishes a magnetic field in association with the inductive device L1. A typical start-up inductive device current is shown in the lower waveform of FIG. 1G.

### 1.11 Run Mode Magnetizing

In the run mode, the magnetizing current for the inductive device L1 is predominantly derived from the discharge of capacitor C1 by the circuit of FIG. 1C. During a first substantial part of the run mode magnetizing stage, the recovered energy stored on the capacitor C1 is directed by switches S1 and S2 to re-establish the magnetic field in the inductive device L1.

Near the end of the run mode magnetizing stage, when and if the voltage on capacitor C1 becomes depleted below the voltage of the supply V1, diode D3 conducts to convert the circuit to that of FIG. 1D. Magnetizing current in the inductive device L1 is then maintained by current flowing directly from the supply V1, through inductor L2, diode D3 and switch S1, and back through switch S2. This relatively small replenishment directly from the supply occurs automatically during every cycle upon depletion of the charge on capacitor C1 and draws energy from the supply, through the choke inductor L2 and diode D3, to make up for losses in the circuit. A typical run-mode supply current is shown in upper waveform of FIG. 1H.

The replenishment voltage provided by the supply V1, although less than the much higher run-mode voltages achieved on capacitor C1, is sufficient to maintain the level of current in the inductive device L1 and prolong the magnetizing begun by the current flow from the capacitor C1.

### 1.12 Energy Recovery

FIG. 1E shows the first effective circuit configuration for the energy recovery stage of circuit operation when switches S1 and S2 are both opened at time t₂. At time t₂ the current through the inductive device L1 and the associated magnetic field begin to collapse, but the voltage on capacitor C1 is less than that of the supply V1, keeping diode D3 still conductive.

The current flows from the inductive device L1 and through diode D2 to charge capacitor C1 and flow back through diode D1 to inductive device L1. This current flows through the inductive device L1 in the same direction as the current used to establish the magnetic field (i.e. from left to right in FIG. 1E), but flows into the capacitor C1 in the opposite direction to the magnetizing current flowing from the capacitor during the magnetizing stage.

Simultaneously with the initial recharging of capacitor C1 by current from the inductive device L1, the capacitor C1 is also charged by a replenishment current flowing from the supply V1, through inductor L2 and the forward biased diode D3.

FIG. 1F shows the second effective circuit configuration for the energy recovery stage of circuit operation when switches S1 and S2 are both still open, the current through the inductive device L1 and the associated magnetic field is still collapsing, but the voltage on capacitor C1 is now greater than that of the supply V1, making diode D3 non-conductive. Current continues to flow from the inductive device L1 and through diodes D2 and D1 to charge capacitor C1.

In both the first and second energy recovery stage circuit configurations as shown in FIGS. 1E and 1F, the flow of the induced current from the inductive device L1 back to the capacitor C1, effectively recovers energy from the magnetic field and transfers the energy to the capacitor C1. This recovered energy is held as a charge on the capacitor C1 until the end of the cycle at time t₃ when it is used to re-establish the magnetic field at the magnetizing stage of the next cycle of operation.

### 1.13 Voltage Multiplication

On initial start-up, the capacitor C1 is charged, in the energy recovery stages of the first few successive cycles of circuit operation, to progressively higher voltages, as may be appreciated from the voltage waveform shown in FIG. 1I. After only a few cycles of operation the capacitor C1 is recharged at each recovery stage to several times the supply voltage.

FIG. 1I shows a typical waveform for the voltage on capacitor C1 for a specific first embodiment having circuit values as discussed below. The capacitor voltage rises to just over 100 volts during the first energy recovery stage, and progressively rises to greater voltages to reach about 225 volts after about 300 mS of operation. In the magnetizing stages, magnetizing current in the inductive device is driven by this capacitor voltage.

FIG. 1J shows the waveform of the voltage on recovery capacitor C1 when the circuit of this specific embodiment has completed start-up and is operating in a run mode. At 400 mS, the capacitor has already been progressively charged to a voltage of about 225 volts by successive magnetization and energy recovery stages. During a magnetizing stage, from 400 mS to 405 mS, the capacitor drives magnetizing current through the inductive device. The capacitor voltage falls to zero as the capacitor discharges. During the following recovery stage, from 405 mS to 410 mS, energy from the collapsing magnetic field is recovered (and augmented by a small top-up from the supply) to recharge recovery capacitor C1 back up to about 225 volts. Repetition of this cycle begins at 420 mS.

The recovery of energy from the collapsing magnetic field at each cycle and its re-use to re-establish the field in the magnetizing stage at the next cycle effectively multiplies the voltage from which the inductive device is driven to provide a significant improvement in efficiency. The voltage multiplication process is similar to the transient charging phase of a resonant inductance-capacitance (L-C) circuit.

With the capacitor C1 recharged to a voltage significantly higher than the supply voltage, the capacitor discharges during the next magnetizing stage over a significantly longer time and with a higher peak current value than those occurring during each of the first few start-up cycles.

In practice, the compounding of voltage on the recovery capacitor C1 is limited by circuit losses and by motional or induced back electromotive forces (BEMFs), if any. Motional BEMFs can arise from a changing inductance in the inductive device L1, such as in a reluctance motor, reducing the amplitude of current in the inductive device. The voltage gain is related to the ratio of the maximum energy stored to the energy dissipated per cycle, or to the loaded Q (the quality factor of the inductance capacitance circuit). Where BEMFs and circuit resistances are kept low, the circuit of the first embodiment drives the inductive device with a voltage that is many times greater than that of the supply.

### 1.14 Energy Transfer

During the capacitor-fed magnetizing period that occurs during the earlier part of the magnetizing stage of each cycle in the run mode, before supply-fed magnetizing takes over, the circuit effectively adopts the configuration as shown in FIG. 1C. This is similar to the familiar resonant inductance-capacitance (L-C) circuit in which energy can be transferred back and forth between the capacitance and the inductance.

For optimum operation of the energy recovery circuit shown in FIG. 1A, the recovered energy stored as a charge on capacitor C1 must be efficiently transferred back to the magnetic field associated with the inductive device L1. Maximum transfer of energy from the capacitor back to the inductive device occurs when the voltage on the capacitor C1 has decreased from a maximum to zero and the current in the inductive device L1 has simultaneously risen from zero to a maximum. The time for this to occur is equal to a quarter of the period of natural resonance of the inductance-capacitance circuit, which in this case is equal to 0.5π√(L1 C1).

For optimum operation of the energy recovery circuit of FIG. 1A, the switches S1 and S2 are closed for each cycle of operation for a time that is approximately equal to 0.5π√(L1 C1) to allow for optimum transfer of energy from the capacitor C1 to the inductive device L1.

The switches S1 and S2 may be maintained closed for a small additional time period to extend the duration of the magnetizing current in the inductive device L1. During this extension period, the magnetizing current is supplied from the supply to compensate for circuit losses.

For optimum operation of the energy recovery circuit shown in FIG. 1A, the energy from the magnetic field associated with the inductive device L1 must be efficiently transferred back to the recovery capacitor C1. Maximum transfer of energy from the magnetic field back to the capacitor occurs when the current flowing in the inductive device L1 has decreased to zero.

For optimum operation of the energy recovery circuit of FIG. 1A, the switches S1 and S2 are open for each cycle of operation for a time that is no shorter than a quarter of the period of natural resonance of the inductance-capacitance (L-C) circuit, which in this case is equal to 0.5π√(L1 C1), to allow for optimum transfer of energy from the inductive device L1 to the capacitor C1. The switches S1 and S2 are maintained opened after cessation of the current in the inductive device L1, while waiting on the re-closing of switches S1 and S2 to re-establish the magnetic field at the commencement of the next cycle.

The upper waveform of FIG. 1H shows the current provided by supply V1 and the lower waveform shows the current in the inductive device L1. The inductive device current begins to rise at the beginning of a cycle at 400 mS. This current is initially derived solely from energy stored on the recovery capacitor C1. No current flows from the supply during the early part of the cycle. Supply current only begins to rise at about 404 mS when the charge on the recovery capacitor C1 is depleted. The supply current maintains current flow in the inductive device during the remainder of the magnetizing stage, i.e. until 405 mS, when the switches S1 and S2 are opened to convert the circuit to the recovery mode. Supply current is then is used to augment the initial current recovered from the inductive device, to recharge the recovery capacitor. After cessation of the supply current, at about 406.5 mS, the recovery capacitor is further charged by current recovered from the inductive device, this charging current falling to zero at about 408.5 mS.

At near optimum operation, the contrast between the relatively small peak value and duration of the run mode supply current pulses shown in the upper waveform of FIG. 1H and the much larger peak value and duration of the run mode inductive device current pulses shown in the lower waveform of FIG. 1H is clearly apparent.

### 1.15 Specific Embodiment

One specific embodiment of the circuit shown in FIG. 1A has the following circuit values:

S1 and S2: IRFK4HE50

D1, D2 and D3: RHRG30120

V1=48 volts

C1=200 μF

L1=36 mH (with an effective series resistance of 0.5 ohms)

L2=5 mH

Switching period t₁ to t₃=20 mS

Switching frequency 50 Hz

Magnetizing period t₁ to t₂=5 mS

In this specific embodiment, the switches S1 and S2 remain closed for 5 mS over the 20 mS period of each cycle. The capacitor-fed magnetizing current endures for 4.2 mS, being 0.5π√(L1 C1) or one quarter of the natural resonance period of the capacitor C1 and inductive device L1. The supply-fed magnetizing current runs for the remaining 0.8 mS of the 5 mS magnetizing stage over which the switches S1 and S2 are closed.

In this specific embodiment the capacitor C1 is recharged at each recovery stage to a voltage that is more than 4 times the supply voltage after the first 15 cycles of operation, i.e. after only 300 mS from starting.

### 1.16 Waveforms

FIGS. 1G, 1H, 1I and 1J show typical simulated waveforms of currents and voltages for the specific first embodiment of the circuit shown in FIG. 1A. The upper waveforms of FIGS. 1G and 1H shows typical supply current waveforms. The lower waveforms of FIGS. 1G and 1H show typical current waveforms for the inductive device L1. FIG. 1I and 1J show typical waveforms of the voltage across the recovery capacitor C1. FIGS. 1G and 1I show several cycles during start-up. FIGS. 1H and 1J show run-mode cycles.

It can be seen that at start-up the voltage on capacitor C1 is equal to the supply voltage of 48 volts but then the peak value of the voltage on capacitor C1 increases rapidly over successive start-up cycles to be approximately 225 volts at 300 mS. The waveforms of FIGS. 1I and 1J show that the recovery capacitor C1 is substantially discharged, i.e. the voltage on the capacitor C1 is zero volts, by the end of the magnetizing stage for each cycle of circuit operation.

In the run-mode of the specific first embodiment of FIG. 1A as described above, the capacitor-fed magnetizing current in the inductive device L1 rises from zero to a peak of approximately 16 amperes in approximately 4.2 mS (being 0.5π√(L1 C1) or one quarter of the natural resonance period of the capacitor C1 and inductive device L1) with a waveform that is very close to one quarter cycle of a sinusoid. The lower waveform of FIG. 1H shows the run-mode magnetizing current. The supply-fed replenishment current then sustains the peak of the sinusoid shape for the remainder of the magnetizing stage. At the end of the magnetizing stage, when the switches S1 and S2 are opened, current induced in the inductive device L1, by the collapsing magnetic field, falls to zero in approximately 3.7 mS with a waveform that is very close to the second quarter cycle of a sinusoid. The current in the inductive device L1 then remains at zero until the start of the next cycle.

In summary, the waveform of the current in the inductive device is substantially a half sinusoid for each cycle of operation. When the capacitor voltage decreases to below the supply voltage, the replenishment current from the supply begins rising from zero and peaks at a current of approximately 11 amperes. An induced current, with a peak amplitude of 16 amperes, flows from the inductive device as a recovery current. The 16 ampere peak amplitude recovery current is superimposed on the 11 ampere peak amplitude replenishment current from the supply to give a current of approximately 27 amperes peak amplitude to recharge the capacitor C1.

The magnetizing period when switches S1 and S2 are closed is 5 mS, and the energy recovery period over which the current established in the inductive device drops to zero is approximately 3.7 mS. These periods are approximately equal to 4.2 mS which is 0.5π√(L1 C1) or one quarter of 16.8 mS, the natural resonance period of the recovery capacitor C1 and the inductance L1.

### 1.17 Circuit Performance

The performance of another specific version of the first embodiment is discussed with reference to the table shown in FIG. 1K and the graph shown in FIG. 1L. This example serves to show how the performance and efficiency of a circuit can be significantly improved by application of the current invention.

The circuit of this specific version is as shown in FIG. 1A, with the exception that the inductor L1 is replaced with a transformer coupled to a load resistor.

The transformer primary winding has an inductance of 36 mH, an equivalent series resistance of 0.5 ohm, and is connected in place of the inductor L1 in the circuit of FIG. 1A. The transformer secondary winding has an inductance of 1 μH and is connected to a load resistor of 0.005 ohm. The transformer has a coupling ratio of 0.99.

The circuit switching is operated with switch timings as shown in FIG. 1B with values of t₁, t₂ and t₃ as given in the table below.

The circuit of this specific version of the first embodiment has the following components and circuit values:

S1 and S2: IRFK3D350

D1, D2 and D3: RHRG30120

V1=24 volts

L2=2 mH

Switching period t₁ to t₃=10 mS

Switching frequency 100 Hz

Magnetizing period t₁ to t₂=5 mS

Recovery period t₂ to t₃=5 mS

In this specific version, the switches S1 and S2 remain closed for 5 mS during the 10 mS period of each cycle.

FIG. 1K shows a table of operating values and measures of circuit performance for a simulation of the specific version of the first embodiment, operating in a stable operating zone about 1 to 2 seconds after initial start-up, over a range of values of capacitance C1 from 2.5 to 8,000 μF. In the table;
Va is the voltage on the capacitor C1 at t₁ (i.e. the beginning of the magnetizing period), expressed in volts;
Vb is the voltage on the capacitor C1 at t₂ (i.e. the end of the magnetizing period), expressed in volts;
Vb/Va is the ratio of the voltages Vb and Va on the capacitor C1 at the end and start of the magnetizing period, expressed as a percentage;
PS is the power delivered from the supply to the circuit, expressed in watts;
PL is the power dissipated by the load resistor connected to the transformer secondary winding, expressed in watts; and
E is the efficiency of overall power transfer from the supply to the load resistor, expressed as a percentage.

FIG. 1L shows a graph of operating values and measures of circuit performance for the simulation of the specific version of the first embodiment, operating in a stable operating zone about 1 to 2 seconds after initial start-up, over a range of values of capacitance C1 from 2.5 to 800 μF. The graph shows:
the ratio Vb/Va, expressed as a percentage and shown by a dashed line;
the power transfer efficiency E, expressed as a percentage and shown as a dotted line; and
the load power PL, expressed in watts and shown as a solid line.

The trends of the performance values for capacitance C1 values above 800 μF are evident from the graph and have been omitted to more clearly demonstrate circuit performance for values of capacitance C1 values below 800 μF.

When capacitance C1 in the specific version of the first embodiment is large, it acts a reservoir capacitor across the supply V1. With such a large value of capacitance, there is insufficient time for the capacitance to discharge during the 5 mS magnetizing period and the voltage remaining on the capacitance C1 at the end of the magnetizing period is not significantly less than the voltage on the capacitance C1 at the start of the magnetizing period. For example, for values of capacitance C1 greater than 4,000 μF, over 92% of the voltage on the capacitance is remaining at the end of the magnetizing period; and even with values of capacitance C1 down to 600 μF, over 49% of the voltage on the capacitance is remaining at the end of the magnetizing period. This equates to less than 24% of the energy stored in the capacitance being utilized when re-establishing the magnetic field in the transformer, given that energy stored in a capacitance is proportional to the square of the voltage across the capacitance.

The circuit operates with efficient transfer of energy between the inductive load device and the recovery capacitor with a range of values of the magnetizing period t_{MAG} (in seconds) that are at least approximately equal to 0.5π√(LC), where L is the inductance value (in henries) of the inductive load device, and C is the capacitance value (in farads) of the recovery capacitor. This range can be expressed as t_{MAG}=kπ√(LC) where k is a factor defining the range. By rearranging this expression, the factor k=t_{MAG}/π√(LC)). In the current example, where t_{MAG}=5 mS and L=36 mH, the factor k=0.0084/√C, where C is the recovery capacitance in microfarads.

With large values of capacitance C1, and therefore relatively high voltages remaining on the capacitance, the recycling of energy from capacitance to the load via the transformer is relatively inefficient and the circuit performance is low. For example, when capacitance C1 is greater than 600 μF, the circuit operates at relatively low efficiencies of about 50% and very low load power output values of less than 4.5 watts. This performance is typical of this type of circuit when operated with the low drive voltage (24 volts) and the circuit components, switching topology and timing as described above.

As the value of the capacitance C1 is decreased, the action of the capacitance C1 changes from that of a reservoir capacitor to that of an energy recovery capacitor. As a reservoir capacitor, the capacitance C1 substantially maintains a steady supply voltage. As a recovery capacitor, the capacitor C1 is charged up to relatively high voltages by energy recovered from the collapsing transformer magnetic field and the resonant voltage compounding action. The capacitor is then is discharged to relatively low voltages when the transformer magnetic field is re-established. As the value of the capacitance C1 is decreased, and the capacitance C1 acts more as a recovery capacitor, the output load power and circuit transfer efficiency increase.

When the voltage remaining across the capacitance C1 at the end of the magnetizing period is less than approximately 50% of the voltage across the capacitance C1 at the start of the magnetizing period, the circuit operates at efficiencies greater than 50% and at load power output values greater than approximately 4.5 watts. This occurs when the value of the capacitance C1 is less than approximately 600 μF. At a capacitance value of 600 μF, the k factor is approximately 0.35.

Furthermore, when the voltage remaining across the capacitance C1 at the end of the magnetizing period is less than 30% of the voltage across the capacitance C1 at the start of the magnetizing period, the circuit operates at efficiencies greater than approximately 53% and at load power output values greater than approximately 6.7 watts. This occurs when the value of the capacitance C1 is less than approximately 400 μF. At a capacitance value of 400 μF, the k factor is approximately 0.42.

Furthermore, when the voltage remaining across the capacitance C1 at the end of the magnetizing period is less than 20% of the voltage across the capacitance C1 at the start of the magnetizing period, the circuit operates at efficiencies greater than approximately 55% and at load power output values greater than approximately 8 watts. This occurs when the value of the capacitance C1 is less than approximately 300 μF. At a capacitance value of 300 μF, the k factor is approximately 0.48.

Furthermore, when the voltage remaining across the capacitance C1 at the end of the magnetizing period is less than 10% of the voltage across the capacitance C1 at the start of the magnetizing period, the circuit operates at efficiencies greater than 58% and at load power output values greater than approximately 14 watts. This occurs when the value of the capacitance C1 is less than about 260 μF. At a capacitance value of 260 μF, the k factor is approximately 0.52.

Further increases in load power output and transfer efficiency can be obtained by decreasing the value of the capacitance still further. Load power output peaks at approximately 48 watts with a transfer efficiency of approximately 84% when the value of the capacitance is approximately 20 μF. At a capacitance value of 20 μF, the k factor is approximately 1.9.

For values of capacitance below 20 μF, output power decreases, although transfer efficiency increases. For example, a load power output of approximately 34 watts at a transfer efficiency of approximately 90% was obtained with a value of capacitance C1 of 2.5 μF. At a capacitance value of 2.5 μF, the k factor is approximately 5.3.

Useful operation of the invention may be obtained for values of the k factor in the ranges between 0.35 and 0.70, between 0.25 and 1.0, between 0.1 and 2.5, or even outside these ranges.

In some applications it may be desirable to operate at less that the maximum possible load power and transfer efficiency: for example, to optimize the load current waveform.

The increase in load output power and transfer efficiency for the lower values of capacitance C1 are due to the capacitance C1 being charged to relatively high voltages. For example, a capacitance of 2.5 μF is charged up to 370 volts. These voltages are relatively high compared to the 24 volts of the supply V1 and provide a very rapid rise in magnetizing current into the transformer. Although the relatively small capacitance is quickly discharged, the magnetizing current pulse can be extended and maintained for the remainder of the 5 mS magnetizing period by the lower supply voltage delivering current through the inductor L2 and diode D3. This is because only a small driving voltage is required to maintain the current through the primary winding inductance of the transformer once the current has reached a peak value.

FIG. 1L shows an inflexion in the transfer efficiency and output load power curves. This inflexion occurs at a transition between two modes of circuit operation. At values of capacitance C1 above about 160 μF, magnetizing current is supplied predominantly by discharge of the capacitance C1 with a small top-up of current from the supply V1 delivered through inductor L2 and diode D3 to make up for losses in the circuit. At values of capacitance C1 below about 120 μF, magnetizing current is supplied initially by discharge of the capacitance C1. But these values of the capacitance C1 are not sufficient to maintain the magnetizing current for the full magnetizing period: instead, after discharge of capacitance C1, the magnetizing current is supplied predominantly by current from the supply V1 delivered through inductor L2 and diode D3.

### 1.18 Dual Mode Operation

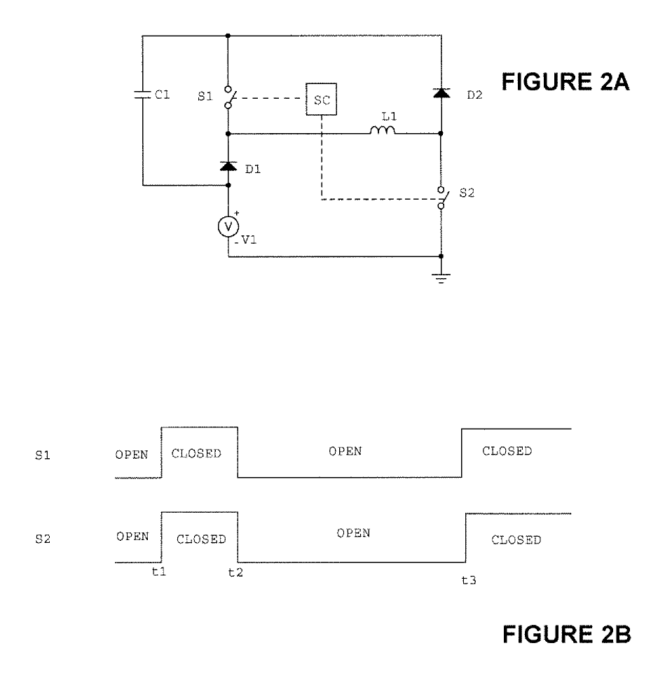

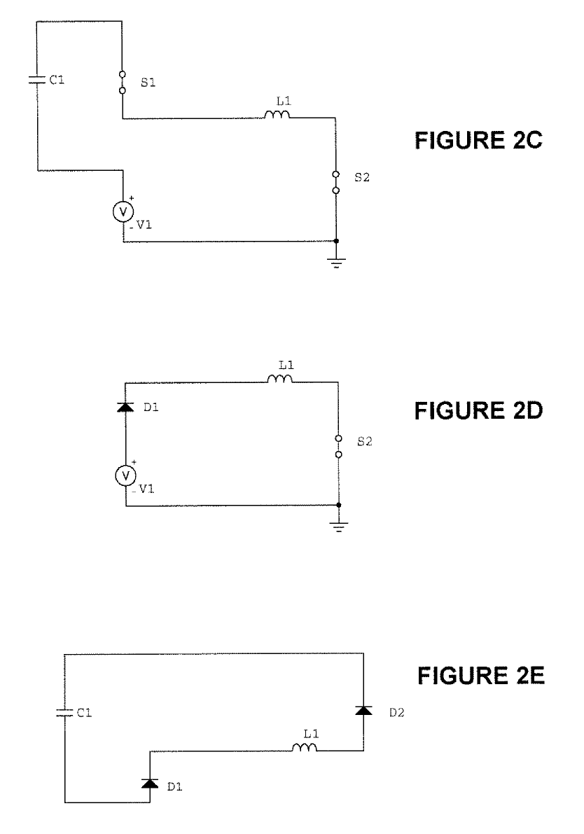

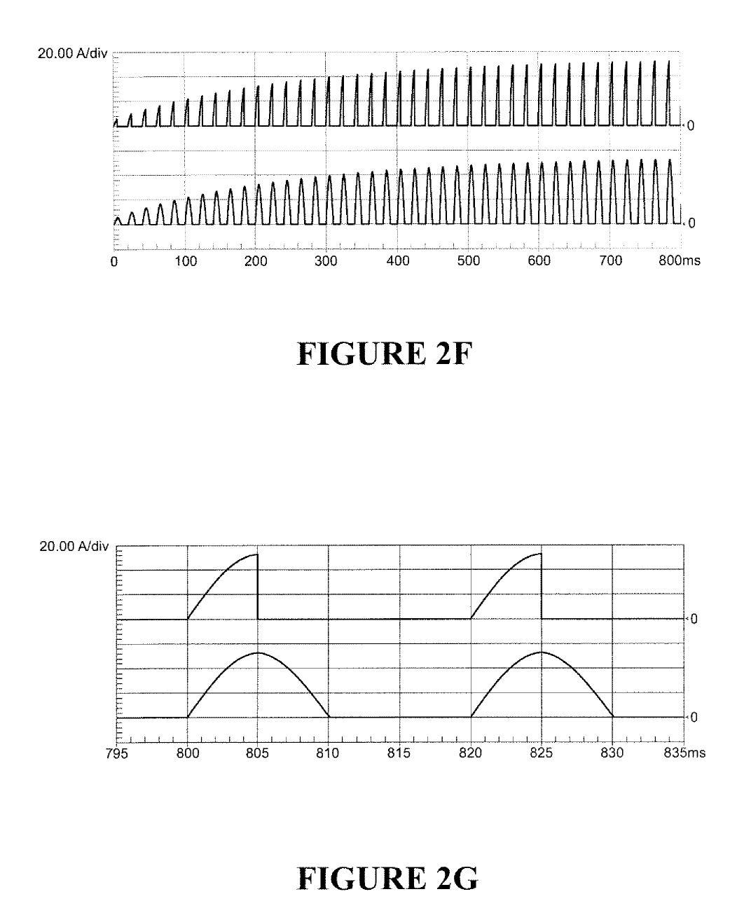

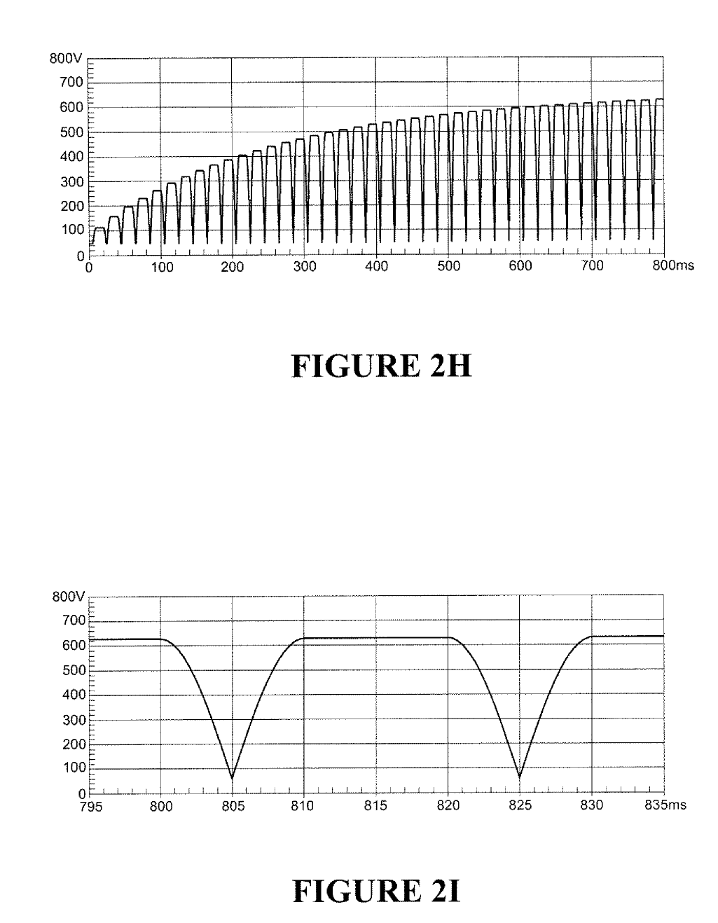

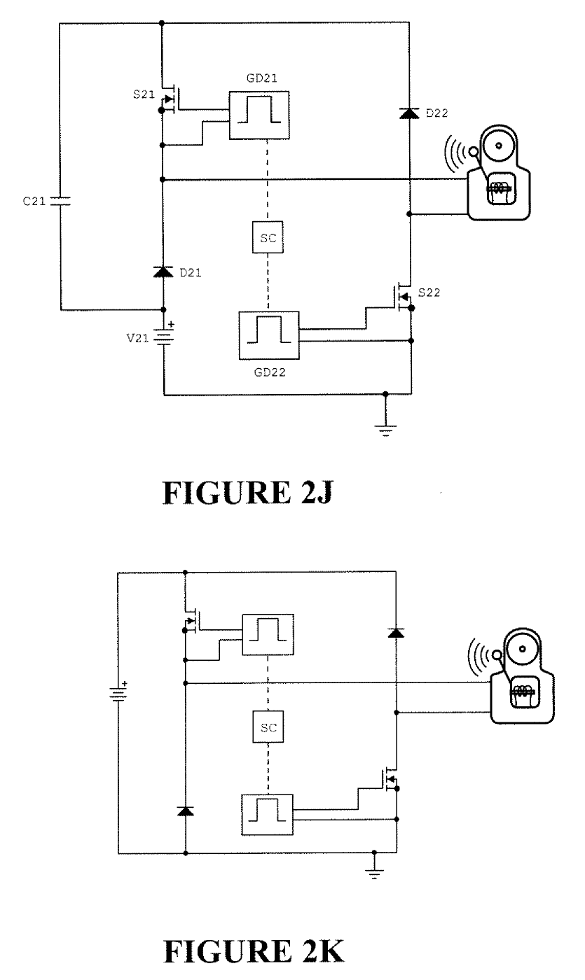

A dual-mode motor drive circuit, using the two circuit topologies shown in FIG. 1A and FIG. 2A, is discussed below in Section 2.16.

### Second Embodiment

### 2.1 Circuit Layout

FIG. 2A is a circuit diagram illustrating a second embodiment of the invention. In this second embodiment, a capacitor C1 storing energy recovered from an inductive device L1 is connected in series with a supply V1 to provide magnetizing current for the inductive device with a first quadrant of a semi-sinusoidal current through the inductive device.

The circuit of FIG. 2A comprises a DC power supply V1, two diodes D1 and D2, a capacitor C1, two controlled switches S1 and S2, and an inductive device L1. Switch S1, diode D1 and supply V1 are connected in series between upper and lower rails to form a first leg of an H-bridge. Diode D2 and switch S2 are connected in series between the upper and lower rails to form the second leg of the H-bridge. The inductive device L1 is connected between the bridge legs. The power supply V1 and the capacitor C1 are connected in series between the upper and lower rails. The circuit is operated by periodically switching the controlled switches S1 and S2 between open and closed states to achieve the effective circuit configurations shown in FIGS. 2C to 2E. The opening and closing of the switches S1 and S2 are controlled by a common switch controller SC.

### 2.2 Switch Timing

FIG. 2B is a switch timing diagram for the controlled switches S1 and S2 showing one cycle of operation from time t₁ to time t₃. Switches S1 and S2 are operated synchronously over each cycle by the switch controller SC.

The switches S1 and S2 are both closed to arrange the circuit of FIG. 2A for a magnetizing stage from time t₁ to time t₂. During this magnetizing stage a current is driven through the inductive device L1 to establish a magnetic field. The magnetizing current flows through the inductive device L1 from left to right in the circuits shown in FIGS. 2A, 2C and 2D.

Switches S1 and S2 remain closed from time t₁ to time t₂ for a period that is approximately equal to 0.5π√(L1 C1).

The magnetizing stage ends at time t₂ at which time switches S1 and S2 are opened to arrange the circuit of FIG. 2A for a recovery stage during which a current induced in the inductive device L1 during collapse of the magnetic field charges capacitor C1. The switches S1 and S2 are kept open from time t₂ to time t₃.

Both switches S1 and S2 are closed at time t₃ to arrange the circuit of FIG. 2A for the next magnetizing stage. The operating cycle is repeated with a repetition period equal to (t₃-t₁).

### 2.3 First Magnetizing Circuit

FIG. 2C shows a first effective circuit for the magnetizing stage of circuit operation when switches S1 and S2 are closed. This circuit applies during the magnetizing stage when diode D1 is non-conductive, i.e. when the voltage on capacitor C1 is sufficient to reverse bias diode D1.

### 2.4 Second Magnetizing Circuit

FIG. 2D shows a second effective circuit for the magnetizing stage of circuit operation when switches S1 and S2 are closed. This circuit applies when the voltage across the capacitor C1 is insufficient to reverse bias diode D1, and diode D1 becomes forward biased and conductive to effectively bypass the capacitor C1. Magnetizing current from the power supply V1 then flows through diode D1 to inductive device L1, and back through closed switch S2 to contribute to the establishment of the magnetic field in association with the inductive device L1.

### 2.5 Magnetizing Circuit Conversion

The conversion of the magnetizing circuit of FIG. 2C to that of FIG. 2D occurs automatically when there is insufficient charge on the recovery capacitor to supply all the magnetizing current for the full magnetizing period and particularly when the voltage on capacitor C1 is insufficient to reverse bias diode D1.

This conversion occurs immediately on first closing switches S1 and S2 at time t₁ of the first cycle of operation, but occurs later in subsequent cycles. In these subsequent cycles, the recovery capacitor can charge to progressively higher voltages as the circuit builds up to an operating mode.

### 2.6 Energy Recovery Circuit

FIG. 2E shows an effective circuit configuration for the energy recovery stage of circuit operation when switches S1 and S2 are both opened at time t₂. Current flowing from the inductive device L1 on collapse of the magnetic field forward biases diodes D1 and D2 and charges capacitor C1, causing the current to fall.

When this falling inductive device current reaches zero, diodes D1 and D2 become non-conductive, blocking discharge of the re-charged capacitor C1. This blocking holds the charge on capacitor C1 until the start of the next cycle at time t₃.

### 2.7 Start-Up Mode Magnetizing—First Cycle

Initial start-up of the circuit occurs when the switches S1 and S2 close at time t₁ of the first cycle of operation. For the purposes of the immediately-following explanation it is assumed that, prior to time t₁, capacitor C1 is uncharged.

At time t₁, switches S1 and S2 close to effectively arrange the circuit as shown in FIG. 2D. Magnetizing current then flows from the supply V1 through diode D1, inductive device L1 and closed switch S2 to establish a magnetic field in association with the inductive device L1.

### 2.8 Start-Up Mode Magnetizing—Subsequent Cycles

On subsequent cycles during start-up operation, the capacitor C1 will already, at time t₁ have some charge from energy recovery from previous cycles. In this case the circuit adopts the configuration shown in FIG. 2C and magnetizing current flows from the series combination of supply V1 and pre-charged capacitor C1, through closed switch S1, inductive device L1 and closed switch S2 to establish a magnetic field in association with the inductive device.

The flow of current out of the capacitor C1 depletes the charge on the capacitor which decreases the voltage across the capacitor. If the voltage across the capacitor C1 becomes insufficient to reverse bias diode D1, diode D1 conducts, the circuit automatically converts to that shown in FIG. 2D, and magnetizing current continues to flow but only from the supply V1. Diode D1 stops capacitor C1 from reverse charging.

### 2.9 Run Mode Magnetizing

In the run mode, the magnetizing current for the inductive device L1 is predominantly derived from the discharge of capacitor C1 connected in series with the supply V1 by the circuit of FIG. 2C.

During a first substantial part of the run mode magnetizing stage, the series combination (of recovery capacitor C1 and the supply V1) is connected by switches S1 and S2 to the inductive device L1, as seen in the circuit of FIG. 2C, to re-establish the magnetic field in the inductive device.

If the falling voltage on capacitor C1 is no longer sufficient to reverse bias diode D1, diode D1 conducts and magnetizing current in the inductive device L1 can be maintained by current flowing from the supply V1 through diode D1 to the inductive device L1, and back through switch S2, as seen in the circuit of FIG. 2D. This continues the flow of magnetizing current in the inductive device L1 using energy direct from the supply. This extension of the duration of the magnetizing current can occur automatically during every cycle if the capacitor C1 becomes depleted, to draw energy from the supply. This extension can make up for losses in the circuit.

### 2.10 Energy Recovery

FIG. 2E shows an effective circuit configuration for the energy recovery stage of circuit operation when switches S1 and S2 are both opened at time t₂. This circuit configuration continues from time t₂ to time t₃. At time t₂, the current through the inductive device L1 and the associated magnetic field begin to collapse.

The collapsing current flows from the inductive device L1 through diode D2 to capacitor C1 and back through diode D1 to inductive device L1. This current flows through the inductive device L1 in the same direction as the current used to establish the magnetic field (i.e. from left to right in FIG. 2E), but flows into the capacitor C1 in the opposite direction to the magnetizing current flowing from the capacitor C1 during the magnetizing stage.

The flow of the induced current, from the inductive device L1 back to the capacitor C1, recharges the capacitor to effectively transfer energy from the magnetic field to the capacitor C1. This recovered energy is used to re-establish the magnetic field during the magnetizing stage of the next cycle of operation.

### 2.11 Voltage Multiplication

On initial start-up, the capacitor C1 is charged, in the energy recovery stages of the first few successive cycles of circuit operation, to progressively higher voltages, as may be appreciated from the voltage waveform shown in FIG. 2H. After only a few cycles of operation the capacitor C1 is recharged at each recovery stage to several times the supply voltage. In the magnetizing stages, magnetizing current in the inductive device is driven by this capacitor voltage.

The recovery of energy from the collapsing magnetic field at each cycle and its re-use to re-establish the field in the magnetizing stage at the next cycle effectively multiplies the voltage from which the inductive device is driven to provide a significant improvement in efficiency. The voltage multiplication process is similar to the transient charging phase of a resonant inductance-capacitance (L-C) circuit.

The capacitor C1 discharges with progressively higher peak current values, during the magnetizing stage of each of the first few start-up cycles. The series combination of supply V1 and capacitor C1 provides a discharge current through closed switch S1 to the inductive device L1, with a return path to earth or ground through the closed switch S2, as seen in the magnetizing circuit shown in FIG. 2C. This current is provided over a significant time during the magnetizing stage before the voltage on the capacitor C1 is sufficiently depleted to remove the reverse bias on diode D1.

If the voltage on capacitor C1 is sufficiently depleted and diode D1 is forward biased, the circuit effectively adopts the supply-fed magnetizing circuit configuration as shown in FIG. 2D, whereupon the magnetizing current in the inductive device is provided from supply V1 via diode D1 to inductive device L1, with a return path to earth or ground through closed switch S2. The voltage of the supply V1, although less than the much higher run-mode voltages achieved on the series combination of supply V1 and capacitor C1, is sufficient to maintain the level of current in the inductive device L1 and extend the duration of the magnetizing current in the inductive device through to the end of the magnetizing stage.

In practice, the compounding of voltage on the recovery capacitor C1 is limited by circuit losses and by motional or induced back electromotive forces (BEMFs), if any. Motional BEMFs can arise from a changing inductance in the inductive device L1, such as in a reluctance motor, reducing the amplitude of current in the inductive device. The voltage gain is related to the ratio of the maximum energy stored to the energy dissipated per cycle, or to the loaded Q (the quality factor of the inductance capacitance circuit). Where BEMFs and circuit resistances are kept low, the circuit of the first embodiment drives the inductive device with a voltage that is many times greater than that of the supply.

### 2.12 Energy Transfer

The supply V1 has an effective capacitance that is many times greater than the capacitance of capacitor C1, giving the series combination of the supply V1 and the capacitor C1 an effective capacitance value substantially equal to the capacitance of capacitor C1. When the capacitor C1 and supply are together providing magnetizing current in the inductive device L1 during the earlier part of the magnetizing stage, before magnetizing from the supply alone takes over, the circuit is effectively capacitor C1 series connected by switches S1 and S2 to inductive device L1.

For optimum operation of the energy recovery circuit shown in FIG. 2A, the recovered energy stored as a charge on capacitor C1 must be efficiently transferred back to the magnetic field associated with the inductive device L1. Maximum transfer of energy from the capacitor back to the inductive device occurs when the voltage on the capacitor C1 has decreased from a maximum to zero and the current in the inductive device L1 has simultaneously risen from zero to a maximum. The time for this to occur is equal to a quarter of the period of natural resonance of the inductance-capacitance (L-C) circuit, which in this case is equal to 0.5π√(L1 C1).

For optimum operation of the energy recovery circuit of FIG. 2A, the switches S1 and S2 are closed for each cycle of operation for a time that is approximately equal to 0.5π√(L1 C1) to allow for optimum transfer of energy from the capacitor C1 to the inductive device L1.

The switches S1 and S2 can be maintained closed after depletion of the charge on capacitor C1 to extend the duration of the magnetizing current in the inductive device L1. During this extension the magnetizing current is supplied from the supply V1 only, via diode D1.

For optimum operation of the energy recovery circuit shown in FIG. 2A, the energy from the magnetic field associated with the inductive device L1 must be efficiently transferred back to the recovery capacitor C1. Maximum transfer of energy from the magnetic field back to the capacitor occurs when the current flowing in the inductive device L1 has decreased to zero.

For optimum operation of the energy recovery circuit of FIG. 2A, the switches S1 and S2 are open for each cycle of operation for a time that is no shorter than a quarter of the period of natural resonance of the inductance-capacitance (L-C) circuit, which in this case is equal to 0.5π√(L1 C1), to allow for optimum transfer of energy from the inductive device L1 to the capacitor C1. The switches S1 and S2 are maintained opened after cessation of the current in the inductive device L1, while waiting on the re-closing of switches S1 and S2 to re-establish the magnetic field at the commencement of the next cycle.

At near optimum operation, the contrast between the shorter duration of the run mode supply current pulses shown in the upper waveform of FIG. 2G and the longer duration of the run mode inductive device current pulses shown in the lower waveform of FIG. 2G is clearly apparent.

### 2.13 Specific Embodiment

One specific embodiment of the circuit shown in FIG. 2A has the following circuit values:

S1 and S2: IRFK4HE50

D1 and D2: RHRG30120

V1=48 volts

C1=290 μF

L1=38 mH (with an effective series resistance of 0.5 ohms)

Switching period t₁ to t₃=20 mS

Switching frequency=50 Hz Magnetizing period t₁ to t₂=5 mS

In this embodiment, the switches S1 and S2 remain closed for 5 mS over the 20 mS period of each cycle. One quarter of the natural resonance period of the capacitor C1 and inductive device L1, i.e. 0.5π√(L1 C1), is equal to 5.2 mS, slightly longer than the time period in each cycle that the switches S1 and S2 are closed.

In this embodiment, the capacitor C1 is recharged at each recovery stage to more than 480 volts (10 times the supply voltage) after the first 20 cycles of operation, i.e. after 400 mS from starting, and reaches 600 volts 15 seconds after start-up. The magnetizing current in the inductive device L1 is provided from the capacitor in series with the supply, giving an effective run-mode supply voltage multiplication of over 13 times. FIG. 2H shows the successive increase in voltage between upper and lower circuit rails during start-up. FIG. 2I shows a typical waveform of the voltage between the upper and lower circuit rails for two cycles during a run-mode. These waveforms and the circuit performance values given above apply to a simulation of the specific embodiment as described above. In practice, variations in the inductance of the inductive device and back emfs can reduce the voltage multiplication effect. Multiplications of the supply voltage by about 2 to 6 times can be expected in practical circuits.

The provision of magnetizing current from the series connection of the supply with the recovery capacitor in this embodiment adds to the voltage on the recovery capacitor and supplies full current to the inductive device, replenishing losses and ensuring the drive voltage is held high. This circuit is particularly suited to applications requiring high start-up force or torque.

### 2.14 Waveforms

FIGS. 2F, 2G, 2H and 2I show typical simulated waveforms of currents and voltages for the specific second embodiment of the circuit shown in FIG. 2A. The upper waveforms of FIGS. 2F and 2G shows typical supply current waveforms. The lower waveforms of FIGS. 2F and 2G show typical current waveforms for the inductive device L1. FIGS. 2H and 2I show typical waveforms of the voltage between the upper and lower circuit rails. FIG. 2F and 2H show several cycles during start-up. FIGS. 2G and 2I show run-mode cycles.

In the run-mode of the specific second embodiment of FIG. 2A having the circuit values described above, the magnetizing current in the inductive device L1 rises from zero to a peak of approximately 52 amperes with a waveform that is very close to one quarter cycle of sinusoid. This may be best appreciated from the lower waveform in FIG. 2G, from 800 mS to 805 mS.

Over the same time period, the voltage on the recovery capacitor C1 drops from 580 volts to 12 volts. This may be best appreciated from the lower waveform in FIG. 2I which shows the voltage across the series combination of the recovery capacitor and the supply dropping from 628 volts to 60 volts over the same period from 800 mS to 805 mS.

At the end of the magnetizing stage, when the switches S1 and S2 are opened, current induced in the inductive device L1, by the collapsing magnetic field, falls to zero in approximately 5 mS with a waveform that is very close to the second quarter cycle of a sinusoid. This may be best appreciated from the lower waveform in FIG. 2G, from 805 mS to 810 mS. The current in the inductive device L1 then remains at zero until the start of the next cycle at 820 mS. In summary, the waveform of the current in the inductive device is substantially a half sinusoid for each cycle of operation.

As shown in the upper waveform of FIG. 2G, the supply current only flows during the first quadrant of the sinusoid, i.e. when switches S1 and S2 are closed. The supply current waveform is a quarter sinusoid, which rises sinusoidally from zero to approximately 52 amperes (for example, between 800 mS and 805 mS) before dropping rapidly to zero when the switches S1 and S2 are opened (for example, at 805 mS).

The magnetizing period when switches S1 and S2 are closed, and the energy recovery period over which the current in the inductive device drops to zero, are each approximately 5 mS. This is approximately equal to 5.2 mS which is 0.5π√(L1 C1) or one quarter of 20.8 mS, the natural resonance period of the recovery capacitor C1 and the inductance L1.

### 2.15 Modifications

One application for which the circuit of FIG. 2A is suitable is as a driver for a high speed, single phase, switched reluctance motor. The inductance value of a motor winding, the recovery capacitor, and the magnetizing period are selected to satisfy the relationship given above so that energy is recovered from the winding as soon as the magnetizing current has reached its peak value.

The FIG. 2A circuit can also be adapted for driving switched reluctance motors in low speed or start-up mode. In this modification the controlled switch S2 of FIG. 2A is held closed for a further period after time t₂, effectively maintaining the circuit configuration of FIG. 2D and drawing current directly from the supply through diode D1. This extends the duration of the magnetizing current in the inductive device by providing a widened magnetizing current pulse having a flattened top. This widened pulse provides the motor with additional drive torque.

In yet a further adaptation of the FIG. 2A circuit, the magnetizing current can be chopped by rapidly closing and opening switches S1 and S2 to provide several sequences of closely following magnetizing and recovery stages followed by a pause. For example, the switches S1 and S2 are simultaneously closed for 3 mS for a magnetizing stage, opened for 1.3 mS for a recovery stage, closed for 1.7 mS for a magnetizing stage, opened for 1.3 mS for a recovery stage, closed for 1.7 mS for a magnetizing stage, opened for 1.3 mS for a recovery stage, closed for 1.7 mS for a magnetizing stage, and then opened, with this sequence being repeated every 30 mS. This effectively extends the magnetizing current to provide a very wide current pulse. The FIG. 2A circuit operated with this switch timing is also suitable for driving low speed solenoids or linear actuators with high force capability.

### 2.16 Dual Mode Operation

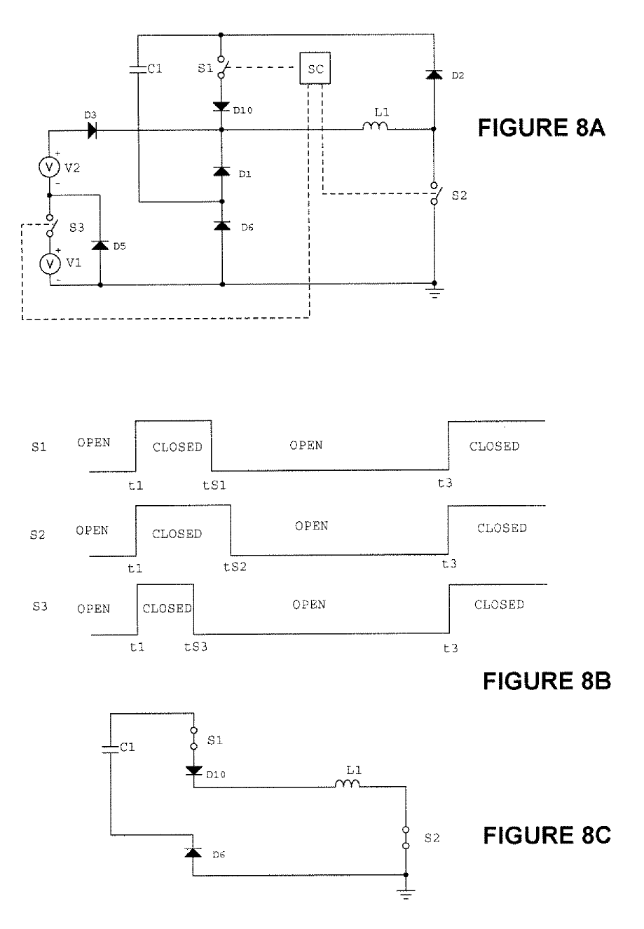

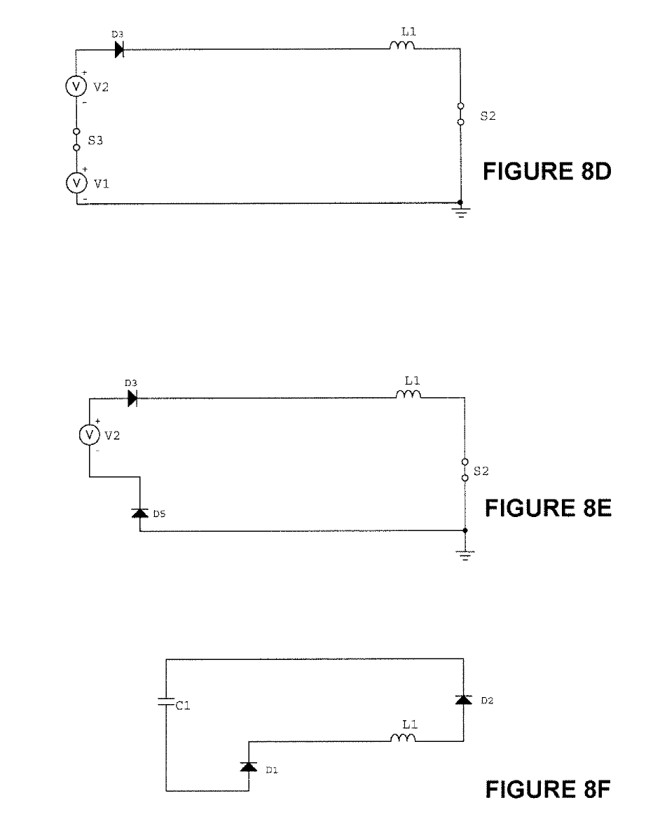

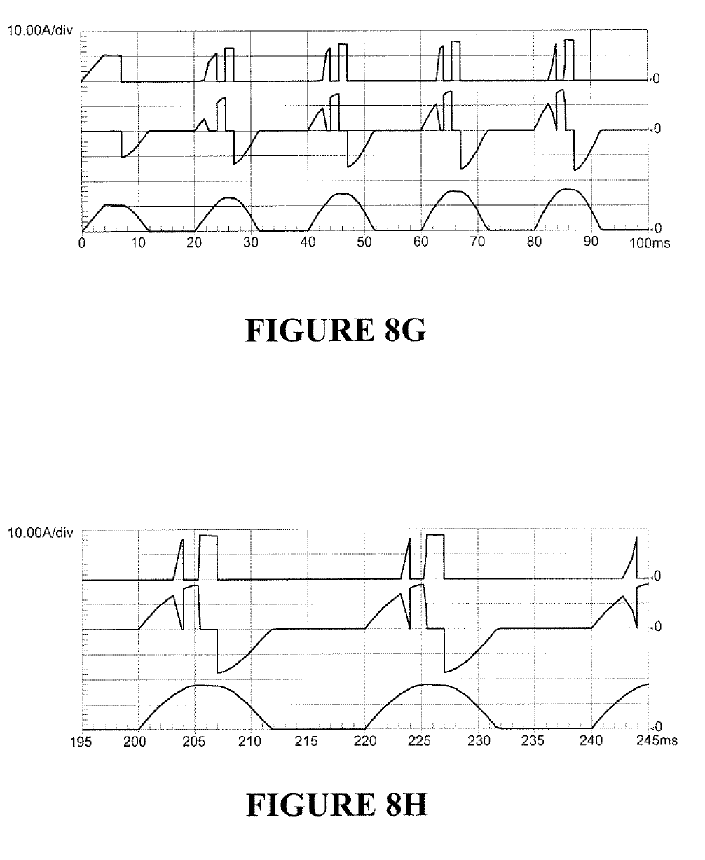

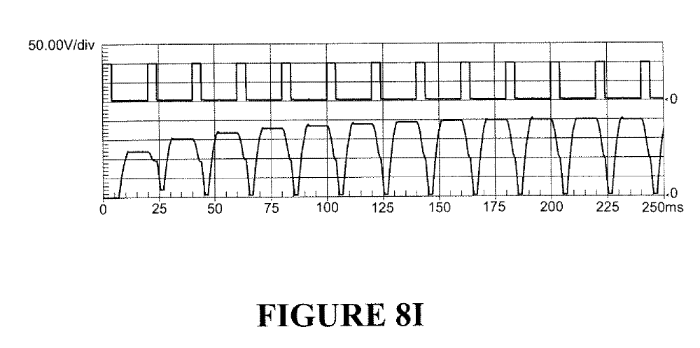

A dual-mode drive circuit (not shown), that effectively switches between the circuit topology of the invention shown in FIG. 2A and that of FIG. 1A or FIG. 8A, can be used to drive a motor. This dual-mode circuit is operated, during motor start-up, in the FIG. 2A mode (discussed above) and, after motor start-up, in the FIG. 1A mode (discussed above) or the FIG. 8A mode (discussed below).

The dual mode drive circuit is initially configured as shown in FIG. 2A to provide a start-up mode providing high initial torque from the rapidly rising peak voltages building on the recovery capacitor C1. Then the dual mode drive circuit is switched over to the configuration of either FIG. 1A or FIG. 8A to provide the motor with run mode torque.

In the case of the circuit of FIG. 8A, high motor torque is provided from the extended width of the magnetizing current pulses obtained from the combined supplies V1 and V2, as described below in Section 8 with reference to FIG. 8A.

### 2.17 Specific Application of Second Embodiment

In one specific example application of the second embodiment, the circuit shown in FIG. 2J is used to drive a modified 150 mm diameter, solenoid-driven, fire bell. The standard bell winding was rewound and mounted on a laminated ‘E’ core. The inductance of the modified winding varies from 13 mH with the moving solenoid armature ‘open’, to 29 mH with the moving armature ‘closed’, i.e. pulled-in. The resistance of the re-wound winding was 0.6 ohm.

The bell is driven by the circuit shown in FIG. 2J in which the inductance and resistance of the winding of the bell solenoid are represented by L21 and R21, respectively. The recovery capacitor C21 is 150 μF, and is made up of a parallel combination of three 50 μF pulse grade metallized polypropylene capacitors.

The circuit of FIG. 2J is operated similarly to the second embodiment described above with switch timing as described above with respect to FIG. 2B. FET switches S21 and S22 are controlled through respective gate drivers by a common switch controller SC to switch alternately between closed and open states.

The FET switches are driven by 2 kV isolated NME1215S DC to DC supplies driving through HCPL 3120 opto-isolated gate drivers. The two FET switches S21 and S22 are 20N60C3, 20 A, 600 V, TO220 case, and are simultaneously closed for 6 mS and then simultaneously opened for 24 mS, with this 30 mS total period pattern repeated at a repetition frequency of 33.3 Hz to ring the bell. The two diodes D21 and D22 are RUR 30 A, 600 V, TO220 case. The switch controller SC uses CMOS logic circuits. The 24 volts supply is stepped down to 12 volts by a Treco Ten-5 or -6 series DC to DC voltage converter to supply the CMOS logic and FET gate drive circuits.

The waveform of the current in the bell winding is similar to a half-wave rectified 33.3 Hz sinewave. However, because the inductance is higher once the armature has pulled in, the energy recovery period during the first part of the 24 mS when the FET switches are opened, and during which period the winding current drops to zero, is longer at about 10 mS than the 6 mS magnetizing period when the FET switches are closed. The inductance drops from the higher value only when the armature releases from its pulled-in position once recovery current flow drops to a low level or ceases. This asymmetry between the shorter magnetizing period and the longer recovery period makes the second quadrant of the 33.3 Hz current waveform longer than the first quadrant and is the direct result of the varying inductance of the bell solenoid.

The supply V21 is a 24 volt DC battery. In an optional arrangement, not shown, the supply V21 is connected to a reservoir capacitor (for example, 22,000 μF) through a series inductor (for example, 5 mH) and the remainder of the circuit, and particularly high pulse currents, are supplied from the reservoir capacitor with the battery then supplying the top-up current to the reservoir capacitor.

Mean current in the winding is 1.76 A rms and total mean power drawn from supply is 42.2 Watts to give a sound level of 114 dB when using this circuit according to the current invention.

Use of the invention in this specific application allows the fire bell to be driven with significantly higher currents using the same supply voltage. In one bell operating example, using a prior art asymmetric converter circuit as shown in FIG. 2K, the bell drew a mean supply current of 25 mA from a 24 volt supply (i.e. 0.66 watts) to provide a sound level of 65 dB when energy recovered from the winding inductance was returned to the supply. The same bell arrangement drew a mean supply current of 1.76 A from the same 24 volt supply (i.e. 42.2 watts) to provide a sound level of 114 dB when using the circuit of FIG. 2J in which energy recovered from the winding inductance L21 and stored on capacitor C21 was connected in series with the supply V21 to deliver the next magnetizing current pulse to the bell winding at a voltage significantly higher than the supply.

The 49 dB increase in the sound level to 114 dB by using the invention equates to greater than a 100 times the sound intensity in watts: (40 dB increase=100 times increase). This increase in sound intensity is obtained with only 64 times the energy from the supply, so not only is the bell output increased but the efficiency of bell operation is also increased in terms of the sound intensity/watt of input.

### Third Embodiment

### 3.1 Circuit Layout

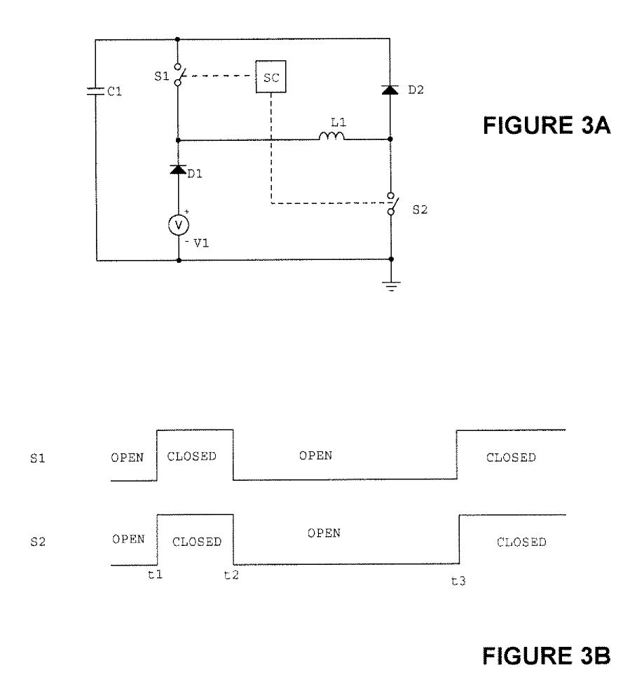

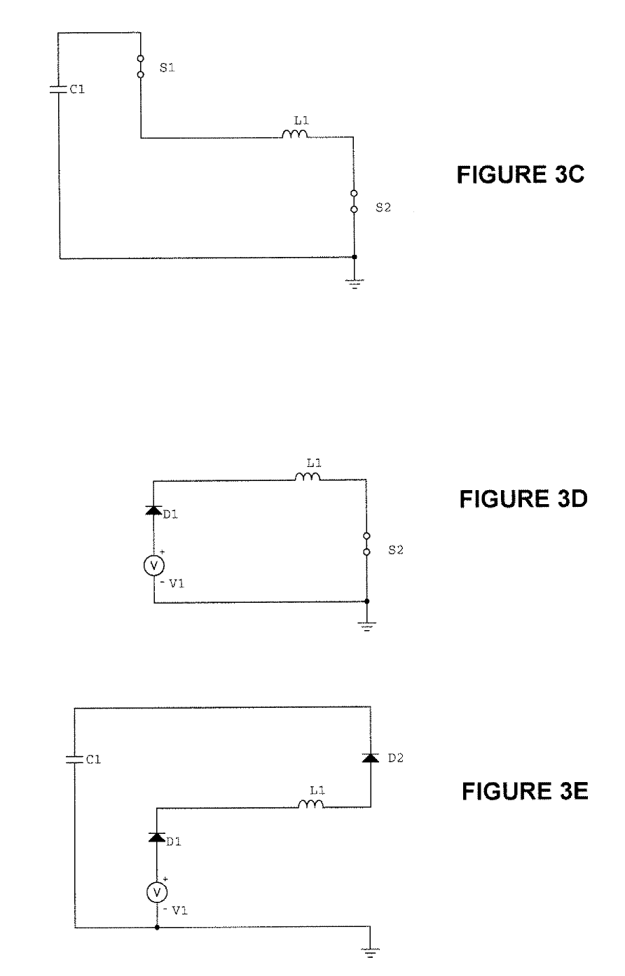

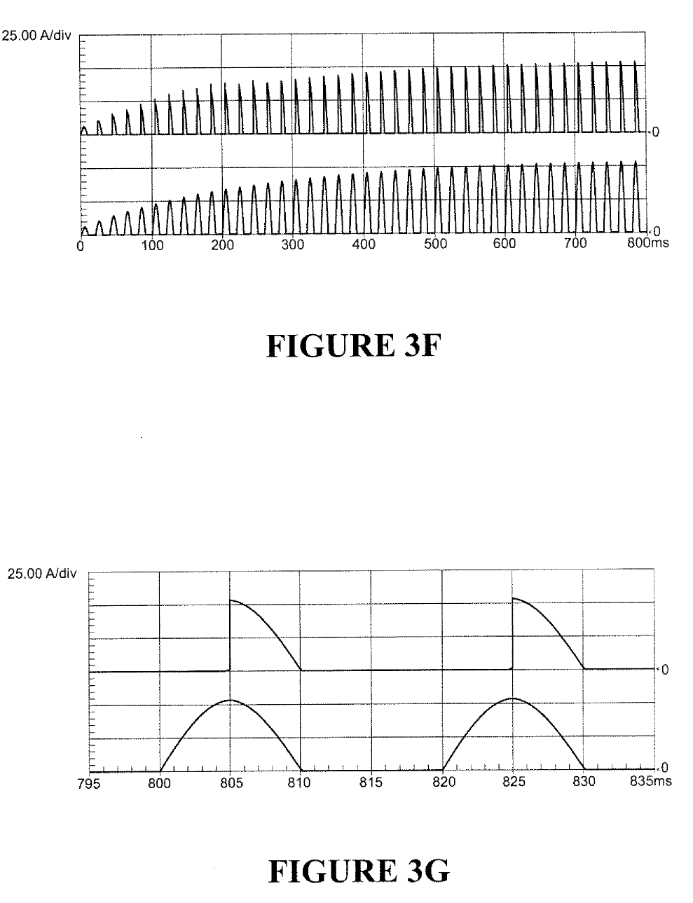

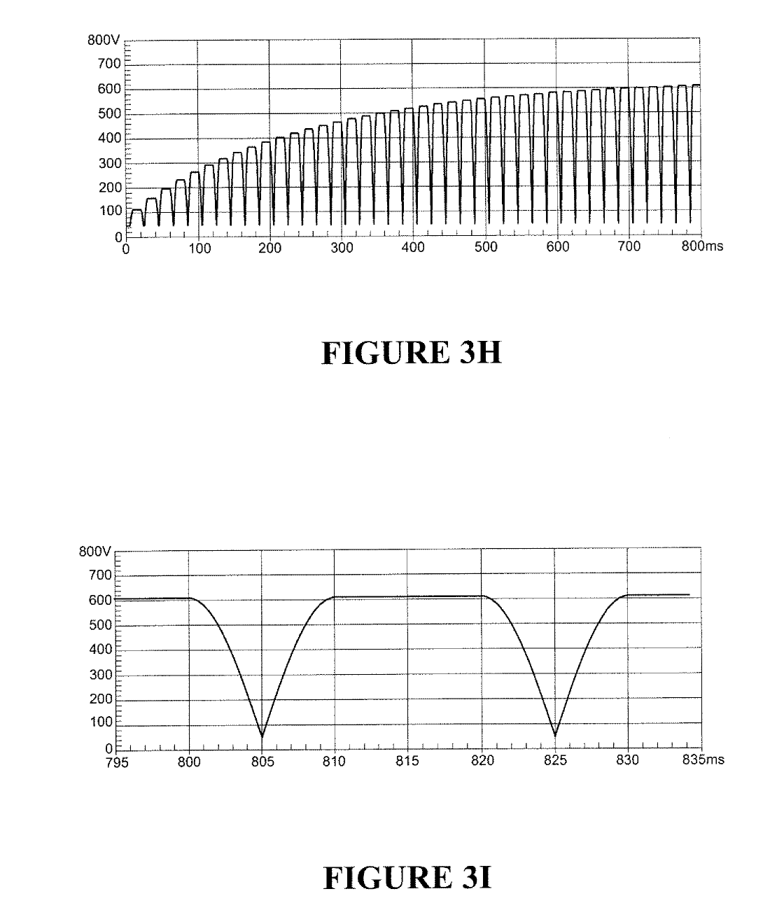

FIG. 3A is a circuit diagram illustrating a third embodiment of the invention. This circuit is a variant of the second embodiment. In this third embodiment, energy recovered from an inductive device L1 is returned to a recovery capacitor C1 connected in series with the supply V1 during a second quadrant of the semi-sinusoidal current through the inductive device.

The circuit of FIG. 3A comprises a DC power supply V1, two diodes D1 and D2, a capacitor C1, two controlled switches S1 and S2, and an inductive device L1. Switch S1, diode D1 and supply V1 are connected in series to form one leg of an H-bridge connected between upper and lower rails. Diode D2 and switch S2 are connected in series between the upper and lower rails to form the second leg of the H-bridge. The inductive device L1 is connected between the bridge legs. The capacitor C1 is connected between the upper and lower rails. The circuit is operated by periodically switching the controlled switches S1 and S2 between open and closed states to achieve the effective circuit configurations shown in FIGS. 3C to 3E. The opening and closing of the switches S1 and S2 are controlled by a common switch controller SC.

### 3.2 Switch Timing

FIG. 3B is a switch timing diagram for the controlled switches S1 and S2 showing one cycle of operation from time t₁ to time t₃. Switches S1 and S2 are operated synchronously over each cycle by the switch controller SC.

The switches S1 and S2 are both closed to arrange the circuit of FIG. 3A for a magnetizing stage from time t₁ to time t₂. During this magnetizing stage a current is driven through the inductive device L1 to establish a magnetic field. The magnetizing current flows through the inductive device L1 from left to right in the circuits shown in FIGS. 3A, 3C and 3D.

Switches S1 and S2 remain closed from time t₁ to time t₂ for a magnetizing period that is approximately equal to 0.5π√(L1 C1). The magnetizing stage ends at time t₂ at which time switches S1 and S2 are opened to arrange the circuit of FIG. 3A for a recovery stage during which a current induced in the inductive device L1 during collapse of the magnetic field charges capacitor C1. The switches S1 and S2 are kept open from time t₂ to time t₃.

Both switches S1 and S2 are closed at time t₃ to arrange the circuit of FIG. 3A for the next magnetizing stage. The operating cycle is repeated with a repetition period equal to (t₃-t₁).

### 3.3 First Magnetizing Stage Circuit

FIG. 3C shows a first effective circuit for the magnetizing stage of circuit operation when switches S1 and S2 are closed. This circuit applies during the magnetizing stage when diode D1 is non-conductive, i.e. when the voltage on capacitor C1 is greater than the voltage of the supply V1, reverse biasing diode D1.

### 3.4 Second Magnetizing Circuit

FIG. 3D shows a second effective circuit for the magnetizing stage of circuit operation when switches S1 and S2 are closed. This circuit applies when the voltage across the capacitor C1 is less than the voltage of the supply V1, making diode D1 forward biased and conductive. Magnetizing current from the power supply V1 then flows through diode D1 and inductive device L1, and back through closed switch S2 to contribute to the establishment of the magnetic field in association with the inductive device L1.

### 3.5 Magnetizing Circuit Conversion

The conversion of the magnetizing circuit of FIG. 3C to that of FIG. 3D occurs automatically during the magnetizing stage. This occurs when the voltage on capacitor C1 falls below, or is less than, that of the supply V1 and there is insufficient charge on the recovery capacitor to supply all the magnetizing current for the full magnetizing period t₁ to t₂.

This conversion occurs immediately on first closing switches S1 and S2 at time t₁ of the first cycle of operation, when there is no charge on the capacitor, but occur later in subsequent cycles. In these subsequent cycles, the recovery capacitor can charge to progressively higher voltages as the circuit builds up to an operating mode.

### 3.6 Energy Recovery Circuit

FIG. 3E shows an effective circuit for the energy recovery stage of circuit operation when switches S1 and S2 are both opened at time t₂. Current flowing from the inductive device L1 on collapse of the magnetic field forward biases diodes D1 and D2 and charges capacitor C1, causing the current to fall.

When this falling inductive device current reaches zero, diodes D1 and D2 become non-conductive, blocking discharge of the re-charged capacitor C1. This blocking holds the charge on capacitor C1 until the start of the next cycle at time t₃.

### 3.7 Start-Up Mode Magnetizing—First Cycle

Initial start-up of the circuit occurs when the switches S1 and S2 close at time t₁ of the first cycle of operation. For the purposes of the immediately-following explanation it is assumed that, prior to time t₁, capacitor C1 is uncharged.

At time t₁, switches S1 and S2 close, effectively arranging the circuit as shown in FIG. 3D. Magnetizing current then flows from the supply V1 through diode D1, inductive device L1 and closed switch S2 to establish a magnetic field in association with the inductive device L1.

### 3.8 Start-Up Mode Magnetizing—Subsequent Cycles

On subsequent cycles during start-up operation, the capacitor C1 will already, at time t₁, have been charged during a previous recovery stage to a voltage higher than that of the supply V1. The circuit then adopts the configuration shown in FIG. 3C. In this configuration, magnetizing current flows from the pre-charged capacitor C1 through closed switch S1, inductive device L1 and closed switch S2 to establish a magnetic field in association with the inductive device L1.

This flow of current out of the capacitor C1 depletes the charge on the capacitor which decreases the voltage across the capacitor. If the voltage across the capacitor C1 decreases below that of the supply V1, diode D1 becomes forward biased and conductive. This switching of the conductive states of diode D1 automatically converts the effective circuit from that shown in FIG. 3C to that shown in FIG. 3D, and magnetizing current continues to flow, now from the supply V1.

### 3.9 Run Mode Magnetizing

In the run mode, the magnetizing current for the inductive device L1 is predominantly derived from the discharge of capacitor C1 by the circuit of FIG. 3C.

During a first substantial part of the run mode magnetizing stage, the capacitor C1 is connected by closed switches S1 and S2 to the inductive device L1 as seen in the circuit of FIG. 3C, to re-establish the magnetic field in the inductive device L1.

If the falling voltage on the discharging capacitor C1 falls below the voltage of the supply V1, diode D1 becomes forward biased and conducts to maintain magnetizing current in the inductive device L1 by current flowing from the supply V1, through diode D1 to inductive device L1 and back through switch S2. This effective circuit is shown in FIG. 3D. This continues the magnetizing current in the inductive device L1 using energy direct from the supply V1. This automatic replenishment of the circuit can occur during every cycle upon depletion of the capacitor C1 to draw energy from the supply to make up for losses in the circuit or to complete the magnetizing current pulse when there is insufficient recovered energy to do so.

### 3.10 Energy Recovery

FIG. 3E shows an effective circuit configuration for the energy recovery stage of circuit operation when switches S1 and S2 are both opened at time t₂. This circuit configuration continues from time t₂ to time t₃. At time t₂, the current through the inductive device L1 and the associated magnetic field begin to collapse.

The collapsing current flows from inductive device L1 through diode D2 to capacitor C1 and back through the supply V1 and diode D1 to inductive device L1. This current flows through the inductive device L1 in the same direction as the current used to establish the magnetic field (i.e. from left to right in FIG. 3E), but flows into the capacitor C1 in the opposite direction to the magnetizing current flowing from the capacitor C1 during the magnetizing stage.

The flow of the induced current, from the inductive device L1 back to the capacitor C1, recharges the capacitor to effectively transfer energy from the magnetic field to the capacitor C1. This recovered energy is used to re-establish the magnetic field during the magnetizing stage of the next cycle of operation.

### 3.11 Voltage Multiplication

On initial start-up, the capacitor C1 is charged, in the energy recovery stages of the first few successive cycles of circuit operation, to progressively higher voltages, as may be appreciated from the voltage waveform shown in FIG. 3H. After only a few cycles of operation the capacitor C1 is recharged at each recovery stage to several times the supply voltage. In the magnetizing stages, the magnetizing current in the inductive device is driven from this capacitor voltage.

The recovery of energy from the collapsing magnetic field at each cycle and its re-use to re-establish the field in the magnetizing stage at the next cycle effectively multiplies the voltage from which the inductive device is driven to provide a significant improvement in efficiency. The voltage multiplication process is similar to the transient charging phase of a resonant inductance-capacitance (L-C) circuit.

The capacitor C1 discharges with progressively higher peak current values, during respective magnetizing stages of each of the first few start-up cycles.

### 3.12 Energy Transfer

When discharge of the capacitor C1 provides the magnetizing current for the inductive device L1 during the earlier part of the magnetizing stages, before magnetizing from the supply alone takes over, the circuit is effectively capacitor C1 series connected by switches S1 and S2 to inductive device L1.

For optimum operation of the energy recovery circuit shown in FIG. 3A, the recovered energy stored as a charge on capacitor C1 must be efficiently transferred back to the magnetic field associated with the inductive device L1. Maximum transfer of energy from the capacitor back to the inductive device occurs when the voltage on the capacitor C1 has decreased from a maximum to substantially equal to the voltage of supply V1, and the current in the inductive device L1 has simultaneously risen from zero to a maximum. The time for this to occur is equal to a quarter of the period of natural resonance of the inductance-capacitance (L-C) circuit, which in this case is equal to 0.5π√(L1 C1).

For optimum operation of the energy recovery circuit of FIG. 3A, the switches S1 and S2 are closed for each cycle of operation for a time that is approximately equal to 0.5π√(L1 C1) to allow for optimum transfer of energy from the capacitor C1 to the inductive device L1.

The switches S1 and S2 may be maintained closed for a small additional time period to extend the duration of the magnetizing current in the inductive device L1. During this extension period, the magnetizing current can be supplied from the supply through diode D1 and switch S2 to compensate for circuit losses.

For optimum operation of the energy recovery circuit shown in FIG. 3A, the energy from the magnetic field associated with the inductive device L1 must be efficiently transferred back to the recovery capacitor C1. Maximum transfer of energy from the magnetic field back to the capacitor occurs when the current flowing in the inductive device L1 has decreased to zero.

For optimum operation of the energy recovery circuit of FIG. 3A, the switches S1 and S2 are open for each cycle of operation for a time that is no shorter than a quarter of the period of natural resonance of the inductance-capacitance (L-C) circuit, which in this case is equal to 0.5π√(L1 C1), to allow for optimum transfer of energy from the inductive device L1 to the capacitor C1. The switches S1 and S2 are maintained opened after cessation of the current in the inductive device L1, while waiting on the re-closing of switches S1 and S2 to re-establish the magnetic field at the commencement of the next cycle.

At near optimum operation, the contrast between the shorter duration of the run mode supply current pulses shown in the upper waveform of FIG. 3G and the longer duration of the run mode inductive device current pulses shown in the lower waveform of FIG. 3G is clearly apparent.

### 3.13 Specific Embodiment

One specific embodiment of the circuit shown in FIG. 3A has the following circuit values:

S1 and S2: IRFK4HE50

D1 and D2: RHRG30120

V1=48 volts

C1=300 μF

L1=36 mH (with an effective series resistance of 0.5 ohms)

Switching period t₁ to t₃=20 mS

Switching frequency=50 Hz

Duration of magnetizing stage t₁ to t₂=5 mS

In this embodiment, the switches S1 and S2 remain closed for 5 mS over the 20 mS period of each cycle. One quarter of the natural resonance period of the capacitor C1 and inductive device L1, i.e. 0.5π√(L1 C1), is equal to 5.2 mS, slightly longer than the time period in each cycle that the switches S1 and S2 are closed.

In this embodiment, the capacitor C1 is recharged at each recovery stage to a voltage of over 600 volts, which is more than 12 times the supply voltage, after the first 40 cycles of operation, i.e. after only 800 mS from starting. The magnetizing current in the inductive device is driven from this capacitor voltage, giving an effective multiplication of the supply voltage.

FIG. 3H shows the successive increase in voltage on the recovery capacitor C1 during start-up. FIG. 3I shows a typical waveform of the voltage on the recovery capacitor C1 for two cycles during a run-mode.

### 3.14 Waveforms

FIGS. 3F, 3G, 3H and 3I show typical simulated waveforms of currents and voltages for the specific third embodiment of the circuit shown in FIG. 3A. The upper waveforms of FIGS. 3F and 3G shows typical supply current waveforms. The lower waveforms of FIGS. 3F and 3G show typical current waveforms for the inductive device L1. FIGS. 3H and 3I show typical waveforms of the voltage across the recovery capacitor C1, i.e. between the upper and lower circuit rails. FIG. 3F and 3H show several cycles during start-up. FIGS. 3G and 3I show run-mode cycles.

In the run-mode of the specific third embodiment of the FIG. 3A circuit as described above, the magnetizing current in the inductive device L1 rises from zero to a peak of approximately 54 amperes over 5 mS with a waveform that is very close to one quarter cycle of a sinusoid. This may be best appreciated from the lower waveform in FIG. 3G, from 800 mS to 805 mS. At the end of the magnetizing stage, when the switches S1 and S2 are opened, current induced in the inductive device L1, by the collapsing magnetic field, falls to zero over approximately 5.2 mS with a waveform that is very close to the second quarter cycle of a sinusoid. This may be best appreciated from the lower waveform in FIG. 3G, from 805 mS to 810 mS. The current in the inductive device L1 then remains at zero until the start of the next cycle at 820 mS. In summary, the waveform of the current in the inductive device is substantially a half sinusoid for each cycle of operation.

Over the magnetizing time period from 800 mS to 805 mS, the voltage on the recovery capacitor C1 drops from approximately 608 volts to 55 volts as may be best appreciated from the waveform of the voltage across the recovery capacitor shown in FIG. 3I.

As shown in the upper waveform of FIG. 3G, the supply current only flows during the recovery stage, i.e. during the second quarter, or quadrant, of the sinusoid. The supply current waveform is a quarter sinusoid, rising rapidly from zero to approximately 54 amperes (for example, at 805 mS) when the switches S1 and S2 are opened, then falling with a quarter sinusoid shape to zero (for example, between 805 mS and 810 mS).

In the run mode, the supply is connected in series with the capacitor C1 to provide a replenishment to make up for circuit losses.

The magnetizing period when switches S1 and S2 are closed, and the energy recovery period over which the current in the inductive device drops to zero, are each approximately 5 mS. This is approximately equal to 5.15 mS which is 0.5π√(L1 C1) or one quarter of 20.6 mS, the natural resonance period of the recovery capacitor C1 and the inductance L1.

### Fourth Embodiment

### 4.1 Circuit Layout

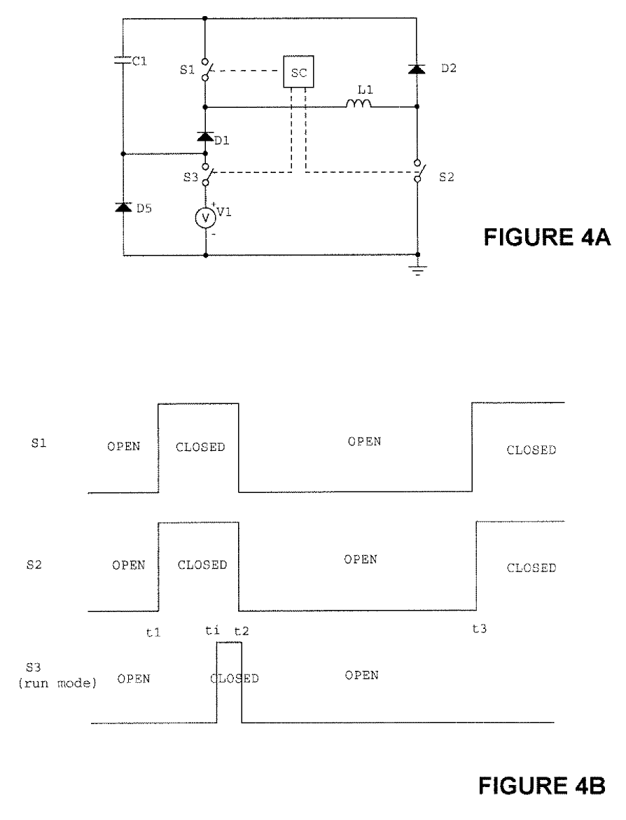

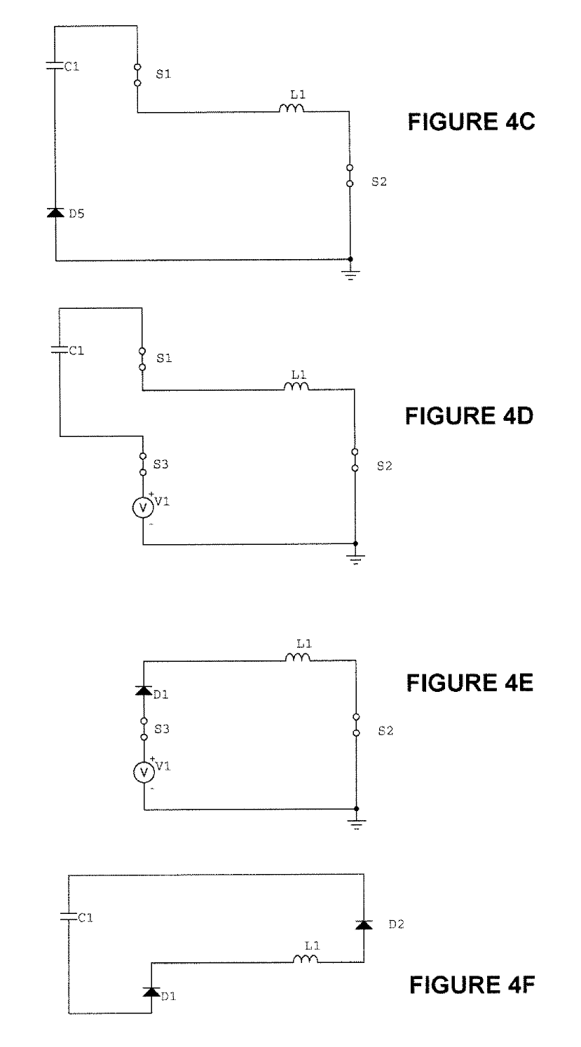

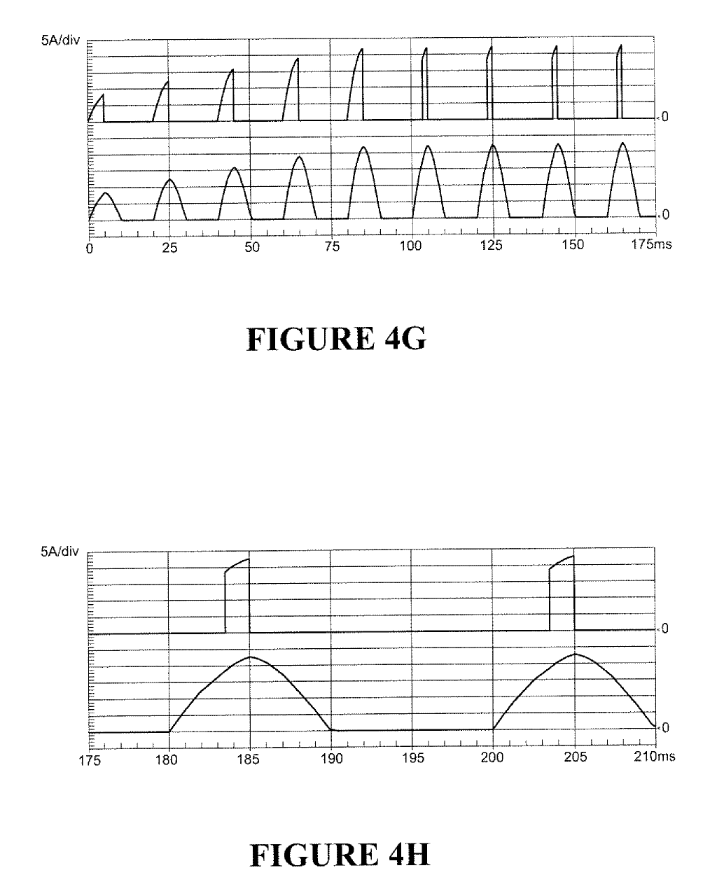

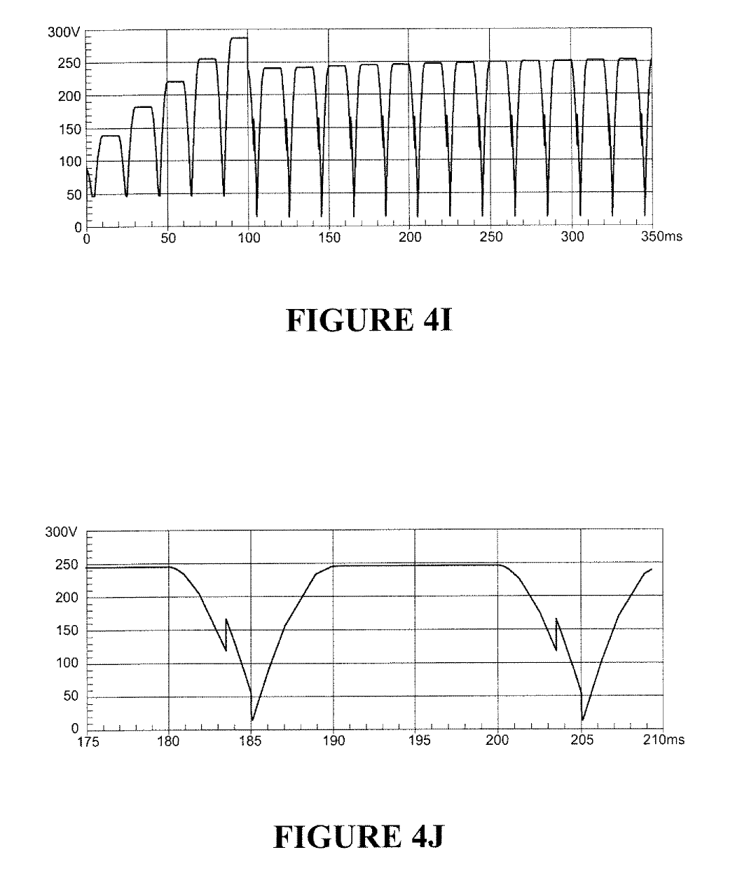

FIG. 4A is a circuit diagram illustrating a fourth embodiment of the invention. This circuit is a variant of the second embodiment. In the fourth embodiment, a capacitor C1 stores energy recovered from an inductive device L1 for providing a re-magnetizing current for the inductive device during a first quadrant of a semi-sinusoidal current through the inductive device. The injection of energy into the circuit from a supply V1 is controlled by an additional switch S3 which connects the supply in series with the capacitor just before the end of the first quadrant. Efficiency gains can be made over the second embodiment by limiting the duration of energy injection from the supply.

The circuit of FIG. 4 comprises a DC power supply V1, three diodes D1, D2 and D5, a capacitor C1, three controlled switches S1, S2 and S3, and an inductive device L1. Switch S1, diode D1, switch S3 and supply V1 are connected in series between upper and lower rails to form a first leg of an H-bridge. Diode D2 and switch S2 are connected in series between the upper and lower rails to form the second leg of the H-bridge. The inductive device L1 is connected between the bridge legs. The power supply V1 and the capacitor C1 are connected in series between the upper and lower rails when switch S3 is closed. The circuit is operated by periodically switching the controlled switches S1, S2 and S3 between open and closed states to achieve the effective circuit configurations shown in FIGS. 4C to 4F. The opening and closing of the switches S1, S2 and S3 are controlled by a common switch controller SC.

### 4.2 Switch Timing

The switches S1, S2 and S3 are controlled over an initial circuit start-up time in a start-up mode and then revert to a run mode.

FIG. 4B is a switch timing diagram for the controlled switches S1, S2 and S3 in the run mode. Switches S1 and S2 are closed and opened synchronously under control of switch controller SC over each cycle of operation from time t₁ to time t₃ according to the timing shown in FIG. 4B to provide respective magnetizing and recovery stages in the run mode. Switch S3 is closed during the latter part of the magnetizing stage at injection time ti and remains closed until the end of that magnetizing stage at time t₂.

In the start-up mode, switches S1 and S2 are closed and opened synchronously over each cycle of operation from time t₁ to time t₃ according to the timing shown in FIG. 4B to provide respective magnetizing and recovery stages. Switch S3 is closed for the duration of the start-up mode.

The switches S1 and S2 are both closed to arrange the circuit of FIG. 4A for a magnetizing stage of the operating cycle from time t₁ to time t₂. During this magnetizing stage a current is driven through the inductive device L1 to establish a magnetic field. The magnetizing current flows through the inductive device L1 from left to right in the circuits shown in FIGS. 4A, 4C, 4D and 4E.

Switches S1 and S2 remain closed from time t₁ to time t₂ for a period that is approximately equal to 0.5π√(L1 C1). The magnetizing stage ends at time t₂ at which time switches Si and S2 are opened to arrange the circuit of FIG. 4A for a recovery stage during which a current induced in the inductive device L1 during collapse of the magnetic field charges capacitor C1. The switches S1, S2 and S3 are kept open from time t₂ to time t₃.

Both switches S1 and S2 are closed at time t₃ to arrange the circuit of FIG. 4A for the next magnetizing stage. The operating cycle is repeated with a repetition period equal to (t₃-t₁).

In the run mode, switch S3 is closed at inject time t₁ to inject current from the supply V1 into the circuit during the latter part of the magnetizing stage. In the start-up mode, switch S3 remains closed to provide injection of current from the supply V1 over the full duration of the magnetizing stage.

### 4.3 First Magnetizing Circuit

FIG. 4C shows a first effective circuit for the first part of the magnetizing stage of circuit operation during the run mode, when switches S1 and S2 are closed and switch S3 is open, i.e. from time t₁ to time t₁.

### 4.4 Second Magnetizing Circuit

FIG. 4D shows a second effective circuit for the magnetizing stage of circuit operation, when switch S3 is closed (either during the start-up mode, or after supply injection time t₁ during the run mode) and when the voltage across the capacitor C1 is sufficient to reverse bias diode D1.

Magnetizing current is injected from the power supply V1 to flow through closed switch S3, capacitor C1, closed switch S1 and inductive device L1, and back through closed switch S2. This injection of supply current into the circuit contributes to the establishment of the magnetic field in association with the inductive device L1.

### 4.5 Third Magnetizing Circuit

FIG. 4E shows a third effective circuit for the magnetizing stage of circuit operation when switch S3 is closed (either during the start-up mode, or during the run mode after supply injection time t₁), and when the voltage across the capacitor C1 is insufficient to reverse bias diode D1. Diode D1 then becomes forward biased and conductive, effectively bypassing the capacitor C1 and closed switch S1, to provide the circuit shown in FIG. 4E.

Magnetizing current injected from the power supply V1 then flows through closed switch S3, diode D1 and inductive device L1, and back through closed switch S2 to inject supply current into the circuit and maintain establishment of the magnetic field in association with the inductive device L1. It is to be noted that this effective circuit is only utilized if the voltage on capacitor C1 drops sufficiently to make diode D1 conductive. This may not occur if the duration of the magnetizing stage period from time t₁ to time t₂ is kept shorter than approximately 0.5π√(L1 C1).

### 4.6 Magnetizing Circuit Conversion

The timing of the conversion of the magnetizing circuit of FIG. 4C to that of FIG. 4D occurs when switch S3 is closed at supply injection time t₁ under control of switch S3. This control of this circuit conversion is in contrast to the automatic conversion provided by the circuits of the first, second and third embodiments described above.

### 4.7 Energy Recovery Circuit

FIG. 4F shows an effective circuit for the energy recovery stage of circuit operation when controlled switches S1, S2 and S3 are opened at time t₂. Current flowing from the inductive device L1 on collapse of the magnetic field forward biases diodes D1 and D2 and charges capacitor C1, causing the current to fall.

When this falling inductive device current reaches zero, diodes D1 and D2 become non-conductive, blocking discharge of the re-charged capacitor C1. This blocking holds the charge on capacitor C1 until the start of the next cycle at time t₃.

### 4.8 Start-Up Mode Magnetizing—First Cycle

Initial start-up of the circuit occurs when the switches S1, S2 and S3 close at time t₁ of the first cycle of operation to effectively arrange the circuit as shown in FIG. 4E. For the purposes of the following explanation it is assumed that, prior to this time t₁, capacitor C1 is uncharged. Magnetizing current flows from the supply V1 through closed switch S3, diode D1, inductive device L1 and closed switch S2. The current flowing through the inductive device L1 establishes a magnetic field in association with the inductive device L1.

### 4.9 Start-Up Mode Magnetizing—Subsequent Cycles

On subsequent cycles during start-up operation, there will, at least initially, be some charge on capacitor C1. In this case the circuit adopts the configuration shown in FIG. 4D and magnetizing current flows from the series connection of supply V1, closed switch S3 and pre-charged capacitor C1, through closed switch S1, inductive device L1 and back through closed switch S2 to establish a magnetic field in association with inductive device L1. This current flow depletes the charge on capacitor C1, decreasing the voltage across the capacitor.

When, in these subsequent cycles during start-up operation, the voltage across the capacitor C1 becomes insufficient to maintain a reverse bias on diode D1, diode D1 becomes conductive and the circuit automatically reverts to that shown in FIG. 4E. The capacitor C1 discharges over a progressively longer time during the magnetizing stage of each of these subsequent start-up cycles. After depletion of voltage on capacitor C1, magnetizing current in the inductive device is provided from supply V1 via closed switch S3 and diode D1, with a return path to earth or ground through closed switch S2. Diode D1 prevents capacitor C1 from becoming substantially reverse charged.

### 4.10 Run Mode Magnetizing

In the run mode, the magnetizing current from the inductive device L1 is predominantly derived from the discharge of capacitor C1 by the circuit of FIG. 4C. During a first substantial part of the run mode magnetizing stage of each run mode cycle, the capacitor C1 is connected by switches S1 and S2, and diode D5, to the inductive device L1, as seen in the circuit of FIG. 4C. Current flows from charged capacitor C1, through closed switch S1, inductive device L1 and closed switch S2, and back through diode D5, to re-establish the magnetic field in association with the inductive device.

At supply injection time tᵢ, switch S3 is closed to effectively convert the circuit to that shown in FIG. 4D. Magnetizing current in the inductive device L1 is then maintained by current flowing from the supply V1, through switch S3, capacitor C1 and switch S1, to inductor L2, and back through switch S2, as seen in the circuit of FIG. 4D. This continues the magnetizing current in the inductive device L1 using energy direct from the supply. This replenishment draws energy from the supply during every cycle to make up for losses in the circuit.

The replenishment voltage provided by the supply V1 is less than the voltage provided by the charged capacitor C1. However, the lower voltage from the supply is sufficient to maintain the level of current in the inductive device L1 and prolong the magnetizing current begun by the current flow from the capacitor C1.

### 4.11 Energy Recovery

FIG. 4F shows the effective circuit configuration for the energy recovery stage of circuit operation when controlled switches S1, S2 and S3 are opened at time t₂. This circuit configuration continues from time t₂ to time t₃.

At time t₂, the current flowing through the inductive device L1 and the associated magnetic field begin to collapse. The collapsing current flows from inductive device L1 through diode D2 to capacitor C1 and back through diode D1 to inductive device L1. The current induced by the collapsing magnetic field flows through the inductive device L1 in the same direction as the current used to establish the magnetic field, (i.e. from left to right in FIG. 4F) but flows into the capacitor C1 in the opposite direction to the magnetizing current flowing from the capacitor C1 during the magnetizing stage. The capacitor C1 is recharged by the induced current.

The flow of the induced current from the inductive device L1 back to the capacitor C1 effectively recovers energy from the magnetic field and transfers the energy to the capacitor C1. This recovered energy is used to re-establish the magnetic field at the magnetizing stage of the next cycle of operation.

### 4.12 Voltage Multiplication

On initial start-up, the capacitor C1 is charged, in the energy recovery stages of the first few successive cycles of circuit operation, to progressively higher voltages, as may be appreciated from the voltage waveform shown in FIG. 4I. After only a few cycles of operation the capacitor C1 is recharged at each recovery stage to several times the supply voltage. In the magnetizing stages, magnetizing current in the inductive device is driven by this capacitor voltage.

The recovery of energy from the collapsing magnetic field at each cycle and its re-use to re-establish the field in the magnetizing stage at the next cycle effectively multiplies the voltage from which the inductive device is driven to provide a significant improvement in efficiency. The voltage multiplication process is similar to the transient charging phase of a resonant inductance-capacitance (L-C) circuit.

### 4.13 Energy Transfer

The supply V1 has an effective capacitance that is many times greater than the capacitance of capacitor C1, giving the series combination of the supply V1 and the capacitor C1 an effective capacitance value substantially equal to the capacitance of capacitor C1. When the capacitor C1 and supply are together providing the magnetizing current for the inductive device L1 during the earlier part of the magnetizing stage, before magnetizing from the supply alone takes over, the circuit is effectively a capacitance equal to that of capacitor C1 series connected by switches S1, S2 and S3 to inductive device L1.

For optimum operation of the energy recovery circuit shown in FIG. 4A, the recovered energy stored as a charge on capacitor C1 must be efficiently transferred back to the magnetic field associated with the inductive device L1. Maximum transfer of energy from the capacitor back to the inductive device occurs when the voltage on the capacitor C1 has decreased from a maximum to zero and the current in the inductive device L1 has simultaneously risen from zero to a maximum. The time for this to occur is equal to a quarter of the period of natural resonance of the inductance-capacitance (L-C) circuit, which is equal to 0.5π√(L1 C1).

For optimum operation of the energy recovery circuit of FIG. 4A, the switches S1 and S2 are closed for each cycle of operation for a time that is approximately equal to 0.5π√(L1 C1) to allow for optimum transfer of energy from the capacitor C1 to the inductive device L1.

If the switches S1 and S2 are kept closed for a small additional time period, the duration of the magnetizing current in the inductive device L1 can be extended. During this extension period, the magnetizing current can be supplied from the supply to compensate for circuit losses.

For optimum operation of the energy recovery circuit shown in FIG. 4A, the energy from the magnetic field associated with the inductive device L1 must be efficiently transferred back to the recovery capacitor C1. Maximum transfer of energy from the magnetic field back to the capacitor occurs when the current flowing in the inductive device L1 has decreased to zero.

For optimum operation of the energy recovery circuit of FIG. 4A, the switches S1 and S2 are open for each cycle of operation for a time that is no shorter than a quarter of the period of natural resonance of the inductance-capacitance (L-C) circuit, which in this case is equal to 0.5π√(L1 C1), to allow for optimum transfer of energy from the inductive device L1 to the capacitor C1. The switches S1 and S2 are maintained opened after cessation of the current in the inductive device L1, while waiting on the re-closing of switches S1 and S2 to re-establish the magnetic field at the commencement of the next cycle.

At near optimum operation, the contrast between the shorter duration of the run mode supply current pulses shown in the upper waveform of FIG. 4H and the longer duration of the run mode inductive device current pulses shown in the lower waveform of FIG. 4H is clearly apparent.

### 4.14 Specific Embodiment

One specific embodiment of the circuit shown in FIG. 4A has the following circuit values:

S1, S2 and S3: IRFK20450

D1, D2 and D5: RHRG30120

V1=48 volts

C1=280 μF

L1=36 mH (with an effective series resistance of 0.5 ohms)

Switching period t₁ to t₃=20 mS

Switching frequency=50 Hz

Duration of magnetizing stage t₁ to t₂=5 mS

Supply injection delay time t₁ to t₁=3.5 mS

Duration of supply injection tᵢ to t₂=1.5 mS

Duration of start-up mode 100 mS

In this embodiment, the switches S1 and S2 remain closed for 5 mS over the 20 mS period of each cycle to provide the magnetizing stage. In the run mode, S3 is closed for 1.5 mS beginning at 3.5 mS after the beginning of each cycle to provide the supply injection. Switch S3 is also closed for the full duration of the start-up period of 100 mS. One quarter of the natural resonance period of the capacitor C1 and inductive device L1, i.e. 0.5π√(L1 C1), is equal to 4.99 mS which is approximately equal to the time period in each cycle that the switches S1 and S2 are closed.

In this embodiment, the capacitor C1 is recharged at each recovery stage in the run mode to approximately 245 volts, a voltage that is more than 5 times the supply voltage, to give an effective supply voltage multiplication.

FIG. 4I shows the successive increase in voltage between upper and lower circuit rails during start-up. FIG. 4J shows a typical waveform of the voltage between the upper and lower circuit rails for two cycles during a run-mode. FIG. 4J shows the voltage between the upper and lower rails falling as the recovery capacitor C1 discharges into the inductive device L1, from 180 mS to 183.5 mS. When the switch S3 is closed at 183.5 mS, the voltage between the upper and lower rails initially steps up by 48 volts but then falls steadily, as the recovery capacitor continues to discharge into the inductive device L1, until 185 mS. Switch S3 is opened at 185 mS causing the voltage between the upper and lower rails to drop suddenly by 48 volts. In this specific fourth embodiment, a small residual charge remains on the capacitor C1.

Switches S1 and S2 are also opened at 185 mS to convert the circuit to the recovery mode. During the recovery mode, the capacitor C1 is recharged back up to about 245 volts ready for the next cycle which begins at 200 mS.

### 4.15 Waveforms

FIGS. 4G, 4H, 4I and 4J show typical simulated waveforms of currents and voltages for the specific fourth embodiment of the circuit shown in FIG. 4A. The upper waveforms of FIGS. 4G and 4H show typical supply current waveforms. The lower waveforms of FIGS. 4G and 4H shows typical current waveforms for the inductive device L1. FIGS. 4I and 4J show typical waveforms of the voltage between the upper and lower circuit rails. FIG. 4G and 4I show several cycles during start-up. FIGS. 4H and 4J show run-mode cycles.

In the run-mode of the specific fourth embodiment of the FIG. 4A circuit having the circuit values described above, the magnetizing current in the inductive device L1 rises from zero to a peak of approximately 22.5 amperes with a waveform that is close to one quarter cycle of sinusoid. This may be best appreciated from the lower waveform in FIG. 4H, from 180 mS to 185 mS. At the end of the magnetizing stage, when the switches S1, S2 and S3 are opened, current induced in the inductive device L1, by the collapsing magnetic field, falls to zero with a waveform that is close to the second quarter cycle of a sinusoid. This may be best appreciated from the lower waveform in FIG. 4H, from 185 mS to 190 mS. The current in the inductive device L1 then remains at zero until the start of the next cycle at 200 mS. In summary, the waveform of the current in the inductive device is substantially similar to a half sinusoid for each cycle of operation.

As shown in the upper waveform of FIG. 4H, current only flows from the supply when switch S3 is closed, for example from 183.5 mS to 185 mS.

As already described above, switch S3 is closed during an initial start-up period. In the specific fourth embodiment switch S3 is closed for an initial start-up period of 100 mS. As may be seen from the upper waveform of FIG. 4G, the continuous closure of switch S3 during the initial 100 mS allows current to flow from the supply during the full 5 mS of each magnetizing stage, i.e. from 0 to 5 mS, from 20 to 25 mS, from 40 to 45 mS, from 60 to 65 mS, and from 80 to 85 mS. After that initial 100 mS start-up period, switch S3 is only closed over the latter 1.5 mS of each 5 mS magnetizing period, i.e. from 103.5 to 105 mS, from 123.5 to 125 mS, from 143.5 to 145 mS, etc. FIG. 4I, which shows the waveform of the voltage between the upper and lower rails, shows that this voltage steps up very rapidly over the first 5 cycles of operation, i.e. during the 100 mS start-up period when switch S3 is continuously closed.

The magnetizing period when switches S1 and S2 are closed, and the energy recovery period over which the current in the inductive device drops to zero, are each approximately 5 mS. This is approximately equal to 4.99 mS which is 0.5π√(L1 C1) or one quarter of 19.95 mS, the natural resonance period of the recovery capacitor C1 and the inductance L1.

### Fifth Embodiment

### 5.1 Circuit Layout

FIG. 5A is a circuit diagram illustrating a fifth embodiment of the invention. This circuit is a variant of the second embodiment shown in FIG. 2A. In the fifth embodiment, the recovery capacitor (corresponding to capacitor C1 in FIG. 2A) is provided by two discrete recovery capacitors C1 and C3 which are interconnected by three diodes D7, D8 and D9 to charge in series but discharge in parallel. The two capacitors discharge in parallel during the first quadrant of the current waveform through the inductive device but charge in series during the second quadrant. This fifth embodiment circuit still provides full energy recovery with compounding voltages. The lower capacitance value of the series connection of the capacitors during the recovery period gives the collapsing current flowing through the inductive device a steeper falling edge, allowing faster recovery of energy. This circuit is particularly suitable for switched reluctance motor drives where the steeper falling edges give earlier termination of the drive current pulses, before the rotor and stator poles become fully aligned. This earlier termination can prevent, or at least reduce, the development of opposing torques.

The circuit of FIG. 5A comprises a DC power supply V1, five diodes D1, D2, D7, D8 and D9, two capacitors C1 and C3, two controlled switches S1 and S2, and an inductive device L1. Switch S1, diode D1 and supply V1 are connected in series between upper and lower rails to form a first leg of an H-bridge. Diode D2 and switch S2 are connected in series between the upper and lower rails to form the second leg of the H-bridge. The inductive device L1 is connected between the bridge legs. The two capacitors C1 and C3 are connected by diodes D7, D8 and D9 to charge in series but discharge in parallel. The circuit is operated by periodically switching the controlled switches S1 and S2 between open and closed states to achieve the effective circuit configurations shown in FIGS. 5C to 5E. The opening and closing of the switches S1 and S2 are controlled by a common switch controller SC.

### 5.2 Switch Timing

FIG. 5B is a switch timing diagram for the controlled switches S1 and S2 showing one cycle of operation from time t₁ to time t₃. Switches S1 and S2 are operated synchronously over each cycle by the switch controller SC.

The switches S1 and S2 are both closed to arrange the circuit of FIG. 5A for a magnetizing stage from time t₁ to time t₂. During this magnetizing stage a current is driven through the inductive device L1 to establish a magnetic field. The magnetizing current flows through the inductive device L1 from left to right in the circuits shown in FIGS. 5A, 5C and 5D.

Switches S1 and S2 remain closed from time t₁ to time t₂ for a period that is approximately equal to 0.5π√(L1(C1+C3)).

The magnetizing stage ends at time t₂ at which time switches S1 and S2 are opened to arrange the circuit of FIG. 5A for a recovery stage during which a current induced in the inductive device L1 during collapse of the magnetic field charges the capacitors C1 and C3, in series. The switches S1 and S2 are kept open from time t₂ to time t₃.

Both switches S1 and S2 are closed at time t₃ to arrange the circuit of FIG. 5A for the next magnetizing stage. The operating cycle is repeated with a repetition period equal to (t₃-t₁).

### 5.3 First Magnetizing Circuit

FIG. 5C shows a first effective circuit for the magnetizing stage of circuit operation when switches S1 and S2 are closed. This circuit applies during the magnetizing stage when diode D1 is non-conductive, i.e. when the voltage across parallel-connected capacitors C1 and C3 is sufficient to reverse bias diode D1.

### 5.4 Second Magnetizing Circuit

When the voltage across the parallel connection of capacitors C1 and C3 is insufficient to reverse bias diode D1, diode D1 becomes forward biased and conductive, effectively bypassing the capacitors C1 and C3, to provide the circuit shown in FIG. 5D. Magnetizing current from the power supply V1 then flows through diode D1, and inductive device L1, and back through closed switch S2 to contribute to the establishment of the magnetic field in association with the inductive device L1.

### 5.5 Magnetizing Circuit Conversion

The conversion of the magnetizing circuit of FIG. 5C to that of FIG. 5D occurs automatically when there is insufficient charge on the recovery capacitors to supply all the magnetizing current for the full magnetizing period and particular when the voltage on the parallel-connected capacitors C1 and C3 is not sufficient to reverse bias diode D1. This occurs immediately on first closing switches S1 and S2 at time t₁ of the first cycle of operation, but occurs later in subsequent cycles. In these subsequent cycles, the recovery capacitor can charge to progressively higher voltages as the circuit builds up to an operating mode.

### 5.6 Energy Recovery Circuit

FIG. 5E shows an effective circuit for the energy recovery stage of circuit operation when switches S1 and S2 are both opened at time t₂. Current flowing from the inductive device L1 on collapse of the magnetic field forward biases diodes D1, D2 and D7 and charges capacitors C1 and C3, causing the current to fall.

When this falling inductive device current reaches zero, diodes D1, D2 and D7 become non-conductive, blocking discharge of the re-charged capacitors C1 and C3. This blocking holds the charge on capacitors C1 and C3 until the start of the next cycle at time t₃.

### 5.7 Start-Up Mode Magnetizing—First Cycle

Initial start-up of the circuit occurs when the switches S1 and S2 close at time t₁ of the first cycle of operation. For the purposes of the following explanation it is assumed that, prior to time t₁, capacitors C1 and C3 are uncharged.

At time t₁, switches S1 and S2 close to effectively arrange the circuit as shown in FIG. 5D. Magnetizing current then flows from the supply V1 through diode D1, inductive device L1 and closed switch S2 to establish a magnetic field in association with the inductive device L1.

### 5.8 Start-Up Mode Magnetizing—Subsequent Cycles

On subsequent cycles during start-up operation, the capacitors C1 and C3 will already, at time t₁, have some charge from energy recovery from previous cycles. In this case the circuit adopts the configuration shown in FIG. 5C and magnetizing current flows from the series connection of the supply V1 and the parallel-connected pre-charged capacitors C1 and C3, through closed switch S1, inductive device L1 and closed switch S2, to establish a magnetic field in association with the inductive device L1.

This flow of current out of the capacitors C1 and C3 depletes the charge on these capacitors which decreases the voltage across the capacitors. If the voltage across the parallel-connected capacitors C1 and C3 becomes insufficient to reverse bias diode D1, diode D1 conducts, the circuit automatically converts to that shown in FIG. 5D, and magnetizing current continues to flow but only from the supply V1. Diode D1 prevents capacitors C1 and C3 from becoming substantially reverse charged.

### 5.9 Run Mode Magnetizing

In the run mode, the magnetizing current for the inductive device L1 is predominantly derived from the discharge of parallel-connected capacitors C1 and C3, in series with the supply V1, by the circuit of FIG. 5C.

During a first part of the run mode magnetizing stage, the series connection (of the supply V1 with the parallel combination of capacitors C1 and C3) is connected by switches S1 and S2 to the inductive device L1, as seen in the circuit of FIG. 5C, to re-establish the magnetic field in the inductive device.

If the voltage on the parallel-connected capacitors C1 and C3 is no longer sufficient to reverse bias diode D1, diode D1 conducts and magnetizing current in the inductive device L1 can be maintained by current flowing from the supply V1, through diode D1 to inductive device L1, and back through switch S2, as seen in the circuit of FIG. 5D. This continues the magnetizing current in the inductive device L1 with energy direct from the supply. This occurs automatically during every cycle upon depletion of the capacitors C1 and C3 and draws energy from the supply to make up for losses in the circuit.

### 5.10 Energy Recovery

FIG. 5E shows an effective circuit configuration for the energy recovery stage of circuit operation when switches S1 and S2 are both opened at time t₂. This circuit configuration continues from time t₂ to time t₃. At time t₂, the current through the inductive device L1 and the associated magnetic field begin to collapse.

The collapsing field induces a current to flow from the inductive device through diode D2 to the capacitors C1 and C3, and back through diode D1 to inductive device L1. The capacitors C1 and C3 are connected in series by diode D7. The current induced by the collapsing magnetic field flows through the inductive device L1 in the same direction as the current used to establish the magnetic field (i.e. from left to right in FIG. 5E), but flows into the series-connected capacitors C1 and C3 in the opposite direction to the magnetizing current flowing from the parallel-connected capacitors C1 and C3 during the magnetizing stage.

The switching of the connection of the capacitors C1 and C3 by the diodes D7, D8 and D9 in FIG. 5A, between a series connection when the capacitors are being charged during recovery of magnetic field energy and a parallel connection when discharging during magnetizing, significantly reduces the time required for recovery of the magnetic field energy.

The flow of the induced current from the inductive device back L1 to the capacitors C1 and C3, recharges the capacitors to effectively transfer energy from the magnetic field to the capacitors C1 and C3. This recovered energy is used to re-establish the magnetic field at the magnetizing stage of the next cycle of operation.

### 5.11 Voltage Multiplication

On initial start-up, the capacitors C1 and C3 are charged in the energy recovery stages of the first few successive cycles of circuit operation, to progressively higher voltages. The circuit settles to a running mode in which the capacitors C1 and C3 are recharged at each recovery stage to many times the supply voltage, giving an effective multiplication of the voltage which drives the magnetizing current for the inductive device.

The recovery of energy from the collapsing magnetic field at each cycle and its re-use to re-establish the field in the magnetizing stage at the next cycle effectively multiplies the voltage from which the inductive device is driven to provide a significant improvement in efficiency. The voltage multiplication process is similar to the transient charging phase of a resonant inductance-capacitance (L-C) circuit.

The capacitors C1 and C3 discharge with progressively higher peak current values, during the magnetizing stage of each of the first few start-up cycles. The voltage of the supply V1, although less than the much higher run-mode voltages achieved on the series combination of supply V1 and parallel-connected capacitors C1 and C3, is sufficient to maintain the level of current in the inductive device L1 and prolong the magnetizing current in the inductive device through to the end of the magnetizing stage.

### 5.12 Energy Transfer

The supply V1 has an effective capacitance that is many times greater than the capacitance of the parallel-connected capacitors C1 and C3, giving the series combination of the supply V1 and the parallel-connected capacitors C1 and C3 an effective capacitance value substantially equal to the capacitance of the parallel-connected capacitors C1 and C3. When the parallel-connected capacitors C1 and C3, and the supply V1 are together providing the magnetizing current for the inductive device L1 during the earlier part of the magnetizing stage, before magnetizing from the supply alone takes over, the circuit is effectively the parallel-connected capacitors C1 and C3 series connected by switches S1 and S2 to the inductive device L1.

For optimum operation of the energy recovery circuit shown in FIG. 5A, the recovered energy stored as a charge on the capacitors C1 and C3 must be efficiently transferred back to the magnetic field associated with the inductive device L1. Maximum transfer of energy from the capacitors back to the inductive device occurs when the voltage on the parallel-connected capacitors C1 and C3 has decreased from a maximum to zero and the current in the inductive device L1 has simultaneously risen from zero to a maximum. The time for this to occur is equal to a quarter of the period of natural resonance of the inductance-capacitance circuit, which is equal to 0.5π√(L1 CX), where CX is the effective capacitance of the parallel-connected capacitors C1 and C3, and is approximately equal to (C1+C3).

For optimum operation of the energy recovery circuit of FIG. 5A, the switches S1 and S2 are closed for each cycle of operation for a time that is approximately equal to 0.5π√(L1(C1+C3)) to allow for optimum transfer of energy from the parallel-connected capacitors C1 and C3 to the inductive device L1.

The switches S1 and S2 can be maintained closed after depletion of the charge on capacitor C1 to extend the duration of the magnetizing current in the inductive device L1. During this extension period, the magnetizing current is supplied from the supply V1 only, via diode D1.

For optimum operation of the energy recovery circuit shown in FIG. 5A, the energy from the magnetic field associated with the inductive device L1 must be efficiently transferred back to the recovery capacitors C1 and C3. Maximum transfer of energy from the magnetic field back to the capacitors occurs when the current flowing in the inductive device L1 has decreased to zero.

For optimum operation of the energy recovery circuit of FIG. 5A, the switches S1 and S2 are open for each cycle of operation for a time that is no shorter than a quarter of the period of natural resonance of the inductance-capacitance (L-C) circuit, which in this case is equal to 0.5π√(L1 C1 C3) (C1+C3), to allow for optimum transfer of energy from the inductive device L1 to the series-connected capacitors C1 and C3. The switches S1 and S2 are maintained opened after cessation of the current in the inductive device L1, while waiting on the re-closing of switches S1 and S2 to re-establish the magnetic field at the commencement of the next cycle.

### 5.13 Specific Embodiment

One specific embodiment of the circuit shown in FIG. 5A has the following circuit values:

S1 and S2: IRFK4HE50

D1, D2, D7, D8 and D9: RHRG30120

V1=48 volts

C1=125 μF

C3=125 μF

L1=36 mH (with an effective series resistance of 0.5 ohms)

Switching period t₁ to t₃=20 mS

Switching frequency=50 Hz

Duration of magnetizing stage t₁ to t₂=5 mS

In this embodiment, the switches S1 and S2 remain closed for 5 mS over the 20 mS period of each cycle. One quarter of the natural resonance period of the parallel-connected capacitors C1 and C3, and inductive device L1, i.e. 0.5π√(L1(C1+C3)), is equal to 4.7 mS, which is slightly less than the time period in each cycle that the switches S1 and S2 are closed.

In this embodiment, the capacitors C1 and C3 are each recharged at each recovery stage to a voltage that is more than 8 times the supply voltage after the first 5 cycles of operation, i.e. after 100 mS from starting. The magnetizing current in the inductive device L1 is provided, in part, from the parallel combination of these capacitors, with the parallel capacitor combination connected in series with the supply, giving an effective supply voltage multiplication of over 9 times.

### 5.14 Waveforms

In the run-mode of the specific fifth embodiment of the FIG. 5A circuit having the circuit values described in the immediately preceding paragraphs, the magnetizing current in the inductive device L1 rises from zero to a peak of approximately 22 amperes over 5 mS with a waveform that approximates one quarter cycle of sinusoid. At the end of the magnetizing stage, when the switches S1 and S2 are opened, current induced in the inductive device L1, by the collapsing magnetic field, falls to zero in about 2.5 mS with a waveform that falls with a near constant slope to zero. This compares to 2.36 mS, i.e. one quarter of the natural resonance period of the two series-connected recovery capacitors C1 and C3 when connected in series with inductance L1. The current in the inductive device L1 then remains at zero until the start of the next cycle.

### 5.15 First Specific Application of Fifth Embodiment

In a first specific example application of the fifth embodiment, the circuit shown in FIG. 5I is used to drive a switched reluctance motor. This motor utilizes a transverse flux format in which the flux paths are arranged in an axial direction between stator and rotor. The motor rotor is made of acetal plastic and has an axial length of 85 mm and a diameter of 300 mm. Eight rotor poles, each made from transformer core ‘I’ laminations with a stack width of 30 mm, are embedded in and fixed to the rotor. A single stator pole is made from 55×85 mm transformer core ‘E’ laminations, with a 30 mm stack width and wound with enamelled copper wire.

The inductance of the stator winding is 12.8 mH when the rotor and stator poles are unaligned, and 25.0 mH when the rotor and stator poles are aligned.

The static Q factor of the stator winding, measured at 120 Hz, is 13.1 when the rotor and stator poles are unaligned, and 21.3 when the rotor and stator poles are aligned.

The stator winding resistance is 0.54 ohms.

The motor is driven by the circuit of FIG. 5I, which is also shown in FIG. 5F in which the inductance and resistance of the winding is represented by L51 and R51, respectively. The recovery capacitance is provided by two metallized polypropylene recovery capacitors C51 and C52, each capacitor having a capacitance of 75 μF.

The circuit as shown in FIG. 5F is supplied from a 36 volt DC supply or battery V51. In an optional arrangement, not shown, the supply V51 is connected to a reservoir capacitor (for example, 22,000 μF) through a series inductor (for example, 5 mH) and the remainder of the circuit, and particularly high pulse currents, are supplied from the reservoir capacitor with the battery then supplying the top-up current to the reservoir capacitor.

During the magnetizing period, when the recovery capacitors C51 and C52 are discharging into the stator winding L51, diodes D51 and D53 are conductive and diode D52 is non-conductive, effectively connecting the two capacitors in parallel to provide a capacitance value of 150 μF. This capacitance discharges into the stator winding when the rotor and stator poles are unaligned. The inductance of the stator winding increases from 12.8 mH as the rotor and stator poles move toward alignment.

During the recovery period, when the recovery capacitors C51 and C52 are being recharged by energy recovered from the collapsing magnetic field from stator winding L51, diodes D51 and D53 are non-conductive and diode D52 is conductive, effectively connecting the two capacitors in series to provide a capacitance value of 37.5 μF.

The relatively lower capacitance value during the field energy recovery reduces the natural resonance period with the winding inductance, allowing faster energy recovery which, in turn, allows the motor to be driven at higher speeds. If the energy recovery is too slow and current is still flowing in the stator winding after alignment of the stator and rotor poles, the torque on the rotor reverses in direction and retards the rotor.

The circuits of FIGS. 5F and 5I are operated similarly to the fifth embodiment described above with switch timing as described above with respect to FIG. 5B. FET switches S51 and S52 are controlled through respective gate drivers by a common switch controller SC to switch alternately between closed and open states.

The FET switches are driven by 2 kV isolated NME1215S DC to DC supplies driving through HCPL 3120 opto-isolated gate drivers. The two FET switches S51 and S52 are IR G4PM50UD, 24 A, 1200 V, TO247 case. The five diodes D51 to D55 are RHRG755120, 75 A, 120 V, TO247 case. The switch controller SC uses CMOS logic circuits. The 36 volts supply is stepped down to 12 volts by a Treco Ten-5 or -6 series DC to DC voltage converter to supply the CMOS logic and FET gate drive circuits.

The switch controller is synchronized by two magnetic Hall Effect sensors (not shown in FIGS. 5F and 5I) which are activated by the position of a series of small sense magnets on the rotor. One of the two Hall Effect sensors synchronizes the switch controller to commence a magnetizing period by closing FET switches S51 and S52. The second of the two Hall Effect sensors synchronizes the switch controller to end the magnetizing period by opening FET switches S51 and S52. This commences the recovery period which continues until current flowing in the stator winding falls to zero, or the next magnetizing period is commenced, whichever occurs first. For example, at a motor speed of 1165 rpm, the magnetizing period is 2.0 mS and the recovery period is 1.2 mS. At this motor speed, the magnetizing periods is less than optimum and the voltage on the recovery capacitor does not fall to near zero but to approximately 14 volts during the magnetizing period. However, this shorter than optimum magnetizing period still allows the motor to operate successfully. In an alternative, not shown, a motor control circuit could advance the timing point at which the magnetizing period commences to allow full discharge of the recovery capacitor and maximum power delivery through a full range of motor speeds.

The Hall Effect sensors are positioned relative to the sense magnets on the rotor so that each set of magnetizing and recovery periods is completed substantially by the time the corresponding rotor and stator poles are aligned. In an alternative arrangement, an optical shaft position encoder is used instead of the two Hall Effect sensors and the sense magnets.

Comparison tests using the three circuits of FIGS. 5G, 5H and 5I were conducted on the switched reluctance motor described above with reference to FIG. 5F.

FIGS. 5G shows a prior art asymmetric switching converter by which energy recovered from the reluctance motor on collapse of the magnetic field is returned to the source, i.e. the power supply. The motor runs at an unloaded speed of 535 rpm using this circuit with a 36 volt supply, a magnetizing period of 4.5 mS and a recovery-to-source period of 3.0 mS.

FIGS. 5H shows a circuit according the second embodiment of the current invention, by which energy recovered from the reluctance motor on collapse of the magnetic field is returned to a recovery capacitor in series with the supply, for subsequent re-use when re-establishing the magnetic field. The recovery capacitor is of fixed value, i.e. the recovery capacitor is not provided by multiple capacitors switched between series and parallel connections. The motor runs at an unloaded speed of 1135 rpm using this circuit with a 36 volt supply, a magnetizing period of 2.0 mS, a recovery-to-source period of 2.75 mS, and a single, i.e. unswitched, recovery capacitor of 150 μF. The voltage across the recovery capacitor drops from 94 to 14 volts during the magnetizing period.

In the circuit of FIG. 5I, the recovery capacitor is switched between series and parallel connections as discussed above, but otherwise the FIG. 5I circuit is similar to the FIG. 5H circuit. The motor runs at an unloaded speed of 1165 rpm using this circuit with a supply voltage of 36 volts, a magnetizing period of 2.0 mS, a recovery-to-source period of 1.75 mS, and using two recovery capacitors of 150 μF connected in parallel during the magnetizing period and in series during the recovery period. The voltage across the parallel-connected recovery capacitors drops from 64 to 2 volts during the magnetizing period.

In loaded motor comparison tests using a mechanical shaft Prony brake, and using the same 36 volt supply voltage, the same switch timings and running the same motor at the same speed, the FIG. 5I circuit took 8.6 times more power from the supply to produce 13.3 times more torque, than the standard prior art asymmetric converter shown in FIG. 5G.

The standard prior art asymmetric “return-to-source” converter of FIG. 5G generated a torque of 62.9 gm-cm/watt of total input power at a motor speed of 480 rpm. The circuit of FIG. 5H, using a fixed recovery capacitor of 150 μF, generated a torque of 92.0 gm-cm/watt at a motor speed of 480 rpm. The circuit of FIG. 5I, using a pair of recovery capacitors switched between series and parallel connection, generated a torque of 97.5 gm-cm/watt at a motor speed of 480 rpm.

The simple energy recovery circuit of FIG. 5H produced 46% more mechanical power in the motor per watt input from the power supply, and the more favoured energy recovery circuit of FIG. 5I produced 55% more mechanical power in the motor per watt input from the power supply, compared with the standard prior art asymmetric “return-to-source” converter of FIG. 5G.

Extrapolating from these results, a switched reluctance motor, e.g. in an electric or hybrid vehicle, driven from an electromagnetic field energy recovery circuit according to the current invention, could produce 13.3 times more torque out of the drive motor on existing batteries, using only 8 times more energy, than the prior art circuit. This result is achievable without requiring higher battery voltages because the current invention drives the motor at higher voltages by placing the recovery capacitor in series with the battery voltage.

Alternatively, it should be possible to produce the same mechanical energy output from the motor using a battery pack supplying half the energy at half the voltage of prior art arrangements.

### 5.16 Second Specific Application of Fifth Embodiment

In a second specific application, the circuit shown in FIG. 5F is used to drive a wood lathe motor obtained from Teknatool International. The Teknatool Nova motor is a 3 phase digital switched reluctance motor. The motor has a quoted speed range of 100-3000 rpm, at a maximum output of 1.5 kW with a converter operating at a voltage of 320-380 volts DC and a current of 2 A rms per phase.

The rotor has eight poles formed by solid steel laminations pressed onto a spindle. The three phase stator has twelve poles wound with stator coils. Four stator coils are connected in series for each phase winding to provide the magnetic forces to turn the spindle. Each stator coil is wound with 200 turns of 0.85 mm enamelled copper wire. The total winding resistance of each phase winding is 10 ohm.

The static inductance of each phase winding varies from 103 mH when the rotor and stator poles are unaligned to 616 mH when the stator and rotor poles are aligned. The static Q factor of each phase winding, measured at 120 Hz, varies from 7.4 when the rotor and stator poles are unaligned to 18.7 when the stator poles are aligned. The static inductances and Q factors are given as a guide to the figure of merit of the winding but it is to be appreciated that the dynamic inductance and Q factor is affected by motor operation. The dynamic inductance and Q factor are affected by the changing winding current. For example, if the stator winding current increases sufficiently to saturate the core, the winding inductance decreases causing a reduction in dynamic Q factor. However even with these moderations to the winding inductance, the loaded or operating Q of the motor is such that a significant voltage gain in the operating or working voltage of the recovery capacitors can be achieved, thereby improving the efficiency of motor operation. When retrofitting an application of the invention to an existing motor, the static Q can be used as a guide to expected performance.

Each of the three phase windings of the Teknatool motor is driven by a respective circuit as shown in FIG. 5F in which the inductance and resistance of the respective winding is represented by L51 and R51, respectively. The recovery capacitance for each winding drive circuit is provided by a respective pair of recovery capacitors C51 and C52. Each capacitor has a capacitance value of 10 μF.

The FET switches S51 and S52 are SPP20N60C3. The series/parallel switching diodes D51, D52 and D53 are HER 307G. Diodes D54 and D55 are MUR 1560G.

The supply V51 is a common 150 volt DC supply supplying each of the three drive circuits. This is half of the original converter operating voltage and is sufficient with use of the current invention to achieve the same winding current and performance as the original combination of converter and motor. The switching controller SC is a common switch controller synchronizing the switching of the FET switches of all three drive circuits with the rotor position relative to the stator. The FET switches S51 and S52 are closed, i.e. made conductive, and opened, i.e. made non-conductive, under control of the switch controller SC through respective gate drivers.

In each respective drive circuit, the FET switches S51 and S52 are closed each time a respective rotor pole approaches a stator pole to discharge capacitors C51 and C52 into the winding comprising inductance L51 and resistance R51. Before alignment of the rotor and stator poles, the FET switches are made non-conductive to end the magnetizing period and commence an energy recovery period. During this recovery period, the magnetic field in the winding collapses, and current flow from the winding inductance is directed by diodes D55 and D54 into the capacitors C51 and C52. The winding current continues to flow until it falls to zero over this energy recovery period. The timing of the FET switching action is determined by shaft position Hall Effect sensors as described below.

During the magnetizing periods of each winding, when the respective recovery capacitors C51 and C52 are discharging into the respective stator winding L51, respective diodes D51 and D53 are conductive and respective diode D52 is non-conductive, effectively connecting the two respective 10F capacitors C51 and C52 in parallel to provide a combined capacitance value of 20 μF.

During the recovery periods, when the respective recovery capacitors C51 and C52 are being recharged by energy recovered from the collapsing magnetic field from the respective stator winding L51, respective diodes D51 and D53 are non-conductive and respective diode D52 is conductive, effectively connecting the two respective 10F capacitors C51 and C52 in series to provide a combined capacitance value of 5 μF. During recovery, just before pole alignment, the stator winding inductance is approaching its maximum value. The decreased recovery capacitance, achieved by the series connection, keeps the recovery period short, even with the stator winding inductance near its maximum value.

The switch controller is synchronized by four magnetic Hall Effect sensors (not shown in FIG. 5F). Two of the four Hall effect sensors sense the position of a slotted encoder disc mounted on the rotor. One of these two Hall effect sensors synchronizes the switch controller to commence the respective magnetizing periods by closing respective FET switches S51 and S52. The second of the two Hall effect sensors synchronizes the switch controller to end the respective magnetizing periods by opening respective FET switches S51 and S52. This commences the respective recovery periods which continue until respective current flowing in the respective stator winding falls to zero.

The other two of the four Hall Effect sensors are used to determine the initial rotor position on start up so that the winding current is initiated in the correct phase.

FIGS. 5J, 5K and 5L show simulated waveforms of current and inductance over one or more winding energizing cycles, for a motor winding in the circuit of FIG. 5F, in the Teknatool motor driven respectively at low, medium and high speeds.

FIGS. 5J, 5K and 5L show the inductance of the stator winding changing linearly between a maximum aligned value of 616 mH when a rotor is aligned with the stator pole, and a minimum unaligned value of 103 mH when the stator pole is not aligned with a rotor pole.

At a slow speed of approximately 240 rpm, as shown in FIG. 5J, the stator winding current rises rapidly from zero when FET switches S51 and S52 are made conductive, soon after the winding inductance begins to increase as a rotor pole begins to approach the pole of the stator. This increase in winding current is initially driven by a voltage of approximately 325 volts obtained from a voltage of 175 volts across the parallel combination of capacitors C51 and C52, connected in series with the 150 volts of supply V51. While the capacitors discharge into the stator winding, the voltage across the capacitors drops from 175 volts to zero volts. That is, the capacitors are fully depleted. After depletion of the capacitors, the 150 volt supply voltage alone continues to drive current into the stator winding through bypass diode D54, extending the magnetizing period beyond that provided initially by the charged recovery capacitors working in series with the supply voltage.

Winding current is regulated by a soft current chopping technique with hysteresis to maintain the winding current between predetermined upper and lower limits. Winding current is sensed by a LEM Hall effect current transducer LTS15NP connected to a LM339 comparator (not shown in FIG. 5F). When the winding current reaches a predetermined upper limit of 2.5 A, the FET switch S52 is turned off, i.e. made non-conductive. At a motor speed of 240 rpm this occurs after approximately 2.1 mS of magnetizing time. With FET switch S52 now non-conductive, stator winding current flows through diode D55 and the still-conductive FET switch S51 in what is termed a “diode clamping” mode. The winding current falls until it reaches a predetermined lower limit of approximately 1.8 A, whereupon FET switch S52 is again turned on, i.e. made conductive to connect the 150 volt supply V51 across the winding, through diode D54. Stator winding current increases until it again reaches the predetermined upper limit whereupon the hysteresis current chopping process continues, maintaining the stator winding magnetizing current between the upper and lower limits. At a motor speed of 240 rpm, the stator winding current goes through three cycles of current chopping extending over a current chopping period of approximately 6 mS. If the recovery capacitors are not fully discharged in the initial magnetizing period, they will serve to supply further current in series with the supply during the soft chopping period.

The switch controller SC makes both FET switches S51 and S52 non-conductive when the rotor position sensor senses that the rotor is positioned just before the rotor pole reaches alignment with the stator pole. This begins an energy recovery period during which the stator magnetic field collapses to zero and current flowing in the winding is directed, via diodes D52, D54 and D55, through the effectively series-connected energy recovery capacitors C51 and C52. At a motor speed of 240 rpm, the recovery period is approximately 1.28 mS.

The recovery period is commenced sufficiently early so that stator winding current flow has ceased before the rotor pole reaches full alignment with the stator pole, avoiding deceleration of the rotor that would occur if the stator winding remains energized after pole alignment. It is observed in switched reluctance motors that most rotor torque is developed well before pole alignment, when the winding inductance is relatively low, so there is little advantage in delaying the magnetizing of the stator until the poles are in close alignment.

During the energy recovery period, when the winding current drops to zero, energy from the stator magnetic field is recovered and stored on the recovery capacitors C51 and C52. During this recovery, the series connection of the two capacitors is charged to 350 volts so that each capacitor is charged to 175 volts. The capacitors are then ready to be connected together in parallel by diodes D51 and D53, with the parallel capacitor combination connected in series with the supply V51 to deliver 325 volts at the beginning of the next magnetizing period of the respective stator winding to repeat the stator winding energization cycle. The other two of the three stator windings are energized identically at appropriately synchronized times with 120 degree phase shift typical of three phase motors.

At a medium speed of approximately 1500 rpm, as shown in FIG. 5K, the stator winding current rises rapidly from zero when FET switches S51 and S52 are made conductive, soon after the winding inductance begins to increase as a rotor pole approaches the pole of the stator. This increase in winding current is initially driven by a voltage of approximately 450 volts obtained from a voltage of 300 volts across the parallel combination of capacitors C51 and C52 connected in series with the 150 volts of supply V51. While the capacitors discharge into the stator winding, the voltage across the capacitors drops from 300 volts to 270 volts. But the winding current continues to increase, albeit more slowly, being driven by the 150 volt supply voltage alone, acting through bypass diode D54 when the capacitors C51 and C52 are depleted. At this medium motor speed, this initial magnetizing period is approximately 0.7 mS.

As in the low motor speed example described above, winding current is regulated by a current chopping technique with hysteresis that maintains the winding current between predetermined upper and lower limits. At this medium motor speed, the current reaches the upper limit and then begins to drop as the FET switch S52 is turned off, i.e. made non-conductive. But at this medium motor speed there is not sufficient time to complete the first current chopping cycle before the magnetizing period is ended and the recovery period begins. At a medium motor speed of 1500 rpm, the recovery period begins approximately 0.55 mS after the FET switch S52 is turned off.

The remainder of the stator magnetizing cycle is similar to that of the low motor speed example described above, but at 1500 rpm the recovery period is approximately 0.49 mS.

During the energy recovery period, when the winding current drops to zero, energy from the stator magnetic field is recovered and stored on the recovery capacitors C51 and C52. During this recovery, the series connection of the two capacitors is charged to 600 volts so that each capacitor is charged to 300 volts. The capacitors are then ready to be connected together in parallel by diodes D51 and D53, with the parallel capacitor combination connected in series with the supply V51 to deliver 450 volts at the beginning of the next magnetizing period of the respective stator winding to repeat the stator winding magnetizing cycle.

At a high motor speed of approximately 3000 rpm, as shown in FIG. 5L, the stator winding current rises rapidly from zero when FET switches S51 and S52 are made conductive, soon after the winding inductance begins to increase as a rotor pole approaches the pole of the stator. This increase in winding current is initially driven by a voltage of approximately 475 volts obtained from a voltage of 325 volts across the parallel combination of capacitors C51 and C52 connected in series with the 150 volts of supply V51. While the capacitors discharge into the stator winding, the voltage across the capacitors drops from 325 volts to 290 volts. But the winding current continues to increase, albeit more slowly, being driven by the 150 volt supply voltage alone, acting through bypass diode D54 when the capacitors C51 and C52 are depleted. At this high motor speed, this initial magnetizing period is approximately 0.63 mS.

At this high speed, there is insufficient time for the stator winding current to reach the upper limit of the current chopping regulator. Instead, magnetizing current continues to rise until the recovery period begins. At 3000 rpm the peak stator winding current is 1.95 A and the recovery period is approximately 0.44 mS.

During the energy recovery period, when the winding current drops to zero, energy from the stator magnetic field is recovered and stored on the recovery capacitors C51 and C52. During this recovery, the series connection of the two capacitors is charged to 650 volts so that each capacitor is charged to 325 volts. The capacitors are then ready to be connected together in parallel by diodes D51 and D53, with the parallel capacitor combination connected in series with the supply V51 to deliver 475 volts at the beginning of the next magnetizing period of the respective stator winding to repeat the stator winding magnetizing cycle.

The capacitance value of the recovery capacitors C51 and C52 is chosen so that at maximum motor operating speed the magnetizing current rises close to, but not above, the upper current chopping limit before the recovery period is initiated so that the magnetizing and recovery periods are consecutive, without the magnetizing pulse extension from the supply V51 (as described above for low and medium speed operation) after depletion of the recovery capacitor.

As described above, the two energy recovery capacitors C51 and C52 are connected in parallel when discharging to transfer energy to the stator winding, and connected in series when being charged by energy transferred from the stator winding. This switching is performed passively by switching diodes D51, D52 and D53 without intervention by the switch controller or any other active control device.

However, in an optional arrangement, and to more advantageously match the magnetizing and recovery periods to motor speed, changeovers between parallel and series connection of these capacitors can be done actively by substituting the diodes D51, D52 and D53 with FETs or other controlled switching devices under control of the switch controller SC or any other suitable control device. For example, active control may be used to provide the following three different capacitor connection strategies for different stages of motor operation:
Motor start-up and low speed operation: the capacitors are maintained in a parallel connection to deliver energy from the capacitors to magnetize the stator winding, and to recover energy from the magnetic field of the winding for storage in the capacitors;
Medium speed operation: the connection of the capacitors is switched between a parallel connection to deliver energy from the capacitors to magnetize the stator winding, and a series connection to recover magnetic field energy from the winding for storage in the capacitors;
High speed operation: the capacitors are maintained in a series connection to delivery energy from the capacitors to magnetize the stator winding, and to recover magnetic field energy from the winding for storage in the capacitors.

Other means to dynamically change the value of the recovery capacitance during motor operation, such as parallel switched banks, can also be employed.

### 5.17 Third Specific Application of Fifth Embodiment

In a third specific application, the circuit shown in FIG. 5F is used to drive an eight pole, three phase Welling SRX-375-8 motor rated at 375 watt, 350 volts DC and a maximum speed of 900 rpm. This motor is used in the Westinghouse-Electrolux LT 959S direct-drive washing machine.

The three phase stator has twelve poles on which stator coils are wound. Four stator coils are connected in series for each phase winding. The stator coils are wound from 600 turns of 0.5 mm enamelled copper wire, giving a total of 2400 turns per phase. The total resistance of each phase winding is 49.5 ohm.

The static inductance of each phase winding varies from 553 mH when the rotor and stator poles are unaligned to 2880 mH when the stator poles are aligned. The static Q factor of each phase winding, measured at 120 Hz, varies from 8.1 when the rotor and stator poles are unaligned to 21.6 when the stator poles are aligned. The static inductances and Q factors are given as a guide but it is to be appreciated that the dynamic inductance and Q factor are affected by motor operation. The dynamic Q factor is affected by frequency, which at high motor speeds can be up to 600 Hz. The dynamic inductance and Q factor are affected by the changes in winding current. For example, if the stator winding current increases sufficiently to saturate the core, the winding inductance decreases causing a reduction in dynamic Q factor.

Each of the three phase windings of the Welling motor is driven by a respective circuit as shown in FIG. 5F in which the inductance and resistance of the respective winding is represented by L51 and R51, respectively. The recovery capacitance for each winding drive circuit is provided by a respective pair of recovery capacitors C51 and C52. Each capacitor has a capacitance value of 5 μF.

The FET switches S51 and S52 are SPP20N60C3. The series/parallel switching diodes D51, D52 and D53 are HER 307G. Diodes D54 and D55 are MUR 1560G. The FET switches S51 and S52 are controlled through respective gate drivers by a switch controller SC.

The supply V51 is a common 150 volt DC supply supplying each of the three drive circuits. The switching controller SC is a common switch controller synchronizing the switching of the FET switches of all three drive circuits with the rotor position relative to the stator. Rotor position relative to the stator is determined by two Hall effect sensors activated by a series of small sense magnets on the motor rotor. One sensor determines the time at which the switch controller SC makes the FET switches conductive to begin a magnetizing period. The second sensor determines the time at which the switch controller SC makes the FET switches non-conductive to end the magnetizing period and begin a recovery period. Alternatively, a shaft encoder with optical sensors or Hall effect sensors could be used to monitor the rotor position.

The Welling motor is operated in a similar manner to the Teknatool motor as described above, and uses current chopping to regulate the peak current in each stator winding at approximately 1 A. Similar improvement in performance to the Teknatool Nova motor is achievable where the converter supply voltage is reduced by 50% at same line currents while still producing the same name plate performance from the motor.

### Sixth Embodiment

### 6.1 Circuit Layout

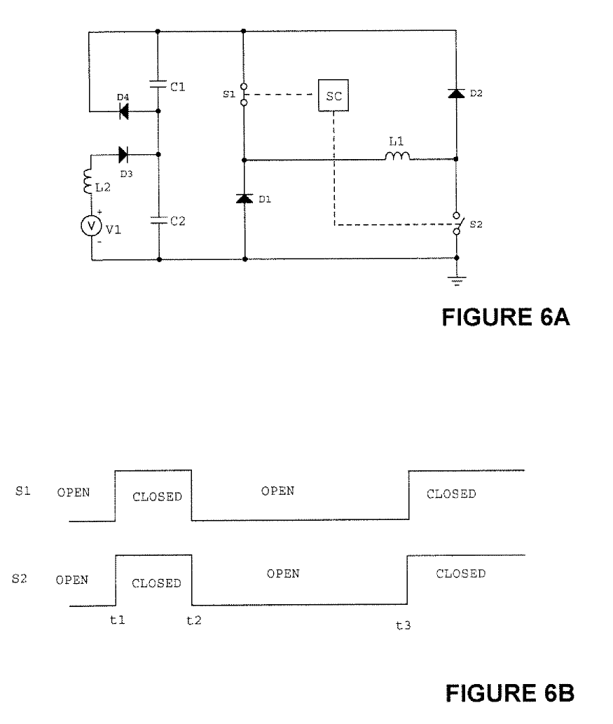

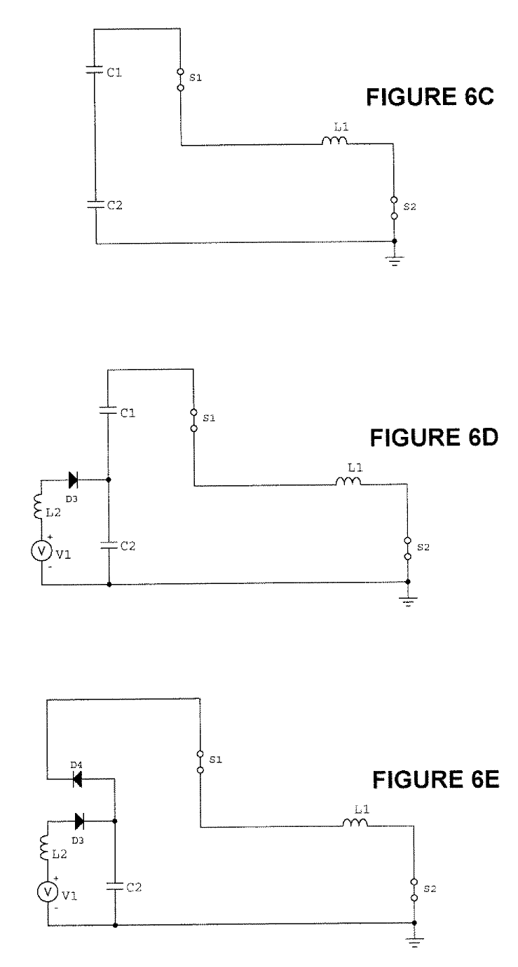

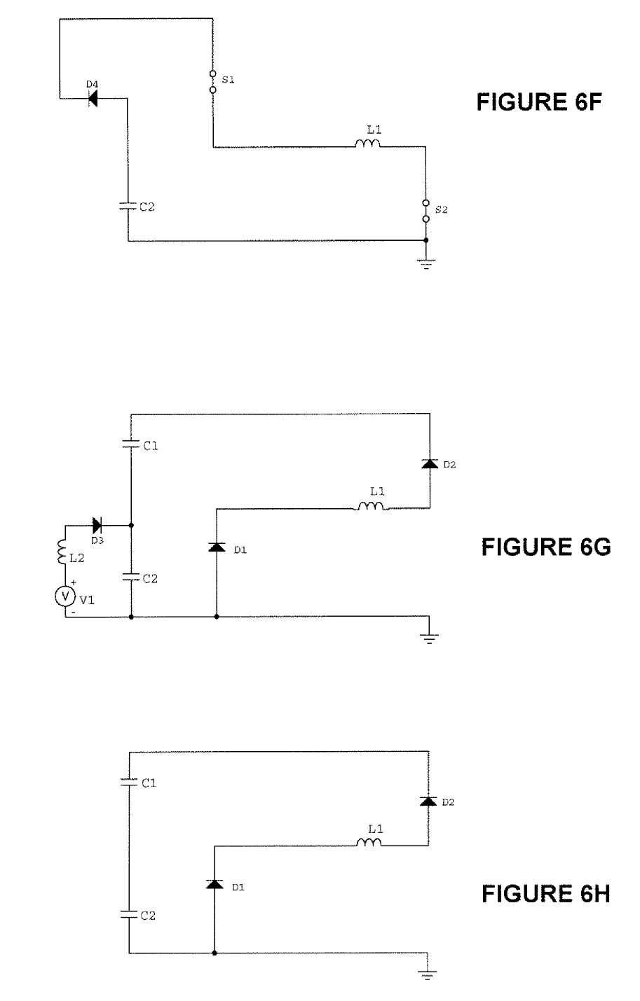

FIG. 6A is a circuit diagram illustrating a sixth embodiment of the invention. This circuit is a variant of the first embodiment. The sixth embodiment has an additional ‘reservoir’ capacitor C2 in parallel with the supply and in series with the recovery capacitor C1. During the recovery stage, the recovery capacitor C1 and the reservoir capacitor C2 are connected in series, so that both capacitors are charged by the same recovery current. This reduces the magnitude of supply current pulses drawn during start-up, but slightly steepens the recovery current waveform through the inductive device. This circuit is more economical on supply energy because the recovery current flows through the supply reservoir capacitor, charging it in the process. In other respects, this sixth embodiment operates similarly to the first embodiment. For example, the voltage driving the inductive device compounds on the recovery capacitor as it does in the first embodiment.

The circuit of FIG. 6A comprises a DC power supply V1, four diodes D1, D2, D3 and D4, two capacitors C1 and C2, two controlled switches S1 and S2, an inductive device L1 and an inductor L2. Switch S1 and diode D1 are connected in series between the upper and lower rails to form one leg of an H-bridge. Diode D2 and switch S2 are connected in series between the upper and lower rails to form the other leg of the H-bridge. The inductive device L1 is connected between the centre junctions of the two bridge legs. The circuit is operated by periodically switching the controlled switches S1 and S2 between open and closed states to achieve the effective circuit configurations shown in FIGS. 6C to 6H. The opening and closing of the switches S1 and S2 are controlled by a common switch controller SC.

### 6.2 Switch Timing

FIG. 6B is a switch timing diagram for the controlled switches S1 and S2 showing one cycle of operation from time t₁ to time t₃. Switches S1 and S2 are operated synchronously over each cycle by the switch controller SC.

The switches S1 and S2 are both closed to arrange the circuit of FIG. 6A for a magnetizing stage from time t₁ to time t₂. During this magnetizing stage a current is driven through the inductive device L1 to establish a magnetic field. The magnetizing current flows through the inductive device L1 from left to right in the circuits shown in FIGS. 6A and 6C to 6F.

Switches S1 and S2 remain closed from time t₁ to time t₂ for a period that is approximately equal to 0.5π√(L1 C1), where L1 is the inductance of the inductive device L1 in henries, C1 is the capacitance of capacitor C1 in farads, and the period is in seconds. The reduction of the natural resonance period of the inductance-capacitance circuit caused by the reservoir capacitor C2 being in series with the recovery capacitor C1, has been ignored in this relationship because the capacitance value of capacitor C2 is significantly larger than that of the recovery capacitor C2.

The magnetizing stage ends at time t₂ at which time switches S1 and S2 are opened to arrange the circuit of FIG. 6A for a recovery stage during which a current induced in the inductive device L1 during collapse of the magnetic field charges recovery capacitor C1 and reservoir capacitor C2. The switches S1 and S2 are kept open from time t₂ to time t₃.

Both switches S1 and S2 are closed at time t₃ to arrange the circuit of FIG. 6A for the next magnetizing stage. The operating cycle is repeated with a repetition period equal to (t₃-t₁).

### 6.3 First Magnetizing Circuit

FIG. 6C shows a first effective circuit for the magnetizing stage of circuit operation when switches S1 and S2 are closed. This circuit applies during the magnetizing stage when diodes D3 and D4 are both non-conductive. This occurs when the recovery capacitor C1 is charged and the voltage on the supply reservoir capacitor C2 is greater than that of the supply V1.

### 6.4 Second Magnetizing Circuit

FIG. 6D shows a second effective magnetizing circuit when switches S1 and S2 are closed. This circuit applies when diode D3 is conductive and diode D4 is non-conductive. This occurs when the recovery capacitor C1 is charged (making diode D4 non-conductive), and the voltage across the supply reservoir capacitor C2 is generally less than the voltage of the power supply V1, making diode D3 forward biased and conductive, and effectively placing the supply V1 in parallel across the reservoir capacitor C2.

### 6.5 Third Magnetizing Circuit

FIG. 6E shows a third effective magnetizing circuit when switches S1 and S2 are closed. This circuit applies when diodes D3 and D4 are both conductive. This circuit applies when the recovery capacitor C1 is discharged (making diode D4 forward biased and conductive to effectively bypass the recovery capacitor C1), and the voltage across the supply reservoir capacitor C2 is generally less than the voltage of the power supply V1, making diode D3 forward biased and conductive, and effectively placing the supply V1 in parallel across the reservoir capacitor C2.

### 6.6 Fourth Magnetizing Circuit

FIG. 6F shows a fourth effective magnetizing circuit when switches S1 and S2 are closed. This circuit applies when diode D3 is non-conductive and diode D4 is conductive. This occurs when the recovery capacitor C1 is discharged (making diode D4 forward biased and conductive, effectively bypassing the recovery capacitor C1), and the voltage on the supply reservoir capacitor C2 is greater than that of the supply V1 (making D3 reverse biased and non-conductive to effectively disconnect the supply circuit of supply V1, inductor L2 and diode D3).

### 6.7 Magnetizing Circuit Conversion

The conversion of the magnetizing circuit between the arrangements shown in FIGS. 6C to 6F occurs automatically.

During the magnetizing stage of the first cycle of the start-up mode, when there is no voltage on capacitor C1, the circuit adopts the arrangement shown in FIG. 6E.

During the magnetizing stage in one or more subsequent start-up cycles, there will be voltage on the capacitor C1, and C2 will have charged to higher than the voltage of the supply V1. In this case, the circuit will initially adopt the arrangement shown in FIG. 6C and will then automatically switch firstly to that of FIG. 6F (when diode D4 becomes conductive) and then that of FIG. 6E (when diode D3 also becomes conductive). This automatic switching occurs progressively later in subsequent cycles as the circuit builds up to an operating mode.

During the magnetizing stage in the run mode, there will be voltage on the capacitor C1, and C2 will have charged to higher than the voltage of the supply V1. In this case, the circuit will initially adopt the arrangement shown in FIG. 6C and will then automatically switch firstly to that of FIG. 6D (when diode D3 becomes conductive) and then that of FIG. 6E (when diode D4 also becomes conductive).

### 6.8 First Energy Recovery Circuit

FIG. 6G shows a first effective circuit for the energy recovery stage of circuit operation when switches S1 and S2 are both opened at time t₂, and the voltage across the supply reservoir capacitor C2 is less than that of the supply, making diode D3 forward biased and conductive.

### 6.9 Second Energy Recovery Circuit

FIG. 6H shows a second effective circuit for the energy recovery stage of circuit operation. Switches S1 and S2 are still open but reservoir capacitor C2 has charged to a voltage which is greater than that of the supply V1, reverse biasing diode D3 to make diode D3 non-conductive and effectively disconnecting the supply V1.

During energy recovery, current flowing from the inductive device L1 on collapse of the magnetic field forward biases diodes D1 and D2 and charges capacitors C1 and C2, causing the current to fall.

When this falling inductive device current reaches zero, diodes D1 and D2 become non-conductive, blocking discharge of the re-charged capacitors C1 and C2. This blocking holds the charge on capacitors C1 and C2 until the start of the next cycle at time t₃.

### 6.10 Energy Recovery Circuit Conversion

The conversion of the energy recovery circuit of FIG. 6G to that of FIG. 6H occurs automatically during the energy recovery stage, when the voltage across the reservoir capacitor C2 increases above the voltage of the power supply

### 6.11 Start-Up Mode Magnetizing—First Cycle

Initial start-up of the circuit occurs when the switches S1 and S2 close at time t₁ of the first cycle of operation. For the purposes of the immediately-following explanation it is assumed that, prior to the initial start-up at time t₁, switches S1 and S2 have been open for sufficiently long for capacitor C2 to have charged from the power supply V1, and for the V1, L2, D3, C2 circuit to have reached a steady state. C1 is not charged.

At time t₁, switches S1 and S2 close to effectively arrange the circuit as shown in FIG. 6E. Magnetizing current begins to flow from the pre-charged reservoir capacitor C2 through diode D4, closed switch S1, inductive device L1 and closed switch S2, to establish a magnetic field in association with the inductive device. This flow of current from reservoir capacitor C2 depletes the charge on the capacitor, immediately decreasing the voltage across the capacitor below the voltage of the power supply V1 to make diode D3 forward biased.

Magnetizing current also flows from the power supply V1, through inductor L2 and diode D3 to augment the magnetizing current flowing from reservoir capacitor C2. The combined currents flow through diode D4, closed switch S1, inductive device L1 (from left to fight in FIG. 6E), and back through closed switch S2 to establish the magnetic field in association with the inductive device L1.

As the voltage on the discharging capacitor C2 falls still further, and as supply current through inductor L2 increases, the discharge of capacitor C2 slows and the capacitor C2 begins to be charged by the current from supply V1 flowing through inductor L2 and diode D3. This recharging of capacitor C1 occurs simultaneously with continued flow of magnetizing current from the supply V1 and through the inductive device L1.

### 6.12 Start-Up Mode Magnetizing—Subsequent Cycles

At time t₁, in subsequent start-up cycles, switches S1 and S2 close to effectively arrange the circuit as shown in FIG. 6C. Magnetizing current then begins to flow from the series combination of the now pre-charged capacitor C1 and charged capacitor C2, through closed switch S1, inductive device L1 and closed switch S2, to establish a magnetic field in association with the inductive device. This current flow depletes the charge on both the recovery capacitor C1 and the reservoir capacitor C2.

In one or more subsequent start-up cycles, recovery capacitor C1 may discharge sufficiently to make diode D4 conductive before the reservoir capacitor C2 is depleted sufficiently to make diode D3 conductive. In this case, the circuit automatically converts to the arrangement shown in FIG. 6F.

Otherwise, the reservoir capacitor C2 will generally be depleted sufficiently to make diode D3 conductive before the recovery capacitor C1 is sufficiently discharged to make diode D4 conductive. In this case, the circuit automatically converts to the arrangement shown in FIG. 6D.

In either case, the circuit then converts to the arrangement shown in FIG. 6E when both the reservoir capacitor C2 is depleted sufficiently to make diode D3 conductive, and the recovery capacitor C1 is sufficiently discharged to make diode D4 conductive.

In the effective circuit arrangement shown in FIG. 6E, magnetizing current flows from the power supply V1, through inductor L2 and diode D3, to augment the magnetizing current that is still flowing from capacitor C2. The combined currents flow through diode D4 and closed switch S1 to inductive device L1, and back through closed switch S2 to continue establishment of the magnetic field in association with the inductive device L1.

The conversion of the magnetizing circuit of FIG. 6C through that of FIGS. 6D and 6E, and on to that of FIG. 6E occurs progressively later in subsequent start-up cycles as the circuit runs up to a run mode. The progressive delay of the conversion occurs because the capacitors C1 and C2 are charged to progressively higher voltages above the voltage of the supply V1, due to the recovery of energy from the inductive device L1 during previous energy recovery stages, as will be explained further below.

### 6.13 Run Mode Magnetizing

In the run mode, the magnetizing current for inductive device L1 is predominantly derived from the discharge of the series combination of recovery capacitor C1 and reservoir capacitor C2 by the circuit of FIG. 6C. During a first substantial part of the run mode magnetizing stage, the recovered energy stored on these capacitors C1 and C2 is directed by switches S1 and S2 to re-establish the magnetic field in the inductive device L1.

Near the end of the run mode magnetizing stage, when and if the voltage on the reservoir capacitor C2 falls below that of the supply V1, diode D3 conducts to convert the circuit to that of FIG. 6D. Magnetizing current in the inductive device L1 is then maintained by current flowing directly from the supply V1, through inductor L2 and diode D3, through recovery capacitor C1 and switch S1, and back through switch S2. This continues the magnetizing current in the inductive device L1, but with energy direct from the supply to augment the continuing discharge current from recovery capacitor C1.

Later in the run mode magnetizing stage, when the recovery capacitor C1 becomes discharged, diode D4 conducts to convert the circuit to that of FIG. 6E. Magnetizing current in the inductive device L1 is then maintained solely by current flowing from the supply V1, through inductor L2 and diode D3, through diode D4 and switch S1, and back through switch S2. This continues the magnetizing current in the inductive device L1, but only with energy direct from the supply.

The replenishment of the circuit with current direct from the supply occurs automatically during every cycle upon discharge of the recovery capacitor C1 and depletion of the reservoir capacitor C2, and draws energy from the supply to make up for losses in the circuit.

The replenishment voltage provided by the supply V1, although less than the much higher run-mode voltages achieved across the series combination of recovery capacitor C1 and reservoir capacitor C2, is sufficient to maintain the level of current in the inductive device L1 and prolong the magnetizing begun by the current flow from the series combination of the two capacitors.

### 6.14 Energy Recovery

FIG. 6G shows the first effective circuit for the energy recovery stage of circuit operation when switches S1 and S2 are both opened at time t₂. At time t₂ the current through the inductive device L1 and the associated magnetic field begin to collapse, but the voltage on reservoir capacitor C2 is less than that of the supply V1, keeping diode D3 still conductive.

The current flows from the inductive device L1 and through diode D2 to simultaneously charge capacitor C1 and reservoir capacitor C2, and flow back through diode D1 to inductive device L1. This current flows through the inductive device L1 in the same direction as the current used to establish the magnetic field (i.e. from left to right in FIG. 6G), but flows into the capacitors C1 and C3 in the opposite direction to the magnetizing current flowing from these capacitors during the magnetizing stage.

Concurrently with the initial recharging of the capacitors C1 and C2 by current from the inductive device L1, the reservoir capacitor C1 is also charged by a replenishment current flowing from the supply V1, through inductor L2 and the forward biased diode D3.

FIG. 6H shows the second effective circuit for the energy recovery stage of circuit operation when switches S1 and S2 are both still open, the current through the inductive device L1 and the associated magnetic field is still collapsing, but the voltage on reservoir capacitor C2 is now greater than that of the supply V1, making diode D3 non-conductive. Current continues to flow from the inductive device L1 and through diodes D2 and D1 to charge both recovery capacitor C1 and reservoir capacitor C2.

In both the first and second energy recovery stage circuits as shown in FIGS. 6G and 6H, the flow of the induced current from the inductive device L1 back to the capacitors C1 and C2, effectively recovers energy from the magnetic field and transfers the energy to the capacitors C1 and C2. This recovered energy is held as a charge on the capacitors C1 and C2 until the end of the cycle at time t₃ when it is used to re-establish the magnetic field at the magnetizing stage of the next cycle of operation.

### 6.15 Voltage Multiplication

On initial start-up, the capacitors C1 and C2 are both charged during the energy recovery stages of the first few successive cycles of circuit operation to progressively higher voltages. The recovery capacitor C1, having a capacitance that is typically ten or more times smaller than that of the reservoir capacitor C2, charges to a voltage that is several times higher than that of the supply voltage V1.

The recovery of energy from the collapsing magnetic field at each cycle and its re-use to re-establish the field at the next cycle compounds the voltage on the recovery capacitor from which the inductive device is driven to provide a significant improvement in efficiency. The voltage multiplication process is similar to the transient charging phase of a resonant inductance-capacitance (L-C) circuit.

With the capacitor C1 recharged to a voltage significantly higher than the supply voltage, the capacitor discharges during the next magnetizing stage over a significantly longer time and with a higher peak current value, than those occurring during each of the first few start-up cycles

### 6.16 Energy Transfer

During the capacitor-fed magnetizing period that occurs during the earlier part of the magnetizing stage of each cycle in the run mode, before supply-fed magnetizing takes over, the circuit effectively adopts the configuration as shown in FIG. 6C. This is similar to the familiar resonant inductance-capacitance (L-C) circuit in which energy can be transferred back and forth between the capacitance and the inductance.

For optimum operation of the energy recovery circuit shown in FIG. 6A, the recovered energy stored as a charge on capacitors C1 and C2 must be efficiently transferred back to the magnetic field associated with the inductive device L1. Maximum transfer of energy from the capacitors back to the inductive device occurs when the voltage on the capacitor C1 has decreased from a maximum to zero and the current in the inductive device L1 has simultaneously risen from zero to a maximum. The time for this to occur is equal to a quarter of the period of natural resonance of the inductance-capacitance (L-C) circuit, which in this case is approximately equal to 0.5π√(L1 C1), where C1 is the capacitance of capacitor C1. As noted above in paragraph 6.2, the effect that reservoir capacitor C2 has on the natural resonance of the inductance-capacitance circuit has been ignored in this relationship because the capacitance value of capacitor C2 is typically significantly larger than that of the recovery capacitor C2.

For optimum operation of the energy recovery circuit of FIG. 6A, the switches S1 and S2 are closed for each cycle of operation for a time that is approximately equal to 0.5π√(L1 C1) to allow for optimum transfer of energy from the capacitor C1 to the inductive device L1.

The switches S1 and S2 may be maintained closed for a small additional time period to extend the duration of the magnetizing current in the inductive device L1. During this extension period, the magnetizing current can be supplied from the supply to compensate for circuit losses.

For optimum operation of the energy recovery circuit shown in FIG. 6A, the energy from the magnetic field associated with the inductive device L1 must be efficiently transferred back to the capacitors C1 and C2. Maximum transfer of energy from the magnetic field back to the capacitors occurs when the current flowing in the inductive device L1 has decreased to zero.

For optimum operation of the energy recovery circuit of FIG. 6A, the switches S1 and S2 are open for each cycle of operation for a time that is no shorter than a quarter of the period of natural resonance of the inductance-capacitance (L-C) circuit, which in this case is approximately equal to 0.5π√(L1 C1), to allow for optimum transfer of energy from the inductive device L1 to the capacitor C1. For the reasons noted above in paragraph 6.2, the effect that reservoir capacitor C2 has on the natural resonance of the inductance-capacitance circuit has been ignored in this relationship because the capacitance value of capacitor C2 is typically significantly larger than that of the recovery capacitor C2.

The switches S1 and S2 are maintained opened after cessation of the current in the inductive device L1, while waiting on the re-closing of switches S1 and S2 to re-establish the magnetic field at the commencement of the next cycle.

### 6.17 Specific Embodiment

One specific embodiment of the circuit shown in FIG. 1A has the following circuit values:

S1 and S2: IRFK4HE50

D1, D2, D3 and D4: RHRG30120

V1=48 volts

C1=300 μF

C2=2500 μF

L1=36 mH (with an effective series resistance of 0.5 ohms)

L2=1 mH

Switching period) t₁ to t₃=20 mS

Switching frequency=50 Hz

Magnetizing period t₁ to t₂=5 mS

In this embodiment, the switches S1 and S2 remain closed for 5 mS over the 20 mS period of each cycle. The capacitor-fed magnetizing current endures for 4.9 mS, being 0.5π√(L1 C1) or one quarter of the natural resonance period of the capacitor C1 and inductive device L1. The supply-fed magnetizing current runs for the remaining 0.1 mS of the 5 mS magnetizing stage over which the switches S1 and S2 are closed.

In this embodiment the series combination of recovery capacitor C1 and reservoir capacitor C2 is recharged at each recovery stage to a voltage that is more than 3.5 times the supply voltage after the first 20 cycles of operation, i.e. after 400 mS from starting.

### 6.18 Waveforms

In the run-mode of the specific sixth embodiment of the FIG. 6A circuit described in the immediately preceding paragraphs, the capacitor-fed magnetizing current in the inductive device L1 rises from zero to a peak of approximately 15 amperes with a waveform that is similar to one quarter cycle of a sinusoid. At the end of the magnetizing stage, when the switches S1 and S2 are opened, current induced in the inductive device L1, by the collapsing magnetic field, falls to zero with a waveform that is similar to the second quarter cycle of the sinusoid. The current in the inductive device L1 then remains at zero until the start of the next cycle.

In summary, the waveform of the current in the inductive device is similar to half a sinusoid for each cycle of operation. A replenishment current from the supply rises softly from zero toward the end of the run mode magnetizing cycle and peaks at a current of approximately 6.5 amperes during the recovery stage before falling to zero.

### Seventh Embodiment

### 7.1 Circuit Layout

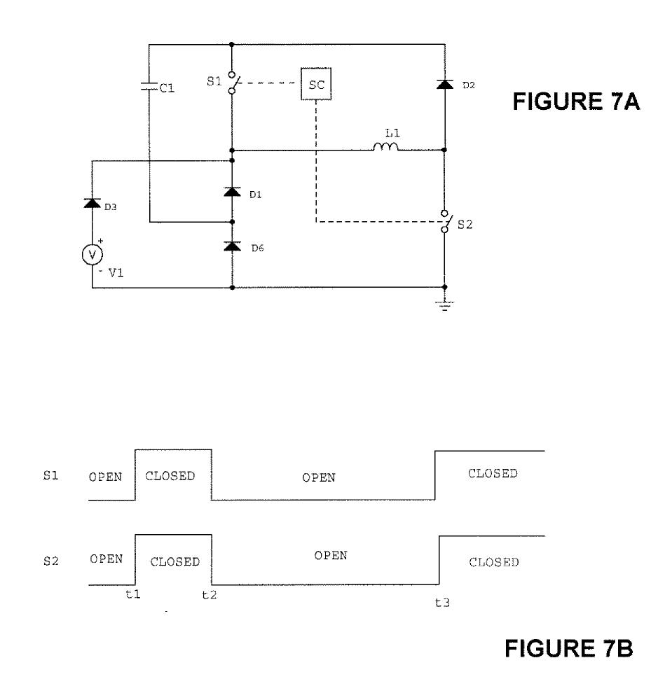

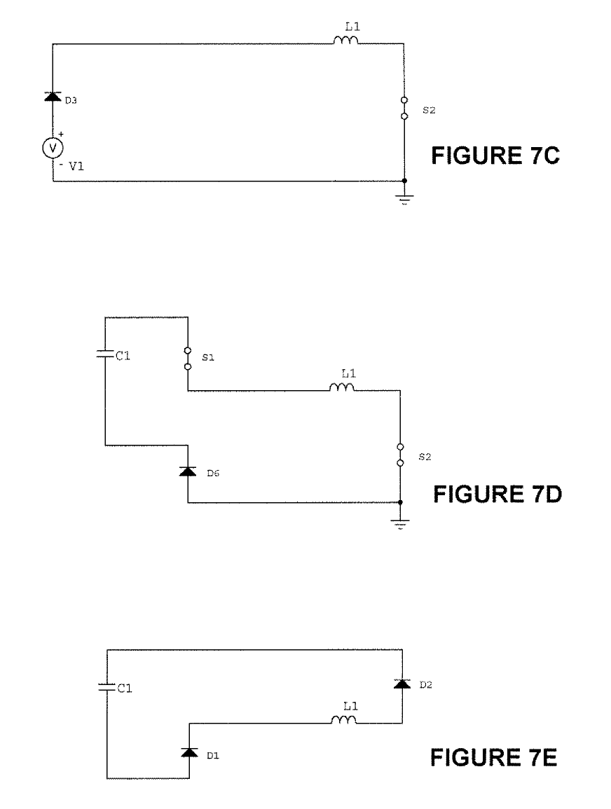

FIG. 7A is a circuit diagram illustrating a seventh embodiment of the invention. This circuit is a variant of the first embodiment. The replenishment of energy lost to circuit losses is automatically met, without using actively controlled switches, by connection of the supply V1 through a diode D3 directly to the inductive device L1, and effectively in parallel with the recovery capacitor C1 (in series with diode D6 and controlled switch S1). The FIG. 7A circuit provides full field energy recovery and voltage compounding, and efficiencies similar to those achieved by other embodiments providing sinusoidal magnetizing current waveforms.

The circuit of FIG. 7A comprises a DC power supply V1, four diodes D1, D2, D3 and D6, a capacitor C1, two controlled switches S1 and S2, and an inductive device L1. Switch S1 and diodes D1 and D6 are connected in series between upper and lower rails to form a first leg of an H-bridge. Diode D2 and switch S2 are connected in series between the upper and lower rails to form the second leg of the H-bridge. The inductive device L1 is connected between the bridge legs. The circuit is operated by periodically switching the controlled switches S1 and S2 between open and closed states to achieve the effective circuit configurations shown in FIGS. 7C to 7E. The opening and closing of the switches S1 and S2 are controlled by a common switch controller SC.

### 7.2 Switch Timing

FIG. 7B is a switch timing diagram for the controlled switches S1 and S2 showing one cycle of operation from time t₁ to time t₃. Switches S1 and S2 are operated synchronously over each cycle by the switch controller SC.

The switches S1 and S2 are both closed to arrange the circuit of FIG. 7A for a magnetizing stage from time t₁ to time t₂. During this magnetizing stage a current is driven through the inductive device L1 to establish a magnetic field. The magnetizing current flows through the inductive device L1 from left to right in the circuits shown in FIGS. 7A, 7C and 7D.

Switches S1 and S2 remain closed from time t₁ to time t₂ for a period that is approximately equal to 0.5π√(L1 C1). The magnetizing stage ends at time t₂ at which time switches S1 and S2 are opened to arrange the circuit of FIG. 7A for a recovery stage during which a current induced in the inductive device L1 during collapse of the magnetic field charges a recovery capacitor C1. The switches S1 and S2 are kept open from time t₂ to time t₃.

Both switches S1 and S2 are closed at time t₃ to arrange the circuit of FIG. 7A for the next magnetizing stage. The operating cycle is repeated with a repetition period equal to (t₃-t₁).

### 7.3 First Magnetizing Circuit

FIG. 7C shows a first effective circuit for the magnetizing stage of circuit operation when switches S1 and S2 are closed. Current flows from the supply V1, through diode D3, inductive device L1 and closed switch S2, to establish a magnetic field in association with the inductive device. This circuit applies during the magnetizing stage when diode D3 is conductive and diode D6 is non-conductive, i.e. when the voltage on capacitor C1 is less than that of the supply V1.

### 7.4 Second Magnetizing Circuit

When the voltage across the capacitor C1, during the magnetizing stage, is greater than that of the supply, diode D3 is reverse biased and non-conductive, diode D6 is forward biased and conductive, providing the effective circuit shown in FIG. 7D. Magnetizing current from the capacitor C1 then flows through closed switch S1 to inductive device L1, and back through closed switch S2 and diode D6 to contribute to the establishment of the magnetic field in association with the inductive device L1.

### 7.5 Magnetizing Circuit Conversion

The magnetizing circuit of FIG. 7D converts to that of FIG. 7C automatically when there is insufficient charge on the recovery capacitor to supply all the magnetizing current for the full magnetizing period and particularly when the voltage on capacitor C1 falls below, or is less than, that of the supply V1. This occurs immediately on first closing switches S1 and S2 at time t₁ of the first cycle of operation because capacitor C1 is uncharged, but can occur progressively later in subsequent cycles. In these subsequent cycles, the recovery capacitor can charge to progressively higher voltages as the circuit builds up to an operating mode.

### 7.6 Energy Recovery Circuit

FIG. 7E shows an effective circuit configuration for the energy recovery stage of circuit operation when switches S1 and S2 are both opened at time t₂. This circuit configuration continues from time t₂ to time t₃. Current flowing from the inductive device L1 on collapse of the magnetic field forward biases diodes D1 and D2 and charges capacitor C1, causing the current to fall.

When this falling inductive device current reaches zero, diodes D1 and D2 become non-conductive, blocking discharge of the re-charged capacitor C1. This blocking holds the charge on capacitor C1 until the start of the next cycle at time t₃.

### 7.7 Start-Up Mode Magnetizing—First Cycle

Initial start-up of the circuit occurs when the switches S1 and S2 close at time t₁ of the first cycle of operation. For the purposes of the immediately-following explanation it is assumed that, prior to time t₁, capacitor C1 is uncharged.

At time t₁, switches S1 and S2 close to effectively arrange the circuit as shown in FIG. 7C. Magnetizing current then flows from the supply V1 through diode D3, inductive device L1 and closed switch S2 to establish a magnetic field in association with the inductive device L1.

### 7.8 Start-Up Mode Magnetizing—Subsequent Cycles

On subsequent cycles during start-up operation, the capacitor C1 will already, at time t₁ have some charge from energy recovery from previous cycles. In this case the circuit adopts the configuration shown in FIG. 7D and magnetizing current flows from the pre-charged capacitor C1, through closed switch S1, inductive device L1, closed switch S2 and diode D6.

This current flow out of the capacitor C1 depletes the charge on the capacitor which decreases the voltage across the capacitor. If the voltage across the capacitor C1 becomes insufficient to maintain the reverse bias on diode D1 and the forward bias on diode D6, diode D1 conducts and diode D6 becomes non-conducting to automatically convert the circuit to that shown in FIG. 7C so that magnetizing current continues to flow but only from the supply V1.

### 7.9 Run Mode Magnetizing

In the run mode, the magnetizing current for the inductive device L1 is predominantly derived from the discharge of capacitor C1 by the circuit of FIG. 7D. The circuit converts to that of FIG. 7C when the voltage across the capacitor C1 falls below that required to maintain the reverse bias on diode D1 and the forward bias on diode D6. Magnetizing current then continues to flow but only from the supply V1 which is effectively then replenishing circuit losses.

### 7.10 Energy Recovery

FIG. 7E shows an effective circuit configuration for the energy recovery stage of circuit operation when switches S1 and S2 are both opened at time t₂. This configuration continues from time t₂ to time t₃. At time t₂, the current through the inductive device L1 and the associated magnetic field begin to collapse.

The collapsing current flows from the inductive device L1 through diode D2 to capacitor C1 and back through diode D1 to inductive device L1. This current flows through the inductive device L1 in the same direction as the current used to establish the magnetic field (i.e. from left to right in FIG. 7E), but flows into the capacitor C1 in the opposite direction to the magnetizing current flowing from the capacitor C1 during the magnetizing stage.

The flow of the induced current, from the inductive device back to the capacitor, recharges the capacitor to effectively transfer energy from the magnetic field to the capacitor C1. This recovered energy is held as a charge on the capacitor C1 until the end of the cycle at time t₃ when it is used to re-establish the magnetic field during the magnetizing stage of the next cycle of operation.

### 7.11 Voltage Multiplication

On initial start-up, the capacitor C1 is charged, in the energy recovery stages of the first few successive cycles of circuit operation, to progressively higher voltages that are significantly higher than that of the supply voltage V1. After only a few cycles of operation the capacitor C1 is recharged at each recovery stage to several times the supply voltage. In the magnetizing stages, the magnetizing current in the inductive device is driven from this capacitor voltage.

The recovery of energy from the collapsing magnetic field at each cycle and its re-use to re-establish the field in the magnetizing stage at the next cycle effectively multiplies the voltage from which the inductive device is driven to provide a significant improvement in efficiency. The voltage multiplication process is similar to the transient charging phase of a resonant inductance-capacitance (L-C) circuit.

The capacitor C1 discharges over progressively longer times, and with progressively higher peak current values, during the magnetizing stage of each of the first few start-up cycles. Once the voltage on capacitor C1 is sufficiently depleted and diode D1 is reverse biased and diode D3 is forward biased, the circuit effectively adopts the supply-fed magnetizing circuit configuration as shown in FIG. 7C, whereupon the magnetizing current in the inductive device is provided from supply V1 via diode D3 to inductive device L1, with a return path to earth or ground through closed switch S2. The voltage of the supply V1, although less than the much higher run-mode voltages achieved on the capacitor C1, is sufficient to maintain the level of current in the inductive device L1 and prolong the magnetizing current in the inductive device through to the end of the magnetizing stage.

### 7.12 Energy Transfer

When the capacitor C1 provides the magnetizing current for the inductive device L1 during the earlier part of the magnetizing stage, before magnetizing from the supply V1 alone takes over, the circuit is effectively capacitor Cl series connected by switches S1 and S2 to inductive device L1.

For optimum operation of the energy recovery circuit shown in FIG. 7A, the recovered energy stored as a charge on capacitor C1 must be efficiently transferred back to the magnetic field associated with the inductive device L1. Maximum transfer of energy from the capacitor back to the inductive device occurs when the voltage on the capacitor C1 has decreased from a maximum to zero and the current in the inductive device L1 has risen simultaneously from zero to a maximum. The time for this to occur is equal to a quarter of the period of natural resonance of the inductance-capacitance (L-C) circuit, which in this case is equal to 0.5π√(L1 C1).

For optimum operation of the energy recovery circuit of FIG. 7A, the switches S1 and S2 are closed for each cycle of operation for a time that is approximately equal to 0.5π√(L1 C1) to allow for optimum transfer of energy from the capacitor C1 to the inductive device L1.

The switches S1 and S2 can be maintained closed after depletion of the charge on capacitor C1 to extend the duration of the magnetizing current in the inductive device L1. During this extension period, the magnetizing current is supplied from supply V1 only, via diode D1.

For optimum operation of the energy recovery circuit shown in FIG. 7A, the energy from the magnetic field associated with the inductive device L1 must be efficiently transferred back to the recovery capacitor C1. Maximum transfer of energy from the magnetic field back to the capacitor occurs when the current flowing in the inductive device L1 has decreased to zero.

For optimum operation of the energy recovery circuit of FIG. 7A, the switches S1 and S2 are open for each cycle of operation for a time that is no shorter than a quarter of the period of natural resonance of the inductance-capacitance (L-C) circuit, which in this case is equal to 0.5π√(L1 C1), to allow for optimum transfer of energy from the inductive device L1 to the capacitor C1. The switches S1 and S2 are maintained opened after cessation of the current in the inductive device L1, while waiting on the re-closing of switches S1 and S2 to re-establish the magnetic field at the commencement of the next cycle.

### 7.13 Specific Embodiment

One specific embodiment of the circuit shown in FIG. 7A has the following circuit values:

S1 and S2: IRFK20450

D1, D2, D3 and D6: RHRG30120

V1=80 volts

C1=250 μF

L1=36 mH (with an effective series resistance of 0.5 ohms)

Switching period t₁ to t₃=20 mS

Switching frequency=50 Hz

Magnetizing period t₁ to t₂=5 mS

In this embodiment, the switches S1 and S2 remain closed for 5 mS over the 20 mS period of each cycle. Switches S1 and S2 are closed for 5 mS which is slightly longer than one quarter of the natural resonance period of the capacitor C1 and inductive device L1, i.e. 0.5π√(L1 C1), which is equal to 4.7 mS.

In this embodiment, the capacitor C1 is recharged at each recovery stage to a voltage that is more than 3.5 times the supply voltage after the first 15 cycles of operation, i.e. after 300 mS from starting.

### 7.14 Waveforms

In the run-mode of the specific seventh embodiment of the FIG. 7A circuit having the circuit values described in the immediately preceding paragraphs, the magnetizing current in the inductive device L1 is similar to a semi-triangular waveform with a peak of approximately 28 amperes. The current rises over the magnetizing stage then falls to zero over the beginning of the recovery stage to remain at zero until the start of the next cycle.

### Eighth Embodiment

### 8.1 Circuit Layout

FIG. 8A is a circuit diagram illustrating an eighth embodiment of the invention. This is a variant of the seventh embodiment, and has a dual voltage supply controlled by an additional switch S3 which is closed to switch the dual supply from a lower to a higher voltage. The higher voltage is provided by connecting a power supply V1 and a power supply V2 in series by closing switch S3. When switch S3 is open, a diode D5 bypasses supply V1, leaving only the supply V2 to power the circuit.

Current from the dual voltage supply is injected into the circuit at the higher voltage, on depletion of energy from the recovery capacitor, to replenish energy lost to circuit losses. Supply current is also injected into the circuit at the lower voltage to extend the duration of the peak of the magnetizing current through the inductive device. This is useful in motor drive circuits where the increased width of the magnetizing current pulse provides more magnetic force for providing mechanical energy.

The eighth embodiment circuit provides full field energy recovery and voltage compounding, and efficiencies similar to those achieved by embodiments providing sinusoidal magnetizing current waveforms. This embodiment is one of the most efficient for near-sinusoidal waveforms.

The circuit of FIG. 8A comprises two DC power supplies V1 and V2, six diodes D1, D2, D3, D5, D6 and D10, a capacitor C1, three controlled switches S1, S2 and S3, and an inductive device L1. The power supply V2 is connected in series with the power supply V1 by controlled switch S3. The voltage ratio V1/V2 of the two supplies typically ranges from about 3/1 to 20/1.

A bypass diode D5 is connected across the series combination of switch S3 and supply V1 to provide a current path for supply V2 when the switch S3 is open. Switch S1 and diodes D10, D1 and D6 are connected in series between upper and lower rails to form a first leg of an H-bridge. Diode D2 and switch S2 are connected in series between the upper and lower rails to form the second leg of the H-bridge. The inductive device L1 is connected between the bridge legs. The circuit is operated by periodically switching the controlled switches S1, S2 and S3 between open and closed states to achieve the effective circuit configurations shown in FIGS. 8C to 8G. The opening and closing of the switches S1, S2 and S3 are controlled by a common switch controller SC.

### 8.2 Switch Timing

FIG. 8B is a switch timing diagram for the controlled switches S1, S2 and S3 showing one cycle of operation from time t₁ to time t₃. The switches S1, S2 and S3 are closed simultaneously at time t₁ at the beginning of each cycle to arrange the circuit of FIG. 8A in a first magnetizing configuration from time t₁ to time t_{S3}. Switch S3 is opened at supply switching time t_{S3} to arrange the circuit into a second magnetizing configuration from time t_{S3} to time t_{S1}. Switch S1 is opened at time t_{S1} to arrange the circuit into a third magnetizing configuration from time t_{S1} to time t_{S2}. The magnetizing stage ends at time t_{S2} when switch S2 is opened to arrange the circuit of FIG. 8A in a recovery configuration from time t_{S2} to time t₃. This is a magnetic-field-energy recovery stage during which a current induced in the inductive device L1 during collapse of the magnetic field charges a recovery capacitor C1. Recovery of magnetic field energy may be completed before time t₃ but the switches S1 and S2 are kept open until time t₃.

During the magnetizing stage, current is driven through the inductive device L1 to establish a magnetic field. This magnetizing current flows through the inductive device L1 from left to right in the circuits shown in FIGS. 8A, 8C, 8D and 8E.

Magnetizing current is drawn from the recovery capacitor C1 during the magnetizing stage for one or more periods that in total approximately equal 0.5π√(L1 C1).

After the recovery stage, all three switches S1, S2 and S3 are closed at time t₃ to arrange the circuit of FIG. 8A for the next magnetizing stage. The operating cycle is repeated with a repetition period equal to (t₃-t₁).

### 8.3 First Magnetizing Circuit

FIG. 8C shows a first effective circuit for the magnetizing stage of circuit operation when switches S1, S2 and S3 are closed. Current flows from charged capacitor C1, through closed switch S1, diode D10, inductive device L1, closed switch S2 and back to the capacitor C1 through diode D6, to establish a magnetic field in association with the inductive device.

The circuit of FIG. 8C applies during the magnetizing stage when diodes D6 and D10 are conductive and diode D3 is non-conductive, i.e. when the voltage on capacitor C1 is greater than that of the series connection of the two supplies V1 and V2. Diode D5 is non-conductive because of the reverse bias provided by supply V1 through closed controlled switch S3.

The circuit of FIG. 8C also applies after switch S3 opens at time t_{S3} and before the earlier of the capacitor C1 discharging to a voltage less than that of supply V2, or the switch S1 opening at time t_{S1}.

### 8.4 Second Magnetizing Circuit

FIG. 8D shows a second effective circuit for the magnetizing stage of circuit operation when switches S1, S2 and S3 are closed. Current flows from the series connection of supplies V1 and V2 (connected in series by closed switch S3), through diode D3, inductive device L1 and closed switch S2, to establish a magnetic field in association with the inductive device. This circuit applies during the magnetizing stage when diode D3 is conductive and diodes D6 and D10 are non-conductive, i.e. when the voltage on capacitor C1 is less than that of the series connection of supplies V1 and V2.

### 8.5 Third Magnetizing Circuit

FIG. 8E shows another effective circuit for the magnetizing stage of circuit operation. This circuit applies after switch S3 has opened at time t_{S3} and capacitor C1 has discharged to a voltage less than that of supply V2 or switch S1 opens at time t_{S1}. Diode D5 is then forward biased and conductive, bypassing the supply V2 and open switch S3. Diode D3 is forward biased and conductive. The voltage on capacitor C1 is less than that of supply V2, making diodes D6 and D10 reverse biased and non-conductive. Magnetizing current from supply V2 flows through diode D3 to inductive device L1, and back through closed switch S2 and diode D5 to contribute to the establishment of the magnetic field in association with the inductive device L1. This circuit applies through to time t_{S2} when switch S2 opens.

### 8.6 Magnetizing Circuit Conversion

The first magnetizing circuit of FIG. 8C converts to the second magnetizing circuit of FIG. 8D automatically when the voltage on capacitor C1 falls below, or is less than, the voltage provided by the series connection of the two supplies V1 and V2. This occurs immediately on first closing switches S1, S2 and S3 at time t₁ of the first cycle of operation because capacitor C1 is uncharged, but occurs progressively later in successive subsequent cycles. In the first several subsequent cycles, the recovery capacitor charges to progressively higher voltages as the circuit builds up to an operating or run mode. In the operating mode, capacitor C1 is left charged, after the conversion to the second magnetizing circuit of FIG. 8D, with a voltage approximately equal to the summation of the voltages of supplies V1 and V2.

The second magnetizing circuit of FIG. 8D then converts back to the first magnetizing circuit of FIG. 8C when switch S3 is opened at time t_{S3}. At this time, the voltage of the supply is switched from voltage V1 plus voltage V2, to voltage V2 only. The capacitor C1 now discharges further, with the capacitor voltage falling from approximately equal to the summation of the voltages of supplies V1 and V2, to the voltage of supply V2.

When the capacitor voltage falls to, or below, that of the supply V2, the circuit configuration converts from the first magnetizing circuit of FIG. 8C to the third magnetizing circuit of FIG. 8E. The lower voltage supply V2 continues to provide magnetizing current through to the end of the magnetizing period at time t_{S2} when switch S2 is opened.

### 8.7 Energy Recovery Circuit

FIG. 8F shows an effective circuit configuration for the energy recovery stage of circuit operation when switch S2 is opened at time t_{S2}, (S1 and S3 having earlier been opened at respective times t_{S1} and t_{S3}). This circuit configuration continues from time t_{S2} to time t₃. Current flowing from the inductive device L1 on collapse of the magnetic field forward biases diodes D1 and D2 and charges capacitor C1, causing the current to fall.

When this falling inductive device current reaches zero, diodes D1 and D2 become non-conductive, blocking discharge of the re-charged capacitor C1. This blocking holds the charge on capacitor C1 until the start of the next cycle at time t₃.

### 8.8 Start-Up Mode Magnetizing—First Cycle

Initial start-up of the circuit occurs when the switches S1, S2 and S3 close at time t₁ of the first cycle of operation. For the purposes of the immediately-following explanation it is assumed that, prior to this initial time t₁, capacitor C1 is uncharged.

At time t₁, switches S1, S2 and S3 close to effectively arrange the circuit as shown in FIG. 8D. The supply V1, connected by closed switch S3, makes diode D5 reversed biased and non-conductive. With capacitor C1 uncharged, diode D3 is forward biased and conductive, and diodes D1, D6 and D10 are reverse biased and non-conductive. Magnetizing current then flows from the series connection of the supplies V1 and V2, through diode D3, inductive device L1 and closed switch S2 to establish a magnetic field in association with the inductive device L1.

At supply switching time t_{S3} switch S3 opens to effectively arrange the circuit as shown in FIG. 8E. Magnetizing current then flows, from supply V2 only, through diode D3, inductive device L1, closed switch S2 and diode D5, to maintain the magnetic field established in association with the inductive device L1. This magnetizing current continues until switch S2 is opened at time t_{S2}.

### 8.9 Start-Up Mode Magnetizing—Subsequent Cycles

On subsequent cycles during start-up operation, the capacitor C1 will already, at time t₁ have some charge from energy recovery from one or more previous cycles. If the recovery capacitor is already charged to a voltage higher than the combined voltages of the two supplies V1 and V2, the circuit will adopt the configuration shown in FIG. 8C from the beginning of the cycle at time t₁. The pre-charged capacitor C1 discharges to provide magnetizing current which flows through closed switch S1, diode D10, inductive device L1, closed switch S2 and diode D6.

When the voltage across the discharging capacitor C1 falls below the combined voltage of the two supplies V1 and V2, and therefore becomes insufficient to maintain the reverse bias on diode D3 and the forward bias on diodes D6 and D10, diode D3 conducts and diodes D6 and D10 become non-conductive, automatically converting the circuit to that shown in FIG. 8D. This conversion interrupts the discharge of the recovery capacitor and the voltage on the capacitor then remains at approximately equal to the combined voltage of the two supplies V1 and V2. Magnetizing current then continues to flow, but from the series connection of the two supplies V1 and V2. This maintains the rising magnetizing current begun by discharge of the recovery capacitor C1.

The automatic conversion from the circuit configuration of FIG. 8C to that of FIG. 8D occurs progressively later in successive start-up cycles as the recovery capacitor C1 is charged to successively higher voltages and the circuit builds up to a fully operational run mode.

At supply switching time t_{S3} switch S3 is opened to disconnect supply V1 and lower the voltage supplied to the circuit to that of the supply V2 only. The circuit reverts back to that as shown in FIG. 8C because the voltage then remaining on the capacitor C1 is greater than the voltage of supply V2, making the diodes D6 and D10 forward biased and conductive, and diodes D1, D3 and D5 reverse biased and non-conductive. Capacitor C1 again discharges, to provide magnetizing current that flows through closed switch S1, diode D10, inductive device L1, closed switch S2 and diode D6.

When the voltage across the discharging capacitor C1 falls below the voltage of the supply V2, and therefore becomes insufficient to maintain the reverse bias on diodes D3 and D5, and the forward bias on diodes D6 and D10, diodes D3 and D5 conduct and diodes D6 and D10 become non-conductive, automatically converting the circuit to that shown in FIG. 8E. Magnetizing current continues to flow, but from the supply V2 only, through diode D3, inductive device L1, closed switch S2 and diode D5. This maintains the magnetizing current, at about the level already established by discharge of the recovery capacitor C1, until switch S2 is opened at time t_{S2}.

### 8.10 Run Mode Magnetizing

In the run mode, the magnetizing current for the inductive device L1 is predominantly derived from the discharge of capacitor C1 by the circuit of FIG. 8C.

At the start of the run mode cycle, at time t₁, the circuit adopts the configuration shown in FIG. 8C. The recovery capacitor is already charged to a voltage higher than the combined voltages of the two supplies V1 and V2. Magnetizing current flows from the pre-charged capacitor C1, through closed switch S1, diode D10, inductive device L1, closed switch S2 and diode D6.

When the voltage across the capacitor C1 falls below the combined voltage of the two supplies V1 and V2, and therefore becomes insufficient to maintain the reverse bias on diode D3 and the forward bias on diodes D6 and D10, diode D3 conducts and diodes D6 and D10 becomes non-conducting to automatically convert the circuit to that shown in FIG. 8D. This conversion interrupts the discharge of the recovery capacitor and the voltage on the capacitor then remains at approximately equal to the combined voltage of the two supplies V1 and V2. Magnetizing current continues to flow, but from the two supplies V1 and V2 connected in series by closed switch S3, through diode D3, inductive device L1 and closed switch S2. The magnetizing current, begun by discharge of the recovery capacitor C1, but now supplied from the series-connected supplies V1 and V2, continues until time t_{S3}.

At time t_{S3} switch S3 opens, removing the series connection between the two supplies V1 and V2, to effectively drop the supply voltage to that of supply V2 only. Diode D3 becomes reverse biased and non-conductive, diodes D6 and D10 become forward biased and conductive, and the circuit converts to that shown in FIG. 8C. Magnetizing current continues to flow from the capacitor C1, through closed switch S1, diode D10, inductive device L1, closed switch S2 and diode D6. Capacitor C1 discharges and the capacitor voltage falls from a voltage approximately equal to the combined voltage of supplies V1 and V2, down to a voltage approximately equal to supply V2.

When the capacitor C1 voltage falls below that of the supply V2, the circuit configuration converts from the first magnetizing circuit of FIG. 8C to the third magnetizing circuit of FIG. 8E. This maintains the magnetizing current at about the level already established by discharge of the recovery capacitor C1. The slope of the magnetizing current waveform over this period can be made positive, zero or negative by appropriate selection of the voltage of the supply V2. The supply V2 continues to provide magnetizing current through to the end of the magnetizing period at time t_{S2} when switch S2 opens.

### 8.11 Energy recovery

FIG. 8F shows an effective circuit configuration for the energy recovery stage of circuit operation when switch S2 is opened at time t_{S2}. At time t_{S2}, the current through the inductive device L1 and the associated magnetic field begin to collapse. This configuration continues from time t_{S2} to time

The collapsing current flows from the inductive device L1 through diode D2 to capacitor C1 and back through diode D1 to inductive device L1. This current flows through the inductive device L1 in the same direction as the current used to establish the magnetic field (i.e. from left to right in FIG. 8F), but flows into the capacitor C1 in the opposite direction to the magnetizing current flowing from the capacitor C1 during the magnetizing stage. This reversal of current direction may be best appreciated from the change in polarity of the capacitor current shown in the middle waveforms of FIGS. 8G and 8H.

The flow of the induced current, from the inductive device back to the capacitor, recharges the capacitor to effectively transfer energy from the magnetic field to the capacitor C1. This recovered energy is held as a charge on the capacitor C1 until the end of the cycle at time t₃ when it is used to re-establish the magnetic field during the magnetizing stage of the next cycle of operation.

### 8.12 Voltage Multiplication

On initial start-up, the capacitor C1 is charged, in the energy recovery stages of the first few successive cycles of circuit operation, to progressively higher voltages that are significantly higher than that of the supply voltage V1. This may be appreciated from the voltage waveform shown in FIG. 8I. After only a few cycles of operation the capacitor C1 is recharged at each recovery stage to several times the supply voltage. In the magnetizing stages, the magnetizing current in the inductive device is driven by this capacitor voltage.

FIG. 8I shows, in the lower waveform, a typical waveform for the voltage on capacitor C1 for a specific eighth embodiment having circuit values as discussed below. The capacitor voltage rises to just over 120 volts during the first energy recovery stage, from 7 mS to about 12 mS, and progressively rises to greater voltages in successive subsequent recovery stages to reach about 200 volts after about 200 mS of operation. During the magnetizing stages, the magnetizing current in the inductive device is driven, in part, by this capacitor voltage.

The recovery of energy from the collapsing magnetic field at each cycle and its re-use to re-establish the field in the magnetizing stage at the next cycle effectively multiplies the voltage from which the inductive device is driven to provide a significant improvement in efficiency. The voltage multiplication process is similar to the transient charging phase of a resonant inductance-capacitance (L-C) circuit.

During the initial part of the magnetizing stage of each successive cycle of the first few start-up cycles, when the circuit adopts the configuration shown in FIG. 8C, the capacitor C1 discharges with progressively higher peak current values. This may be seen in the middle waveform of FIG. 8G which shows the capacitor first discharging in the second cycle, from 20 mS to about 22.5 mS, with a peak current of about 4.8 A. In the initial part of later cycles the capacitor C1 discharges with a peak current of about 14 A. This may be seen in the middle waveform of FIG. 8H which shows the capacitor discharging from 200 mS to about 22.5 mS with a peak current of about 4.8 A.

When the voltage on capacitor C1 is below that of the combined voltage of the dual voltage supplies V1 and V2, and diodes D6 and D10 are reverse biased and diode D3 is forward biased, the circuit effectively adopts the supply-fed magnetizing circuit configuration as shown in FIG. 8D, whereupon the magnetizing current in the inductive device is provided from the series connection of the supplies V1 and V2 via diode D3 to inductive device L1, with a return path to earth or ground through closed switch S2 and diode D6. This may be seen in FIGS. 8G and 8H in which the upper waveform shows the supply current. In the first cycle, the supply current begins rising from 0 mS, as seen in FIG. 8G. In subsequent cycles, the supply current rises when the capacitor discharge current begins to fall, for example at about 21.8 mS, 42.7 mS, 62.8 mS, and 82.5 mS, as seen in FIG. 8G.

As described above, the supply voltage is switched to a lower value at supply switching time t_{S3} by the opening of switch S3. The supply voltage, as applied to the anode of diode D3, is shown in the upper waveform of FIG. 8I which clearly shows the switching of the supply voltage between higher and lower voltages. The voltage of the series connection of the two supplies V1 and V2, and the voltage of the supply V2 only, although less than the much higher run-mode voltages achieved on the capacitor C1, are sufficient to maintain the level of current in the inductive device L1 and extend the magnetizing period of the inductive device through to the end of the magnetizing stage.

### 8.13 Energy Transfer

When the capacitor C1 provides the magnetizing current for the inductive device L1 the circuit is effectively capacitor C1 series connected to inductive device L1, by switches S1 and S2 and diode D6.

For optimum operation of the energy recovery circuit shown in FIG. 8A, the recovered energy stored as a charge on capacitor C1 must be efficiently transferred back to the magnetic field associated with the inductive device L1. Maximum transfer of energy from the capacitor back to the inductive device occurs when the voltage on the capacitor C1 has decreased from a maximum to zero and the current in the inductive device L1 has simultaneously risen from zero to a maximum. The time for this to occur is equal to a quarter of the period of natural resonance of the inductance-capacitance (L-C) circuit, which in this case is equal to 0.5π√(L1 C1).

For optimum operation of the energy recovery circuit of FIG. 8A, the switch S1 is closed for each cycle of operation for a time that is not less than 0.5π√(L1 C1) to allow for optimum transfer of energy from the capacitor C1 to the inductive device L1.

The switch S1 is maintained closed after depletion of the charge on capacitor C1 to extend the duration of the magnetizing current in the inductive device L1. During this extension period, the magnetizing current can be supplied from supply V2 alone, or from the combined supplies V1 and V2, to compensate for circuit losses. This extension period may be best seen in FIG. 8H in which the supply current, shown in the upper waveform, flows from about 205.3 mS to about 207 mS, and from about 225.2 mS to 227 mS, to extend the magnetizing current as seen by the flat top to the inductive device current shown in the lower waveform.

For optimum operation of the energy recovery circuit shown in FIG. 8A, the energy from the magnetic field associated with the inductive device L1 must be efficiently transferred back to the recovery capacitor C1. Maximum transfer of energy from the magnetic field back to the capacitor occurs when the current flowing in the inductive device L1 has decreased to zero.

For optimum operation of the energy recovery circuit of FIG. 8A, the switches S1 and S2 are simultaneously open for each cycle of operation for a time that is no shorter than a quarter of the period of natural resonance of the inductance-capacitance (L-C) circuit, which in this case is equal to 0.5π√(L1 C1), to allow for optimum transfer of energy from the inductive device L1 to the capacitor C1. The switches S1 and S2 are maintained opened after cessation of the current in the inductive device L1, while waiting on the re-closing of switches S1 and S2 to re-establish the magnetic field at the commencement of the next cycle.

At near optimum operation, the contrast between the relatively shorter total duration of the run mode supply current pulses shown in the upper waveform of FIG. 8H and the much longer duration of the run mode inductive device current pulses shown in the lower waveform of FIG. 8H is clearly apparent.

### 8.14 Specific Embodiment

A first specific embodiment of the circuit shown in FIG. 8A has the following circuit values:

S1, S2 and S3: IRFK20450

D1, D2, D3, D5, D6 and D10: RHRG30120

V1=95 volts

V2=5 volts

C1=250 μF

L1=36 mH (with an effective series resistance of 0.5 ohms)

Switching period t₁ to t₃=20 mS

Switching frequency=50 Hz

Switch S1 closed period t₁ to t_{S1}=5.5 mS

Switch S2 closed period t₁ to t_{S2}=7.0 mS

Switch S3 closed period t₁ to t_{S3}=4.0 mS

In this embodiment, for the 20 mS period of each cycle, the switch S3 is closed only over the first 4.0 mS, the switch S1 is closed only over the first 5.5 mS, and the switch S2 is closed only over the first 7.0 mS. Switch S1 is closed for 5.5 mS which is longer than one quarter of the natural resonance period of the capacitor C1 and inductive device L1, i.e. 0.5π√(L1 C1), which is equal to 4.7 mS. This allows time (0.8 mS) for the extension of the magnetizing current from the combined supplies V1 and V2 to occur. Switch S2 is closed for 7.0 mS to allow time for further extension of the magnetizing current from the supply V2 alone to occur, after depletion of the charge on the recovery capacitor C1.

In this embodiment, in the run mode after the first 10 cycles of operation, i.e. after 200 mS from starting, the capacitor C1 is substantially discharged at each cycle to provide re-magnetizing current to the inductive device and is recharged at each recovery stage to a voltage that is more than twice the combined supply voltage of supplies V1 and V2. The voltage on the capacitor C1 is shown in the lower waveform of FIG. 8I.

As best shown by FIG. 8H, the waveform of the current in the inductive device (shown in the lower waveform) has a relatively smooth semi-sinusoidal shape. This current is provided by two discrete periods of discharge current from the recovery capacitor (as seen in the positive portion of the middle waveform), interleaved with two distinct periods of current from the supply (as seen in the upper waveform). The semi-sinusoidal waveform is completed by the current flowing back into the recovery capacitor on collapse of the magnetic field, (as seen in the negative portion of the middle waveform).

The current in the inductive device L1 of this first embodiment of the FIG. 8A circuit, in the cycle shown in FIG. 8H beginning at 200 mS, is made up of the following five components.
1. A first discharge current from the capacitor C1 (charged in the previous cycle to about 200 volts) begins to rise at the beginning of the cycle at 200 mS when switches S1, S2 and S3 are closed. This first discharge current continues to rise to a peak at about 203 mS, and then falls to zero between 203 mS to 204 mS as the voltage on the discharging capacitor falls below 100 volts, the combined supply voltage.
2. A first supply current (from the series combination of the two supplies V1 and V2) begins to rise at 203 mS, and continues to rise to a peak until suddenly falling at 204 mS when the supply V1 is disconnected by the opening of the switch S3.
3. A second discharge current from the capacitor C1 rises suddenly at 204 mS when the voltage provided by the supply suddenly drops upon opening of the switch S3. This second discharge current continues until depletion of the capacitor when the voltage on the discharging capacitor falls to 5 volts, the voltage of the supply V2 working alone, at about 205.5 mS.
4. A second supply current (from supply V2 working alone) rises at about 205.5 mS upon the depletion of the capacitor C1, and continues to flow until the switch S2 is opened at 207 mS.
5. A recovery current, flowing from the inductive device and recharging the capacitor C1, begins to flow at 207 mS when switch S2 is opened and continues to flow until the current in the inductive device has fallen to zero at about 211.8 mS.

In a second specific version of the eighth embodiment, the recovery capacitor is not as fully discharged as in the example described above. In this case, the switch S1 closed period (t₁ to t_{S1}) equals 3.5 mS and the switch S2 closed period (t₁ to t_{S2}) equals 5.0 mS with all other circuit and component values remaining as in the first specific version of the eighth embodiment. With these two timing changes, the recovery capacitor C1 is charged to over 280 volts in the run-mode recovery stages, but only discharges to a voltage of about 120 volts, well above the voltage of the combined supplies V1 and V2, during the run-mode magnetization stages. This circuit provides useful recovery of magnetic field energy, even with the significant residual voltage remaining on the capacitor after discharge to provide the re-magnetizing current for the inductive device. In this case, run-mode current in the inductive device is made up of only three components: current from the discharging recovery capacitor, current from the supply, and current induced in the inductive device by the collapsing field and used to recharge the capacitor. These three components roughly correspond to the components 1, 4 and 5 as described above in relation to the first specific embodiment of the FIG. 8A circuit.

### 8.15 Waveforms

FIGS. 8G, 8H and 8I show typical simulated waveforms of currents and voltages for the specific eighth embodiment of the circuit shown in FIG. 8A. The upper waveforms of FIGS. 8G and 8H show typical supply current waveforms. The middle waveforms of FIGS. 8G and 8H show typical current waveforms for the recovery capacitor C1. The lower waveforms of FIGS. 8G and 8H show typical current waveforms for the inductive device L1. The upper waveform of FIG. 8I shows a typical waveform of the voltage provided by the dual voltage supply as applied to the anode of the diode D3. The lower waveform of FIG. 8I shows a typical waveform of the voltage on the recovery capacitor C1. FIGS. 8G and 8I show several cycles during start-up. FIG. 8H shows run-mode cycles.

It can be seen from the lower waveform of FIG. 8I that at start-up the voltage on capacitor C1 is initially zero but then the peak value of the voltage on capacitor C1 increases rapidly over successive start-up cycles to be approximately 200 volts at 200 mS. The lower waveform of FIG. 8I shows that the recovery capacitor C1 is nearly completely discharged, i.e. the voltage on the capacitor C1 is close to zero volts, by the end of the magnetizing stage for each cycle of circuit operation in the run mode.

In the run-mode of the specific eighth embodiment of the FIG. 8A circuit having the circuit values described above, the magnetizing current in the inductive device L1 is similar to a flattened half sinusoid with a flat peak value of approximately 18 amperes, as is seen in the lower waveforms of FIGS. 8G and 8H.

The magnetizing current in the inductive device rises over the first part of the magnetizing stage, is held almost constant for a short period of about 2 mS, then falls to zero over the beginning of the recovery stage to remain at zero until the start of the next cycle. The slope of the flat peak of the current in the inductive device L1 may be made to rise or fall by appropriate selection of the voltage of the supply V2.

### 8.16 Dual Mode Operation

A dual-mode motor drive circuit, using the two circuit topologies shown in FIG. 2A and FIG. 8A, is discussed above in Section 2.16.

### Ninth Embodiment

### 9.1 Circuit Layout

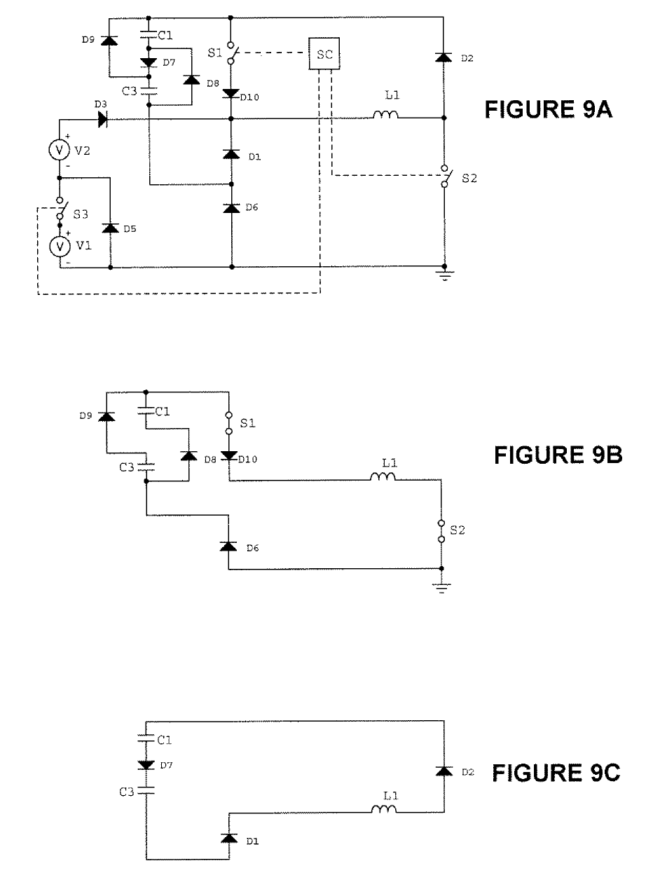

FIG. 9A is a circuit diagram illustrating a ninth embodiment of the invention. This is a variant of the eighth embodiment. In general, the ninth embodiment operates similarly to that of the eighth embodiment as described above, but with the differences described in the following paragraphs 9.2 to 9.11, in which reference is made to FIGS. 8C, 8D, 8E and 8F of the eighth embodiment.

In the ninth embodiment, the recovery capacitor (corresponding to capacitor C1 in FIG. 8A) is provided by two discrete recovery capacitors C1 and C3 which are interconnected by three diodes D7, D8 and D9 to charge in series but discharge in parallel. The two capacitors discharge in parallel during the first quadrant of the current waveform through the inductive device but re-charge in series during the second quadrant. This ninth embodiment circuit still provides full energy recovery with compounding voltages. The lower capacitance of the series connection of the capacitors gives the recovery current through the inductive device a steeper falling edge, allowing faster recovery of energy and making this circuit particularly suitable for switched reluctance motor drives where rapid ‘de-fluxing’ is desirable.

### 9.2 Switch Timing

With the exception of the substitution of capacitor C1 with the series-parallel connection of recovery capacitors C1 and C3, the ninth embodiment operates with the switch timing as described above in section 8.2 and as shown in FIG. 8B. The opening and closing of the switches S1, S2 and S3 are controlled by a common switch controller SC.

### 9.3 First Magnetizing Circuit

FIG. 9B corresponds to the circuit of FIG. 8C of the eighth embodiment. FIG. 9B shows a first effective circuit for the magnetizing stage of circuit operation of the ninth embodiment when switches S1, S2 and S3 are closed. Capacitors C1 and C3 are connected in parallel by forward biased diodes D8 and D9. Diode D7 is reverse biased and non-conductive. Current flows from the parallel-connected and charged capacitors C1 and C3, through closed switch S1, diode D10, inductive device L1, closed switch S2 and diode D6, to establish a magnetic field in association with the inductive device.

This circuit applies during the magnetizing stage when diodes D6 and D10 are conductive and diode D3 is non-conductive, i.e. when the voltage on the parallel-connected capacitors C1 and C3 is greater than that of the series connection of the two supplies V1 and V2. Diode D5 is non-conductive because of the reverse bias provided by supply V1 through closed controlled switch S3.

The circuit of FIG. 9B also applies after switch S3 opens at time t_{S3} and before the earlier of the capacitors C1 and C3 discharging to a voltage less than that of supply V2, or the switch S1 opening at time t_{S1}.

### 9.4 Magnetizing Circuit Conversion

The magnetizing circuit of FIG. 9B converts automatically to the circuit shown in FIG. 8D when the voltage on the parallel-connected capacitors C1 and C3 falls below, or is less than, that of the series connection of the two supplies V1 and V2. This occurs immediately on first closing switches S1, S2 and S3 at time t₁ of the first cycle of operation because the capacitors C1 and C3 are uncharged, but occurs progressively later in subsequent cycles. In these subsequent cycles, the recovery capacitor charges to progressively higher voltages as the circuit builds up to an operating, or run, mode.

### 9.5 Energy Recovery Circuit

FIG. 9C shows an effective circuit configuration for the energy recovery stage of circuit operation when switch S2 is opened at time t_{S2}, (S1 and S3 having earlier been opened at respective times t_{S1} and t_{S3}). The capacitors C1 and C3 are connected in series by the forward biased diode D7. Diodes D8 and D9 are reverse biased and non-conductive. This circuit configuration continues from time t_{S2} to time t₃. Current flowing from the inductive device L1 on collapse of the magnetic field forward biases diodes D1, D2 and D7 and charges capacitors C1 and C3, causing the current to fall.

When this falling inductive device current reaches zero, diodes D1, D2 and D7 become non-conductive, blocking discharge of the re-charged capacitors C1 and C3. This blocking holds the charge on capacitors C1 and C3 until the start of the next cycle at time t₃.

### 9.6 Start-Up Mode Magnetizing—Subsequent Cycles

On subsequent cycles during start-up operation, the capacitors C1 and C3 will already, at time t₁ have some charge from energy recovery from one or more previous cycles. If both recovery capacitors C1 and C3 have already charged to a voltage higher than the combined voltages of the two supplies V1 and V2, the circuit adopts the configuration shown in FIG. 9B from the beginning of the cycle at time t₁. The capacitors C1 and C3 discharge to provide magnetizing current which flows through closed switch S1, diode D10, inductive device L1, closed switch S2 and diode D6.

This current flow out of the capacitors C1 and C3 depletes the charge on the capacitors which decreases the voltage across the capacitors. When the voltage across the parallel connected capacitors C1 and C3 becomes insufficient to maintain the reverse bias on diode D3 and the forward bias on diodes D6 and D10, diode D3 conducts and diodes D6 and D10 become non-conducting to automatically convert the circuit to that shown in FIG. 8D so that magnetizing current continues to flow but only from the series connection of the supplies V1 and V2. This maintains the rising magnetizing current begun by discharge of the recovery capacitor C1.

The automatic conversion from the circuit configuration of FIG. 9B to that of FIG. 8D occurs progressively later in successive start-up cycles as the recovery capacitors C1 and C3 are charged to successively higher voltages and the circuit builds up to a fully operational run mode.

At supply switching time t_{S3} switch S3 is opened to disconnect supply V1 and lower the voltage supplied to the circuit to that of the supply V2 only. The circuit reverts back to that as shown in FIG. 9B because the voltage then remaining on the parallel-connected capacitors C1 and C3 is greater than the voltage of supply V2, making the diodes D6 and D10 forward biased and conductive, and diodes D1, D3 and D5 reverse biased and non-conductive. Capacitors C1 and C3 again discharge, to provide magnetizing current that flows through closed switch S1, diode D10, inductive device L1, closed switch S2 and diode D6.

When the voltage across the discharging capacitors C1 and C3 falls below the voltage of the supply V2, and therefore becomes insufficient to maintain the reverse bias on diodes D3 and D5, and the forward bias on diodes D6 and D10, diodes D3 and D5 conduct and diodes D6 and D10 become non-conductive, automatically converting the circuit to that shown in FIG. 8E. Magnetizing current continues to flow, but from the supply V2 only, through diode D3, inductive device L1, closed switch S2 and diode D5. This maintains the magnetizing current, at about the level already established by discharge of the recovery capacitors C1 and C3, until switch S2 is opened at time t_{S2}.

### 9.7 Run Mode Magnetizing

In the run mode, the magnetizing current for the inductive device L1 is predominantly derived from the discharge of the recovery capacitors C1 and C3 by the circuit of FIG. 9B.

At the start of the run mode cycle, at time t₁, the circuit adopts the configuration shown in FIG. 9B. The recovery capacitors C1 and C3 are already charged to a voltage higher than the combined voltages of the two supplies V1 and V2. Magnetizing current flows from the pre-charged and parallel-connected capacitors C1 and C3, through closed switch S1, diode D10, inductive device L1, closed switch S2 and diode D6.

When the voltage across the parallel-connected capacitors C1 and C3 falls below the combined voltage of the two supplies V1 and V2, and therefore becomes insufficient to maintain the reverse bias on diode D3 and the forward bias on diodes D6 and D10, diode D3 conducts and diodes D6 and D10 becomes non-conducting to automatically convert the circuit to that shown in FIG. 8D. This conversion interrupts discharge of the recovery capacitors and the voltage on the capacitors then remains at approximately equal to the combined voltage of the two supplies V1 and V2. Magnetizing current continues to flow, but from the two supplies V1 and V2 connected in series by closed switch S3, through diode D3, inductive device L1 and closed switch S2. The magnetizing current, begun by discharge of the recovery capacitors C1 and C3, but now supplied from the series-connected supplies V1 and V2, continues to rise until time t_{S3}.

At time t_{S3} switch S3 opens, removing the series connection between the two supplies V1 and V2, to effectively drop the supply voltage to that of supply V2 only. Diode D3 becomes reverse biased and non-conductive, diodes D6 and D10 become forward biased and conductive, and the circuit converts to that shown in FIG. 9B. Magnetizing current continues to flow from the parallel-connected capacitors C1 and C3, through closed switch S1, diode D10, inductive device L1, closed switch S2 and diode D6. Capacitors C1 and C3 discharge and the voltage on the parallel-connected capacitors falls from a voltage approximately equal to the combined voltage of supplies V1 and V2, down to a voltage approximately equal to supply V2.

When the voltage on the parallel-connected capacitors C1 and C3 falls below that of the supply V2, the circuit configuration converts from the first magnetizing circuit of FIG. 9B to the third magnetizing circuit of FIG. 8E. This maintains the magnetizing current at about the level already established by discharge of the recovery capacitors C1 and C3. The slope of the magnetizing current waveform over this period can be made positive, zero or negative by appropriate selection of the voltage of the supply V2. The supply V2 continues to provide magnetizing current through to the end of the magnetizing period at time t_{S2} when switch S2 opens.

### 9.8 Energy Recovery

FIG. 9C shows an effective circuit configuration for the energy recovery stage of circuit operation when switch S2 is opened at time t_{S2}. This corresponds to the energy recovery circuit of the eighth embodiment as shown in FIG. 8F. At time t_{S2}, the current through the inductive device L1 and the associated magnetic field begin to collapse. This configuration continues from time t_{S2} to time t₃.

The collapsing current flows from the inductive device L1 through diode D2 to series-connected capacitors C1 and C3, and back through diode D1 to inductive device L1. This current flows through the inductive device L1 in the same direction as the current used to establish the magnetic field (i.e. from left to right in FIG. 9C), but flows into the capacitors C1 and C3 in the opposite direction to the magnetizing current flowing from the capacitors during the magnetizing stage.

The flow of the induced current, from the inductive device back to the series-connected energy recovery capacitors C1 and C3, recharges the recovery capacitors to effectively transfer energy from the magnetic field to the recovery capacitors. This recovered energy is held as a charge on the capacitor C1 until the end of the cycle at time t₃ when it is used to re-establish the magnetic field during the magnetizing stage of the next cycle of operation.

### 9.9 Energy Transfer

When the capacitors C1 and C3 provide the magnetizing current for the inductive device L1 during the earlier part of the magnetizing stage, before magnetizing from the series connection of the supplies V1 and V2 takes over, the circuit is effectively the parallel-connected capacitors C1 and C3, series connected to inductive device L1, by switches S1 and S2 and diodes D6 and D10.

For optimum operation of the energy recovery circuit shown in FIG. 9A, the recovered energy stored as a charge on capacitors C1 and C3 must be efficiently transferred back to the magnetic field associated with the inductive device L1. Maximum transfer of energy from the capacitors back to the inductive device occurs when the voltage on the capacitors C1 and C3 has decreased from a maximum to zero, or near zero, and the current in the inductive device L1 has simultaneously risen from zero to a maximum. The time for this to occur is equal to a quarter of the period of natural resonance of the inductance-capacitance (L-C) circuit, which in this case is equal to 0.5π√(L1 CX), where CX is the effective capacitance of the parallel-connected capacitors C1 and C3, and is approximately equal to (C1+C3).

For optimum operation of the energy recovery circuit of FIG. 9A, the switch S1 is closed for each cycle of operation for a time that is not less than 0.5π√(L1 C1) to allow for optimum transfer of energy from the capacitors C1 and C3 to the inductive device L1.

The switch S1 is maintained closed after depletion of the charge on the capacitors C1 and C3 to extend the duration of the magnetizing current in the inductive device L1. During this extension period, the magnetizing current can be supplied from supply V2 alone, or from the combined supplies V1 and V2, to compensate for circuit losses.

For optimum operation of the energy recovery circuit shown in FIG. 9A, the energy from the magnetic field associated with the inductive device L1 must be efficiently transferred back to the recovery capacitors C1 and C3. Maximum transfer of energy from the magnetic field back to the capacitors occurs when the current flowing in the inductive device L1 has decreased to zero.

For optimum operation of the energy recovery circuit of FIG. 9A, the switches S1 and S2 are simultaneously open for each cycle of operation for a time that is no shorter than a quarter of the period of natural resonance of the inductance-capacitance (L-C) circuit, which in this case is approximately equal to 0.5π√(L1 C1 C3) (C1+C3), to allow for optimum transfer of energy from the inductive device L1 to the series-connected capacitors C1. The switches S1 and S2 are maintained opened after cessation of the current in the inductive device L1, while waiting on the re-closing of switches S1 and S2 to re-establish the magnetic field at the commencement of the next cycle.

### 9.10 Specific Embodiment

One specific embodiment of the circuit shown in FIG. 9A has the following circuit values:

S1, S2 and S3: IRFK20450

D1, D2, D3, D5, D6 and D10: RHRG30120

V1=40 volts

V2=8 volts

C1=120 μF

C3=120 μF

L1=36 mH (with an effective series resistance of 0.5 ohms)

Switching period t₁ to t₃=20 mS

Switching frequency=50 Hz

Switch S1 closed period t₁ to t_{S1}=5.5 mS

Switch S2 closed period t₁ to t_{S2}=7.0 mS

Switch S3 closed period t₁ to t_{S3}=4.0 mS

In this embodiment, for the 20 mS period of each cycle, the switch S3 is closed only over the first 4.0 mS, the switch S1 is closed only over the first 5.5 mS, and the switch S2 is closed only over the first 7.0 mS. Switch S2 is closed for 7 mS which is longer than one quarter of the natural resonance period of the parallel-connected capacitors C1 and C3 and inductive device L1, i.e. 0.5π√(L1 CX), which is equal to 4.6 mS. This allows time for the extension of the magnetizing current from the lower voltage supply V2 to occur.

In this embodiment, each of the recovery capacitors C1 and C3 is recharged at each recovery stage to approximately 113 volts, i.e. more than twice the combined voltage of supplies V1 and V2, after the first 10 cycles of operation, i.e. after 200 mS from starting.

### 9.11 Waveforms

In the run-mode of the specific ninth embodiment of the FIG. 9A circuit having the circuit values described in the immediately preceding paragraphs, the magnetizing current in the inductive device L1 rises to approximately 9.4 amperes over the first 5 mS of the magnetizing stage, is then maintained approximately constant for the remaining 2 mS of the magnetizing stage, and then falls to zero over the first 2.3 mS of the recovery stage to then remain at zero until the start of the next cycle. Currents of this waveform are suitable for running switched reluctance motors.

The recovery period, i.e. the period required for the current flowing in the inductive device to fall to zero in the recovery stage, is 2.3 mS in this ninth embodiment. This is significantly shorter than the 4.8 mS recovery period of the first specific version of the eighth embodiment as described above. This reduction is achieved by the effective series-connection of the two recovery capacitors C1 and C3 during the recovery stage.

### Tenth Embodiment

### 10.1 Circuit Layout

FIG. 10A is a circuit diagram illustrating a tenth embodiment of the invention. This is a variant of the second embodiment shown in FIGS. 2A to 2E. The circuit of FIG. 10A is a full wave AC configuration suitable for driving devices that require a sinusoidal waveform: for example AC synchronous reluctance motors, transformers and AC solenoids.

The FIG. 10A circuit comprises two H-bridge circuits each operating similarly to the H-bridge described above in the second embodiment. A first H-bridge circuit comprises controlled switches S1A and S4A and diode D1A in a first leg, and diode D2A, controlled switch S2A and diode D11A in a second leg. A second H-bridge circuit comprises controlled switches S1B and S4B and diode D1B in a first leg, and diode D2B, controlled switch S2B and diode D11B in a second leg. The two H-bridge circuits are connected to a common recovery capacitor C1, and a common supply section comprising DC supply V1, controlled switch S3, diodes D3 and D5, inductor L2 and reservoir capacitor C2. A common inductive device L1 is connected between the legs of each H-bridge.

The two H-bridge circuits are connected as shown in FIG. 10A to draw current from the common DC supply V1 and alternately drive magnetizing currents in opposite directions through the inductive device L1, to energise it with an alternating sinusoidal current. Magnetic field energy is recovered at each half cycle and stored on the common recovery capacitor C1 for use in establishing the magnetic field of opposite polarity on the next half cycle.

One H-bridge circuit comprises a first leg comprising controlled switches S1A and S4A, and diode D1A connected in series between an upper rail and a positive supply rail, and a second leg comprising diode D2A, controlled switch S2A and diode D11A connected in series between the upper rail and a negative supply rail. The second H-bridge circuit comprises a first leg comprising controlled switches S1B and S4B, and diode D1B connected in series between the upper rail and the positive supply rail, and a second leg comprising diode D2B, controlled switch S2B and diode D11B connected in series between the upper rail and the negative supply rail.

The circuit is operated by periodically switching the controlled switches S1A, S2A, S4A, S1B, S2B, S4B and S3 between open and closed states to achieve the effective circuit configurations shown in FIGS. 10C to 10H. The opening and closing of the switches S1A, S1B, S2A, S2B, S3, S4A and S4B are controlled by a common switch controller SC. Switches S1A, S2A and S4A control one H-bridge circuit. Switches S1B, S2B and S4B control the other H-bridge circuit. Switch S3 is operated to control the timing of the input of energy from supply V1 to the remainder of the circuit.

In general, the two H-bridge circuits of the tenth embodiment each operate similarly to that of the second embodiment as described above.

### 10.2 Switch Timing

FIG. 10B is a switch timing diagram for the controlled switches S1A, S2A, S4A, S1B, S2B, S4B and S4 showing one cycle of operation from time t₁ to time t₈. Switches S1A and S2A are operated synchronously over each cycle. Switches S1B and S2B are operated synchronously over each cycle. Switches S1A, S2A and S4A are closed only when S2A, S2B and S4B are open, and vice versa. S3 is closed when S4A is closed and S1A and S2A are open. S3 is also closed when S4B is closed and S1B and S2B are open.

The switches S1A, S2A and S4A are closed at time t₁ to arrange the circuit of FIG. 10A for a first magnetizing stage from time t₁ to time t₂. During this first magnetizing stage, current is driven through the inductive device L1 to establish a magnetic field of a first polarity. This magnetizing current flows through the inductive device L1 from left to right in the circuits shown in FIGS. 10A, 10C and 10D.

Switches S1A and S2A remain closed from time t₁ to time t₂ for a period that is approximately equal to 0.5π√(L1 C1).

The first magnetizing stage ends at time t₂ at which time switch S4A remains closed but switches S1A and S2A are opened to arrange the circuit of FIG. 10A for a first energy recovery stage during which a current induced in the inductive device L1 during collapse of the magnetic field charges capacitor C1. The switches S1A and S2A are kept open from time t₂ to time t₉. Switch S3 is closed at time t₃ and remains closed until time t₄ when switch S3 is opened.

The switches S1B, S2B and S4B are closed at time t₅ to arrange the circuit of FIG. 10A for a second magnetizing stage from time t₅ to time t₆. During this second magnetizing stage, current is driven through the inductive device L1 to establish a magnetic field of a second polarity opposite to the first field polarity. This magnetizing current flows through the inductive device L1 from right to left in the circuits shown in FIGS. 10A, 10F and 10G.

Switches S1B and S2B remain closed from time t₅ to time t₆ for a period that is approximately equal to 0.5π√(L1 C1).

The second magnetizing stage ends at time t₆ at which time switch S4B remains closed but switches S1B and S2B are opened to arrange the circuit of FIG. 10A for a second energy recovery stage during which a current induced in the inductive device L1 during collapse of the magnetic field charges capacitor C1. The switches S1B and S2B are kept open after time t₆. Switch S3 is closed at time t₇ and remains closed until time t₈.

Switches S1A, S2A and S4A are closed at time t₉ to arrange the circuit of FIG. 10A for the next magnetizing stage. The operating cycle is repeated with a repetition period equal to (t₉−t₁).

### 10.3 First Magnetizing Circuit

FIG. 10C shows a first effective circuit for the first magnetizing stage of circuit operation when switches S1A, S2A and S4A are closed and switches S1B, S2B, S3 and S4B are open. This circuit applies during the magnetizing stage when diode D1A is non-conductive, i.e. when the voltage on capacitor C1 is sufficient to reverse bias diode D1A.

### 10.4 Second Magnetizing Circuit

FIG. 10D shows a second effective circuit for the first magnetizing stage of circuit operation when switches S1A, S2A and S4A are closed and switches S1B, S2B, S3 and S4B are open. This circuit applies when the voltage across the recovery capacitor C1 is insufficient to reverse bias diode D1A, and diode D1A becomes forward biased and conductive to effectively bypass the capacitor C1. Magnetizing current from the power supply reservoir capacitor C2 then flows through diode D1A, closed switch S4A, inductive device L1 (from left to right in FIG. 10D), and through closed switch S2A and diode D11A to contribute to the establishment of the magnetic field of first polarity in association with the inductive device L1.

### 10.5 Third Magnetizing Circuit

FIG. 10F shows a third effective circuit for a second magnetizing stage of circuit operation when switches S1B, S2B and S4B are closed and switches S1A, S2A, S3 and S4A are open. Current flows from the series combination of supply reservoir capacitor C2 and recovery capacitor C1, through closed switch S1B, inductive device L1 (from right to left in FIG. 10F), closed switch S2B and diode D11B, to establish a magnetic field of a second (and opposite) polarity in association with the inductive device. This circuit applies during the second magnetizing stage when diode D1B is non-conductive, i.e. when the voltage on recovery capacitor C1 is sufficient to reverse bias diode D1B.

### 10.6 Fourth Magnetizing Circuit

FIG. 10G shows a fourth effective circuit for the second magnetizing stage of circuit operation when switches S1B, S2B and S4B are closed and switches S1A, S2A, S3 and S4A are open. This circuit applies when the voltage across the recovery capacitor C1 is insufficient to reverse bias diode D1B, and diode D1B becomes forward biased and conductive to effectively bypass the recovery capacitor C1. Magnetizing current from the power supply reservoir capacitor C2 then flows through diode D1B, closed switch S4B, inductive device L1 (from right to left in FIG. 10G), and through closed switch S2B and diode D11B to contribute to the establishment of the magnetic field of second polarity in association with the inductive device L1.

### 10.5 Magnetizing Circuit Conversion

The conversion of the magnetizing circuit of FIG. 10C to that of FIG. 10D occurs automatically when there is insufficient charge on the recovery capacitor to supply all the magnetizing current for the full magnetizing period and particularly when the voltage on recovery capacitor C1 is insufficient to reverse bias diode D1A. This occurs immediately on first closing switches S1A and S2A at time t₁ of the first cycle of operation, because recovery capacitor C1 is initially not charged, but occurs later in subsequent cycles. In these subsequent cycles, the recovery capacitor can charge to progressively higher voltages as the circuit builds up to an operating mode.

The conversion of the magnetizing circuit of FIG. 10 to that of FIG. 10G occurs automatically when the voltage on recovery capacitor C1 is insufficient to reverse bias diode D1B. This occurs soon after the first closing of switches S1B and S2B at t₅ of the first cycle of operation, because recovery capacitor C1 is partially charged during the first recovery stage of the first cycle (from time t₂ to time t₄), and occurs later in subsequent cycles as the circuit runs up to a run mode.

By the circuit configurations of FIGS. 10D and 10G, energy from the supply V1 stored on reservoir capacitor C2 is connected directly to provide magnetizing current to the inductive device L1 during a substantial part of the magnetizing stages during start-up.

### 10.6 First Energy Recovery Circuit

FIG. 10E shows an effective circuit configuration for the first energy recovery stage of circuit operation when switches S1A and S2A are both opened at time t₂. This configuration continues from time t₂ to time t₄. During this first recovery stage, energy from the magnetic field of first polarity is recovered and used to charge the recovery capacitor C1. Current flowing from the inductive device L1 on collapse of the magnetic field of first polarity forward biases diodes D1A and D2A and charges capacitor C1, causing the current to fall.

When this falling inductive device current reaches zero, diodes D1A and D2A become non-conductive, blocking discharge of the re-charged capacitor C1. This blocking holds the charge on capacitor C1 until required for establishment of the magnetic field of second polarity at time t₅.

### 10.7 Second Energy Recovery Circuit

FIG. 10H shows an effective circuit configuration for the second energy recovery stage of circuit operation when switches S1B and S2B are both opened at time t₆. This configuration continues from time t₆ to time t₈. During second recovery stage, energy from the magnetic field of second polarity is recovered and used to charge the recovery capacitor C1. Current flowing from the inductive device L1 on collapse of the magnetic field of second polarity forward biases diodes D1B and D2B and charges capacitor C1, causing the current to fall.

When this falling inductive device current reaches zero, diodes D1B and D2B become non-conductive, blocking discharge of the re-charged capacitor C1. This blocking holds the charge on capacitor C1 until required for next establishing the magnetic field of first polarity at time t₁ in the next cycle.

Although energy is being recovered from magnetic fields of opposite polarity in the first and second energy recovery stages, in each case the charging current flows into the recovery capacitor C1 in the same direction.

### 10.8 Start-Up Mode Magnetizing

In start-up mode, the two H-bridges of the tenth embodiment operate alternately to provide the inductive device with an alternating magnetizing current to establish a magnetic field of alternating polarity. Each H-bridge operates similarly to that of the second embodiment as described above.

### 10.9 Run Mode Magnetizing

In the run mode, the magnetizing current for the inductive device L1 is predominantly derived from the discharge of capacitor C1 in series with capacitor C2 by the circuit of FIG. 10C.

In the run mode, during a first substantial part of the first magnetizing stage from time t₁ to time t₂, the series combination of recovery capacitor C1 and the reservoir capacitor C2 is connected to discharge through closed switch S1A to provide a current flow though inductive device L1 (from left to right in FIG. 10C), and through closed switch S2A and diode D11A, to re-establish the magnetic field of first polarity in association with the inductive device L1.

If the falling voltage on capacitor C1 is no longer sufficient to reverse bias diode D1A, diode D1A conducts and magnetizing current in the inductive device L1 can be maintained by current flowing from the reservoir capacitor C2 through diode D1A, closed switch S4A, inductive device L1, closed switch S2A and diode D11A, as seen in the circuit of FIG. 10D. This continues the magnetizing current in the inductive device L1 with energy stored on supply reservoir capacitor C2. This replenishment occurs automatically upon depletion of the capacitor C1 and makes up for losses in the circuit.

During a first substantial part of the second magnetizing stage from time t₅ to time t₆, the series combination of recovery capacitor C1 and the reservoir capacitor C2 is connected to discharge through closed switch S1B to provide a current flow though inductive device L1 (from right to left in FIG. 10F), and through closed switch S2B and diode D11B, to re-establish the magnetic field of second polarity in the inductive device L1.

If the voltage on capacitor C1 is no longer sufficient to reverse bias diode D1B, diode D1B conducts and magnetizing current in the inductive device L1 can be maintained by current flowing from the reservoir capacitor C2 through diode D1B, closed switch S4B, inductive device L1 (from right to left in FIG. 10G), closed switch S2B and diode D11B. This continues the magnetizing current in the inductive device L1 using energy stored on supply reservoir capacitor C2. This replenishment occurs automatically upon depletion of the capacitor C1 and makes up for losses in the circuit.

### 10.10 Energy Recovery

FIG. 10E shows an effective circuit configuration for the first energy recovery stage of circuit operation when switches S1A and S2A are both opened at time t₂. This circuit configuration continues from time t₂ to time t₄. Just before time t₂, current has been flowing through the inductive device L1 (from left to right in FIGS. 10C and 10D). At time t₂ this current and the associated magnetic field of first polarity begin to collapse.

The collapsing current flows from the inductive device L1 through diode D2A to capacitor C1 and back through diode D1A and closed switch S4A to inductive device L1. This current flows through the inductive device L1 in the same direction (left to right) as the current used to establish the magnetic field of first polarity that is collapsing, but flows into the capacitor C1 in the opposite direction to the magnetizing current flowing from the capacitor C1 during the first magnetizing stage.

The flow of the induced current, from the inductive device L1 back to the capacitor C1, recharges the capacitor to effectively transfer energy from the magnetic field of first polarity to the capacitor C1. This recovered energy is used to re-establish the magnetic field of second polarity during the second magnetizing stage of the same cycle of operation.

FIG. 10H shows an effective circuit configuration for the second energy recovery stage of circuit operation when switches S1B and S2B are both opened at time t₆. This circuit configuration continues from time t₆ to time t₈. Just before time t₆, current has been flowing through the inductive device L1 (from right to left in FIGS. 10F and 10G). At time t₆ this current and the associated magnetic field of second polarity begin to collapse.

The collapsing current flows from the inductive device L1 through diode D2B to capacitor C1 and back through diode D1B and closed switch S4B to inductive device L1. This current flows through the inductive device L1 in the same direction (right to left) as the current used to establish the magnetic field of second polarity that is collapsing, but flows into the capacitor C1 in the opposite direction to the magnetizing current flowing from the capacitor C1 during the second magnetizing stage.

The flow of the induced current, from the inductive device L1 back to the capacitor C1, recharges the capacitor to effectively transfer energy from the magnetic field of second polarity to the capacitor C1. This recovered energy is used to re-establish the magnetic field of first polarity during the first magnetizing stage of the next cycle of operation.

Substantially simultaneously with each energy recovery stage of each cycle, controlled switch S3 is closed to connect supply V1 through closed switch S3, diode D3 and inductor L2, to reservoir capacitor C2. This injects energy from the supply V1 into capacitor C2. Switch S3 is closed in each cycle from time t₃ to time t₄ and from time t₇ to time t₈, to be closed substantially simultaneously with both the first and second energy recovery stages.

### 10.11 Voltage Multiplication

As with the previously-described embodiments, the capacitor C1 is charged on initial start-up, in the first and second energy recovery stages of each of the first few successive cycles of circuit operation, to progressively higher voltages. After only a few cycles of operation the capacitor C1 is recharged at each recovery stage to several times the supply voltage. The magnetizing current in the inductive device, which is driven from this capacitor voltage in series with the voltage on reservoir capacitor C2, peaks at progressively higher amplitudes over the first few cycles of circuit operation at start-up, as may be appreciated from the current waveform shown in FIG. 10I.

The recovery of energy from the collapsing magnetic field at each half cycle and its re-use to re-establish the field in next half cycle effectively multiplies the voltage from which the inductive device is driven to provide a significant improvement in efficiency. The voltage multiplication process is similar to the transient charging phase of a resonant inductance-capacitance (L-C) circuit.

### 10.12 Energy Transfer

The reservoir capacitor C2 has a capacitance that is many times greater than that of capacitor C1, giving the series combination of capacitors C1 and C2 an effective capacitance value substantially equal to that of capacitor C1. When the capacitors C1 and C2 are together providing the magnetizing current for the inductive device L1 during the earlier part of each magnetizing stage (as in the circuits of FIGS. 10C and 10F), before magnetizing from the reservoir capacitor C2 alone takes over (as in the circuits of FIGS. 10D and 10G), the circuit is effectively capacitor C1 series connected to inductor L1 by switches S1A and S2A and diode D11A, or switches S1B and S2B and diode D11B.

For optimum operation of the energy recovery circuit shown in FIG. 10A, the recovered energy stored as a charge on capacitor C1 must be efficiently transferred back to the magnetic field associated with the inductive device L1. Maximum transfer of energy from the capacitor back to the inductive device occurs when the voltage on the capacitor C1 has decreased from a maximum to zero and the current in the inductive device L1 has simultaneously risen from zero to a maximum. The time for this to occur is equal to a quarter of the period of natural resonance of the inductance-capacitance (L-C) circuit, which in this case is approximately equal to 0.5π√(L1 C1).

For optimum operation of the energy recovery circuit of FIG. 10A, the three switches S1A, S2A and S4A and the three switches S1B, S2B and S4B, are respectively closed for the magnetizing stages in each cycle of operation for a time that is approximately equal to 0.5π√(L1 C1) to allow for optimum transfer of energy from the capacitor C1 to the inductive device L1.

The switches can be maintained closed after depletion of the charge on capacitor C1 to extend the duration of the magnetizing current in the inductive device L1. During this extension period, the magnetizing current is supplied from the reservoir capacitor C2 (charged from supply V1).

For optimum operation of the energy recovery circuit shown in FIG. 10A, the energy from the magnetic field associated with the inductive device L1 must be efficiently transferred back to the recovery capacitor C1. Maximum transfer of energy from the magnetic field back to the capacitor occurs when the current flowing in the inductive device L1 has decreased to zero.

For optimum operation of the energy recovery circuit of FIG. 10A, the switch S4A is closed and switches S1A and S2A are open, and then the switch S4B is closed and switches S1B and S2B are open, for the respective recovery stages of each cycle of operation for times that are each no shorter than a quarter of the period of natural resonance of the inductance-capacitance (L-C) circuit, which in this case is equal to 0.5π√(L1 C1), to allow for optimum transfer of energy from the inductive device L1 to the capacitor C1. The switches S1A, S2A, S1B and S2B, are kept opened after cessation of the current in the inductive device L1, while waiting on the closing of switches S1B and S2B at time t₅ to establish the magnetic field of second polarity, and while waiting on the closing of switches S1A and S2A to re-establish the magnetic field of first polarity at the commencement of the next cycle.

At near optimum operation, the contrast between the shorter duration of the run mode supply current pulses shown in the upper waveform of FIG. 10JG and the longer duration of the run mode inductive device current pulses shown in the lower waveform of FIG. 10J is clearly apparent.

### 10.13 Specific Embodiment

One specific embodiment of the circuit shown in FIG. 10A has the following circuit values:

S1A, S1B, S2A, S2B, S3, S4A, S4B: IRFK4HE50

D1A, D1B, D2A, D2B, D3, D5, D11A and D11B: RHRG30120

V1=48 volts

C1=250 μF

C2=20 mF

L1=36 mH (with an effective series resistance of 1.0 ohm)

L2=1 mH

Switching period t₁ to t₉=20 mS

Switching frequency=50 Hz

Magnetizing periods t₁ to t₂ and t₅ to t₆=4.9 mS

Recovery periods t₂ to t₄ and t₆ to t₈=5.0 mS

Supply injection periods t₃ to t₄ and t₇ to t₈=4.9 mS

On first powering the circuit, there is preferably a delay, e.g. a 60 S delay, while the supply input, under control of switch S3, charges the supply reservoir capacitor C2. Any other suitable supply inrush control technique can be used.

A small dead time (typically 0.1 mS in the specific embodiment) is provided in the circuit timing for the crossover between the positive and negative cycles. This ensures that all winding currents have fallen to zero before the next switching takes place.

### 10.14 Waveforms

FIGS. 10I and 10J show typical simulated waveforms of currents for the specific tenth embodiment of the circuit shown in FIG. 10A. The upper waveforms show typical waveforms for supply current delivered from the reservoir capacitor C2 to the remainder of the circuit (i.e. to the right of capacitor C2 as seen in FIG. 10A). The lower waveforms show typical waveforms for current flowing in the inductive device L1. FIG. 10I shows waveforms over several cycles during start-up. FIG. 10J shows waveforms over several run-mode cycles.

In the run-mode of the specific tenth embodiment of the FIG. 10A circuit having the circuit values described above, the magnetizing current in the inductive device L1 is close to a sinusoidal 50 Hz AC waveform, as can be seen in the lower waveforms of FIGS. 10I and 10J. The first and third quarters of each cycle of the near-sinusoidal current in the inductive device L1 flows from the reservoir capacitor C2, as can be seen from the upper waveform. This current also flows through the recovery capacitor C1. This magnetizing current is thus supplied by the effective series connection of the reservoir and recovery capacitors. In the run-mode, the reservoir capacitor C2 is charged to a voltage of about 48 volts, i.e. the supply voltage, and the recovery capacitor C1 is charged during the recovery stage of each half cycle to about 330 volts and is substantially discharged completely, i.e. to zero volts, during the magnetizing stage of each half cycle.

### 10.15 Specific Application of Tenth Embodiment

In one specific application, the circuit shown in FIG. 10K is used to drive a low frequency induction heater demonstrator. The induction heater work coil is wound on a laminated 55×85 mm ‘E’ core with a stack width of 38 mm. The induction heater was tested with an 85×38×6.5 mm copper block placed on the open ‘E’ core stack to provide the induction heating load.

The inductance of the work coil is 17 mH and its resistance is 0.8 ohm.

The induction heater is driven by the circuit shown in FIG. 10K in which the inductance and resistance of the winding is represented by L112 and R111, respectively. The recovery capacitor C112 is a 150 μF metallized polypropylene, pulse grade capacitor. The natural resonance period of the winding inductance L112 and the recovery capacitor C112 is 10 mS. The magnetizing and recovery periods, described below, are each 2.4 mS which is approximately equal to one quarter of this natural resonance period.

The circuit of FIG. 10K is operated similarly to the tenth embodiment described above with switch timing as described above in section 10.2 ‘Switch timing’, with reference to FIG. 10B. FET switches S111, S112, S113, S114, S115, S116 and S117 are controlled through respective gate drivers by a common switch controller SC to switch alternately between closed and open states in a manner corresponding to the switching pattern shown in FIG. 10B and described above for respective switches S3, S1A, S4A, S2B, S2A, S1B and S4B. The switching pattern is repeated at a repetition frequency of 100 Hz to provide the work coil with a sinusoidal 100 Hz AC current with a waveform shape substantially as shown in the lower waveform of FIG. 10J. The FET switches are operated to provide, in turn:
a first magnetizing period of 2.4 mS, during which the recovery capacitor is discharged in a first direction into the heater coil;,
a first recovery period of 2.4 mS, during which energy from the collapsing first magnetic field is returned to the capacitor;
a pause of 0.2 mS at the changeover between positive-going and negative-going half cycles of the alternating polarity coil current;
a second magnetizing period of 2.4 mS, during which the recovery capacitor is discharged in a second opposite direction into the heater coil;
a second recovery period of 2.4 mS, during which energy from the collapsing second magnetic field is returned to the capacitor; and
a pause of 0.2 mS at the changeover between negative-going and positive-going half cycles of the alternating polarity coil current.

The SC switch controller uses CMOS logic circuits. The FET switches are driven by 2 kV isolated NME1215S DC to DC supplies driving through HCPL 3120 opto-isolated gate drivers. The seven FET switches S111 to S117 are 20N60C3, 20 A, 600 V, TO220 case. The eight diodes D111 to D118 are RHR 30 A, 600 V, TO220 case. The switch controller SC uses CMOS logic circuits. The 29 volts supply is stepped down to 12 volts by a Treco Ten-5 or -6 series DC to DC voltage converter to supply the CMOS logic and FET gate drive circuits.

The circuit is supplied from a 29 volt DC supply or battery V111. In an optional arrangement, not shown, the supply V111 is connected to a reservoir capacitor (for example, 22 mF) through a series inductor (for example, 5 mH) and the remainder of the circuit, and particularly high pulse currents, are supplied from the reservoir capacitor.

When the circuit was supplied with 51 Watts from a 29 volt DC supply V111 at a mean current of 1.76 A, the copper block was heated from 22.4° C. to 50.7° C. in 2.5 minutes with a current of 4.0 A rms flowing in the work coil. The waveform of the current in the heater coil was very close to a full wave sinusoid.

Use of the invention in this specific application allows the induction heater to be driven with significantly higher currents using the same supply voltage. In one arrangement, the induction heater drew a mean supply current of 0.51 A and provided a temperature increase in a copper test block from 22.5° C. to 29.6° C. in 5 minutes when energy recovered from the work coil was returned to the supply in a conventional circuit topology. This results in a rate of temperature change of 0.024° C./second. This same arrangement drew a mean supply current of 1.76 A and provided a temperature increase in the same copper test block from 22.4° C. to 50.7° C. in 2.5 minutes when using the circuit of FIG. 10K in which energy recovered from the winding inductance L112 and stored on capacitor C112 was connected in series with the supply reservoir capacitor C111 to deliver the next magnetizing current cycle to the induction coil at a voltage higher than that of the supply V111. This results in a rate of temperature change of 0.188° C./second.

In comparing the operation of the two circuits, the use of the circuit embodiment in FIG. 10K results in a 7.8 times increase in rate of change of temperature for only a 3.4 times increase in power to the circuit. Using the standard measure of induction heating performance based on the square of the work coil current, the heating ability of the circuit increases by at least 7.8 times for only a 3.4 times increase in input power.

### Eleventh Embodiment

### 11.1 Circuit Layout

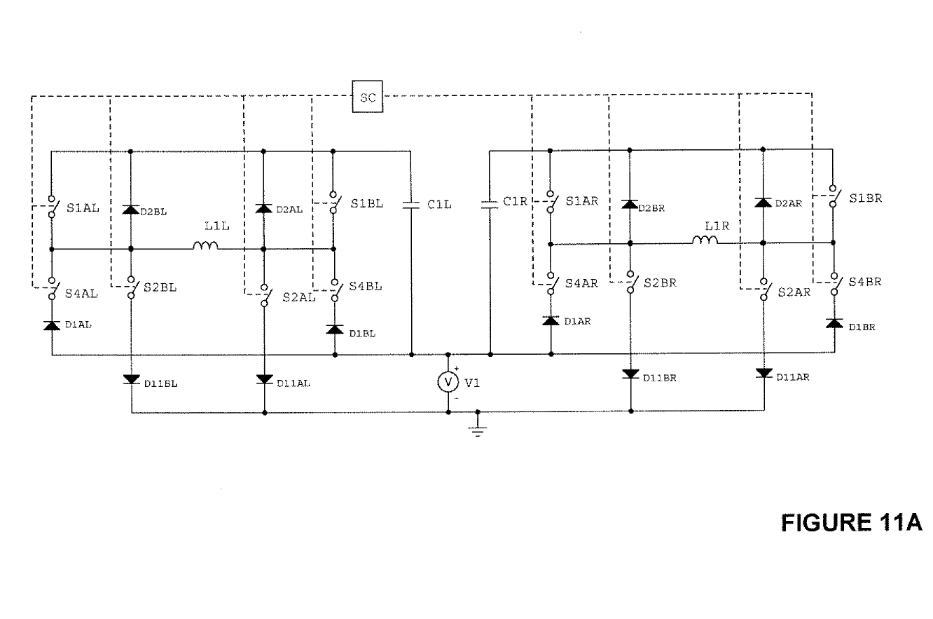

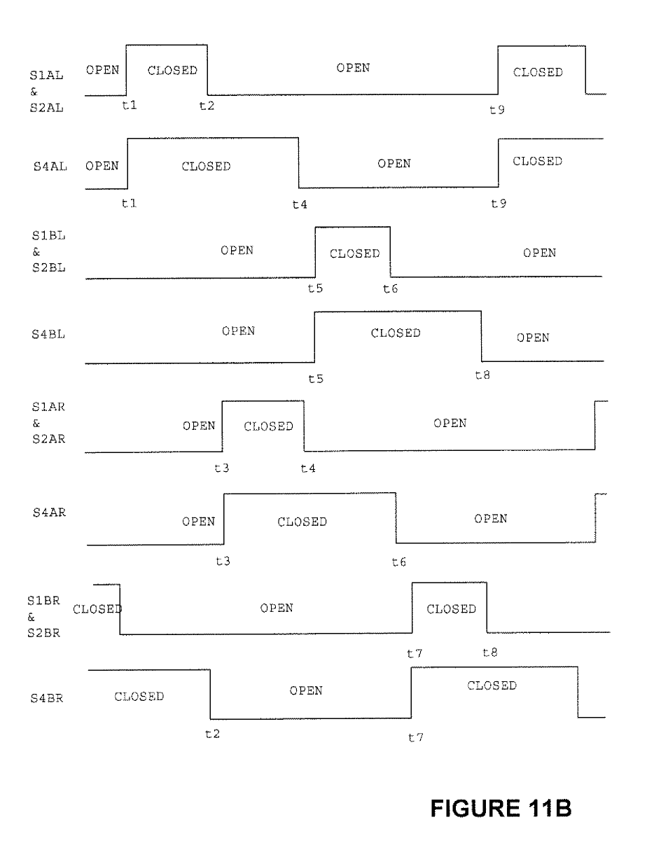

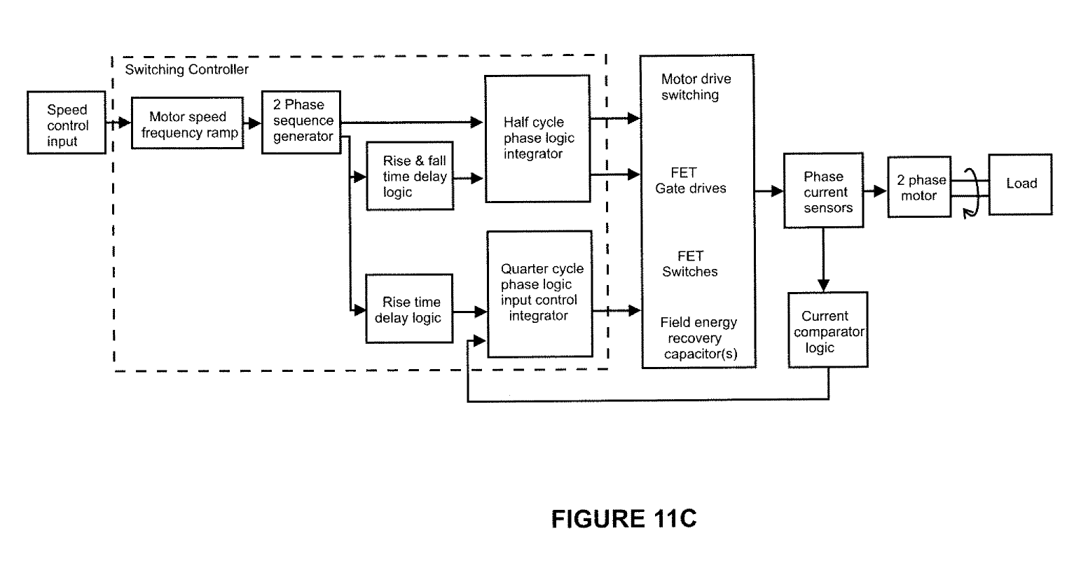

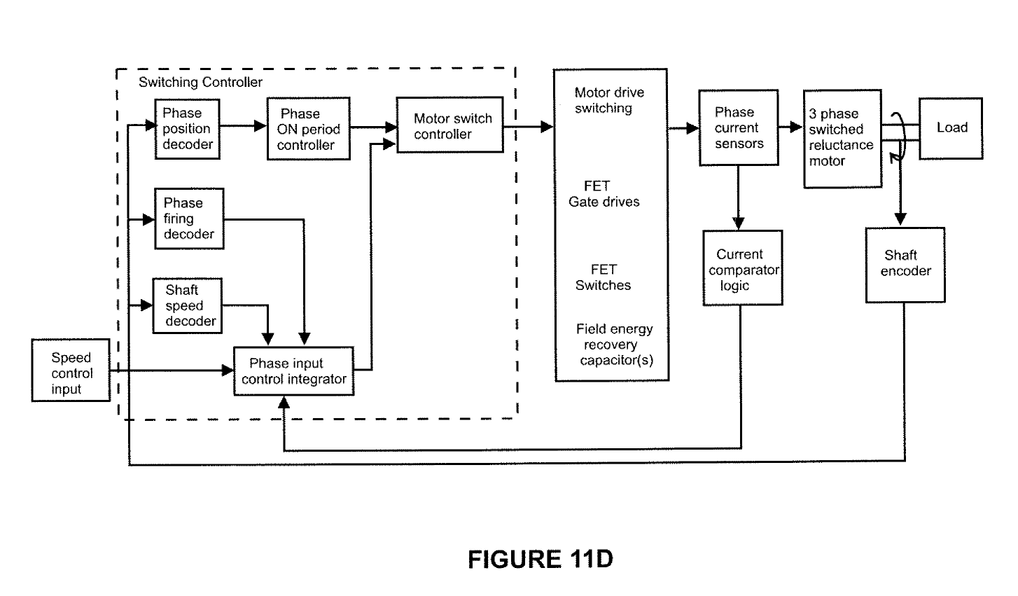

FIG. 11A is a circuit diagram illustrating an eleventh embodiment of the invention. This is a variant of the second embodiment shown in FIGS. 2A to 2E. The FIG. 11A circuit comprises two pairs of H-bridge circuits. Each pair of H-bridge circuits drives a respective inductive device L1L or L1R. Each of the four H-bridge circuits operates similarly to the H-bridge described above in the second embodiment. The circuit of FIG. 11A is a two phase, full wave, AC configuration suitable for driving two phase devices that require sinusoidal waveforms: for example two phase AC synchronous reluctance motors, transformers and AC solenoids.

The left side of FIG. 11A shows a left pair of H-bridge circuits connected to a common inductive device L1L. A first H-bridge circuit of the left pair comprises controlled switches S1AL and S4AL and diode D1AL in a first leg, and diode D2AL, controlled switch S2AL and diode D11AL in a second leg. A second H-bridge circuit of the left pair comprises controlled switches S1BL and S4BL and diode D1BL in a first leg, and diode D2BL, controlled switch S2BL and diode D11BL in a second leg. The two H-bridge circuits of the left pair are connected to a common recovery capacitor C1L. A common inductive device L1L is connected between the legs of each of the left pair of H-bridges.

The right side of FIG. 11A shows a right pair of H-bridge circuits connected to a common inductive device L1R. A first H-bridge circuit of the right pair comprises controlled switches S1AR and S4AR and diode D1AR in a first leg, and diode D2AR, controlled switch S2AR and diode D11AR in a second leg. A second H-bridge circuit of the right pair comprises controlled switches S1BR and S4BR and diode D1BR in a first leg, and diode D2BR, controlled switch S2BR and diode D11BR in a second leg. The two H-bridge circuits of the right pair are connected to a common recovery capacitor C1R. A common inductive device L1R is connected between the legs of each of the right pair of H-bridges.

The left and right pairs of H-bridge circuits are supplied from a common DC supply V1.

The two pairs of H-bridge circuits are connected as shown in FIG. 10A to draw current from the common DC supply V1 and drive alternating sinusoidal magnetizing currents through each of the inductive devices L1L and L1R. In each of the left and right pairs of H-bridge circuits, energy is recovered at each half cycle from the magnetic field and stored on the respective common recovery capacitor C1L and C1R for use in establishing the magnetic field of opposite polarity in the respective inductive device L1L and L1R on the next half cycle.

### 11.2 Switch Timing

An application for this circuit is a two phase AC drive, for example for driving a two phase motor. The switches of the two pairs of H-bridge circuits are operated at the same switching frequency, for example 50 Hz, but with the switching signals of one pair of H-bridge circuits delayed by one quarter cycle. For example, where the switching frequency is 50 Hz, the switching cycle period is 20 mS and the switching signals of one pair of H-bridge circuits are delayed by 5 mS. The opening and closing of the switches S1AL, S2AL, S4AL, S1BL, S2BL, S4BL, S1AR, S2AR, S4AR, S1BR, S2BR and S4BR are controlled by a common switch controller SC through respective gate drivers.

FIG. 11B is a switch timing diagram for the controlled switches S1AL, S2AL, S4AL, S1BL, S2BL, S4BL, S1AR, S2AR, S4AR, S1BR, S2BR and S4BR, showing one cycle of operation from time t₁ to time t₉.

### 11.3 Waveforms

The four quarters of the sinusoidal alternating current in the first inductive device L1L are provided by controlling the switches as described below.
1. Switches S1AL, S2AL and S4AL are closed from time t₁ to time t₂ to provide inductive device L1L with a magnetizing current of a first polarity provided by discharging capacitor C1L. This is the first quarter of the sinusoidal current in the inductive device L1L.
2. Switches S1AL and S2AL are opened while S4AL remains closed from time t₂ to time t₄ to allow current induced by the collapsing magnetic field to flow back into the capacitor C1L. The current collapses back to zero to provide the second quarter of the sinusoidal current in the inductive device L1L.
3. Switches S1BL, S2BL and S4BL are closed from time t₅ to time t₆ to provide inductive device L1L with a magnetizing current of opposite polarity provided by discharging capacitor C1R. This is the third quarter of the sinusoidal current in the inductive device L1L.
4. Switches S1BL and S2BL are opened while S4BL remains closed from time t₆ to time t₈ to allow current induced by the collapsing magnetic field to flow back into the capacitor C1L. The current collapses back to zero to provide the fourth quarter of the sinusoidal current in the inductive device L1L.

The four quarters of the sinusoidal alternating current in the second inductive device L1R are provided by controlling the switches as described below.
1. Switches S1AR, S2AR and S4AR are closed from time t₃ to time t₄ to provide inductive device L1R with a magnetizing current of a first polarity provided by discharging capacitor C1R. This is the first quarter of the sinusoidal current in inductive device L1R and occurs simultaneously with the second quarter of the sinusoidal current in inductive device L1L.
2. Switches S1AR and S2AR are opened while S4AR remains closed from time t₄ to time t₆ to allow current induced by the collapsing magnetic field to flow back into the capacitor C1R. The current collapses back to zero to provide the second quarter of the sinusoidal current in inductive device L1R. This second quarter occurs simultaneously with the third quarter of the sinusoidal current in inductive device L1L.
3. Switches S1BR, S2BR and S4BR are closed from time t₇ to time t₈ to provide inductive device L1R with a magnetizing current of opposite polarity provided by discharging capacitor C1R. This is the third quarter of the sinusoidal current in inductive device L1R and occurs simultaneously with the fourth quarter of the sinusoidal current in inductive device L1L.

Switches S1BR and S2BR are opened while S4BR remains closed from time t₈ to time t₂ of the next cycle to allow current induced by the collapsing magnetic field to flow back into the capacitor C1R. The current collapses back to zero to provide the fourth quarter of the sinusoidal current in inductive device L1R. This fourth quarter occurs simultaneously with the first quarter of the sinusoidal current in inductive device L1L.

### 11.4 Specific Application of Eleventh Embodiment

FIG. 11C shows a block diagram of an application of the eleventh embodiment of the invention for driving a two phase motor. The block labelled ‘Motor drive switching’ in FIG. 11C is the switching circuit of FIG. 11A. This circuit drives a two phase motor (the windings of which are represented in FIG. 11A by inductors L1L and L1R) via phase winding current sensors. The motor drive switching block also includes FET switches, FET gate drives, and field energy recovery capacitors.

The FET switches are shown in FIG. 11A as switches S1AL, S1BL, S2Al, S2BL, S4AL, S4BL, S1AR, S1BR, S2AR, S2BR, S4AR and S4BR.

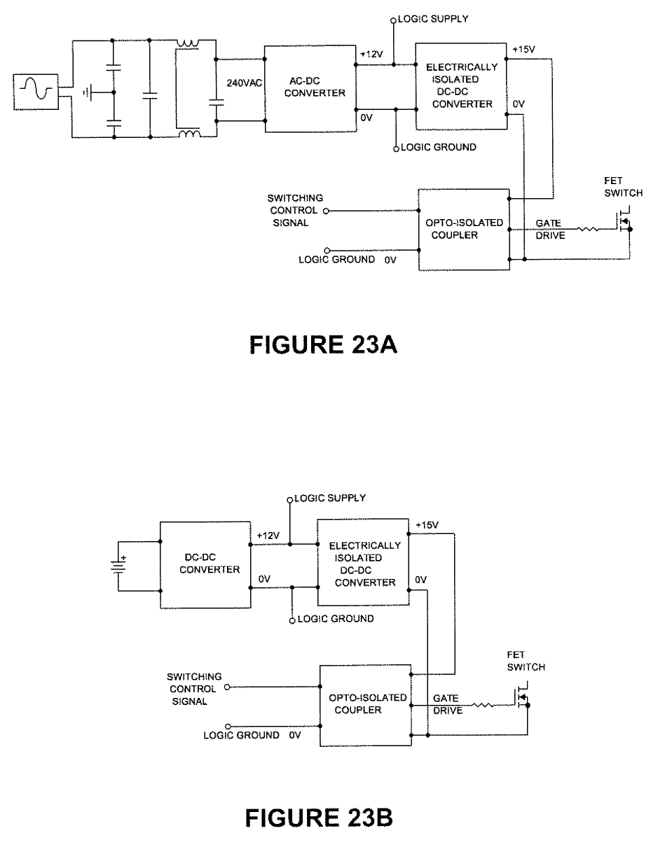

Suitable FET gate drives (not shown in FIG. 11A) are described below in Section 23 and shown in FIGS. 23A and 23B.

The field energy recovery capacitors are shown in FIG. 11A as capacitors C1L and C1R.

The switching controller (outlined in FIG. 11C by a broken line) is shown in FIG. 11A as switching controller SC.

A speed control input signal is fed to the switching controller. A motor speed frequency ramp is generated and converted to a two phase sequence of switching signals. Signal transitions are delayed to control the rise and fall times of the motor drive switching control signals. Logic blocks generate half cycle and quarter cycle control signals for connection, via FET gate drives, to the FET switches in the motor drive switching block.

Sensed phase winding currents are compared with predetermined values and the FET switches controlled to maintain winding currents within predetermined ranges.

### 11.5 Specific Application of Adaptation of Eleventh Embodiment

FIG. 11D shows a block diagram of an application of an adaptation of the eleventh embodiment of the invention for driving a three phase switched reluctance motor.

In FIG. 11D, the block labelled ‘Motor drive switching’ is a three phase adaptation of the two phase switching circuit of FIG. 11A. This circuit drives a three phase motor via phase winding current sensors. The motor drive switching block also includes FET switches, FET gate drives, and field energy recovery capacitors corresponding to those described above with reference to FIG. 11C.

The switching controller is outlined in FIG. 11D by a broken line. In addition to the sensing of phase winding currents and other features already discussed with reference to FIG. 11C, the application of the current invention for driving a three phase switched reluctance motor, as shown in FIG. 11D, also incorporates a shaft position encoder to synchronize the motor winding switching signals with the position and direction of rotation of the motor shaft.

### Twelfth Embodiment

### 12.1 Circuit Layout

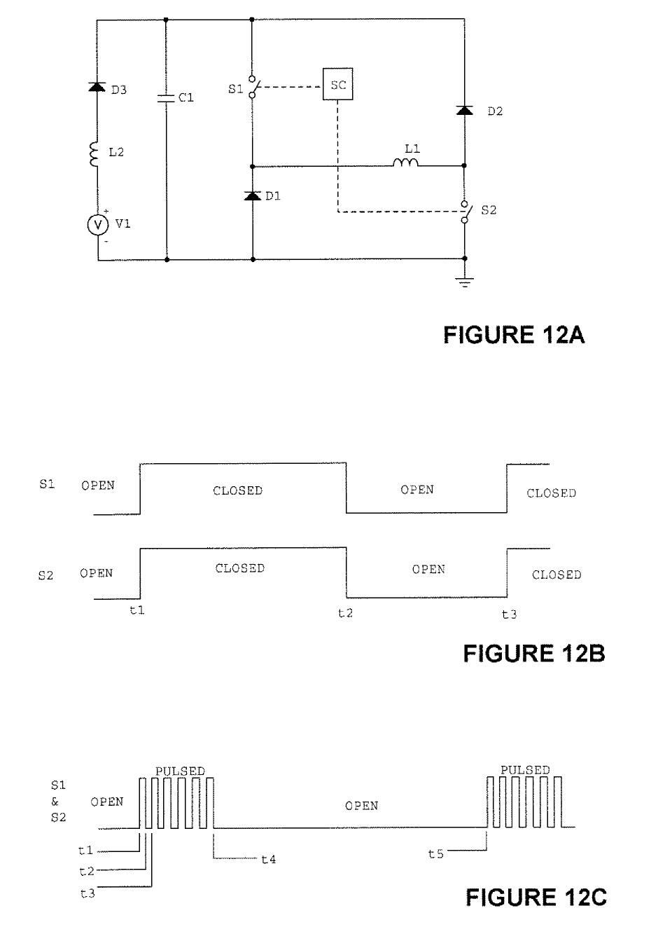

FIG. 12A is a circuit diagram illustrating a twelfth embodiment of the invention. The circuit layout is identical to that of the first embodiment shown in FIG. 1A. The FIG. 12A circuit is operated by periodically switching the controlled switches S1 and S2 between open and closed states under control of a common switch controller SC. However, the circuit of FIG. 12A circuit is operated in a manner differing from that of the first embodiment described above. In the twelfth embodiment, the switches are repetitively switched between a pulsed state and a continuously open state. In the pulsed state, the switches are rapidly switched between open and closed states to achieve the effective circuit configurations shown in FIGS. 1C to 1F and operating as described above for the first embodiment.

This technique allows low frequency solenoids to be driven at a higher frequency. The spaced apart groups of pulses create an effective lower frequency drive while using practical inductor winding volumes. These circuits are also effective at accommodating the change in inductance that occurs with closing solenoids.

### 12.2 Switch Timing

FIGS. 12B and 12C are switch timing diagrams for the controlled switches S1 and S2. The time scales in FIGS. 12B and 12C are different. FIG. 12B shows one minor pulse cycle from time t₁ to time t₃. Switches S1 and S2 are operated synchronously over each minor pulse cycle by the switch controller SC, being closed for a magnetizing stage from time t₁ to time t₂, and open for a recovery stage over the remainder of each minor pulse cycle from time t₂ to time t₃. The minor pulse cycle begins repeating at time t₃ when the switches close again.

FIG. 12C shows one major cycle for the controlled switches S1 and S2. The switches are repetitively pulsed between closed and open states (as shown in the timing diagram of FIG. 12B) from time t₁ to time t₄ of each major cycle. The switches are continuously open for the remainder of the major cycle from time t₄ to time t₅. The major cycle begins repeating at time t₅ when the switches are again repetitively pulsed between closed and open states.

In one specific twelfth embodiment, switches S1 and S2 are closed for 3.5 mS over a minor pulse period of 6.25 mS. The switches S1 and S2 are pulsed thus 16 times over 100 mS then held continuously open for 400 mS, over each major cycle period of 500 mS.

In the pulse mode, the switches S1 and S2 arrange the circuit of FIG. 12A in the configurations shown in FIGS. 1C to 1F to operate the circuit as already described above with reference to the first embodiment.

As shown in FIG. 12C, the end of the pulsed operation at time t₄ is timed to occur at a time t₃, being at the end of a minor pulse cycle, so that the recovery capacitor C1 is recharged with energy recovered from the collapsing magnetic field of the inductive device L1. This energy is stored in capacitor C1, from time t₄ to time t₅, for use in next re-establishing the magnetic field at time t₁ of the next minor pulse cycle.

### Thirteenth Embodiment

### 13.1 Circuit Layout

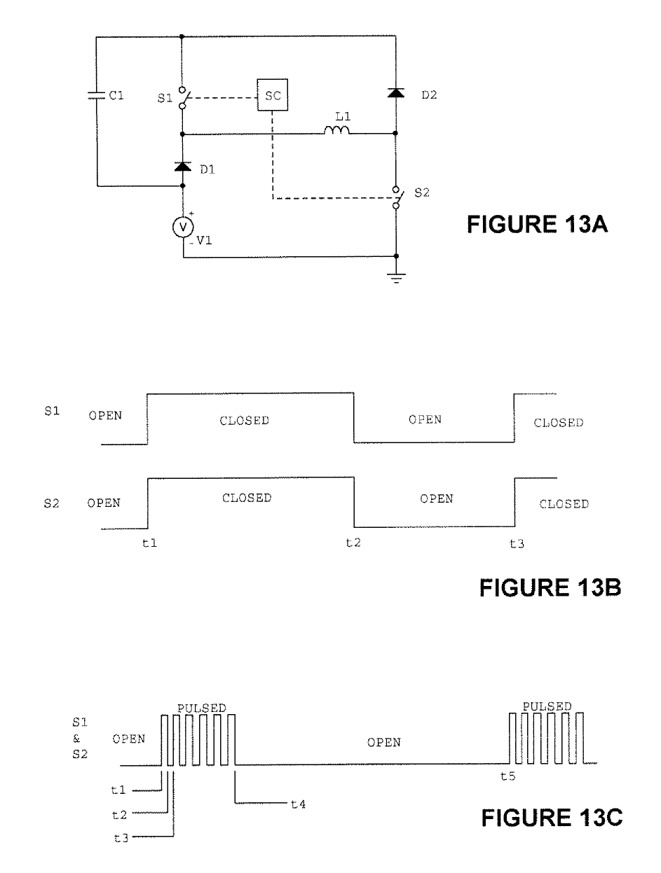

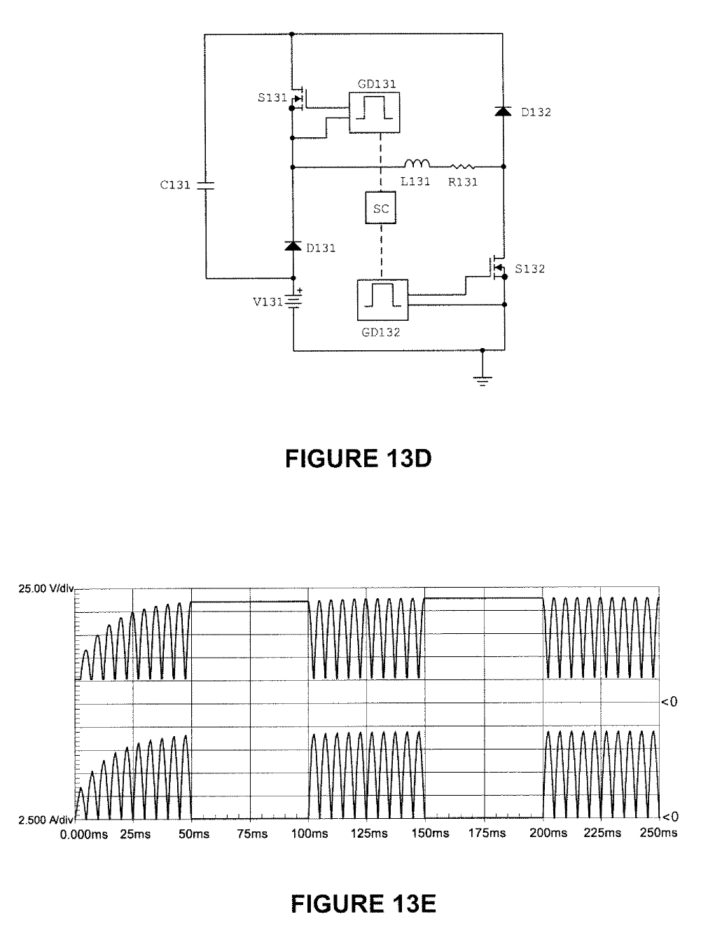

FIG. 13A is a circuit diagram illustrating a thirteenth embodiment of the invention. The circuit layout is identical to that of the second embodiment shown in FIG. 2A. The circuit is operated by periodically switching the controlled switches S1 and S2 between open and closed states. The switches are repetitively switched between a pulsed state and a continuously open state. The periodic switching and pulsing of the switches S1 and S2 between open and closed states is controlled by a common switch controller SC. In the pulsed state, the switches are rapidly switched between open and closed states to achieve the effective circuit configurations shown in FIGS. 2C to 2D, as described above for the second embodiment.

This technique allows low frequency solenoids to be driven at a higher frequency. The spaced apart groups of pulses create an effective lower frequency drive while using practical inductor winding volumes.

### 13.2 Switch Timing

FIGS. 13B and 13C are switch timing diagrams for the controlled switches S1 and S2. The time scales of FIGS. 12B and 12C are different. FIG. 13B shows one minor pulse cycle from time t₁ to time t₃. Switches S1 and S2 are operated synchronously over each minor pulse cycle, being closed for a magnetizing stage from time t₁ to time t₂, and open for a recovery stage over the remainder of each minor pulse cycle from time t₂ to time t₃. The minor pulse cycle begins repeating at time t₃ when the switches close again.

FIG. 13C shows one major cycle for the controlled switches S1 and S2. The switches are repetitively pulsed between closed and open states (as shown in the timing diagram of FIG. 13B) from time t₁ to time t₄ of each major cycle. The switches are continuously open for the remainder of the major cycle from time t₄ to time t₅. The major cycle begins repeating at time t₅ when the switches are again repetitively pulsed between closed and open states.

In one specific thirteenth embodiment, switches S1 and S2 are closed for 3.5 mS over a minor pulse period of 6.25 mS. The switches S1 and S2 are pulsed thus 16 times over 100 mS then held continuously open for 400 mS, over each major cycle period of 500 mS.

In the pulse mode, the switches S1 and S2 arrange the circuit of FIG. 13A in the configurations shown in FIGS. 2C to 2E to operate the circuit as already described above with reference to the second embodiment.

As shown in FIG. 13C, the end of the pulsed operation at time t₄ is timed to occur at a time t₃, being at the end of a minor pulse cycle, so that the recovery capacitor C1 is recharged with energy recovered from the collapsing magnetic field of the inductive device L1. This energy is stored in capacitor C1, from time t₄ to time t₅, for use in next re-establishing the magnetic field at time t₁ of the next minor pulse cycle, as may be seen in the recovery capacitor voltage waveform shown as the upper waveform in FIG. 13E.

### 13.3 Specific Application of Thirteenth Embodiment

In one specific application, the circuit shown in FIG. 13A is used to drive a modified Flojet Model ET508-224A solenoid driven piston pump. The standard pump is rated at 0.48 A, 230 volts AC, 50 Hz and is designed to work on a half wave 50 Hz pulse to deliver a maximum flow rate of 1000 ml/minute.

The winding of the standard pump was rewound with 1.45 mm diameter enamelled copper wire giving a winding inductance of 16.8 mH and a winding resistance of 1.9 ohm.

The pump is driven by the circuit shown in FIG. 13D in which the voltage of source V131 is 28 volts, the inductance and resistance of the solenoid winding are represented by L131 and R131, respectively. The recovery capacitor C131 is 150 μF, and is made up of a parallel combination of three 50 μF pulse grade metallized polypropylene capacitors.

The natural resonance period of the solenoid winding inductance L131 and the recovery capacitor C131 is approximately 10 mS. The magnetizing and recovery periods, described below, are each 2.5 mS which is approximately equal to one quarter of this natural resonance period.

The circuit of FIG. 13D is operated similarly to the thirteenth embodiment described above with respect to FIGS. 13B and 13C. In the circuit of FIG. 13D, the FET switches S131 and S132 are controlled through respective gate drivers by a common switch controller SC to pulse alternately between the closed and open states.

The FET switches are driven by 2 kV isolated NME1215S DC to DC supplies driving through HCPL 3120 opto-isolated gate drivers. The two FET switches S131 and S132 are 20N60C3, 20 A, 600 V, TO220 case. The two diodes D131 and D132 are RUR 30 A, 600 V, TO220 case. The switch controller SC uses CMOS logic circuits. The 28 volts supply is stepped down to 12 volts by a Treco Ten-5 or -6 series DC to DC voltage converter to supply the CMOS logic and FET gate drive circuits.

The two FET switches S131 and S132 are simultaneously closed for a magnetizing period of 2.5 mS and then, following the magnetizing period, are simultaneously opened for a recovery period of 2.5 mS, with this 5 mS (200 Hz) pattern repeated to give ten pulse cycles over 50 mS. The two FET switches are then kept open for 50 mS. This 100 mS switching pattern is repeated at a repetition frequency of 10 Hz to operate the pump. The waveform of the 200 Hz multiple pulse current in the pump winding is very close to a full-wave rectified 100 Hz sinewave.

FIG. 13E shows simulated voltage and current waveforms for the circuit of FIG. 13D. The upper waveform shows the voltage across the series combination of recovery capacitor C131 and supply V131 at a scale of 25 volts per division. The lower waveform shows the current through the solenoid winding represented by inductance L131 and resistance R131 at a scale of 2.5 amperes per division.

FIG. 13E shows the voltage and current waveforms for the first 250 mS from start-up, with recovery capacitor C131 initially uncharged. When FET switches S131 and S132 are first closed for 2.5 mS on start-up, the 28 volt supply voltage is applied across the solenoid winding causing the solenoid current to rise to approximately 3.5 amperes before the two FET switches are opened for 2.5 mS, whereupon the solenoid current falls back to zero. The falling solenoid current is directed by diodes D132 and D131 back to the recovery capacitor charging it to approximately 30 volts and lifting the voltage across capacitor C131 and supply V131 to approximately 58 volts. The FET switches S131 and S132 are then closed for 2.5 mS to re-magnetize the solenoid with the higher voltage, this time causing the solenoid current to rise to approximately 5.2 amperes.

The 5 mS cycle is repeated over the first 50 mS period, incrementally lifting the voltage across the recovery capacitor from 0 volts initially to approximately 82 volts at the end of the period. With FET switches S131 and S132 then held open for the next 50 mS, the capacitor holds this voltage ready for assisting in successively re-magnetizing the solenoid ten times over the following 50 mS, to repeat the 100 mS cycle. After start-up, the solenoid is re-magnetized during successive 100 mS cycles by a peak voltage of approximately 110 volts across the recovery capacitor and the supply, obtained by recovering energy from the previous collapse of the solenoid magnetic field. This provides a peak solenoid current of approximately 9.2 amperes.

The pump draws 22.4 watts from voltage source V131 which is a 28 volt DC supply or battery. In an optional arrangement, not shown, a battery supply V131 is connected to a reservoir capacitor (for example, 22 mF) through a series inductor (for example, 5 mH) and the remainder of the circuit, and particularly high pulse currents, are supplied from the reservoir capacitor, with the battery just supplying the circuit top-up current.

Use of the invention in this specific application allows the pump to be driven with significantly higher currents using the same supply voltage.

In one pump arrangement driven by a circuit not using the invention, the pump drew 6.46 Watts at a mean supply current of 0.23 A and delivered 30 ml/minute to a fixed height when energy recovered from the winding inductance was returned to the supply by a conventional asymmetric converter circuit topology. The same pump arrangement drew 22.4 Watts at a mean supply current of 0.8 A and delivered 420 mL/minute to the same fixed height when using the circuit of FIG. 13D in which energy recovered from the winding inductance L132 and stored on capacitor C131 was connected in series with the supply V131 to deliver the next magnetizing current pulse to the winding at a voltage substantially higher than the supply.

In comparing the operation of the two circuits, the use of the circuit of FIG. 13D results in a performance of 53 watts/litre of water pumped compared to the standard circuit of 210 watts/litre pumped, using exactly the same supply voltage and switch timings.

The solenoid pump driver could also be adapted to drive the solenoid pump using the soft current chopping technique described above in Section 5.16 with reference to the Teknatool Nova motor.

### Fourteenth Embodiment

### 14.1 Circuit Layout

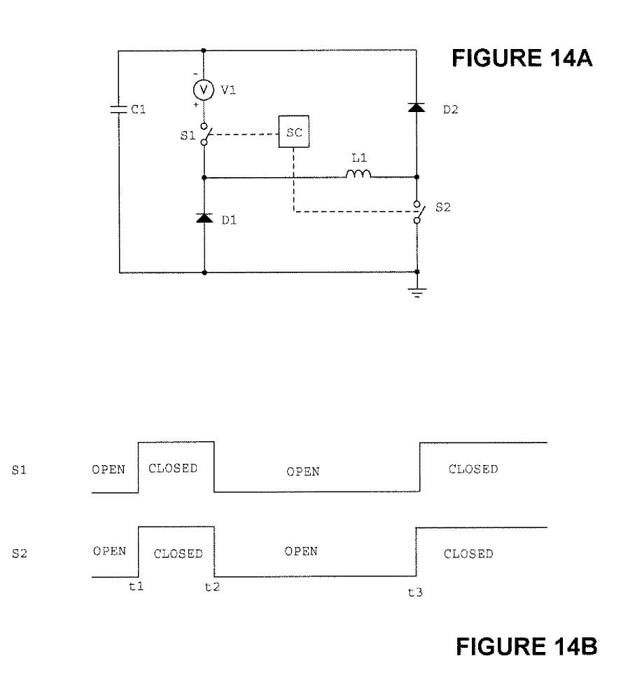

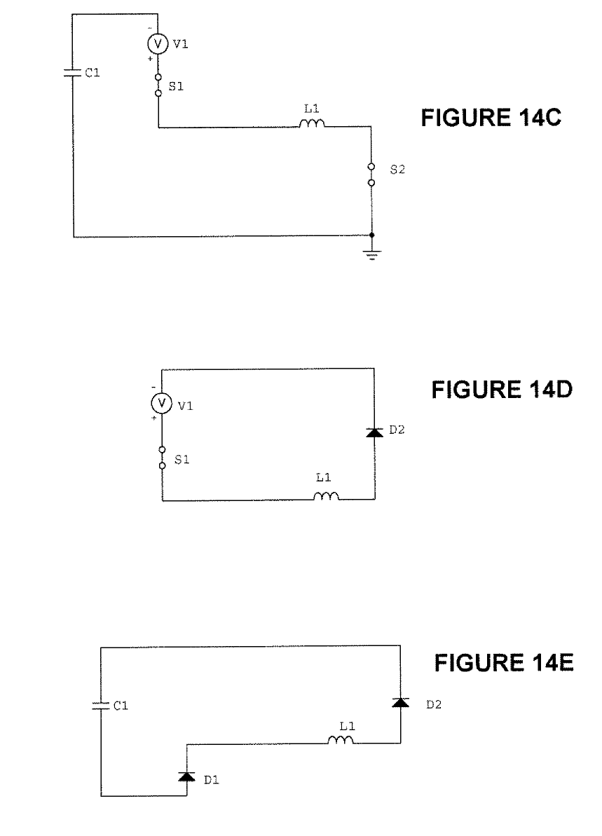

FIG. 14A is a circuit diagram illustrating a fourteenth embodiment of the invention. In this fourteenth embodiment, a capacitor C1 storing energy recovered from an inductive device L1 is connected in series with a supply V1 to provide the inductive device with a first quadrant of a semi-sinusoidal re-magnetizing current.

The circuit of FIG. 14A comprises a DC power supply V1, two diodes D1 and D2, a capacitor C1, two controlled switches S1 and S2, and an inductive device L1. The supply V1, switch S1 and diode D1 are connected in series between upper and lower rails to form a first leg of an H-bridge. Diode D2 and switch S2 are connected in series between the upper and lower rails to form the second leg of the H-bridge. The inductive device L1 is connected between the bridge legs. The capacitor is connected between the two rails. The circuit is operated by periodically switching the controlled switches S1 and S2 between open and closed states to achieve the effective circuit configurations shown in FIGS. 14C to 14E. The opening and closing of the switches S1 and S2 are controlled by a common switch controller SC.

### 14.2 Switch Timing

FIG. 14B is a switch timing diagram for the controlled switches S1 and S2 showing one cycle of operation from time t₁ to time t₃. Switches S1 and S2 are operated synchronously over each cycle by the switch controller SC.

The switches S1 and S2 are both closed to arrange the circuit of FIG. 14A for a magnetizing stage from time t₁ to time t₂. During this magnetizing stage a current is driven through the inductive device L1 to establish a magnetic field. The magnetizing current flows through the inductive device L1 from left to right in the circuits shown in FIGS. 14A, 14C and 14D.

Switches S1 and S2 remain closed from time t₁ to time t₂ for a period that is approximately equal to 0.5π√(L1 C1).

The magnetizing stage ends at time t₂ at which time switches S1 and S2 are opened to arrange the circuit of FIG. 14A for a recovery stage during which a current induced in the inductive device L1 during collapse of the magnetic field charges capacitor C1. The switches S1 and S2 are kept open from time t₂ to time t₃.

Both switches S1 and S2 are closed at time t₃ to arrange the circuit of FIG. 14A for the next magnetizing stage. The operating cycle is repeated with a repetition period equal to (t₃-t₁).

### 14.3 First Magnetizing Circuit

FIG. 14C shows a first effective circuit for the magnetizing stage of circuit operation when switches S1 and S2 are closed. This circuit applies during the magnetizing stage when diode D1 is non-conductive, i.e. when the voltage on capacitor C1 reverse biases diode D2.

### 14.4 Second Magnetizing Circuit

FIG. 14D shows a second effective circuit for the magnetizing stage of circuit operation when switches S1 and S2 are closed. This circuit applies when the voltage across the capacitor C1 is insufficient to reverse bias diode D2, and diode D2 becomes forward biased and conductive to effectively bypass the capacitor C1. Magnetizing current from the power supply V1 then flows through closed switch S1 to inductive device L1 and back through diode D2, to contribute to the establishment of the magnetic field in association with the inductive device L1.

### 14.5 Magnetizing Circuit Conversion

The conversion of the magnetizing circuit of FIG. 14C to that of FIG. 14D occurs automatically when there is insufficient charge on the recovery capacitor to supply all the magnetizing current for the full magnetizing period and particularly when the voltage on capacitor C1 is insufficient to reverse bias diode D2. This occurs immediately on first closing switches S1 and S2 at time t₁ of the first cycle of operation, but can occur progressively later in subsequent cycles. In these subsequent cycles, the recovery capacitor can charge to progressively higher voltages as the circuit builds up to an operating mode.

### 14.6 Energy Recovery Circuit

FIG. 14E shows an effective circuit configuration for the energy recovery stage of circuit operation when switches S1 and S2 are both opened at time t₂. This circuit configuration continues from time t₂ to time t₃.

Current flowing from the inductive device L1 on collapse of the magnetic field forward biases diodes D1 and D2 and charges capacitor C1, causing the current to fall.

When this falling inductive device current reaches zero, diodes D1 and D2 become non-conductive, blocking discharge of the re-charged capacitor C1. This blocking holds the charge on capacitor C1 until the next cycle starts at time t₃.

### 14.7 Start-Up Mode Magnetizing—First Cycle

Initial start-up of the circuit occurs when the switches S1 and S2 close at time t₁ of the first cycle of operation. For the purposes of the immediately-following explanation it is assumed that, prior to time t₁, capacitor C1 is uncharged.

At time t₁, switches S1 and S2 close to effectively arrange the circuit as shown in FIG. 14D. Magnetizing current then flows from the supply V1 through closed switch S2, inductive device L1 and diode D2 to establish a magnetic field in association with the inductive device L1.

### 14.8 Start-Up Mode Magnetizing—Subsequent Cycles

On subsequent cycles during start-up operation, the capacitor C1 will already, at time t₁ have some charge from energy recovery from previous cycles. In this case the circuit adopts the configuration shown in FIG. 14C and magnetizing current flows from the series combination of pre-charged capacitor C1 and supply V1, through closed switch S1, inductive device L1 and closed switch S2 to establish a magnetic field in association with the inductive device.

The flow of current out of the capacitor C1 depletes the charge on the capacitor which decreases the voltage across the capacitor. If the voltage across the capacitor C1 becomes insufficient to reverse bias diode D2, diode D2 conducts, the circuit automatically converts to that shown in FIG. 14D, and magnetizing current continues to flow but only from the supply V1. Diode D2 stops capacitor C1 from reverse charging.

### 14.9 Run Mode Magnetizing

In the run mode, the magnetizing current for the inductive device L1 is predominantly derived from the discharge of capacitor C1 in series with the supply V1 by the circuit of FIG. 14C.

During a first substantial part of the run mode magnetizing stage, the series combination of capacitor C1 and the supply V1 is connected by switches S1 and S2 to the inductive device L1 as seen in the circuit of FIG. 14C, to re-establish the magnetic field in the inductive device.

When the voltage on capacitor C1 is no longer sufficient to reverse bias diode D2, diode D2 conducts and a magnetizing current in the inductive device L1 is maintained by current flowing from the supply V1 through closed switch S1 to the inductive device L1, and back through diode D2, as seen in the circuit of FIG. 14D. This continues the magnetizing of the inductive device L1 with energy direct from the supply. This replenishment occurs automatically during every cycle upon depletion of the capacitor C1 and draws energy from the supply to make up for losses in the circuit.

### 14.10 Energy Recovery

FIG. 14E shows an effective circuit configuration for the energy recovery stage of circuit operation when switches S1 and S2 are both opened at time t₂. This circuit configuration from time t₂ to time t₃. At time t₂, the current through the inductive device L1 and the associated magnetic field begin to collapse.

The collapsing current flows from the inductive device L1 through diode D2 to capacitor C1 and back through diode D1 to inductive device L1. This current flows through the inductive device L1 in the same direction as the current used to establish the magnetic field (i.e. from left to right in FIG. 14E), but flows into the capacitor C1 in the opposite direction to the magnetizing current flowing from the capacitor C1 during the magnetizing stage.

The flow of the induced current, from the inductive device L1 back to the capacitor C1, recharges the capacitor to effectively transfer energy from the magnetic field to the capacitor C1. This recovered energy is held as a charge on the capacitor C1 until the end of the cycle at time t₃ when it is used to re-establish the magnetic field during the magnetizing stage of the next cycle of operation.

### 14.11 Voltage Multiplication

On initial start-up, the capacitor C1 is charged, in the energy recovery stages of the first few successive cycles of circuit operation, to progressively higher voltages. After only a few cycles of operation the capacitor C1 is recharged at each recovery stage to several times the supply voltage. In the magnetizing stages, a magnetizing current in the inductive device is driven from this capacitor voltage.

The recovery of energy from the collapsing magnetic field at each cycle and its re-use to re-establish the field in the magnetizing stage at the next cycle effectively multiplies the voltage from which the inductive device is driven to provide a significant improvement in efficiency. The voltage multiplication process is similar to the transient charging phase of a resonant inductance-capacitance (L-C) circuit.

The capacitor C1 discharges over progressively longer times, and with progressively higher peak current values, during the magnetizing stage of each of the first few start-up cycles. The series combination of capacitor C1 and supply V1 provides a discharge current through closed switch S1 to the inductive device L1, with a return path to earth or ground through the closed switch S2, as seen in the magnetizing circuit shown in FIG. 14C. This current is provided over a significant time during the magnetizing stage before the voltage on the capacitor C1 is sufficiently depleted to remove the reverse bias on diode D2.

Once the voltage on capacitor C1 is sufficiently depleted and diode D2 is forward biased, the circuit effectively adopts the supply-fed magnetizing circuit configuration as shown in FIG. 14D, whereupon the magnetizing current in the inductive device L1 is provided from supply V1 via closed switch S1 to inductive device L1, with a return path to the upper rail through diode D2. The voltage of the supply V1, although less than the much higher run-mode voltages achieved on the series combination of capacitor C1 and supply V1, is sufficient to maintain the level of current in the inductive device L1 and prolong the magnetizing current flowing in the inductive device through to the end of the magnetizing stage.

In practice, the compounding of voltage on the recovery capacitor C1 is limited by circuit losses and by motional or induced back electromotive forces (BEMFs), if any. Motional BEMFs can arise from a changing inductance in the inductive device L1, such as in a reluctance motor, reducing the amplitude of current in the inductive device. The voltage gain is related to the ratio of the maximum energy stored to the energy dissipated per cycle, or to the loaded Q (the quality factor of the inductance capacitance circuit). Where BEMFs and circuit resistances are kept low, the circuit of the first embodiment drives the inductive device with a voltage that is many times greater than that of the supply.

### 14.12 Energy Transfer

The supply V1 has an effective capacitance that is many times greater than the capacitance of capacitor C1, giving the series combination of the capacitor C1 and the supply V1 an effective capacitance value substantially equal to the capacitance of capacitor C1. When the capacitor C1 and the supply V1 are in series together providing the magnetizing current for the inductive device L1 during the earlier part of the magnetizing stage, before magnetizing from the supply alone takes over, the circuit is effectively capacitor C1 series connected by switches S1 and S2 to inductive device L1, but with an effective voltage on capacitor C1 that is higher, by the voltage of the supply V1, than the actual voltage on capacitor C1

For optimum operation of the energy recovery circuit shown in FIG. 14A, the recovered energy stored as a charge on capacitor C1 must be efficiently transferred back to the magnetic field associated with the inductive device L1. Maximum transfer of energy from the capacitor back to the inductive device occurs when the voltage on the capacitor C1 has decreased from a maximum to zero and the current in the inductive device L1 has simultaneously risen from zero to a maximum. The time for this to occur is equal to a quarter of the period of natural resonance of the inductance-capacitance (L-C) circuit, which in this case is equal to 0.5π√(L1 C1).

For optimum operation of the energy recovery circuit of FIG. 14A, the switches S1 and S2 are closed for each cycle of operation for a time that is approximately equal to 0.5π√(L1 C1) to allow for optimum transfer of energy from the capacitor C1 to the inductive device L1.

The switches S1 and S2 can be maintained closed after depletion of the charge on capacitor C1 to extend the duration of the magnetizing current in the inductive device L1. During this extension period, the magnetizing current is supplied from the supply V1 only, via diode D2.

For optimum operation of the energy recovery circuit shown in FIG. 14A, the energy from the magnetic field associated with the inductive device L1 must be efficiently transferred back to the recovery capacitor C1. Maximum transfer of energy from the magnetic field back to the capacitor occurs when the current flowing in the inductive device L1 has decreased to zero.

For optimum operation of the energy recovery circuit of FIG. 14A, the switches S1 and S2 are open for each cycle of operation for a time that is no shorter than a quarter of the period of natural resonance of the inductance-capacitance (L-C) circuit, which in this case is equal to 0.5π√(L1 C1), to allow for optimum transfer of energy from the inductive device L1 to the capacitor C1. The switches S1 and S2 are maintained opened after cessation of the current in the inductive device L1, while waiting on the re-closing of switches S1 and S2 to re-establish the magnetic field at the commencement of the next cycle.

### 14.13 Specific Embodiment

One specific embodiment of the circuit shown in FIG. 14A has the following circuit values:

S1 and S2: IRFK4HE50

D1 and D2: RHRG30120

V1=48 volts

C1=250 μF

L1=36 mH (with an effective series resistance of 1 ohm)

Switching period t₁ to t₃=20 mS

Switching frequency=50 Hz

Magnetizing period t₁ to t₂=5 mS

In this embodiment, the switches S1 and S2 remain closed for 5 mS over the 20 mS period of each cycle. One quarter of the natural resonance period of the capacitor C1 and inductive device L1, i.e. 0.5π√(L1 C1), is equal to 4.7 mS, slightly shorter than the time period in each cycle that the switches S1 and S2 are closed.

In this embodiment, the capacitor C1 is recharged at each recovery stage to a voltage that is more than 7 times the supply voltage after the first 25 cycles of operation, i.e. after 500 mS from starting. A magnetizing current in the inductive device L1 is driven by the capacitor in series with the supply, giving an effective supply voltage multiplication of over 8 times

### 14.14 Waveforms

In the run-mode of the specific second embodiment of FIG. 14A having the circuit values described in the immediately preceding paragraphs, the magnetizing current in the inductive device L1 rises from zero to a peak of approximately 31 amperes with a waveform that is very close to one quarter cycle of sinusoid. At the end of the magnetizing stage, when the switches S1 and S2 are opened, current induced in the inductive device L1, by the collapsing magnetic field, falls to zero with a waveform that is very close to the second quarter cycle of a sinusoid. The current in the inductive device L1 then remains at zero until the start of the next cycle. In summary, the waveform of the current in the inductive device is substantially a half sinusoid for each cycle of operation.

The supply current only flows when switches S1 and S2 are closed, i.e. during the first quadrant of the sinusoid. The supply current waveform is a quarter sinusoid, rising sinusoidally from zero to approximately 31 amperes before dropping rapidly to zero when the switches S1 and S2 are opened.

### Fifteenth Embodiment

### 15.1 Circuit Layout

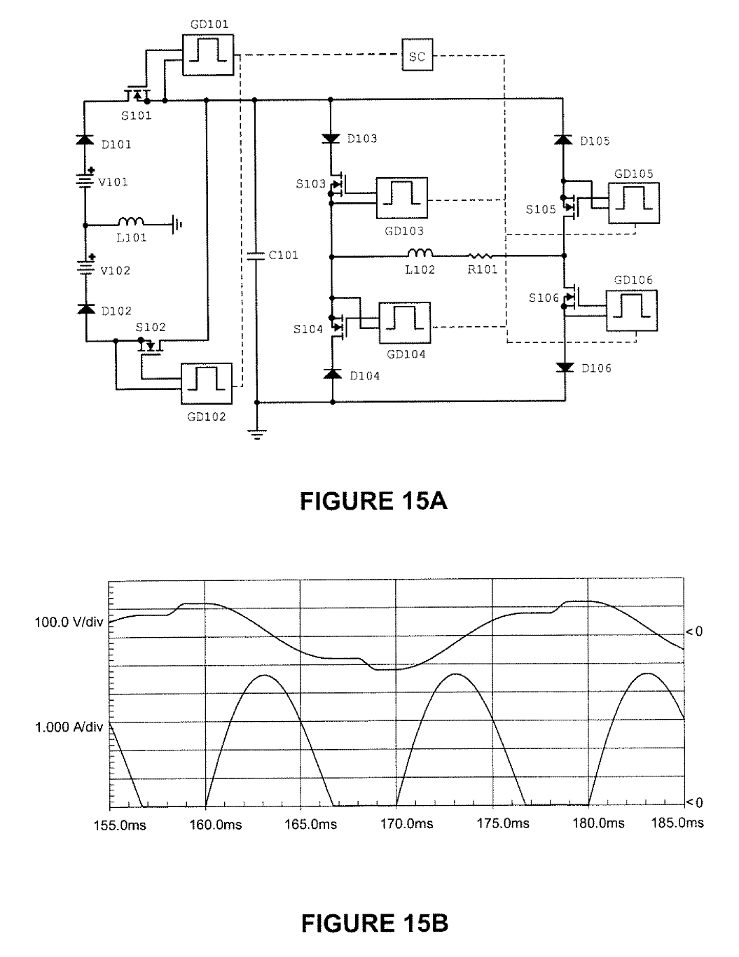

FIG. 15A is a circuit diagram illustrating a fifteenth embodiment of the invention. In this fifteenth embodiment, a capacitance C101 stores energy recovered from an inductive device, represented by inductance L102 and series resistance R101, for use in later magnetizing the inductive device.

The circuit of FIG. 15A comprises a pair of opposite polarity DC power supplies V101 and V102 having a common terminal connected to ground or earth through inductance L101. The supplies are respectively connected through diodes D101 and D102, and controlled switches S101 and S102, to the capacitance C101.

FET switches S101, S102, S103, S104, S105 and S106 are opened and closed under control of a common switch controller SC through respective gate drivers.

FET switches S103, S104, S105 and S106, and respective associated diodes D103, D104, D105 and D106 are arranged in an H-bridge arrangement. By alternately switching diagonally opposite limbs of the full wave H-bridge arrangement ‘on’, i.e. closing or making conductive, and ‘off’, i.e. opening or making non-conductive, the inductive device is driven with magnetizing current pulses of one polarity from an alternating voltage on the capacitor C101. After each magnetizing period, energy is recovered from the collapsing magnetic field by directing current from the inductive device back to the capacitor C101.

One difference of the embodiment of FIG. 15A over the above-described first to fourteenth embodiments is that the FET switches that are switched on to initiate a magnetizing period are not switched off at the end of the respective magnetizing period. Instead, the FET switch configuration remains unchanged over the magnetizing period and over the immediately-following energy recovery period.

Instead of an actively controlled changeover of switch configuration between magnetizing and energy recovery periods, changeover from magnetizing to energy recovery occurs automatically when the voltage on the capacitor C101 decreases through zero and the current flowing in the inductive device begins to decrease, instead of increasing as it does during the magnetizing period. This reverses the polarity of the voltage on the recovery capacitor C101 for every alternate magnetizing cycle of the inductive device, while allowing the inductive device to be driven with magnetizing current pulses of one polarity.

Similarly, no actively controlled switching action is required at the end of the recovery period. Changeover from energy recovery to a pause period occurs automatically when the current flowing in the inductive device falls to zero. This occurs because blocking diodes D103, D104, D105 and D106, which are connected in series with the respective FET switches S103, S104, S105 and S106, only remain conductive for positive diode current flow.

The above-described automatic changeover between magnetizing and recovery periods, and between recovery and pause periods, allows the circuit to freely resonate through one cycle when initiated by switching on the appropriate diagonal pair of FET switches. These automatic changeovers ensure that the recovery capacitor C101 fully discharges to transfer recovered energy back to the inductive device, and that the inductive device current falls to zero to transfer recovered energy from the magnetic field back to the recovery capacitor. This ensures optimum efficiency of electromagnetic field energy recycling without requiring precise control of switch timing.

The recovery capacitor C101 is topped up on alternate half cycles by alternately making FET switches S101 and S102 momentarily conductive in respective alternate pause periods when current is not flowing in the inductive device. These top-ups of energy compensate for circuit losses and may be seen in the upper voltage waveform of FIG. 15B, where the voltage of capacitor C101 is boosted prior to initiation of the next magnetizing period.

### 15.2 Specific Embodiment

One specific embodiment of the circuit shown in FIG. 15A has the following circuit values:

S101 to S106: IRFK4JE50;

V101 and V102=100 volts;

C101=100 μF;

L101=1 mH;

L102=45 mH;

R101=5 ohm; and

FET switching frequency 50 Hz.

In each 20 mS switching cycle:
FET switch S101 is closed for only 1 mS, from 18-19 mS;
FET switch S102 is closed for only 1 mS, from 8-9 mS;
FET switches S103 and S106 are both closed for only 7 mS, from 0-7 mS; and
FET switches S104 and S105 are both closed for only 7 mS, from 10-17 mS.

### 15.3 Waveforms

FIG. 15B shows simulated waveforms of the alternating polarity voltage across a recovery capacitor (upper waveform), and uni-polar current through the inductive device (lower waveform) of the specific embodiment of the circuit of FIG. 15A when using the above-listed circuit values.

### Sixteenth Embodiment

### 16.1 Circuit Layout

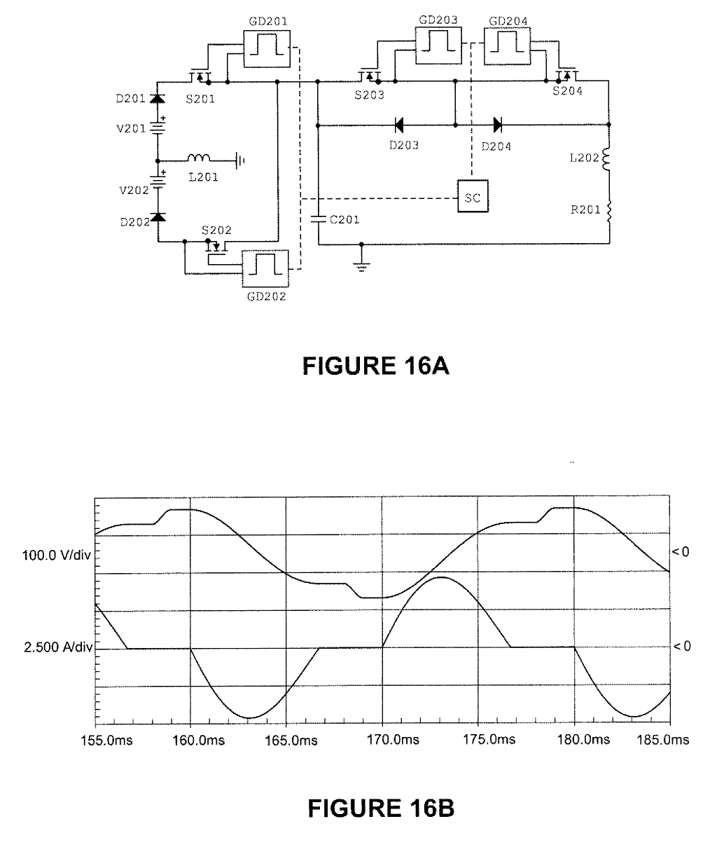

FIG. 16A is a circuit diagram illustrating a sixteenth embodiment of the invention. In this embodiment, a recovery capacitor C201 stores energy recovered from an inductive device, represented by inductance L201 and series resistance R201, for use in later re-magnetizing the inductive device.

The circuit of FIG. 16A comprises a pair of opposite polarity DC power supplies V201 and V202 having a common terminal connected to ground or earth through inductance L201. The supplies are respectively connected through diodes D201 and D102, and controlled switches S201 and S202, to the capacitor C201.

FET switches S201, S202, S203, S204, S205 and S206 are opened and closed under control of a common switch controller SC through respective gate drivers.

FET switch S203 and associated diode D204, and FET switch S204 and associated diode D203, provide alternate paths for currents flowing in respective opposite directions between recovery capacitor C201 and the inductive device. By alternately switching the two FET switches S203 and S204 ‘on’ and ‘off’, the inductive device is driven with magnetizing current pulses of alternating polarity from an alternating voltage on the capacitor C201. After each magnetizing period, energy is recovered from the collapsing magnetic field by directing current from the inductive device back to the capacitor C201.

The diodes D203 and D204 may be discrete components or may each be provided by the diode that is an inherent part of the respective parallel FET switch S203 and S204.

This sixteenth embodiment makes use of the same automatic switching from a magnetizing period to a recovery period, and from the recovery period to a pause period, as described above for the fifteenth embodiment.

### 16.2 Specific Embodiment

One specific embodiment of the circuit shown in FIG. 16A has the following circuit values:

S201 to S206: IRFK4JE50;

V201 and V202=100 volts;

C201=100 μF;

L201=1 mH;

L202=45 mH;

R201=5 ohm; and

FET switching frequency 50 Hz.

In each 20 mS switching cycle:
FET switch S201 is closed for only 1 mS, from 18-19 mS;
FET switch S202 is closed for only 1 mS, from 8-9 mS;
FET switch S203 is closed for only 7 mS, from 0-7 mS; and
FET switch S204 is closed for only 7 mS, from 10-17 mS.

### 16.3 Waveforms

FIG. 16B shows simulated waveforms of the alternating polarity voltage across a recovery capacitor (upper waveform), and the alternating polarity current through the inductive device (lower waveform) of the specific embodiment of the circuit of FIG. 16A when using the above-listed circuit values. This circuit uses fewer FET switches and diodes than that of FIG. 15A and provides similar performance, with the exception that in the circuit of FIG. 16A the inductive device current pulses alternate in polarity. This may not be a disadvantage when the circuit is used to drive a reluctance motor or other reluctance type device, where polarity of magnetization is immaterial.

### Seventeenth Embodiment

### 17.1 Circuit Layout

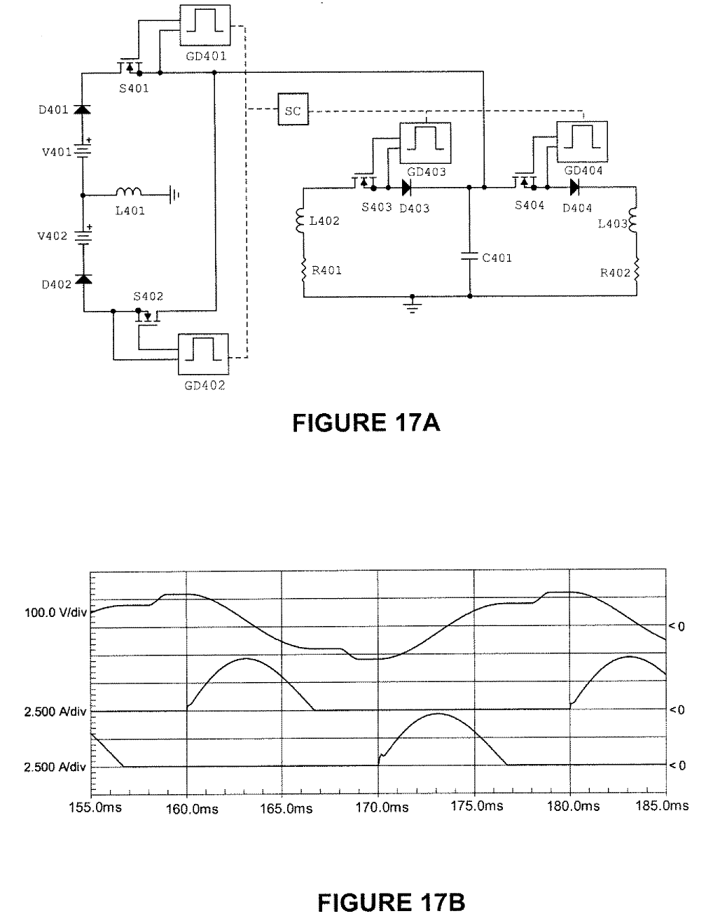

FIG. 17A is a circuit diagram illustrating a seventeenth embodiment of the invention. In this seventeenth embodiment, a capacitance C401 stores energy recovered alternately from two inductive devices, represented respectively by inductance L402 and series resistance R401, and by inductance L403 and series resistance R402, for use in later magnetizing the inductive device.

The circuit of FIG. 17A comprises a pair of opposite polarity DC power supplies V401 and V402 having a common terminal connected to ground or earth through inductance L401. The supplies are respectively connected through diodes D401 and D402, and controlled switches S401 and S402, to the capacitor C401.

FET switches S401, S402, S403 and S404 are opened and closed under control of a common switch controller SC through respective gate drivers.

FET switch S403 and associated diode D403 provide a path for current flowing down through recovery capacitor C401 and up through the inductive device represented by inductance L402 and resistance R401. FET switch S404 and associated diode D404 provide a path for a half cycle of a resonant current flowing up through recovery capacitor C401 and down through the inductive device represented by inductance L403 and resistance R402. By alternately switching the two FET switches S403 and S404, the inductive devices are driven alternately with magnetizing current pulses of one polarity from an alternating voltage on the capacitor C401. After each magnetizing period, energy is recovered from the collapsing magnetic field by directing current from the respective inductive device back to the capacitor C401.

This seventeenth embodiment makes use of the same automatic switching as described above in the fifteenth embodiment.

One difference of the embodiment of FIG. 17A over the above-described first to sixteenth embodiments is that the circuit drives two inductive devices using only a single recovery capacitor. In a variation of the seventeenth embodiment, the two inductive devices represented in FIG. 17A may be respective windings on the same device, for example respective stator pole windings of a two phase motor, or two windings on a common core.

### 17.2 Specific Embodiment

One specific embodiment of the circuit shown in FIG. 17A has the following circuit values:

S401 to S404: IRFK4JE50;

V401 and V402=100 volts;

C401=100 μF;

L401=1 mH;

L402 and L403=45 mH;

R401 and R402=5 ohm; and

FET switching frequency 50 Hz.

In each 20 mS switching cycle:
FET switch S401 is closed for only 1 mS, from 18-19 mS;
FET switch S402 is closed for only 1 mS, from 8-9 mS;
FET switches S403 is closed for only 7 mS, from 10-17 mS; and
FET switches S404 is closed for only 7 mS, from 0-7 mS.

### 17.3 Waveforms

FIG. 17B shows simulated waveforms of the alternating polarity voltage across recovery capacitor C401 (upper waveform), uni-polar current through the inductive device represented by inductance L403 and resistance R402 (middle waveform), and uni-polar current through the inductive device represented by inductance L402 and resistance R401 (lower waveform), of the specific embodiment of the circuit of FIG. 17A when using the above-listed circuit values.

### Eighteenth Embodiment

### 18.1 Circuit Layout

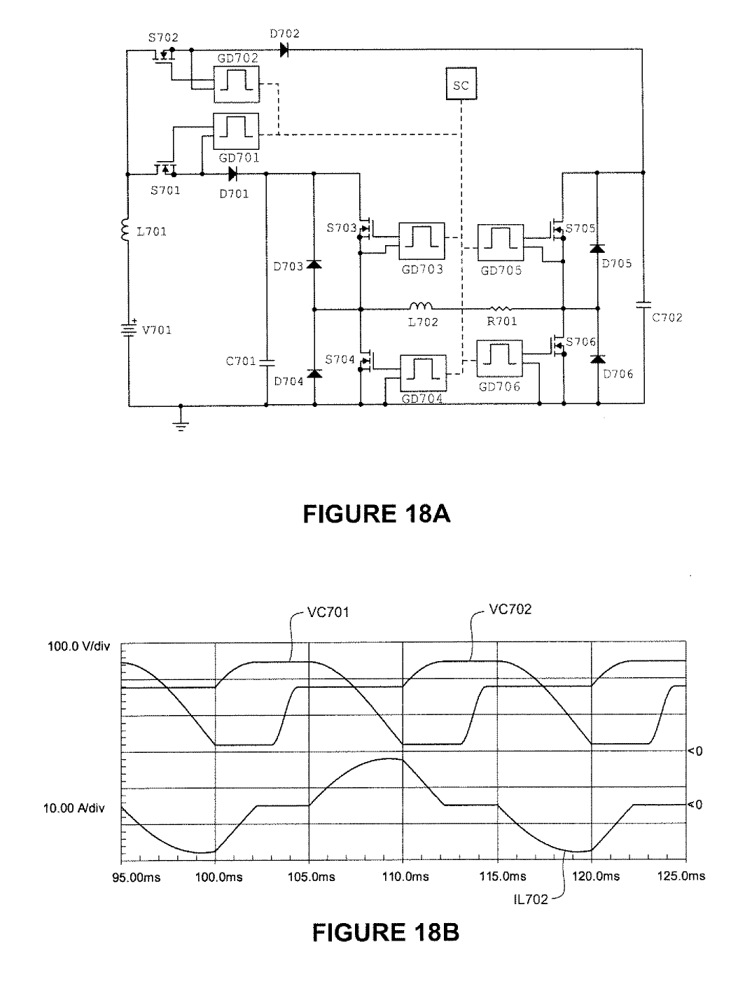

FIG. 18A is a circuit diagram illustrating an eighteenth embodiment of the invention. In this eighteenth embodiment, two energy recovery capacitors C701 and C702 alternately store energy recovered from an inductive device, represented respectively by inductance L702 and series resistance R701, for use in later magnetizing the inductive device.

The circuit of FIG. 18A comprises a DC power supply V701 and a series power supply current control inductance L701. The opening and closing of FET switches S701, S702, S703, S704, S705 and S706 are controlled by a common switch controller SC through respective gate drivers to alternately connect the supply, through FET switches S701 and S702 and respective series diodes D701 and D702, to the capacitors C701 and C702. The capacitors C701 and C702 are alternately discharged into, and recharged from, the inductive device by repetitively switching respective diagonal pairs of controlled FET switches S703 and S706, and S704 and S705.

During each repetitive switch cycle, FET switches S703 and S706 are simultaneously closed, i.e. made conductive, to discharge a pre-charged first capacitor C701 through the inductive device to establish a magnetic field. While the voltage across the discharging first capacitor C701 falls, the current in the inductive device increases. The FET switches S703 and S706 remain conductive for a period approximately equal to one quarter of the natural resonant period of the first capacitor C701 and inductance L702 of the inductive device. At the end of this period, the voltage on the capacitor C701 has dropped to, or close to, zero and the FET switches S703 and S706 are opened, i.e. made non-conductive. Current in the inductance stops increasing and, with FET switches S703 and S706 non-conductive, flows instead through diodes D704 and D705 to charge a second capacitor C702 using energy recovered from the collapsing magnetic field.

The current flowing in the inductive device decreases, and ceases when it reaches zero. During this pause in inductive current flow, FET switch S701 is closed, i.e. made conductive, for a short period to pre-charge first capacitor C701 from the supply V701 through current control inductor L701 and reverse blocking diode D701.

The pause in inductive current flow ends when controlled FET switches S704 and S705 are simultaneously closed, i.e. made conductive, to discharge the now-charged second capacitor C702 back through the inductive device. While the voltage across the discharging capacitor C702 falls, the current in the inductive device increases. This current flows in the opposite direction to the above-described current flowing through the inductive device when FET transistors S703 and S706 were conductive. The FET switches S704 and S705 remain conductive for a period approximately equal to one quarter of the natural resonant period of the second capacitor C702 and inductance L702 of the inductive device. At the end of this period, the voltage on the capacitor C702 has dropped to, or close to, zero and the FET switches S704 and S705 are opened, i.e. made non-conductive. Current in the inductance stops increasing and, with FET switches S704 and S705 non-conductive, flows instead through diodes D703 and D706 to further charge the first capacitor C701 using energy recovered from the magnetic field.

The current flowing in the inductive device decreases, and again ceases when it reaches zero. During this pause in inductive current flow, FET switch S702 is closed, i.e. made conductive, for a short period to pre-charge second capacitor C702 from the supply V701 through current control inductor L701 and reverse blocking diode D702.

In this way, voltages across each of the two energy recovery capacitors C701 and C702 remain positive, while an AC current flows in the inductive device.

This eighteenth embodiment makes use of automatic switching similar to that described above for the fifteenth embodiment. In particular, firstly, if the diagonal pairs of FET switches are kept conductive for longer than the respective quarter resonant periods, diodes D704 and D706 will become forward biased and conductive to prevent respective capacitor C701 and C702 from charging in a reverse direction to negative voltages. And secondly, respective diagonal pairs of diodes D704 and D705, and D703 and D706 become non-conductive to initiate respective pauses when inductive device currents in respective directions reach zero. These actions occur automatically without specific intervention from the switch controller.

The diodes D703, D704, D705 and D706 may be discrete components or may each be provided by the diode that is an inherent part of the respective parallel FET switch S703, S704, S705 and S706.

One difference of the embodiment of FIG. 18A over the above-described first to seventeenth embodiments is that the circuit uses two energy recovery capacitors to alternately drive current in opposite directions through an inductive device.

### 18.2 Specific Embodiment

One specific embodiment of the circuit shown in FIG. 18A has the following circuit values:

S701 to S706: IRFK4JE50;

V701=100 volts;

C701=200 μF;

C702=200 μF;

L701=1 mH;

L702=45 mH;

R701=5 ohm; and

FET switching frequency 50 Hz.

In each 20 mS switching cycle:
FET switch S701 is closed for only 1.5 mS, from 13-14.5 mS;
FET switch S702 is closed for only 1.5 mS, from 3-4.5 mS;
FET switches S703 and S706 are closed for only 5 mS, from 5-10 mS; and
FET switches S704 and S705 are closed for only 5 mS, from 15-20 mS.

### 18.3 Waveforms

FIG. 18B shows simulated waveforms of voltages VC701 and VC702 across respective recovery capacitors C701 and C702, (upper two waveforms); and of current IL702 flowing (with positive polarity indicative of current flow from left to right) in the inductance L702 of the inductive device (bottom waveform); of the specific embodiment of the circuit of FIG. 18A when using the above-listed circuit values.

It can be seen that the inductive device is magnetized alternately by opposite polarity current pulses having a peak amplitude of 12 amperes. The current increases by discharge of one of the two capacitors to establish a magnetic field, and decreases to charge the other of the two capacitors using energy recovered from the collapsing field. The recovered energy stored by the capacitors is then later recycled back to the inductive device to re-establish the magnetic field.

### Nineteenth Embodiment

### 19.1 Circuit Layout

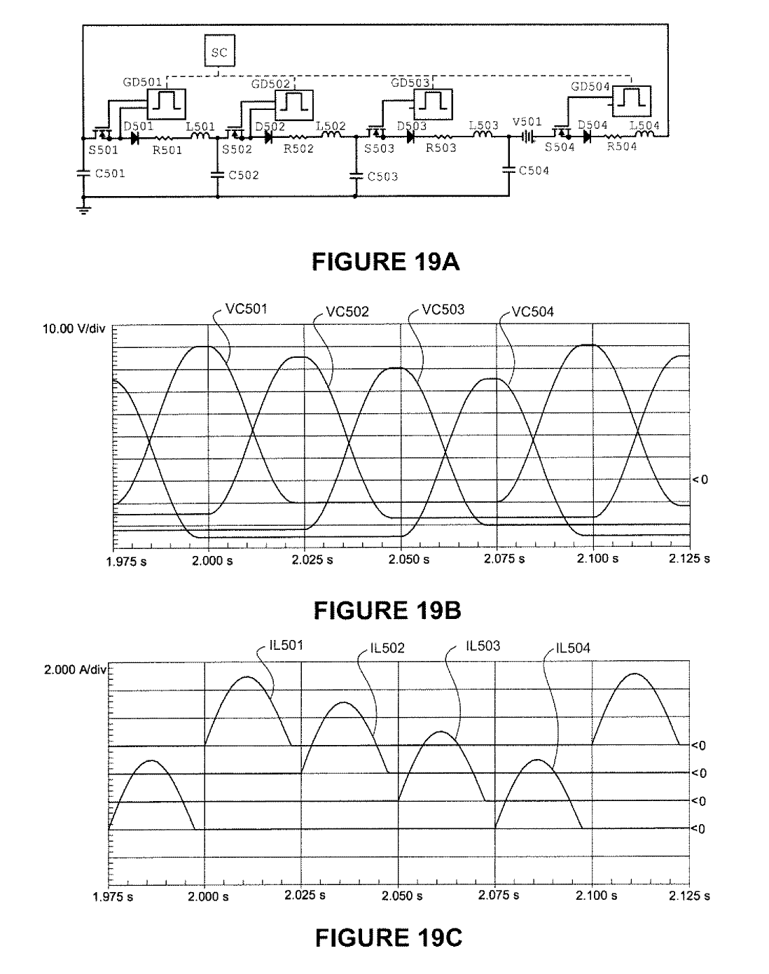

FIG. 19A is a circuit diagram illustrating a nineteenth embodiment of the invention. This nineteenth embodiment is a four stage ring circuit. Energy, initially derived from DC power supply V501, is used to magnetize, and then recover energy from, four inductive devices, successively. In each case, recovered energy is stored on a respective capacitor from which it is used to assist in energizing the next succeeding inductive device. In this way, energy from the supply is used and reused successively around the ring, and only augmented from the supply once for each circulation of recycled energy around the four stage ring. This embodiment operates with a four phase cycle. For each cycle, only one of the four windings is energized and the remaining three stages are pausing.

FET switches S501, S502, S503 and S504 are opened, i.e. made non-conductive, and closed, i.e. made conductive, under control of a common switch controller SC through respective gate drivers.

In each stage, a respective recovery capacitor C501, C502, C503, C504, stores energy recovered from a preceding stage. Respective FET switch S501, S502, S503, S504 is made conductive to discharge the capacitor through respective blocking diode D501, D502, D503, D504, and a respective winding represented by respective resistance R501, R502, R503, R504, and inductance L501, L502, L503, L504, to establish a magnetic field in the winding.

The FET switches are each made conductive for a period slightly greater than half the natural resonant period of each stage to initiate discharge of the stage capacitor through the winding to magnetize the winding inductance and then allow collapse of the magnetic field. After a small pause, the following stage is activated, and the process repeated. While the FET switch of a stage is conductive, the stage operates with automatic changeover from magnetizing to energy recovery, and from energy recovery to pause, similarly to the automatic switching described above for the fifteenth, sixteenth and seventeenth embodiments.

One difference of the embodiment of FIG. 19A over the above-described first to sixteenth embodiments is that the circuit drives more than two inductive devices. These may be respective windings on the same device, for example four windings of a four phase motor. Although FIG. 19A shows four stages, the number of stages can be selected to suit the application. For example, three windings of a three phase motor may be driven by a three stage variant of the FIG. 19A circuit. Or the circuit could be used in a linear reluctance motor or track with multiple independently-powered stages for example.

### 19.2 Specific Embodiment

One specific embodiment of the circuit shown in FIG. 19A has the following circuit values:

S501 to S504: IRFK4J350;

V501=20 volts;

C501 to C504=1000 μF;

L501 to L504=100 mH;

R501 to R504=1 ohm; and

FET switching frequency 10 Hz.

In each 100 mS switching cycle:
FET switch S501 is closed for only 24.5 mS, from 0-24.5 mS;
FET switch S502 is closed for only 24.5 mS, from 25-49.5 mS;
FET switch S503 is closed for only 24.5 mS, from 50-74.5 mS; and
FET switch S504 is closed for only 24.5 mS, from 75-99.5 mS.

### 19.3 Waveforms

FIG. 19B shows simulated waveforms of voltages VC501, VC502, VC503, and VC504 across respective capacitors C501, C502, C503 and C504; and FIG. 19C shows simulated waveforms of currents IL501, IL502, IL503, and IL504 flowing in respective winding inductances L501, L502, L503 and L504; of the specific embodiment of the circuit of FIG. 19A when using the above-listed circuit values.

It can be seen that the windings are magnetized sequentially by half-sinusoidal current pulses of substantially equal amplitudes. Each pulse is derived by a half cycle of resonant current flow from the respective stage capacitor, through the respective winding, to the capacitor of the next following stage. This resonant current flow discharges the positively charged stage capacitor to zero and recharges it to the opposite polarity, at the same time causing a similar but opposite change in the voltage of the capacitor of the next following stage. When the voltages of these two capacitors are equal (at the cross-over of the corresponding waveforms), the voltage applied across the winding is zero and the half-sinusoidal current pulse in the respective winding current is at its maximum value. With zero applied voltage, the winding current falls as the magnetic field in the winding collapses, thereby recharging each of the two capacitors to opposite potentials.

For example, at time 2.0 seconds seen in the waveforms FIGS. 19B and 19C, capacitor C501 is positively charged and capacitors C502, C503 and C504 are negatively charged. The first stage is operated by making FET switch S501 conductive for 24.5 mS, discharging the series combination of capacitors C501 and C502 into the winding represented in FIG. 19A by inductance L501 and resistance R501. This causes a rise in the winding current IL501.

At approximately 2.012 seconds seen in the waveforms FIGS. 19B and 19C, the voltages VC501 and VC502 across respective capacitors C501 and C502 are equal and the winding current IL501 is at its maximum value. As the winding current falls to zero, capacitor C501 is charged negatively taking voltage VC501 negative, and capacitor C502 is charged positively taking voltage VC502 positive. This process has magnetized the winding using energy from recovery capacitor C501 and then recovered the energy from the magnetic field and transferred it to recovery capacitor C502.

This process is repeated to successively magnetize the four windings represented in FIG. 19A by respective inductances L501, L502, L503 and L504 and respective resistances R501, R502, R503 and R504.

Supply V501 is connected in series with FET switch S504. When FET switch S504 is closed to establish a magnetic field in the fourth winding represented by inductance L504 and resistance R504, and transfer energy recovered from collapse of that field to recovery capacitor C501, energy from the supply V501 is introduced into the circuit. A significant part of this energy is transferred to, and recovered from, each successive winding to circulate around the ring.

### Twentieth Embodiment

### 20.1 Circuit Layout

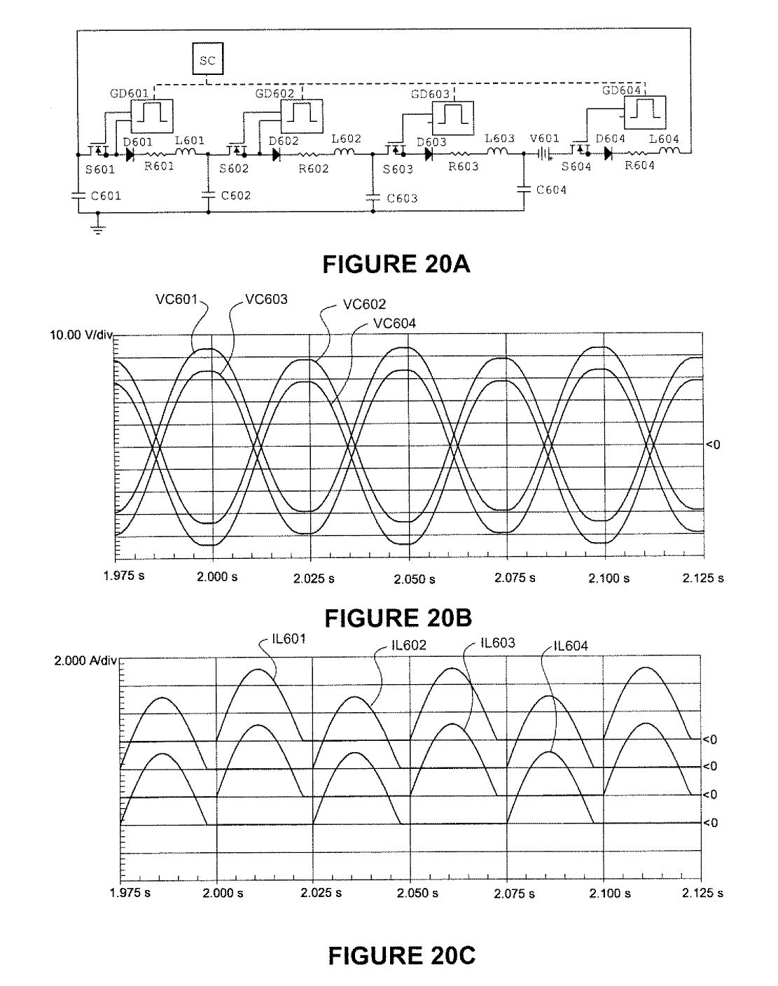

FIG. 20A is a circuit diagram illustrating a twentieth embodiment of the invention. This twentieth embodiment is a four stage ring circuit, similar to that of the nineteenth embodiment shown in FIG. 19A. Energy, initially derived from DC power supply V601, is used to magnetize, and then recover energy from, four inductive devices. In each case, recovered energy is stored on a respective capacitor from which it is used to energise the next succeeding inductive device. In this way, energy from the supply is used and reused successively around the ring, and only augmented from the supply once for each circulation of recycled energy around the four stage ring. The difference of this twentieth embodiment over that of the nineteenth embodiment is that the twentieth embodiment operates with a two phase cycle. For each cycle, two non-adjacent stages simultaneously magnetize respective windings while the other two stages are pausing.

FET switches S601, S602, S603 and S604 are opened, i.e. made non-conductive, and closed, i.e. made conductive, under control of a common switch controller SC through respective gate drivers.

In each stage, a respective recovery capacitor C601, C602, C603, C604, stores energy recovered from a preceding stage. Respective FET switch S601, S602, S603, S604 is made conductive to discharge the capacitor through respective blocking diode D601, D602, D603, D604, and a respective winding represented by respective resistance R601, R602, R603, R604, and inductance L601, L602, L603, L604, to establish a magnetic field in the winding.

The FET switches are each made conductive for a period slightly greater than half the natural resonant period of each stage to initiate discharge of the stage capacitor through the winding to magnetize the winding and then allow collapse of the magnetic field. After a small pause, the following stage is activated, and the process repeated.

While the FET switch of a stage is conductive, the stage operates with automatic changeover from magnetizing to energy recovery, and from energy recovery to pause, similarly to the automatic switching described above for the fifteenth, sixteenth. seventeenth and eighteenth embodiments.

One difference of the embodiment of FIG. 20A over the above-described first to sixteenth embodiments is that the circuit drives more than two inductive devices. These may be respective windings on the same device, for example four windings of a four phase motor. Although FIG. 20A shows four stages, the number of stages can be selected to suit the application. For example, the circuit could be used in a linear reluctance motor or track with multiple independently-powered stages.

### 20.2 Specific Embodiment

One specific embodiment of the circuit shown in FIG. 20A has the following circuit values:

S601 to S604: IRF4J350;

V601=20 volts;

C601 to C604=1000 μF;

L601 to L604=100 mH;

R601 to R604=1 ohm; and

FET switching frequency 20 Hz.

In each 50 mS switching cycle:
FET switches S601 and S603 are both closed for only 24.5 mS, from 0-24.5 mS; and
FET switches S602 and S604 are both closed for only 24.5 mS, from 25-49.5 mS.

### 20.3 Waveforms

FIG. 20B shows simulated waveforms of voltages VC601, VC602, VC603, and VC604 across respective capacitors C601, C602, C603 and C604; and FIG. 20C shows simulated waveforms of currents IL601, IL602, IL603, and IL604 flowing in respective winding inductances L601, L602, L603 and L604; of the specific embodiment of the circuit of FIG. 20A when using the above-listed circuit values.

It can be seen that pairs of non-adjacent windings are magnetized sequentially by half-sinusoidal current pulses of substantially equal amplitudes. Each pulse is derived by a half cycle of resonant current flow from the respective stage capacitor, through the respective winding, to the capacitor of the next following stage. This resonant current flow discharges the positively charged stage capacitor to zero and recharges it to the opposite polarity, at the same time causing a similar but opposite change in the voltage of the capacitor of the next following stage. When the voltages of these two capacitors are equal (at the cross-over of the corresponding waveforms), the voltage applied across the winding is zero and the half-sinusoidal current pulse in the respective winding current is at its maximum value. With zero applied voltage, the winding current falls as the magnetic field in the winding collapses, thereby recharging each of the two capacitors to opposite potentials.

For example, at time 2.0 seconds seen in the waveforms FIGS. 20B and 20C, capacitors C601 and C603 are positively charged and capacitors C602 and C604 are negatively charged. The first and third stages are operated simultaneously by making FET switches S601 and S603 conductive for 24.5 mS, discharging the series combination of capacitors C601 and C602 into the winding represented in FIG. 20A by inductance L601 and resistance R601, and discharging the series combination of capacitors C603 and C604 into the winding represented in FIG. 20A by inductance L603 and resistance R603. This causes a rise in the two winding currents IL601 and IL603.

At approximately 2.012 S, the voltages VC601 and VC602 across respective capacitors C601 and C602 are equal, and the voltages VC603 and VC604 across respective capacitors C603 and C604 are equal, and the winding currents IL601 and are each at their maximum values. As the winding currents fall to zero, capacitors C601 and C603 are charged negatively taking voltages VC601 and VC603 negative, and capacitors C602 and C604 are charged positively taking voltages VC602 and VC604 positive.

This process has simultaneously magnetized two respective stage windings using energy from respective recovery capacitors C601 and C603 and then recovered and transferred the energy from the respective magnetic fields to respective recovery capacitors C602 and C604.

A similar process simultaneously magnetizes the other two windings represented in FIG. 20A by respective inductances L602 and L604 and respective resistances R602 and R604.

Supply V601 is connected in series with FET switch S604. When FET switch S604 is closed to establish a magnetic field in the fourth winding represented by inductance L604 and resistance R604, and to transfer energy recovered from collapse of that field to recovery capacitor C601, energy from the supply V601 is introduced into the circuit. A significant part of this energy is transferred to, and recovered from, each successive winding to circulate around the ring.

By simultaneously operating pairs of non-adjacent windings, the frequency of winding current pulses is doubled and the capacitor voltage waveforms show only small flats at both the positive and negative peaks. Otherwise, the capacitor voltage waveforms are substantially sinusoidal. The flats correspond to the pause at the end of each stage cycle while the respective resonant cycle is interrupted, when the respective winding current reaches zero on completion of energy recovery, and before initiation of a resonant cycle in the next following stage.

### Applications

### 21.1 Applications of the Current Invention

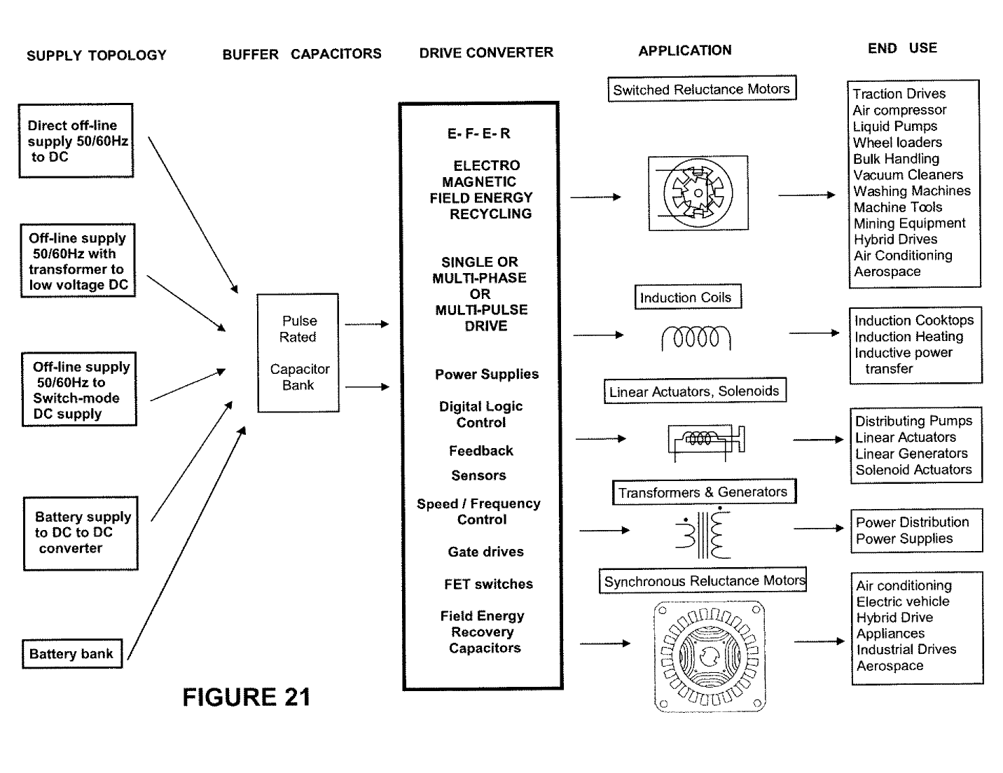

FIG. 21 shows examples of end uses of applications of the current invention using various inductive devices driven by drive converters according to the current invention supplied via a buffer capacitor bank from various supply types.

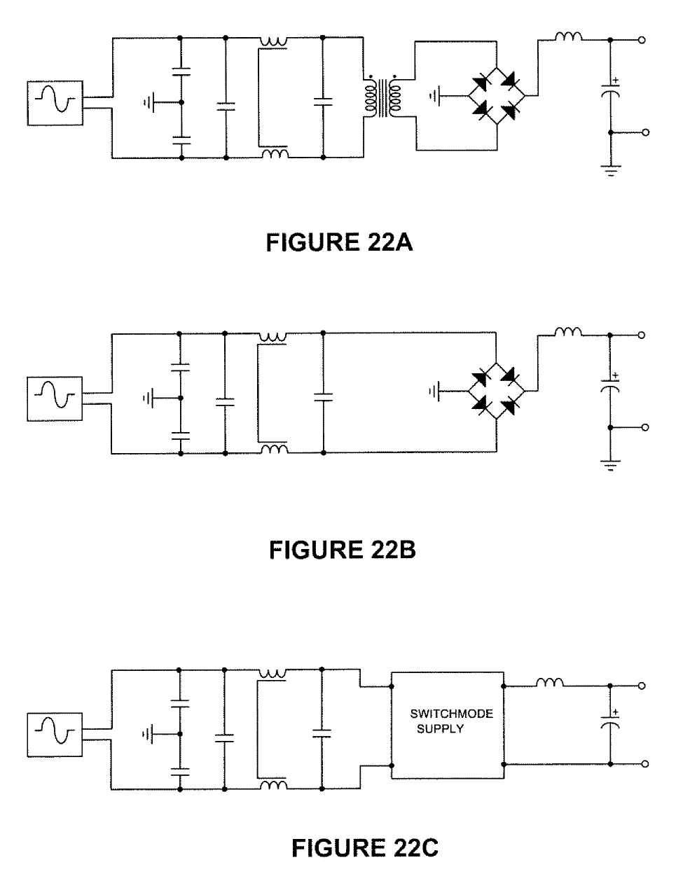

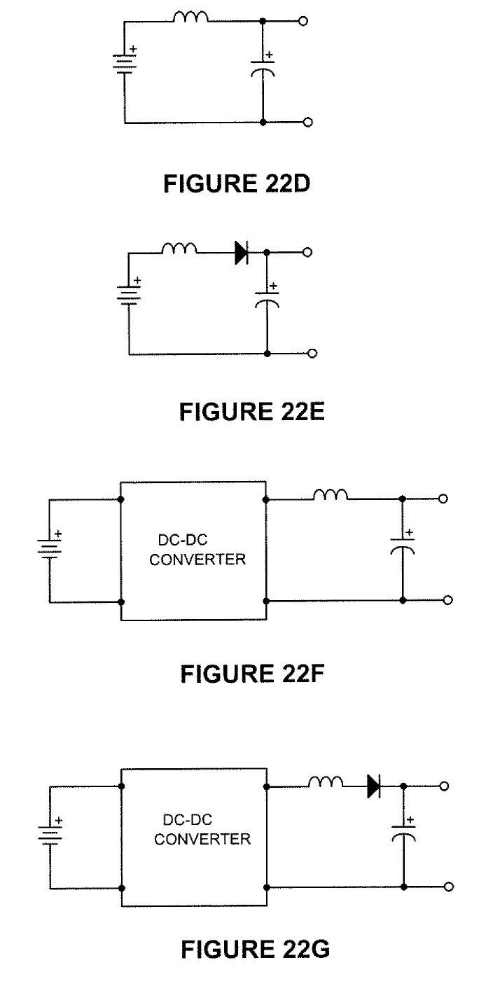

FIG. 21 shows examples of supply topologies, including direct and transformer-coupled off-line supplies, switchmode off-line supplies, and battery supplies. Further details of these supply types are shown in FIGS. 22A to 22G and discussed below.

FIG. 21 shows examples of application of the current invention to inductive devices that can be driven by the current invention. Typical inductive devices include switched reluctance motors, inductions coils, linear actuators, solenoids, transformers, generators and synchronous reluctance motors. The current invention has application to single and multi-phase inductive devices, including but not limited to two phase and three phase devices. The current invention can be applied to power generation alternators; to field and/or output windings.

FIG. 21 shows examples of a wide range of end uses to which the current invention can be applied.

Examples of end uses for switched reluctance motors include traction drives, air compressors, liquid pumps, wheel loaders, bulk handlers, vacuum cleaners, washing machines, machine tools, mining equipment, air conditioning and aerospace applications. Examples of end uses for synchronous reluctance motors include air conditioning, electric and hybrid drive vehicles, electrically powered machines and appliances, industrial drives and aerospace applications. Further details of applications of the current invention to motors are given below in Section 21.4

Examples of end uses for induction coils include induction heating work coils, inductive power transfer systems for materials handling and non-contact power transfer. One application of the latter is in safe electrically-isolated power transfer of energy for recharging batteries in electric and hybrid vehicles.

Examples of end uses for linear actuators and solenoids include distributing pumps, linear actuators, linear generators, solenoid valves, solenoid actuators and bells. Further details of applications of the current invention to solenoids and linear actuators are given below in Section 21.3.

Example applications of end uses for transformers and generators include power distribution and electrical power supplies. Further details of applications of the current invention to transformers are given below in Section 21.2.

### 21.2 Transformers

Standard transformer designs do not usually use field energy recovery on the primary winding. In switch mode power supplies, it is common to control the magnetic field in the primary winding but energy is not purposely recovered, stored for feeding back to the power source, or used to effectively multiply the voltage used to drive the winding. Magnetic field energy recycling circuits according to the current invention as described above can be used to drive transformers with improved efficiencies over prior art transformer power supplies. Circuits described above can be used advantageously for driving transformers using magnetic core material with low remanence, so that the residual magnetization in the transformer laminations can fall close to zero when the magnetizing field drops to zero at each successive AC cycle.

A modification of the tenth embodiment, with switch S3, diodes D3 and D5, inductor L2 and capacitor C2 omitted and the supply V1 connected directly, can be used to drive a transformer in the position of the inductive device L1 with a full near-sinusoidal AC waveform. It is necessary to control secondary winding load current so that currents in the secondary load circuit, and consequent induced back EMFs, do not deplete the current during the field energy recovery stage. The secondary load circuit is switched on during the magnetizing stages, and is switched off (i.e. open circuited) during recovery stages when the magnetic field in the transformer collapses and the field energy is being recovered to recharge the recovery capacitor C1. This switching allows greater field build and recovery and much better efficiencies than if the secondary winding is loaded through both the rising and falling quadrants of each half cycle.

The primary and secondary windings can be configured in a 1:1 ratio for a close magnetic coupled circuit, and the primary winding magnetizing inductance, the capacitor C1 and the magnetizing time period selected to optimize the energy recovery as described above.

For loosely coupled transformer circuits, the primary to secondary winding ratio can be 1:2 and the load is then switched in during the field energy recovery period.

Reduction of back EMFs is an important requirement in maximizing energy recycling in transformers. Reduction of back EMFs requires the following.
Limitation of secondary load ‘induced’ back EMFs by controlling the period during which the load is applied.
A controlled load circuit allowing for controlled switching of the output to load.
Use of specialized lamination steels with very low magnetic retentitivity.
Magnetic coupling between primary and secondary windings optionally controlled by an air gap in the magnetic circuit (in some cases).

These same considerations can be applied to energy recycling circuits used for switch mode or resonant mode converters employing pulse transformers with isolated primary and secondary windings. Multiphase transformer circuits can be driven by compiling a number of bridge circuits.

### 21.3 Solenoids and Linear Actuators

Conventional solenoid coils and linear electromagnetic actuators build a magnetic field to perform work by magnetic attraction or repulsion. The energy built up or contained within the magnetic field can be substantial. The dissipation of this energy, usually after the work has been performed, has been seen as a nuisance. Many control strategies have been employed to deplete the field while minimizing damage to circuit components from voltage spikes. Eddy current shorting rings, diode clamps, application of reverse voltages and other field control techniques have been employed to safely dissipate the field energy.

The second and third embodiments provide effective supply voltage multiplication and wave shaping permitting a lower supply voltage to be used to power a solenoid or actuator with greater efficiency. The multi-pulsing described in the twelfth and thirteenth embodiments and the extension of the magnetizing pulse width of the eighth embodiment allow field energy recycling techniques to be used when the frequency of operation is much lower than the optimum repetition frequency of the magnetizing and recovery cycle for a particular winding inductance.

The multi-pulsed operation described in the twelfth and thirteenth embodiments is particularly suitable for driving linear actuators and solenoids. The multi-pulsing technique allows pulses at a relatively high repetition frequency, for example 160 Hz, to provide effective energy recycling according to the invention while being interrupted at a relatively low frequency, for example 2 Hz. This allows effective energy recycling with the inductance values typical of these devices.

### 21.4 Motors

In conventional AC motor drives, a sinusoidal waveform is synthesized by an inverter using a complex switching sequence. While this allows for easy frequency variation, it does not provide for the efficiency improvements provided by recycling (i.e. the recovery and reuse) of the magnetic field energy.

The voltage multiplying and wave shaping functions of the second, third and fifth embodiments, when used in full bridge circuits providing alternating magnetizing currents, such as the tenth and eleventh embodiments, make these circuits particularly suitable for switched reluctance motors, AC synchronous reluctance motors and AC induction motors, and particularly those motors with low or no motional back EMFs, such as those used in hybrid and electric vehicle drives and similar traction applications where the use of lower supply bus voltages can be used to advantage by application of the present invention. As well as driving the motor windings with full sinusoidal drive currents, these circuits also provide good start-up and low speed characteristics that are advantageous in providing substantially more torque during motor start-up. The drive circuits can be timed from a motor shaft sensor or run at a frequency varying from start-up up to a set frequency.

The connection of the recovery capacitor to magnetize the winding provides the near sinusoidal current waveform provided that there is little or no motional back EMF present during the field recovery stages, i.e. during the second half of each half cycle of the sinusoidal current. With some motional or induced back EMF, such as in AC squirrel cage induction motors, the sinusoidal waveform may be distorted but the motor will still function well and energy savings and efficiency improvements can still be obtained.

Reluctance motors of the switched or synchronous reluctance types are particularly suited to magnetic field energy recovery because, unlike squirrel cage induction motors, they do not create ‘motional’ back EMFs in the stator winding arising from rotation of the rotor. Although there is a motional change of inductance in the motor winding of some reluctance motors, this does not destroy the field energy recovery and in some cases can aid it. For example, if the inductance increases as the winding current is falling, then this will delay the fall and increase the width of the current pulse in some designs.

### Power Supplies

### 22.1 Off-Line Power Supplies

FIGS. 22A-22C show three off-line power supplies suitable for powering the electromagnetic field energy recycling drive circuits according to the current invention. The topologies of these supply circuits are standard prior art arrangements and are typically driven from 50 Hz or 60 Hz mains power. Capacitors and inductors provide filtering. Each supply has a large reservoir capacitor placed across the DC output of the supply near the drive circuit for supply pulse currents.

FIG. 22A shows a transformer-coupled off-line supply. The transformer may have a step-up, step-down, or 1:1 winding ratio. A full wave bridge rectifier provides DC from the off-line AC.

FIG. 22B shows a direct-coupled off-line supply. A full wave bridge rectifier provides DC from the off-line AC.

FIG. 22C shows a switchmode off-line supply. A switchmode supply converts the off-line AC to DC.

### 22.2 Battery Power Supplies

FIGS. 22D-22G show four battery power supplies suitable for powering the electromagnetic field energy recycling drive circuits according to the current invention. The topologies of these supply circuits are standard prior art arrangements and are typically supplied from a battery or a bank of batteries. Capacitors and inductors provide filtering. Each supply has a large reservoir capacitor placed across the DC output of the supply near the drive circuit for supply pulse currents.

FIG. 22D shows a simple battery supply with a series filter inductor between the battery and the reservoir capacitor.

FIG. 22E shows a simple battery supply with a series filter inductor and semiconductor diode between the battery and the reservoir capacitor.

FIG. 22F shows a battery supply with a DC to DC converter for stepping up or stepping down the battery voltage to obtain the voltage for the drive circuit. The output of the DC to DC converter is connected to the reservoir capacitor and the drive circuit through a series filter inductor.

FIG. 22G shows a battery supply with a DC to DC converter for stepping up or stepping down the battery voltage to obtain the voltage for the drive circuit. The output of the DC to DC converter is connected to the reservoir capacitor and the drive circuit through a series filter inductor and semiconductor diode.

### Gate Drivers

### 23.1 FET Switch Gate Drivers

FIGS. 22A and 23B show FET switch gate drivers suitable for driving the FET switches shown in the embodiments of the current invention. A FET switch is controlled by a switching control signal derived from a switching controller (not shown in FIGS. 23A and 23B, but shown as switching controller SC in other figures). The switching control signal is connected to the FET switch gate through an optically isolated opto-coupler, for example HCPL-3120 from Hewlett Packard. The opto-coupler is powered from a 15 volt supply derived from an electrically isolated DC to DC converter. One suitable converter is NME1215S from C&D Technologies which provides 2 kV isolation and supplies 1 watt at 15 volts output for a 12 volt input.

The 12 volt supply for the electrically isolated converter is derived from an AC or DC supply.

FIG. 23A shows a gate driver supplied off-line by an AC to DC converter. The converter converts the line frequency, for example 50 Hz or 60 Hz, to DC. TRECO supplies one suitable converter that converts 50 Hz 240 volts AC to the 12 volts DC for supply the electrically isolated converter.

FIG. 23B shows a gate driver supplied from a battery or battery bank by a DC to DC converter. The converter converts the battery voltage to 12 volts DC. TRECO supplies suitable converters that convert 9 to 36 volts DC, or 18 to 72 volts DC, to the 12 volts DC for supply the electrically isolated converter.

### Optimization

### 24.1 Circuit Resistances and Decrements

For maximum efficiency of the energy recycling circuits described above, it is important that circuit losses, and particularly the loaded circuit decrement of the inductance-capacitance recycling circuit, be kept as low as practicable. The decrement is the lost energy over each cycle that needs to be topped up from the supply. The decrement of an LCR circuit is the energy dissipated per cycle and is denoted by:

E^{D}=RI²/2f

where I=maximum peak value of current
R=circuit resistance
f=frequency.

The decrement is a similar parameter to the quality factor (Q) which is the ratio of the maximum energy stored to the energy dissipated per cycle.

The circuit resistance includes the resistances of the winding, the controlled switches and the diodes, and the equivalent series resistance (ESR) of the recovery capacitor. For optimum or good energy recovery, it is necessary to keep the total circuit resistances as low as possible.

One useful rule of thumb is that the resistance of any winding group or inductive device should be no more than one ohm, particularly for lower frequency applications running at 50 to 100 Hz. It is desirable that the series circuit comprising the inductive device and the recovery capacitor has a total resistance of less than one ohm.

### 24.2 Number of Winding Turns

Field energy recovery is aided by keeping the ratio of the number of winding turns (N) to the inductance L high, and by keeping as much of the magnetic flux as possible encompassed within the winding cross-sectional area so that on collapse of the flux, the induced currents and voltages are as high as possible.

It is advantageous if the number of turns is not less than 280, in applications operating at 50 Hz.

Inductance is directly proportional to the number of winding turns squared (N²) and the cross-sectional area (A) of the winding. Therefore, it is important to keep the cross-sectional area as small as possible. For practical purposes compact coils or windings with small mean radii will perform best. In electrical machines, the rotor length to diameter ratio (L/D), controlled by the lamination stack length, is best kept around 1.0 to 1.2. However, values outside this optimum can still result in successful application of the present invention and in many cases the invention can be advantageously applied to conventional electrical equipment without modification of the winding or windings.

### 24.3 Magnetizing Period

The magnetizing period has been described in some embodiments as being substantially equal to kπ√(LC) where L is the inductance value of the inductive device L1, C is the capacitance value of the recovery capacitor C1, and k is substantially between 0.1 and 2.5, preferably between 0.25 and 1.0, more preferably between 0.35 and 0.70, and most preferably approximately equal to 0.5.

In general, the circuits can be operated with efficient transfer of energy between the inductive device and the recovery capacitor when the magnetizing period t_{MAG} is close to or substantially equal to 0.5π√(LC). However, circuits with combinations of magnetizing period, and inductance and capacitance values not satisfying that relationship are useful and still provide energy recycling and voltage compounding or multiplication. For example, the specific version of the first embodiment, described above in Section 1.17 with reference to the table shown in FIG. 1K and the graph shown in FIG. 1L, operates at high load power output levels and high power transfer efficiencies at a magnetizing period of 5 mS, an inductance of 36 mH, and values of recovery capacitance less than the 281 μF value satisfying the relationship t_{MAG}=0.5π√(LC). In other examples, such as the second, third, fourth and fifth embodiments, the recovery capacitor can be oversized, i.e. made larger than specified by the above relationship, to give good peak magnetizing currents but with some ‘peaking’ in the shape of the sinusoidal wave form. The use of an oversized capacitor has been found to be suitable for variable or synchronous reluctance motors which operate with changing inductance.

Optimization of circuit performance depends on the application and on the desired attributes. For example, copper volume of the winding of the inductive device, purity of sinusoidal waveform of the magnetizing current, overall energy efficiency, start-up and/or running torque, must be balanced against each other in a practical application.

### Winding Q

While practical values of winding resistances are usually greater than 1 ohm in fractional horse power machines, any winding can be assessed for electromagnetic field energy recycling conversion by measurement of the static inductance, or the range of change of inductance, and the winding resistance. Calculation or measurement of the Q at 50 Hz or 100 Hz is then sufficient to provide a figure of merit for that particular winding.

Providing the loaded Q of the operating circuit can be kept greater than 1, the efficiency of circuits with windings of 10 to 20 ohms or more is still acceptable because the ratio of inductance to resistance remains high. Keeping the resistance as low as possible and the inductance high always provides the best loaded Q and circuit efficiency but requires greater than standard winding volumes and is therefore only possible in custom made designs.

Alternatively, the loaded Q of the recycling circuits described above is advantageously designed to be kept at 2 or above.

### Simulation

### 25.1 Circuit Simulation

Operation of the embodiments and applications of the current invention described above can be simulated on SPICE-based CircuitMaker 2000 or other suitable simulation programs. Although such simulations may use algorithms that in some cases do not always accurately correspond to practical circuit operation, useful predictions of optimum component values and circuit performances can be obtained. A voltage variable SPICE inductor model allows modelling of the circuits of the invention with varying inductance such as seen in the operation of reluctance motors, solenoids and linear actuators. Finite Element Analysis (FEA) simulation programs can also be used to model the invention. In cases where practical circuits according to some embodiments of the invention have been constructed, bench tests have confirmed results obtained by simulation.

1. A magnetic field energy recycling circuit comprising one or more capacitances, an inductive device, a switching circuit, and a switching circuit controller;
the switching circuit controller being arranged to repetitively configure the switching circuit in a first switching circuit configuration by which the switching circuit electrically couples a first capacitance to a first inductance of the inductive device in a first circuit for a first period to transfer energy stored in the first capacitance to the inductive device by discharge of the first capacitance to thereby assist in establishing a magnetic field at the inductive device, the voltage across the first capacitance at the end of the first period being less than half the voltage across the first capacitance at the beginning of the first period;
subsequent to configuration of the switching circuit in the first switching circuit configuration, the switching circuit adopting a second switching circuit configuration by which the switching circuit electrically couples a second inductance of the inductive device to a second capacitance in a second circuit for a second period to transfer energy stored in the magnetic field to the second capacitance by a current flow in the second inductance to thereby assist in establishing a charge on the second capacitance, the current flow in the second inductance being substantially zero at the end of the second period;
subsequent to configuration of the switching circuit in the second switching circuit configuration, the switching circuit adopting a third switching circuit configuration by which the charge established on the second capacitance during the second period is held on the second capacitance; and
the switching circuit controller being arranged to configure the switching circuit, subsequent to configuration of the switching circuit in the third switching circuit configuration, in a switching circuit configuration by which energy stored in the second capacitance is transferred to an inductive device.

2. A magnetic field energy recycling circuit as claimed in claim 1, wherein the voltage across the first capacitance at the end of the first period is less than 10% of the voltage across the first capacitance at the beginning of the first period.

3. A magnetic field energy recycling circuit as claimed in claim 1, wherein the voltage across the first capacitance at the end of the first period is substantially zero.

4. A magnetic field energy recycling circuit as claimed in claim 1, wherein:
the first period is substantially equal to one quarter of a natural resonance period of the first circuit; and
the second period is substantially equal to one quarter of a natural resonance period of the second circuit.

5. A magnetic field energy recycling circuit as claimed in claim 1, wherein:
the first period, in seconds, is substantially equal to half the product of pi and the square root of the product of the first capacitance in farads during the first period and the average value of the first inductance in henries during the first period; and
the second period, in seconds, is substantially equal to half the product of pi and the square root of the product of the second capacitance in farads during the second period and the average value of the second inductance in henries during the second period.

6. A magnetic field energy recycling circuit as claimed in claim 1, wherein:
the first period is substantially equal to kπ√(L1 C1) seconds, where C1 is the first capacitance in farads during the first period and L1 is the average value of the first inductance in henries during the first period,
the second period is substantially equal to kπ√(L2 C2) seconds, where C2 is the second capacitance in farads during the second period and L2 is the average value of the second inductance in henries during the second period, and
k is between 0.35 and 2.5.

7. A magnetic field energy recycling circuit as claimed in claim 1, wherein the magnetic field energy recycling circuit is adapted for connection to a supply of electrical energy that is electrically coupled in series with the first capacitance when the switching circuit is configured in the first switching circuit configuration.

8. A magnetic field energy recycling circuit as claimed in claim 1, wherein:
the first capacitance is provided by one or more capacitors; and
the second capacitance is provided by the same one or more capacitors.

9. A magnetic field energy recycling circuit as claimed in claim 8, wherein:
the first capacitance is provided by two or more capacitors electrically connected in parallel when the switching circuit is in the first switching circuit configuration; and
the second capacitance is provided by the same two or more capacitors electrically connected in series when the switching circuit is in the second switching circuit configuration.

10. A magnetic field energy recycling circuit as claimed in claim 8, wherein the voltage across the one or more capacitors at the beginning of the first period and the voltage across the one or more capacitors at the end of the second period have the same polarity.

11. A magnetic field energy recycling circuit as claimed in claim 8, wherein the voltage across the one or more capacitors at the beginning of the first period and the voltage across the one or more capacitors at the end of the second period have opposite polarities.

12. A magnetic field energy recycling circuit as claimed in claim 1, wherein:
the first capacitance is provided by one or more capacitors; and
the second capacitance is not provided by the same one or more capacitors providing the first capacitance.

13. A magnetic field energy recycling circuit as claimed in claim 12, wherein:
one terminal of the first capacitance and one terminal of the second capacitance are connected to a common potential; and
the voltage across the first capacitance at the beginning of the first period and the voltage across the second capacitance at the end of the second period have the same polarity.

14. A magnetic field energy recycling circuit as claimed in claim 1, wherein the first inductance and the second inductance are provided by respective windings of the same inductive device.

15. A magnetic field energy recycling circuit as claimed in claim 1, wherein the first inductance and the second inductance are both provided by a common winding of the same inductive device.

16. A magnetic field energy recycling circuit as claimed in claim 15, wherein:
the switching circuit, when in the first switching circuit configuration, is configured to transfer energy stored in the first capacitance to the winding to establish a magnetic field at the winding;
the switching circuit, when in the second switching circuit configuration, is configured to transfer energy stored in the magnetic field at the winding to the second capacitance to establish a charge on the second capacitance; and
the switching circuit, when in the third switching circuit configuration, is configured to hold the charge on the second capacitance until the switching circuit controller configures the switching circuit in a further switching circuit configuration for a further period by which further configuration energy stored in the second capacitance is transferred back to the winding.

17. A magnetic field energy recycling circuit as claimed in claim 1, and adapted for connection to a supply of electrical energy, wherein after the end of the first period and before the beginning of the second period, the switching circuit is configured in an intermediate switching circuit configuration by which current from the supply is directed through the first inductance to assist in maintaining the magnetic field established at the inductive device.

18. A magnetic field energy recycling circuit comprising a capacitor, an inductive device and a switching circuit, wherein:
the switching circuit is configurable in a first configuration to direct a capacitor discharge current to flow in a first direction from the capacitor and through the inductive device to thereby establish a magnetic field in association with the inductive device;
the switching circuit is configurable in a second configuration, after the magnetic field has been established, to direct a current induced in the inductive device during collapse of the magnetic field to flow into the capacitor in a second direction that is opposite the first direction to thereby charge the capacitor; and
the switching circuit is configured in the first configuration for a period that is substantially equal to kπ√(LC) seconds, where L is the inductance value in henries of the inductive device, C is the capacitance value in farads of the capacitor, and k is between 0.1 and 2.5.

19. A magnetic field energy recycling circuit comprising a capacitor, an inductive device and first, second, third and fourth switching devices, wherein:
each of the first and second switching devices is a respective controllable switch having a closed state and an open state;
each of the third and fourth switching devices has a closed state and an open state;
the capacitor, the first switching device, the inductive device and the second switching device are series connected in that order in a first series circuit through which, during a first period when the first and second switching devices are each in the closed state, a capacitor discharge current flows in a first direction from the capacitor and through the inductive device to thereby establish a magnetic field in association with the inductive device;
the capacitor, the third switching device, the inductive device and the fourth switching device are series connected in that order in a second series circuit through which, after the magnetic field has been established and during a second period when the first and second switching devices are each in the open state, a current induced in the inductive device during collapse of the magnetic field flows into the capacitor in a second direction that is opposite the first direction to thereby charge the capacitor; and
the first period is substantially equal to kπ√(LC) seconds, where L is the inductance value of the inductive device, C is the capacitance value of the capacitor, and k is between 0.1 and 2.5.

20. A magnetic field energy recycling circuit comprising a capacitor, an inductive device and first, second, third, fourth, fifth and sixth switching devices, wherein:
each of the switching devices is a respective controllable switch having a closed state and an open state;
the capacitor, the first switching device, the inductive device and the second switching device are series connected in that order in a first series circuit through which, during a first period when the first and second switching devices are each in the closed state and the third, fourth, fifth and sixth switching devices are each in the open state, a capacitor discharge current flows in a first direction from the capacitor and through the inductive device to thereby establish a first magnetic field in association with the inductive device, the first magnetic field having a first polarity;
the capacitor, the third switching device, the inductive device and the fourth switching device are series connected in that order in a second series circuit through which, after the first magnetic field has been established and during a second period when the first, second, fifth and sixth switching devices are each in the open state and the third and fourth switching devices are each in the closed state, a current induced in the inductive device during collapse of the first magnetic field flows to provide a capacitor charge current flowing in a second direction that is opposite the first direction to thereby charge the capacitor;
the capacitor, the fourth switching device, the inductive device and the fifth switching device are series connected in that order in a third series circuit through which, during a third period when the fourth and fifth switching devices are each in the closed state and the first, second, third and sixth switching devices are each in the open state, a capacitor discharge current flows in the first direction from the capacitor and through the inductive device to thereby establish a second magnetic field in association with the inductive device, the second magnetic field having a second polarity that is opposite the first polarity;
the capacitor, the sixth switching device, the inductive device and the first switching device are series connected in that order in a fourth series circuit through which, after the second magnetic field has been established and during a fourth period when the second, third, fourth and fifth switching devices are each in the open state and the first and sixth switching devices are each in the closed state, a current induced in the inductive device during collapse of the second magnetic field flows into the capacitor in the second direction to thereby charge the capacitor;
the switching devices are repeatedly switched between the closed and open states to repeatedly provide in sequence the first, second, third and fourth series circuits for the respective first, second, third and fourth periods; and
the first and third periods are each substantially equal to kπ√(LC) seconds, where L is the inductance value of the inductive device, C is the capacitance value of the capacitor, and k is between 0.1 and 2.5.

21. A magnetic field energy recycling circuit comprising a capacitor, an inductive device and a switching circuit, wherein:
the switching circuit is configurable in a first configuration to direct a capacitor discharge current to flow in a first direction from the capacitor and through the inductive device to substantially discharge the capacitor and thereby establish a magnetic field in association with the inductive device;
the switching circuit is configurable in a second configuration, after the magnetic field has been established, to direct a current induced in the inductive device during collapse of the magnetic field to flow into the capacitor in a second direction that is opposite the first direction to thereby charge the capacitor.

22. A magnetic field energy recycling circuit as claimed in claim 21, wherein the capacitor discharge current discharges the capacitor such that the voltage across the capacitor is zero.

23. A switched reluctance motor comprising a magnetic field energy recycling circuit as claimed in claim 1, wherein the inductive device is a stator winding of the switched reluctance motor.

24. A synchronous reluctance motor comprising a magnetic field energy recycling circuit as claimed in claim 1, wherein the inductive device is a stator winding of the synchronous reluctance motor.

25. A solenoid driven actuator comprising a magnetic field energy recycling circuit as claimed in claim 1, wherein the inductive device is a solenoid of the solenoid driven actuator.

26. A solenoid driven pump comprising a magnetic field energy recycling circuit as claimed in claim 1, wherein the inductive device is a solenoid of the solenoid driven pump.

27. A transformer comprising a magnetic field energy recycling circuit as claimed in claim 1, wherein the inductive device is a winding of the transformer.

28. An electrical generator comprising a magnetic field energy recycling circuit as claimed in claim 1, wherein the inductive device is a winding of the electrical generator.

29. An induction heater comprising a magnetic field energy recycling circuit as claimed in claim 1, wherein the inductive device is a work coil of the induction heater.

30. An inductive power transfer device comprising a magnetic field energy recycling circuit as claimed in claim 1, wherein the inductive device is a winding of the inductive power transfer device.

31. A method of operating an inductive device comprising the steps of:
(a) connecting a capacitance to an inductance of the inductive device in a first circuit for a first period to transfer energy stored in the capacitance to the inductive device by discharge of the capacitance such that voltage across the capacitance at the end of the first period is less than half the voltage across the capacitance at the beginning of the first period, and to thereby assist in establishing a magnetic field at the inductive device;
(b) connecting the inductance of the inductive device to the capacitance in a second circuit for a second period to transfer energy stored in the magnetic field to the capacitance by a current flow in the inductance such that the current flow in the inductance at the end of the second period is substantially zero, and to thereby assist in establishing a charge on the capacitance;
(c) holding the charge, established on the capacitance during the second period, on the capacitance for a third period; and
d) repeating steps (a), (b) and (c).

32. A method of operating an inductive device as claimed in claim 31, wherein in step (a), the voltage across the capacitance at the end of the first period is less than 10% of the voltage across the capacitance at the beginning of the first period.

33. A method of operating an inductive device as claimed in claim 31, wherein in step (a), the voltage across the capacitance at the end of the first period is substantially zero.

34. A method of operating an inductive device as claimed in claim 31, wherein:
the first period is substantially equal to one quarter of a natural resonance period of the first circuit; and
the second period is substantially equal to one quarter of a natural resonance period of the second circuit.

35. A method of operating an inductive device as claimed in claim 31, wherein:
the first period, in seconds, is substantially equal to half the product of pi and the square root of the product of the capacitance in farads during the first period and the average value of the inductance in henries during the first period; and
the second period, in seconds, is substantially equal to half the product of pi and the square root of the product of the capacitance in farads during the second period and the average value of the inductance in henries during the second period.

36. A method of operating an inductive device as claimed in claim 31, wherein:
the first period is substantially equal to 0.5π√(L1 C1) seconds where C1 is the capacitance in farads during the first period and L1 is the average value of the inductance in henries during the first period, and
the second period is substantially equal to 0.5π√(L2 C2) seconds, where C2 is the capacitance in farads during the second period and L2 is the average value of the inductance in henries during the second period.

37. A method of operating an inductive device as claimed in claim 31, wherein in step (a), a supply of electrical energy is electrically connected in series with the capacitance.

38. A method of operating an inductive device as claimed in claim 31, wherein:
in step (a), the capacitance is provided by one or more capacitors connected in parallel; and
in step (b), the capacitance is provided by the same one or more capacitors connected in series.

39. A method of operating an inductive device as claimed in claim 31, wherein between steps (a) and (b), current from a supply of electrical energy is directed through the inductance to assist in maintaining the magnetic field established in step (a) at the inductive device.

40. A method of operating an inductive device as claimed in claim 31, wherein the inductive device is a stator winding of a switched reluctance motor.

41. A method of operating an inductive device as claimed in claim 31, wherein the inductive device is a stator winding of a synchronous reluctance motor.

42. A method of operating an inductive device as claimed in claim 31, wherein the inductive device is a solenoid of a solenoid driven actuator.

43. A method of operating an inductive device as claimed in claim 31, wherein the inductive device is a solenoid of a solenoid driven pump.

44. A method of operating an inductive device as claimed in claim 31, wherein the inductive device is winding of a transformer.

45. A method of operating an inductive device as claimed in claim 31, wherein the inductive device is a winding of an electrical generator.

46. A method of operating an inductive device as claimed in claim 31, wherein the inductive device is a work coil of an induction heater.

47. A method of operating an inductive device as claimed in claim 31, wherein the inductive device is a winding of an inductive power transfer device.
